(19) United States
(12) Patent Application Publication
(10) Pub. No.: US 2015/0347984 A1
(43) Pub. Date: Dec. 3, 2015

(54) SYSTEMS AND METHODS INVOLVING FEATURES OF TERMINAL OPERATION INCLUDING TRACKING, APPOINTMENT AND/OR OTHER FEATURES

(71) Applicant: Ports America, Jersey City, NJ (US)

(72) Inventors: Irina SHEYKH-ZADE, San Ramon, CA (US); Geeta Desai, Dublin, CA (US); Sophie Miron, San Leandro, CA (US); Chung Daniel Song, Newark, CA (US); Nathan Johnson, Paradise Valley, AZ (US); Theresa Hill, Richmond, CA (US); Eldar Sheykh-Zade, San Ramon, CA (US); Liang Lu, Alameda, CA (US); Teresa Duffy, Alameda, CA (US); Kathryn R. Scott, Neptune Beach, FL (US); Young iL Moon, Dublin, CA (US)

(21) Appl. No.: 14/609,182

(22) Filed: Jan. 29, 2015

Related U.S. Application Data
(60) Provisional application No. 61/965,458, filed on Jan. 29, 2014.

(51) Int. Cl. G06Q 10/10; G06F 3/0481; G06Q 20/10; G06F 3/0484

(52) U.S. Cl. CPC G06Q 10/1095; G06F 3/04842; G06F 3/04817; G06Q 20/10

(57) ABSTRACT

Systems and methods are disclosed for processing information related to appointment systems as well as associated terminal operating systems and other related systems. According to one illustrative implementation, an exemplary method for processing information involving appointment systems herein may include receiving/handling/processing data in a TOS format associated with a TOS type, converting the data into a TOS agnostic format, and performing processing using the TOS agnostic data. In another exemplary implementation, there is provided computer-implemented methods for processing information for appointment systems in conjunction with associated systems and operations. Systems and computer-implemented methods herein may include or involve processing information related to an appointment system and interrelationships with associated terminal operating systems, gate systems, and/or various TOS-agnostic features and functionality.

### CROSS-REFERENCE TO RELATED APPLICATION(S)

This application claims benefit/priority of U.S. provisional patent application No. 61/965,458, filed Jan. 29, 2014, which is incorporated herein by reference in entirety.

### APPENDIX MATERIALS

Appendices, labeled “Appendix 1” through “Appendix 5”, are attached hereto and incorporated by reference herein in their entirety. This application also includes and hereby incorporates by reference the computer program appendix materials submitted herewith on compact disc (CD) as well as the Transmittal Letter regarding the CD materials, which lists the files on each compact disc. The incorporated computer program materials are contained on one compact disc, and a duplicate copy is also provided per 37 CFR 1.77(b)(5), thus two (2) discs are submitted herewith (labeled “Copy 1” and “Copy 2”, respectively).

### BACKGROUND

The process of importing and exporting containers and goods at a port involves multiple parties and requires significant communication and coordination. In addition, the parties involved must adhere to numerous regulations and guidelines.

Systems known as Terminal Operating Systems (TOS) have been developed to support this process at port terminals around the world. Many of the standard operating procedures related to activities at the terminal, such as import and export functions, have become a part of these TOS applications, although they are implemented differently.

However, aspects such as resource (equipment utilization and labor) planning and management, exception management, real-time exception management, TOS-agnostic software/platforms/components and other interrelated functionality are areas that have not been adequately addressed by existing Terminal Operating Systems.

The shipping industry, as briefly described in FIG. 1, includes both the actual transport of goods from and to overseas, but also the interface with port facilities and third parties. As FIG. 1 shows, there are multiple parties involved in the transportation of goods through port facilities, and the port interfaces are capable of introducing delays in the overall shipping time.

For example, a Trucking Company may schedule a pick-up a container and make an appointment that includes specific counts and types of containers. For each container, attributes such as dimensions, etc. are specified. When an entity associated with such container (e.g., driver etc.) comes to the terminal to process or deliver the container, system uses information pre-entered by the entity while making an appointment. Attributes of one or more containers may not match the specified attributes of the appointment. In this scenario, such entity typically will not be allowed to process or deliver the container until the information matches the container.

In the past, issues such as the one described above required a significant amount of communication and paperwork between parties to understand the nature of the problem and to update or correct the information so that the entity could continue with the desired handling of the container(s).

### BRIEF DESCRIPTION OF THE DRAWINGS

The accompanying drawings, which constitute a part of this specification, illustrate various implementations and features of the present inventions and together with the description, help explain aspects of the innovations herein. In the drawings:

FIG. 1 is an illustration of a shipping cycle consistent with one or more aspects of the innovations herein.

FIG. 2 is a block diagram of a Terminal Operating System consistent with one or more aspects of the innovations herein.

FIG. 3A is a block diagram of illustrative model, view and controller applications, components and/or interactions as may be associated with implementations of Terminal Operating Systems consistent with one or more aspects of the innovations herein.

FIGS. 3B-3C are block diagrams of illustrative model, view and controller applications, components and/or interactions as may be associated with implementations of Terminal Operating Systems consistent with one or more aspects of the innovations herein.

FIG. 4 is a block diagram showing various entities and interactions within or among such entities and an illustrative web- or network-based system consistent with one or more aspects of the innovations herein.

FIG. 5 is a block diagram depicting various exemplary features, services or components involved with present TOS web portal implementations consistent with one or more aspects of the innovations herein.

FIG. 6 is a block diagram depicting exemplary booking module aspects and entities consistent with one or more aspects of the innovations herein.

FIG. 7 is a diagram showing exemplary hierarchy and structure of illustrative web-based modules consistent with one or more aspects of the innovations herein.

FIG. 8 is a block diagram showing illustrative aspects of repository mapping from TOS to business entities consistent with one or more aspects of the innovations herein.

FIG. 9 is a diagram showing an illustrative repository caching scheme consistent with one or more aspects of the innovations herein.

FIG. 10 is an illustration of an exemplary TOS-independent or TOS-agnostic repository locator consistent with one or more aspects of the innovations herein.

FIG. 11 is a block diagram illustrating exemplary system topology consistent with one or more aspects of the innovations herein.

FIG. 12 is an exemplary flow diagram of an illustrative user authentication and authorization process consistent with one or more aspects of the innovations herein.

FIG. 13 is an exemplary flow diagram of an illustrative forms authentication and authorization process consistent with one or more aspects of the innovations herein.

FIGS. 14A-1, 14A-2, and 14A-3 show exemplary flow diagrams involving illustrative repository processing consistent with one or more aspects of the innovations herein.

FIGS. 14B-1 and 14B-2 show exemplary flow diagrams involving illustrative repository processing consistent with one or more aspects of the innovations herein.

FIG. 14C shows an exemplary sequence diagram involving an illustrative business object processing consistent with one or more aspects of the innovations herein.

FIG. 14D shows another exemplary flow chart involving illustrative business object processing consistent with one or more aspects of the innovations herein.

FIG. 15 shows an exemplary flow of processing performed via an illustrative TOS agnostic system and associated processing consistent with one or more aspects of the innovations herein.

FIG. 16 shows an exemplary work flow diagram of illustrative TOS agnostic processing consistent with one or more aspects of the innovations herein.

FIG. 17A shows an exemplary flow diagram of illustrative TOS agnostic repository locator processing consistent with one or more aspects of the innovations herein.

FIG. 17B shows an exemplary sequence diagram involving an illustrative appointment process and TOS agnostic processing consistent with one or more aspects of the innovations herein.

FIGS. 18A-18D are block diagrams depicting illustrative layer architectures for an exemplary TOS agnostic system consistent with one or more aspects of the innovations herein.

FIG. 19 is a block diagram depicting illustrative layer architecture and associated processing modules for an exemplary TOS agnostic system consistent with one or more aspects of the innovations herein.

FIG. 20 is a block diagram depicting an illustrative repository locator hierarchy/structure for an exemplary TOS agnostic system consistent with one or more aspects of the innovations herein.

FIG. 21 shows an exemplary sequence diagram involving an illustrative appointment process and TOS agnostic processing consistent with one or more aspects of the innovations herein.

FIGS. 22A-22E illustrate block diagrams of exemplary appointment environments and systems consistent with one or more aspects of the innovations herein.

FIGS. 23A-23E are diagrams illustrating appointment features or processes consistent with one or more aspects of the innovations herein.

FIGS. 24A-B are block diagrams illustrating truck company profile systems or processes consistent with one or more aspects of the innovations herein.

FIGS. 24C-D are block diagrams depicting illustrative layer architectures for an exemplary TOS agnostic system for making an appointment consistent with one or more aspects of the innovations herein.

FIGS. 24E-G are sequence diagrams illustrating an exemplary TOS agnostic system for making an appointment consistent with one or more aspects of the innovations herein.

FIGS. 24H-L are exemplary flow diagrams of an illustrative workflow process consistent with one or more aspects of the innovations herein.

FIG. 24M is an exemplary flow diagram of an illustrative workflow process for making a dual appointment consistent with one or more aspects of the innovations herein.

FIG. 24N is an exemplary flow diagram of an illustrative workflow process for making an appointment for multiple terminals consistent with one or more aspects of the innovations herein.

FIG. 24O is an exemplary flow diagram of an illustrative workflow process for an appointment interface with a gate operating system consistent with one or more aspects of the innovations herein.

FIG. 24P is an exemplary block diagram of an illustrative workflow process of an appointment interface with a gate operating system consistent with one or more aspects of the innovations herein.

FIG. 24Q is an exemplary flow diagram of an illustrative workflow process for RFID registration consistent with one or more aspects of the innovations herein.

FIGS. 24R-S are an exemplary flow diagram of an illustrative workflow process for truck company registration and appointments consistent with one or more aspects of the innovations herein.

FIGS. 25A-25J are diagrams of exemplary Appointment user interfaces consistent with one or more aspects of the innovations herein.

FIGS. 25K-25V are diagrams of exemplary Appointment user interfaces consistent with one or more aspects of the innovations herein.

FIGS. 26A-26E are diagrams of exemplary Appointment user interfaces consistent with one or more aspects of the innovations herein.

FIGS. 27A-B are diagrams of exemplary Appointment user interfaces with payment features and functionality consistent with one or more aspects of the innovations herein.

FIGS. 28A1-28A4 and 28B-28E are diagrams of exemplary Appointment user interfaces consistent with one or more aspects of the innovations herein.

FIGS. 29A-29C are diagrams of exemplary Appointment user interfaces consistent with one or more aspects of the innovations herein.

FIG. 30 is a diagram of an exemplary Demurrage Calculator user interface consistent with one or more aspects of the innovations herein.

FIG. 31 is a diagram of an exemplary Site Management user interface consistent with one or more aspects of the innovations herein.

FIGS. 32A-32B are diagrams of exemplary Steamship Company user interfaces consistent with one or more aspects of the innovations herein.

FIG. 33 is a diagram of an exemplary Trucking Company user interface consistent with one or more aspects of the innovations herein.

FIGS. 34A-34B are diagrams of exemplary Administrator Daily Message user interfaces and features consistent with one or more aspects of the innovations herein.

FIGS. 35A-35C are diagrams of an exemplary Reports user interface consistent with one or more aspects of the innovations herein.

FIG. 36 is a diagram of an exemplary broadcast email user interface consistent with one or more aspects of the innovations herein.

FIGS. 37A-37C are diagrams of an exemplary EIR user interface consistent with one or more aspects of the innovations herein.

FIG. 38 is a diagram of an exemplary Release user interface consistent with one or more aspects of the innovations herein.

FIG. 39 is a diagram of an exemplary Reports user interface consistent with one or more aspects of the innovations herein.

FIG. 40 is a diagram of an exemplary MultiTrack user interface consistent with one or more aspects of the innovations herein.

FIG. 41 is a diagram of an exemplary Equipment History user interface consistent with one or more aspects of the innovations herein.

FIG. 42 illustrates an exemplary block diagram for integration of an appointment system and gate consistent with one or more aspects of the innovations herein.

FIG. 43 illustrates an exemplary block diagram for truck arrival at a terminal consistent with one or more aspects of the innovations herein.

FIG. 44 illustrates an exemplary block diagram for OCR terminal and gate portal consistent with one or more aspects of the innovations herein.

FIG. 45 illustrates an exemplary block diagram for pre-advice of containers consistent with one or more aspects of the innovations herein.

FIG. 46 illustrates an exemplary chart of timeslot scenarios consistent with one or more aspects of the innovations herein.

FIGS. 47A-47U are diagrams of exemplary mobile appointment user interfaces including a landing page (FIG. 47A), terminal landing page (FIG. 47B), menu (FIG. 47C), login (FIG. 47D), gate inquiry (FIGS. 47E-47F), import inquiry (FIGS. 47G-47H), appointment (FIGS. 47I-47P), daily message (FIG. 47Q), terminal location (FIGS. 47R-47T), contact (FIG. 47U), about (FIG. 47V), consistent with one or more aspects of the innovations herein.

### DETAILED DESCRIPTION OF ILLUSTRATIVE IMPLEMENTATIONS

Reference will now be made in detail to various implementations, examples of which are illustrated in the accompanying drawings. In the following detailed description, numerous specific details are set forth in order to provide a sufficient understanding of the subject matter presented herein. But it will be apparent to one of ordinary skill in the art that implementations subject matter may be practiced without such specific details. Moreover, the particular implementations described herein are provided by way of example, and should not be used to limit the scope of the invention to particular embodiments. In other instances, well-known methods, procedures, components, and circuits have not been described in detail so as not to unnecessarily obscure aspects of the innovations herein.

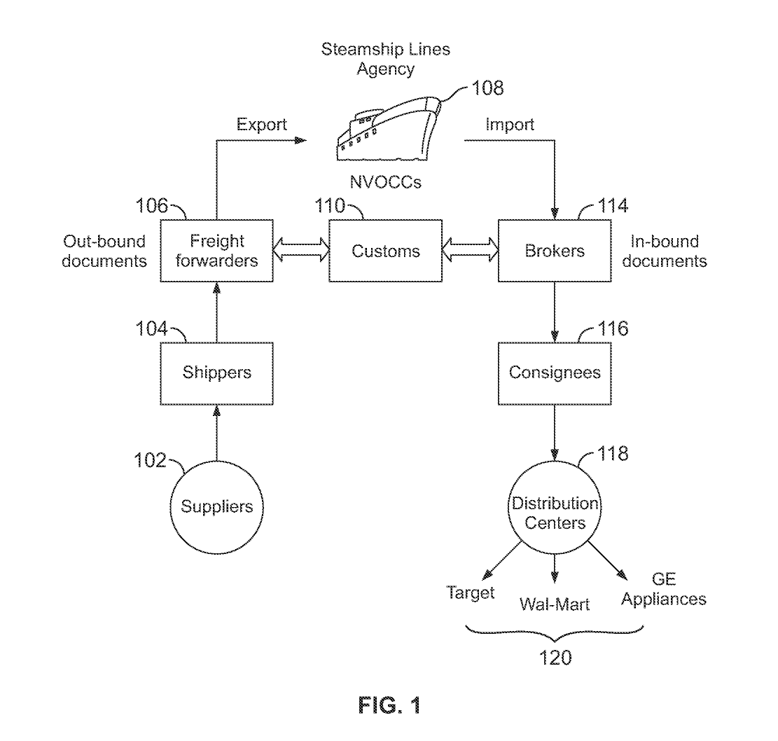

FIG. 1 illustrates a shipping environment, parties involved and logistical framework. In a typical shipping cycle, for example, suppliers 102 use shippers 104 to transport freight, which is often handled by freight forwarders 106 during the freight's passage over a common carrier 108 and through customs 110. The goods are sometimes then handled by brokers 114, who deliver the goods to consignees 116 and eventually onto distribution centers 118 and retailers 120.

In accordance with aspects of the present inventions, various computer hardware, software, user interface (UI) and/or communications features may be utilized or involved in novel ways to provide the innovative systems and methods herein. According to certain embodiments, for example, an illustrative implementation may comprise a set of computer network based applications and machine readable instructions that interface with a Terminal's TOS (Terminal Operating System). In some embodiments, implementations herein are capable of providing real-time access to information and tools for business parties including SSCOs, trucking companies, brokers, consignees, etc. to update that information, e.g., via such interface. Consistent with the present disclosure, some implementations may drive operational efficiencies and/or improve customer service. Some additional beneficial characteristics of various implementations may include, for example, one or more of the following: minimizing cargo movement problems at the terminal; improving terminal operators' ability to successfully service SSCOs and carriers; removing terminals from the role of broker between trucking and steamship companies; eliminating reliance on phone, fax and other non-electronic instructions to the terminal; delivering real-time, accurate information carriers can use to quickly pass through terminal gates; preventing terminal/gate congestion; and/or expedited trouble resolution resulting in improved turn-times for entities transferring freight/cargo.

Various implementations herein have the capability of minimizing communication and can streamline various aspects of the processes. Further, some implementations may also accomplish benefits herein by interfacing with other applications, such as an associated tracking application. Here, for example such application may facilitate logistical information sharing and communication flow among members of the shipping industry.

As a function of these systems, methods and features herein, inventions herein possess capabilities and yield abilities to give terminals network-based visibility and functionality from a variety of places at any time. For example, via features and functionality associated with the present systems and methods, implementations herein may allow trucking company to be informed when a container is ready for pick up, processed by driver, or missed reserved time slot, etc. In addition, the trucking company may be presented quick links to access, review and update their data related to the container.

Additionally, system and methods of some implementations may provide user access to real-time vessel schedules, import and export container information, gate activity, and/or user account information generated from a TOS. The terminal administrators can set up terminal-specific configuration and information; perform user account management and setup for automatic send of emails or faxes to users.

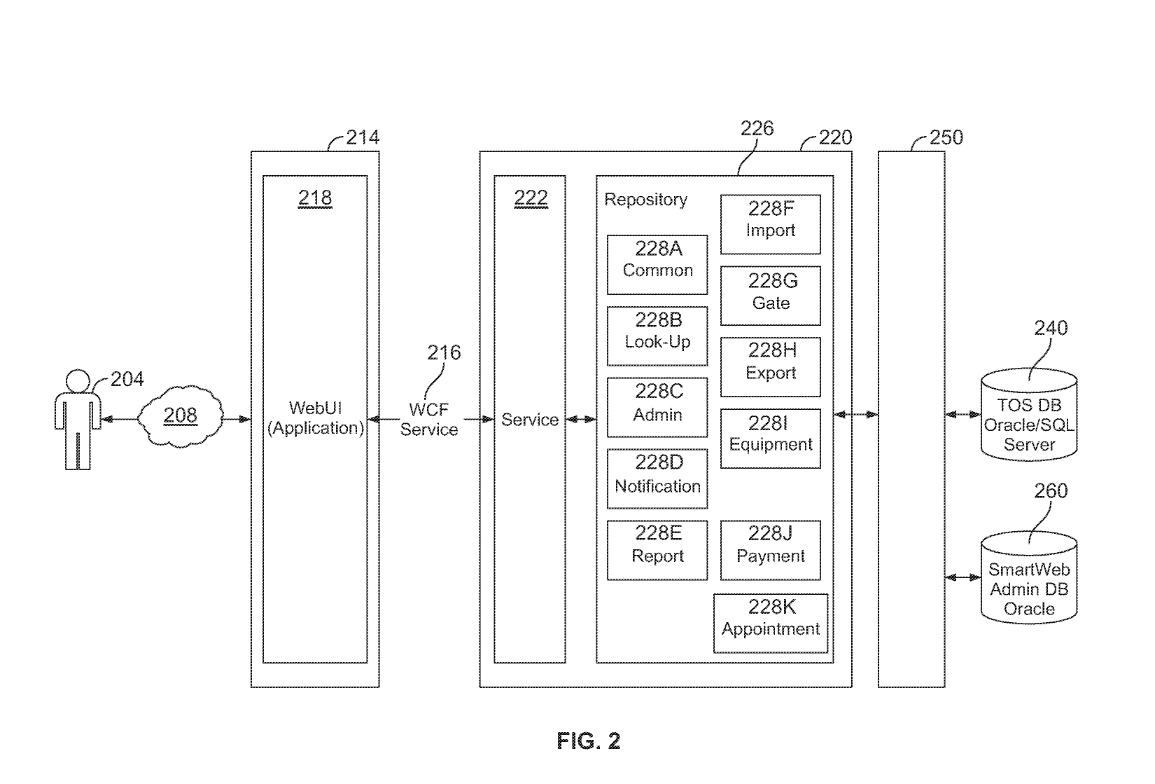

FIG. 2 details exemplary architecture of some illustrative implementations used to employ particular methods, which may be layered, module based and/or TOS agnostic. Examples of various features shown here are described below.

### Layered Architecture/Business Logic/Data Access

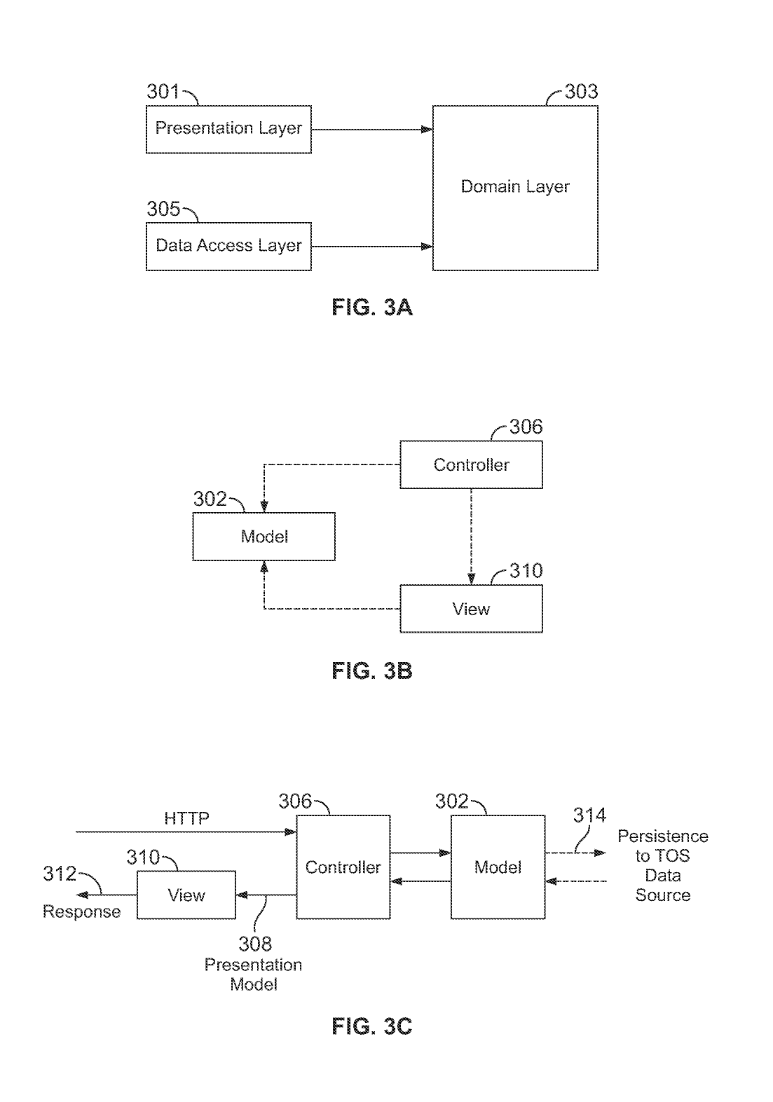

Referring to FIGS. 2 and 3A, an illustrative system is shown in FIG. 2 including a representation of an exemplary Presentation Layer 214, 301, which may be built on ASP.NET, and may involve aspects of a layered process or layered processing including features of business logic, at least one domain layer 303, and/or at least one data access layer 305.

### Layered Architecture

According to some of the present systems and methods, innovative layered architecture(s) herein are capable of providing separation of concerns and factoring of code, which in some implementations may also provide the ability to update or enhance existing features and add new features without interfering with other parts of the applications and/or the ability to split out layers into separate physical tiers to improve scalability by adding more computing resources with increase of usages. Splitting the source code into layers may allow for separate layers of the code to be edited/added/deleted/etc. separately from one another, so that some elements may be changed without affecting other elements of the system. According to an example of present systems and methods, as set forth in one illustrative implementation shown in FIG. 2, innovations herein may perform processing and/or operate in four layers: Presentation 214, Service 222, Business Logic 220 and Data Access 250 layers.

In some embodiments, the business logic in present systems and methods may be represented by a domain model of the domain layer 303 which may involve or be a conceptual model that represents the various business domain(s) of the system. Here, for example, such domain model may mingle data and process, have multivalued attributes and a complex web of associations, and/or utilize inheritance features. The domain layer 303 may include the domain model and may define the interaction between elements of the domain model.

As shown in FIG. 3A, for example, data access layer 305 may be configured as a layer that communicates with the data store for persisting and retrieving business objects. In such implementations, this data access layer 305 may include create, read, update and delete (CRUD) methods, transaction management, data concurrency, and a querying mechanism to enable the business logic layer to retrieve object for any given criteria.

Different terminal operating systems may use different data persisting technologies and may require different methods to access persisted data, addressed herein. For example, such access might entail access to relational databases from different vendors (Oracle, MS Sql, MySql, etc.), or such access might be access to the end point of WS*—compliant web services. Implementations designed to be TOS agnostic may have to switch data access method(s) with minimum impact at business logic layer and presentation layer.

According to further implementations, systems and methods herein may be designed or configured to be loosely coupled as a function of Dependency Inversion Principal (DIP) aspects. In some embodiments, such Dependency Inversion Principal aspects may state that high-level features (e.g., Business logic layer information or processing) may not depend on a lower level class (e.g., Data access layer). For example, classes in Business logic layer may instead always depend on abstractions of their required classes in the Data access layer. Thus, the Data access layer may be easily replaceable with abstractions or other data using different architecture and technology.

Here, the attached Appendices/computer program (CD) materials illustrate specific aspects and interrelations of the features described above, below and elsewhere herein.

### Presentation Layer

In certain, other implementations, the Presentation layer may include or involve components of a Model-View Controller (MVC) framework, e.g. as set forth in FIGS. 3B and 3C, able to implement the Model-View-Controller pattern. Such MVC pattern may separate the modeling of the domain, the presentation, and the actions based on user input 204 into three separate classes:

Model. The model 302 may contain or represent the data (e.g., view model or domain model) with which the user works. The model 302 may manage the behavior and data of the application domain, responds to requests for information about its state (usually from the view), and respond to instructions to change state (usually from the controller).
View. The view 310 manages the display of information. Views may be utilized to render some part of the model 302 as a user interface (“UI”).
Controller. The controller 306 interprets the mouse and keyboard inputs from the user 204, informing the model 302 and/or the view 310 to change as appropriate.

Exemplary details of such MVC framework are found in FIG. 3B which shows an example structural relationship between the three objects. Further, FIG. 3C shows an example set of Interactions in an MVC Application. In this example, the controller 306 may incorporate HTTP input and provide output represented as data in the model 302, which in some implementations may persist in a relational database 314. The controller may feed such data to the view 310 via a presentation model 308, which may govern how the data are displayed, and may prompt or interact with a user regarding a response 312. For example, the controller receives HTTP messages which may include details of user requests. Once the controller receives user request, the controller may create a model to process the request and use it to communicate with database. The model may be filled with information from database or used to update database. The model may be used to create a View that will be returned as a response.

Presentation layer also includes logics to support various mobile devices used by end users including automatic redirection and responsive UI.

Service Layer

According to various implementations herein, the service layer may define an application's boundary with a layer that establishes a set of available operations and coordinates the application's response in each operation. In some embodiments, the service layer will include the service contracts and operation contracts that are used to define the service interfaces that will exposed at the service boundary. Data contracts are also defined to pass in and out of the service.

Further, various systems and methods herein may implement the WCF [Windows Communication Foundation] service from Microsoft or similar services. However, service boundaries may be explicit, which includes or involves hiding all the details of the implementation behind the service boundary. This may include revealing or dictating what particular technology was used.

In connection with the above, as set forth in more detail in connection with FIG. 5, systems and methods herein may include or involve an Operation Service, an Infrastructure Service, an Appointment Service, a Payment Service, a Notification Service, and/or a Report Service.

In some implementations, the service layer 222 may be compiled into a separate class assembly and hosted in a service host environment. Here, for example, the application layer 214 will only know about and have access to this layer. Whenever a request is received by the service layer 222, the request may be dispatched to the business logic layer and the business logic layer may perform the requested task. In such implementation(s), if any database support is needed by the business logic layer, the business logic layer may always go through the data access layer.

Referring again to FIG. 2, a representative Service Layer 222 is shown, wherein an application's boundary with a layer may be defined that establishes a set of available operations and coordinates the application's response in each operation, the service layer 222 may include the service contracts and operation contracts that are used to define the service interfaces that will be exposed at the service boundary. Data contracts may also be defined to pass in and out of the service.

In one example instantiation, the invention may implement a WCF (Windows Communication Foundation) service 216, a framework for building service-oriented applications. However, in such instantiation(s), the service boundaries may be explicit, which means hiding all the details of the implementation behind the service boundary 222. This includes revealing or dictating what particular technology was used.

FIG. 5 is a block diagram depicting various exemplary features, services or components involved with present TOS web portal implementations 514 consistent with one or more aspects of the innovations herein. Referring to FIG. 5, implementations of the present systems may include or involve components such as an operation service 502, an appointment service 580, a payment service 560, a notification service 520, a report service 540, and/or an infrastructure service 590, among other such components. Some of these example services are shown in FIG. 5. In some illustrative implementations, the operation service 502 component may include a subcomponent service to handle import 504, export 510, equipment control 506, and gate activity 508. Similarly, an illustrative notification service 520 may include subcomponent services for gate activity 522, appointment status 524, booking 526, demurrage 528, and container status 530. The reporting service 540 may include subcomponent services for import container 542, vessel schedule 544, export booking 548, gate activity 546, bill of lading 550. The payment service 560 may include subcomponent services for demurrage 562, tariff 566, and payment 564. The appointment service 580 may include subcomponent services for import full-out 582, empty-in checker 584, export full-in/empty-out 586, and chassis in/out 588. The infrastructure service 590 may include subcomponent services for user accounts 592, at least one site service 594, and a SSCO service 596. The infrastructure services may include features for setting up and managing data for basic entities in applications such as users, trucking companies, steamship lines, and sites.

In another example, the service layer 222 is compiled into a separate class assembly and hosted in a service host environment. The application layer 214 only knows about and has access to this layer. Whenever a request is received by the service layer 222, the request may be dispatched to the repository 226, and the business logic layer may handle the request. If any database support is needed by the repository 226, the repository 226 may access the data access layer 250.

### Business Logic Layer

Referring again to FIG. 2, the third layer in this illustrated example is the Business Logic Layer 220. Such business logics associated with TOS web portal 514 implementations herein may be represented by a domain model which is a conceptual layer that represents the TOS web portal 514 business domain. Such domain model(s) may freely mingle data and process, have multi-valued attributes and a web of associations, and uses inheritance.

According to one illustrative TOS web portal 514 implementation, the domain model may be configured to look like the database design with mostly one domain object for each database table. Further, here, because the behavior of the business is subject to change, it is important to be able to modify, build, and test this layer easily. As such, minimum coupling features from the domain model to other layers in the system may be implemented.

Entities.

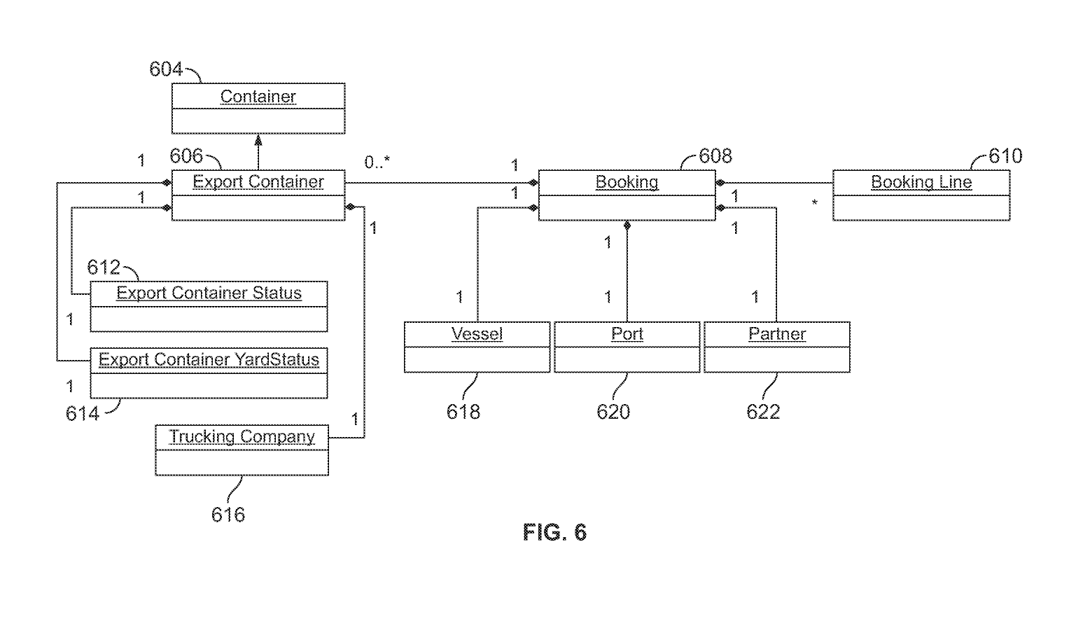

Implementations of such TOS web portal 514 may define business object as an entity, such as Bill of Lading, Container, Equipment, Booking, Release, Appointment, Demurrage, Payment, Vessel Schedule, Notifications, etc. Each entity may represent some meaningful individual in business domain. These objects mimic the data in business and objects that capture the rules the business uses. Inheritance, compositions, aggregation relationships are defined among those entities. FIG. 6 depicts an example of Entities in the Booking Module. A Booking Entity has Vessel, Port, Partner and Booking Line entities as properties and there are one-to-one relationships between them except Booking Line. Booking and Booking Line has one-to-many relationships. Booking entity might have one or more Export Container entities which are inherited from Container object. Export Container entity has Export Container Status, Export Container Yard Status, and Trucking Company entities as properties and has one-to-one relationship. Here, for example, such booking object 608 may have vessels 618, port 620, partners 622 objects, as well as trucking company 616 and status of export containers 606.

### Data Access Layer

Referring once again to FIG. 2, the fourth layer of the example is the data access layer 250. In some implementations, the data access layer 250 is the layer that is solely responsible for talking to the data store and persisting and retrieving business objects. The layer may include create, read, update and delete (CRUD) methods, transaction management, data concurrency, and/or a querying mechanism to enable the business logic layer to retrieve object for any given criteria.

Repository.

Referring once again to FIG. 2, the repository 226 mediates between the data access layer 250 and the business layers 220 of the application, for example. In some implementations, the repository 226 may query the data source for the data, maps the data from the data source to a business entity, and persists changes in the business entity, and presents changes to the data source. Further, the repository 226 may separate the business logic from the interactions with the underlying data sources.

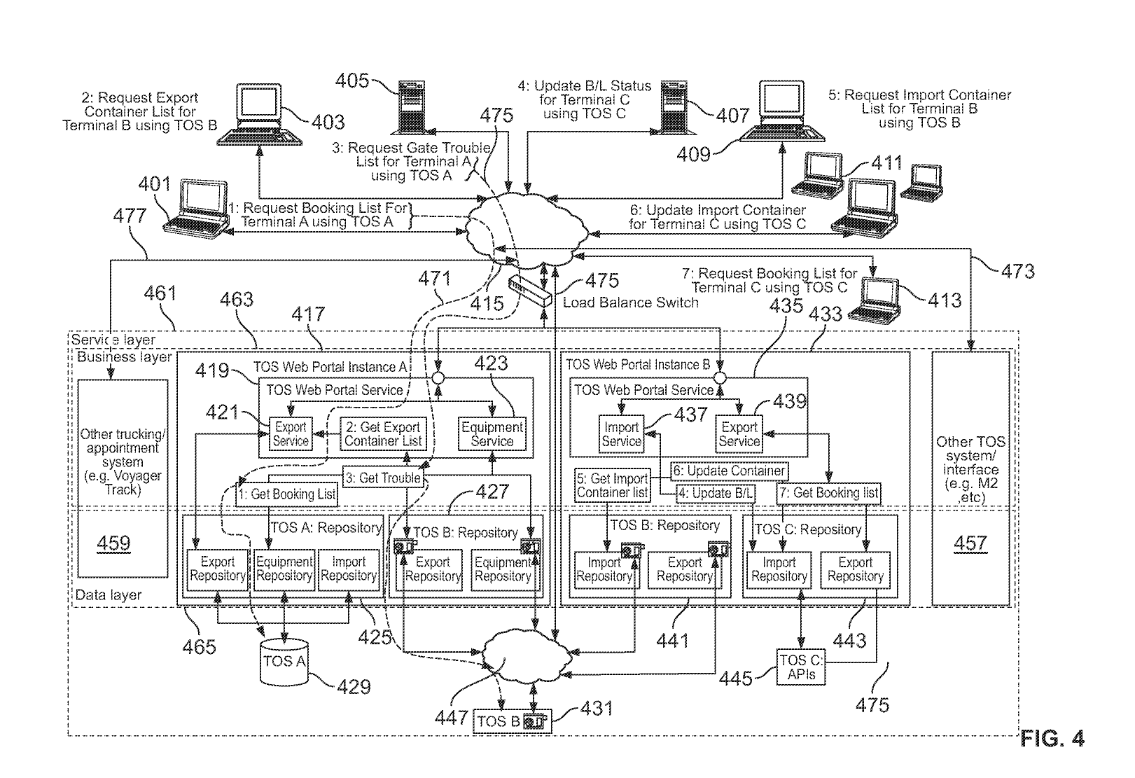

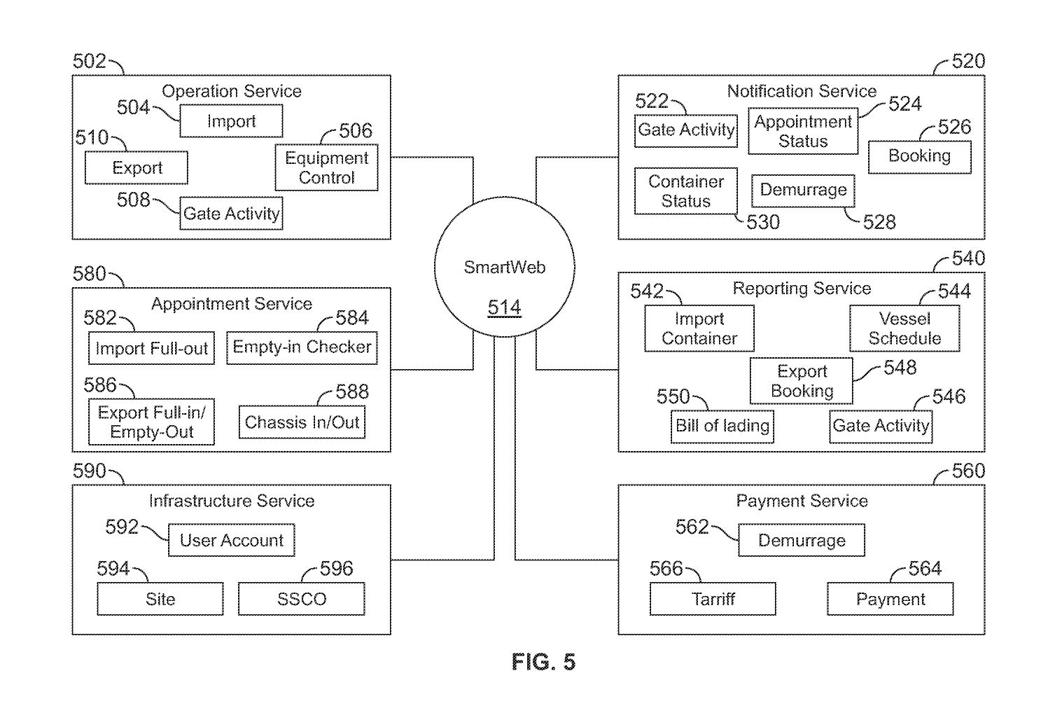

FIG. 4 is a block diagram showing various entities and interactions within or among such entities and an illustrative web- or network-based system consistent with one or more aspects of the innovations herein. Terminal Operating System information may be input by a device 401-413 that includes, but is not limited to a computer, laptop, mobile device, server, etc. that may request and obtain terminal information from any of a plurality of Terminal Operating Systems 429, 431 and 445. Any of the data requests 1-7 may be input at any of the devices 401-413. In this example, requests for information are transmitted through a network 415 to a TOS web portal instance A 417 or TOS web portal instance B 433. In FIG. 4, requests 1-3 are processed by web portal A 417 and requests 4-7 are processed by web portal instance B 433. The request 1 is a request for the booking list for Terminal A that operates under the Terminal Operating System A. The request is routed to the web portal instance A and processed by the export service 421. A GetBookingList method is called by the export service to the TOS A repository 425, and specifically the export repository, where the booking list is obtained. If the requested booking repository type is already cached, then the data is retrieved from TOS A database 429 using the repository instance. However, if the requested booking repository type is not in the repository cache, then the repository instance is created and added to the cache. This newly created repository instance is utilized to retrieve the booking listing from the TOS A database 429. Once retrieved, the booking list information that is provided in the TOS A format is mapped by the repository 425 into a TOS agnostic format such as a business entity or business object format that is processed and presented to the user in the same manner, no matter which TOS the data is obtained from. Conversion from the TOS agnostic format to a TOS specific format is performed in the repository. Accordingly, all the data requests/commands inputted by any of the devices 401-413 are processed in a TOS agnostic format. Only when interfacing directly with the Terminal Operating Systems are the TOS agnostic data converted into data formats compatible with the different Terminal Operating Systems. Thus, a user is able to interact with a plurality of Terminal Operating Systems from a single device without concern for the Terminal Operating System employed by each terminal.

A similar process may occur for each of the remaining requests 2-7, with differences in which web portal instance, service and repository are accessed. For example, a user at device 403 requests an export container list (#2) for a Terminal B that operates using a Terminal Operating System B different from the Terminal Operating System A. The request 2 for the export container list is routed to the export service 421 of the web portal instance 417. A GetExportContainerList method is called to an export repository of the TOS B repository 427. This export repository retrieves the requested export container list from the web portal service TOS B 431 via a network 447. The web portal instance A 417 returns the export container list 403 to the device 403.

A user at device 407 may input an update for a bill of lading (B/L) status for a Terminal C using a Terminal Operating System C. The update is input in a TOS agnostic data format. The update is transmitted to the import service 437 of the web portal instance B 433. An update B/L method is called by the import service 437 to the import repository of the TOS C repository 443. Within the TOS C repository 443, the import repository maps the user input of the B/L update status into the TOS C data format and transmits the update to the TOS C API 445. In response, the TOS C API 445 may transmit an acknowledgement or other reply to the TOS C repository 443. The TOS C repository 443 transforms any data in the TOS C format into the TOS agnostic format and returns the relevant information to the device 407. Taking one more example, a user at device 413 inputs a request for booking list information for the Terminal C that operates using a TOS C that is different from TOS A and TOS B. The request is forwarded to an export service 439 of the web portal instance B 433. The export service 439 calls a GetBookingList method to the export repository of the TOS C repository 443.

Referring to FIG. 4, sample interrelations with other entities, such as a trucking/appointment system 459 (e.g., a system like VoyagerTrack, etc.) and another TOS system/interface 457 (e.g., a system like M21, etc.) are shown. By features herein, information and data may be processed throughout the service layers of any such systems or entities. For example, a request 477 from a trucking/appointment system 459 may be processed consonant with a request 475 regarding gate trouble (#3) from entity 405. Also by way of example, a request 473 from another TOS system/interface 457 may be processed consonant with a request 471 for a booking list (#1) from entity 401.

### Module Based Applications

In certain instances of the system and method here, the TOS web portal 514 may be a module-based application and may include a collection of modules that can be added and removed independently. Each module may be defined as a .NET assembly (dynamic link library assembly) within the TOS web portal 514. Further, a module can be responsible for exposing business logic to a client which is any entity that uses the module.

If a user desires to modify a module implementation, changes may be constrained to that module only. Such module-based architecture allows modules and clients to evolve separately. New versions of the existing module can be deployed without affecting existing client applications. Also new version of the existing client application can be deployed without affecting existing modules.

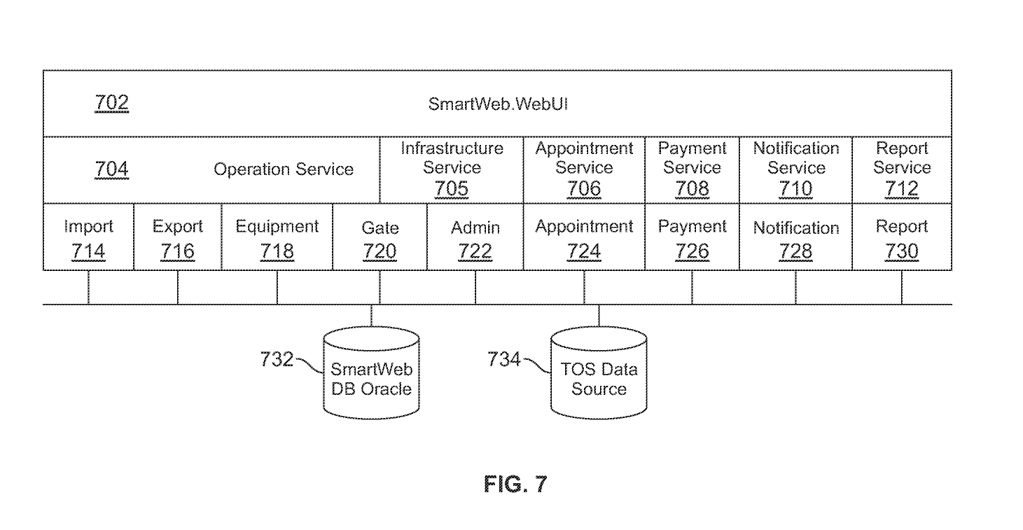

According to some implementations herein, development of modules in such TOS web portal implementations may have one or more of the following characteristics, some of which are depicted in FIG. 7:
Interface-Based Programming
   Characterizing separation of interface from implementation. Here, for example, the client may be coded against an abstraction of a service (the interface), not a particular implementation of it (the object). As a result, changing an implementation detail on the server side or even switching to a different service provider does not affect the client.
Location Transparency
   TOS web portal implementations 514 may contain multiple modules. These modules can all exist in the same process, in different processes on the same machine, or on the different machines on a network. However, there may not be anything in the client's code pertaining to where the objects execute.
Versioning Support
   Implementations herein may deploy new versions or updated versions of existing modules without affecting other modules. As a result, a module can be allowed to evolve along different paths and different versions of the same module can be deployed on the same machine, or even in the same client process, side by side.

Referring to FIG. 7, implementations of a TOS web portal 702 herein may include, involve and/or access services such as operations services 704, infrastructure services 705, appointment services 706, payment services 708, notification services 710, and/or report services 712. The user interface of the TOS web portal 702 may support various devices, such as mobile devices, personal computers, etc. Here, for example, illustrative infrastructure services herein may provide users with interfaces to manage user accounts, add or update steamship lines, and/or change site configurations, among other things. Further, appointment services may be utilized by or for a trucking company to create, read, update and delete appointments for picking up or delivering a container at a terminal. Terminal users can utilize such services to plan capacity and manage work load. In further implementations, appointment services may also have report functionalities.

Further, also referring to FIG. 7, embodiments of TOS web portal 702 herein may include, involve and/or have access to capabilities of import 714, export 716, gate 720 and equipment control 718 modules that are able to replace traditional functionalities in existing systems, report 730, appointment 724, payment 726 and notification 728 modules for associated tracking applications/components, and/or an admin module 722 that combines both applications.

### TOS Agnostic

Some implementations or instantiations of the system and methods disclosed herein may include a TOS Agnostic design. That is, the system is configured so that operation may occur without ‘care’ for various processing as to which TOS it is dealing with. In the context of the frameworks set forth above, for example, such implementations may include configuration(s) as a Repository—Pattern. The repository pattern is used to enable Terminal Operating System (TOS) independence. Each TOS may utilize its own unique database schema.

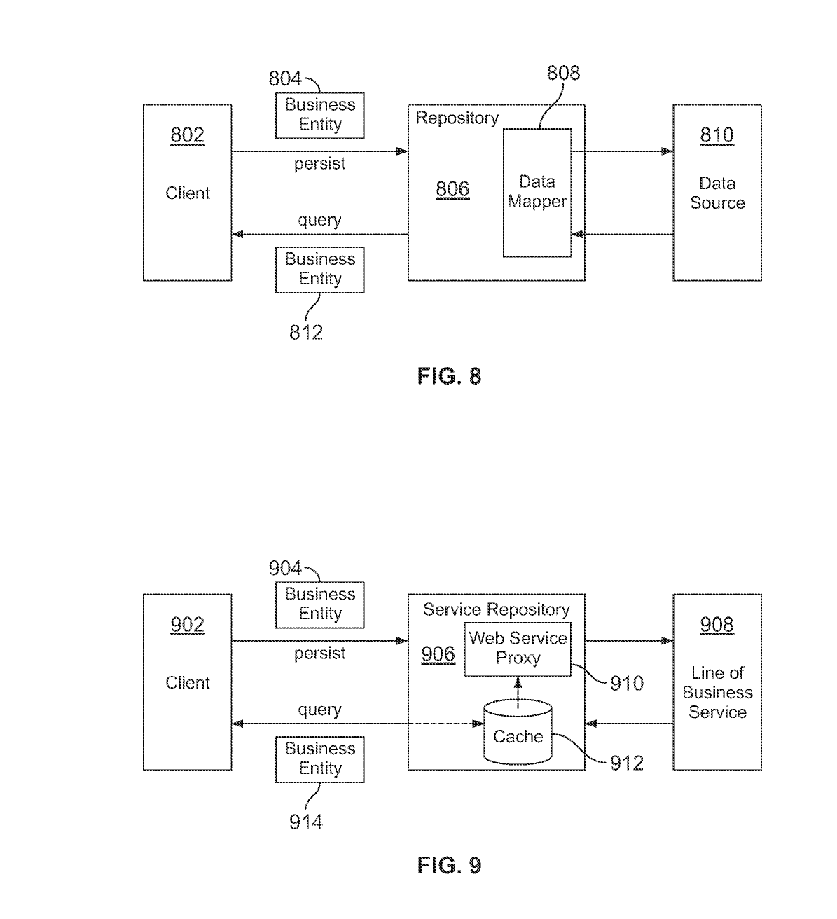

FIG. 8 is a block diagram showing illustrative aspects of repository mapping from TOS to business entities consistent with one or more aspects of the innovations herein. Referring to FIG. 8, an illustrative repository 806 may separate the logic that retrieves the data and map it to the entity model from the business logic that acts on the model. Further, the business logic may be agnostic to the type of data that comprises the data source layer 810. For example, the data source layer 810 can be a database or a Web service. FIG. 8 shows an example repository mapping from TOS to business entities 804, 812.

FIG. 9 is a diagram showing an illustrative repository caching scheme consistent with one or more aspects of the innovations herein. Here, for example, a backing store for data can be a business service that is exposed by a line-of-business (LOB) application 908. Services are often expensive to invoke and benefit from caching strategies that are implemented within the repository 906. In such cases, the query logic in the repository 906 may first check to see whether the queried repository instance are in the cache 912. If they are not, the repository 906 accesses the Web service to retrieve the information. Such illustrative caching scheme is shown in FIG. 9.

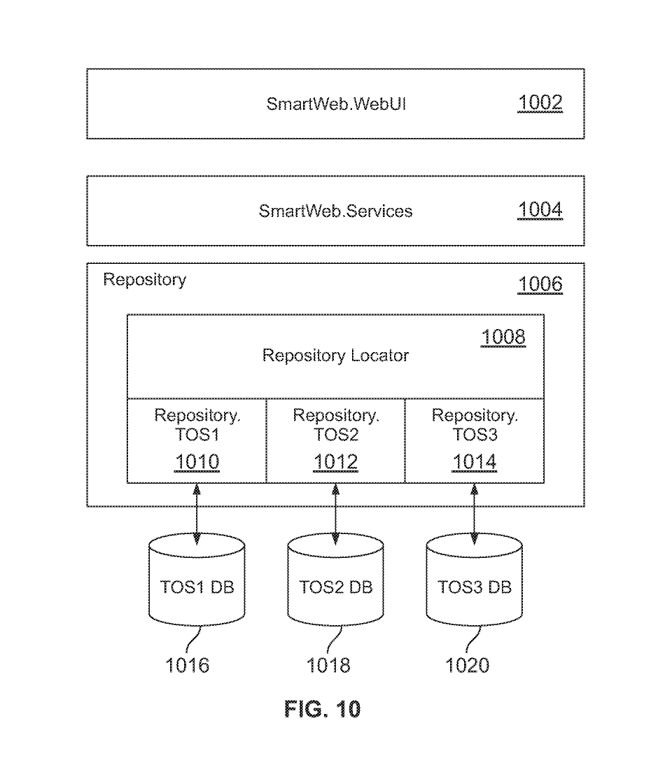

FIG. 10 is an illustration involving an exemplary TOS-independent or TOS-agnostic repository locator consistent with one or more aspects of the innovations herein. Referring to the representative diagram of FIG. 10, a services component 1004 of the TOS web portal may be designed to support multi-terminals with different Terminal Operating Systems. To support multi-terminals in a TOS agnostic way, the services component 1004 may include or involve another component or application that performs processing associated with and looks up the repository that provide access to distributed terminal databases 1016, 1018, 1020. Here, for example, such functionality may be accomplished via a repository locator component or device 1008.

According to implementations herein, such repository locator 1008 may centralize distributed repository lookups, provide a centralized point of control, and may act as a cache that eliminates redundant lookups. Again, an exemplary TOS independent repository locator is shown in FIG. 10. Additional technical details of some TOS agnostic innovations are set forth further below and in the included Appendix materials.

### System and Process Architecture

The design and architecture of some of the examples of the system disclosed here, enable the present TOS Web Portal implementations 514 to be an add-on to any existing TOS as opposed to being integrated with a single TOS. This approach allows the present innovations and functionality to be incorporated into any existing TOS through a web-service API layer. Interfaces to other TOS's can be accomplished without the need to re-design or re-architect the TOS Web Portal implementations herein.

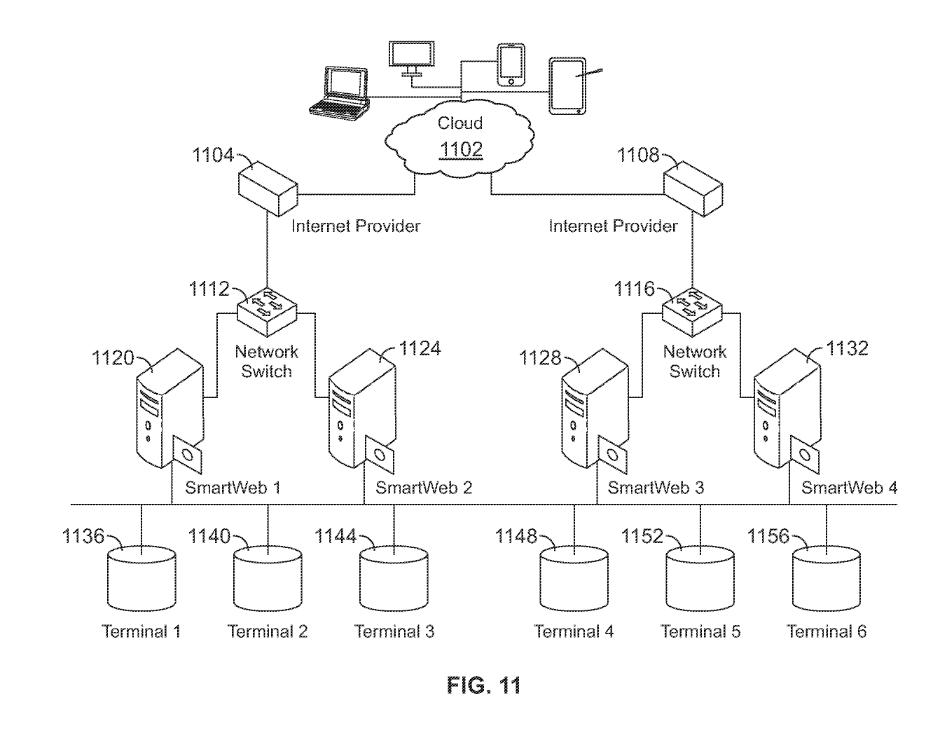

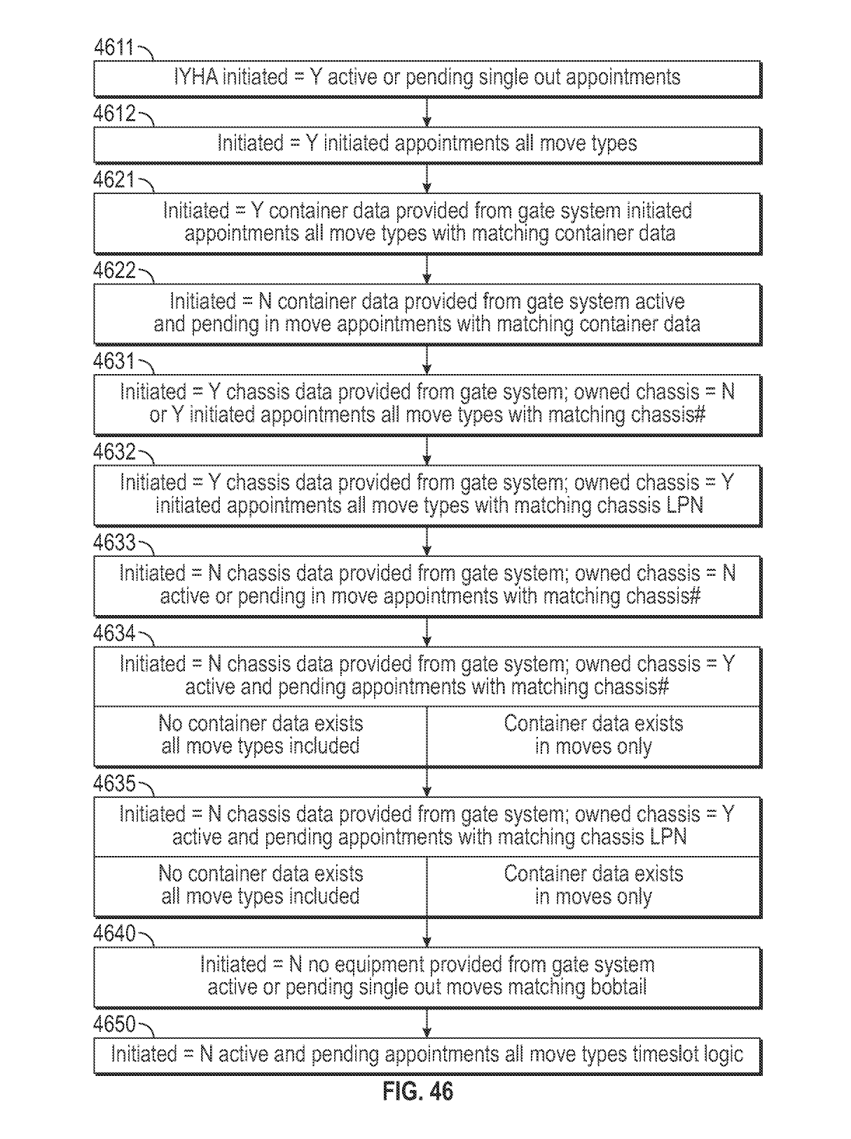

FIG. 11 is a block diagram illustrating exemplary system topology consistent with one or more aspects of the innovations herein. For instance, multiple instances of the TOS web interface server will be deployed in two physical locations to support multiple terminals. One location has two instances (1120 and 1124) those are connected via Network Switch. Network Switch distributes user requests to balance load in each server instance. Another set of server instances (1128 and 1132) perform in the same way but are located in different physical location to recover problems such as earth quake, power shortage in a certain location, etc. As such, multiple instances of the present TOS Web Portal 1120, 1124, 1128, 1132 may be used to interface with multiple different TOS systems 1136, 1140, 1144, 1148, 1152, 1156, even across multiple internet providers 1104, 1108, all interfacing with a central cloud server 1102. The central cloud server 1102 may communicate with various end user devices (e.g., laptop, desktop, mobile device, tablet, etc.), as shown in more detail in connection with FIGS. 46A-46S.

### Object Oriented Programming (OOP)

Systems and methods herein may also be configured using concepts and rules of Object-Oriented Programming. Here, for example, some implementations may utilize objects—data structures consisting of data fields and methods—that are defined along with abstractions of business processes for Terminal Operation. Such implementations utilizing object-oriented features and/or programming may provide many benefits, such as in one or more areas of reusability, extensibility, decoupling, maintainability, and/or reducing complexities, among others.

Reusability.

Some illustrative object-oriented implementations with reusability features may be configured with classes, which can be used by several applications. For example, such systems and methods may define common business model as objects and represent them using classes, such as Container, Vessel, Port, Partner, Appointment, Demurrage, Payment, Notification etc. Illustrative constructs, here, may include configurations such as seen in Insert X1: Reusability Code Example:

### X1: Reusability

In the object-oriented approach, we build classes, which can be used by several applications. smartWeb defines common business model as objects and represent them using classes, such as Container, Vessel, Port, Partner, Appointment, Demurrage, Payment, Notification, etc.

```
  public class Vessel : IEquatable<Vessel>
  {
    public string VesselCode { get; set; }
    public string Name { get; set; }
    public string CallYear { get; set; }
    public string CallSequence { get; set; }
    public string VoyageNumber { get; set; }
  }
  public class Container
  {
    public string Number { get; set; }
    public string CombinedCode { get; set; }
    public ContainerType Type { get; set; }
    public ContainerLength Length { get; set; }
    public ContainerHeight Height { get; set; }
  }
  public abstract class Partner
  {
    public PartnerKey Key { get; set; }
    public string ScacOrSscoType { get; set; }
    public string ScacOrSscoCode { get; set; }
    public string EnglishShortName { get; set; }
    public string AgreementNotSigned { get; set; }
    public string InsuranceNotReceived { get; set; }
    public string InsuranceExpired { get; set; }
    public string PerDiemCheck { get; set; }
    public string RepairCheck { get; set; }
    public DateTime? EIAStartDate { get; set; }
    public DateTime? EIAEndDate { get; set; }
    public string CitationCheck { get; set; }
    public virtual bool AgreementExists { get; set; }
    private bool m_isOnHold;
    public virtual bool IsOnHold
    {
      get
      {
        return AgreementExists && (AgreementNotSigned ==
        DomainConstants.YES
||
          InsuranceNotReceived == DomainConstants.YES ||
          InsuranceExpired == DomainConstants.YES ||
          PerDiemCheck == DomainConstants.YES ||
          RepairCheck == DomainConstants.YES ||
          CitationCheck == DomainConstants.YES) ;
      }
      private set { m_isOnHold = value; }
    }
    private bool m_isAgreementValid;
    public virtual bool IsAgreementValid
    {
      get
      {
        return AgreementExists && EIAStartDate.HasValue &&
          EIAEndDate.HasValue &&
          EIAStartDate.Value.Date <= DateTime.Today &&
          EIAEndDate.Value.Date >= DateTime.Today;
      }
      private set {m_isAgreementValid = value; }
    }
  }
```

Here, such constructs and definitions of objects may be reused throughout the application many times. Furthermore, the same object may be used to extend existing features or add new feature of the application. Accordingly, applications may be modified using working objects and thus code does not need to be written from scratch. Such reuse of objects reduces the effort of recreating them as well as reduces the chances of introducing errors. This not only saves development time but also improves the robustness of such applications.

Further, various OOP's programming functions and modules can be reused. For example, the following, Insert X2: Table Example may be used to call a method in service. The same function may also be used throughout application since the method is defined OOP practices.

### X2: Reuse

These definitions of objects may be reused throughout the application. Furthermore, the same object may be used to extend existing features or add new feature of the application. Applications may be modified using working objects, rather than by writing code from scratch. The reuse of objects reduces the effort of recreating them as well as reduces the chances of introducing errors. This not only saves development time but also improves the robustness of the application.

In OOP's programing functions and modules can be reused. The following method may be used to call a method in service. The same function is used throughout the application in this example, since the method is defined OOP practices.

```
  public TResponse Call< TRequest, TResponse >(
    TRequest request,
    Func <MainServiceClient, TRequest, TResponse> callOperation,
    Action<string> onFailure = null)
  {
    try
    {
        var principal = HttpContext.Current.User as PortsPrincipal;
        using (var contextScope = new
OperationContextScope(ServiceClient.InnerChannel) )
        {
          if (principal != null)
            SetupMessageHeader(principal);
          return callOperation(ServiceClient, request);
        }
    }
    catch (FaultException<ServiceException> ex)
    {
        CLogManager.LogError(“faultexception ” + ex.Message);
        if (onFailure != null)
          onFailure.Invoke(ex.Message);
        return default(TResponse);
    }
    catch (FaultException ex)
    {
        CLogManager.LogError(“faultexception ” + ex.Message);
        if (onFailure != null)
          onFailure.Invoke(ex.Message);
        return default(TResponse);
    }
    catch (CommunicationException ex)
    {
        CLogManager.LogError(“comunication error”);
        CLogManager.LogError(ex);
        CloseService( );
        m_serviceClient = new MainServiceClient( );
        if (onFailure != null)
          onFailure.Invoke(ex.Message);
        return default(TResponse);
    }
    catch (Exception ex)
    {
        if (onFailure != null)
          onFailure.Invoke(ex.Message);
        return default(TResponse);
    }
    finally
    {
        CloseService( );
    }
  }
```

Extensibility.

To illustrate such features, see Insert X3. Assume Trucker is the salient Partner. Here, then, implementations may define a trucker by inheriting Partner. Via such aspects implementations may eliminate redundant code and extend the use of existing classes.

### X3: Extensibility

Trucker is a Partner. Thus, we define a trucker by inheriting Partner. Through this we can eliminate redundant code and extend the use of existing classes.

```
public class Trucker : Partner
{
  public string TruckerCheck { get; set; }
  public bool IsValid
  {
    get
    {
        return IsAgreementValid && !IsOnHold;
    }
  }
  public override bool IsOnHold
  {
    get
    {
      return base.IsOnHold || TruckerCheck == DomainConstants.YES;
    }
  }
}
```

Decoupling.

With regard to decoupling, systems and methods may be configured to decouple modules using an interface instead of using the implementation. In some implementations, for example Insert X4, a Repository object may be defined to satisfy interfaces. Such decoupling of interface from implementation enabling the application to be TOS agnostic; illustrative configurations, here, may be structured as follows.

### X4: Decoupling

OOP practices in smartWeb may decouple modules using an interface instead of using the implementation. For example, Repository object is defined to satisfy interfaces. This decoupling of interface from implementation allows for the application to be TOS agnostic.

public override IBookingRepository LocateBookingRepository( )
public override IBookingOperationRepository
LocateBookingOperationRepository( )
public override ITransshipBookingRepository
LocateTransshipBookingRepository( )
public override IExportContainerRepository
LocateExportContainerRepository( )
public override IBillOfLadingRepository LocateBillOfLadingRepository( )
public override IContainerRepository LocateContainerRepository( )
public override IImportDrayInRepository LocateImportDrayInRepository( )
public override IRailBookingRepository LocateRailBookingRepository( )
public override IPreStageHazardousRepository
LocatePreStageHazardousRepository( )
public override IBookingNonHazardousRepository
LocateBookingNonHazardousRepository( )

Maintainability.

Via use of objects and various OOP features herein, functions defined in such implementations may have very simple return values and parameters compared to those in existing systems. The following table show some illustrative examples as seen in Insert X5:

### X5: Maintainability

Using objects, functions defined herein may have very simple return values and parameters. For example.

TABLE 1

| VoyagerTrack | smartWeb |
|---|---|
| Public Function FetchEquipment( | public EquipmentContainer |
| ByVal strEquipment As String, _{—} | FindEquipmentContainer(string |
| ByRef rsReturn As Variant, _{—} | equipmentNumber, string ssco, IList<string> |
| ByRef intContainerStatus As Variant, | associatedSsco) |
| ByRef param0 As Variant, _{—} | |
| ByRef param1 As Variant, _{—} | |
| ByRef param2 As Variant, _{—} | |
| ByRef param3 As Variant, _{—} | |
| ByRef param4 As Variant, _{—} | |
| ByRef param5 As Variant, _{—} | |
| ByRef param6 As Variant, _{—} | |
| ByRef param7 As Variant, _{—} | |
| ByRef param8 As Variant, _{—} | |
| ByRef param9 As Variant, _{—} | |
| ByRef param10 As Variant, _{—} | |
| ByRef param11 As Variant, _{—} | |
| ByRef param14 As Variant, _{—} | |
| ByRef varInOutData As Variant, _{—} | |
| ByRef varAuthSSCO As Variant, _{—} | |
| ByRef varMessage As Variant, _{—} | |
| ByRef pstrPendSvcCode As Variant, _{—} | |
| ByRef pstrPendRemark _{—} | |
| ) As Integer | |
| Public Sub FetchInOutData(ByVal | private EquipmentContainer |
| strCntr As String, | GetInOutData(EquipmentContainer container) |
| ByVal strVslCd As String, | |
| ByVal strCallYr As String, | |
| ByVal strCallSeq As String, | |
| ByRef varReturn As Variant, | |
| varMessage As Variant) | |
| Private Function UpdateALL(ByVal | public bool Update(ImportContainer container) |
| pstrTerminal, | |
| ByVal strLocalClearValue As Variant, | |
| ByVal pstruserid As Variant, _{—} | |
| ByVal strUSDAValue As Variant, | |
| ByVal strFreightValue As Variant, _{—} | |
| ByVal pstrDemStatusValue As Variant, | |
| ByVal pstrSSCO As Variant, _{—} | |
| ByVal pstrTruckerCode As Variant, | |
| ByVal pstrTruckerName As String, _{—} | |
| ByVal pstrOrigTrucker As String, | |
| ByVal pstrCustomRmk As String, _{—} | |
| ByVal lngPIN As Variant, | |
| strOriginalPIN As Variant, _{—} | |
| ByVal strFreeDays As Variant, | |
| ByVal strDemRateCode As Variant, _{—} | |
| ByVal strContNumber As Variant, | |
| strMessage As Variant, _{—} | |
| ByVal pstrRights As Variant, | |
| ByVal pstrDemDate As Variant, _{—} | |
| ByVal pstrServiceCode As Variant, | |
| ByVal pstrBondDest As Variant, _{—} | |
| ByVal pstrCarrierStatus As Variant, | |
| ByVal pstrCarrierCategory As Variant, _{—} | |
| ByVal pstrCarrierRemark As Variant, _{—} | |
| ByVal pstrBlNo As Variant, _{—} | |
| ByVal strVslCd As Variant, | |
| ByVal strCallYear As Variant, | |
| ByVal strCallSeq As Variant, _{—} | |
| ByVal pstrOverrideTRKCode As Variant, | |
| ByVal pstrOverrideTRKName As String, _{—} | |
| ByVal pstrCustomStatus As Variant, | |
| Optional ByVal boolUpdateTrk As | |
| Boolean = True, _{—} | |
| Optional ByVal boolUpdateOverrideTrk | |
| As Boolean = True) As Boolean | |
| Private Function | private bool |
| ValidateTruckerFully( | ValidateTruckerInfo(ImportContainer |
| ByRef pstrSTCTrucker As Variant, | container) |
| ByVal pstrShippingCo As String, _{—} | |
| ByVal pstrTruckerCode As Variant, | |
| ByRef pstrTruckerCompany As Variant, _{—} | |
| ByRef pstrTrucker As Variant, | |
| ByRef pstrTruckerName As String, _{—} | |
| strMessage As Variant) As Integer | |

Reducing Complexity/Complexities.

Here, a given problem in business can be viewed as a collection of difference objects. Each object may represent a business entity and may have all relevant business properties and processes as properties and methods. This abstraction may reduce the complexity of a problem and make it easy to manage. For example, in Insert X6, EquipmentControlEditModel object abstracts all business properties and processes relevant to managing containers or chassis in terminal.

### X6: Reduced Complexity of a Problem

A given problem in business can be viewed as a collection of difference objects. Each object may represent a business entity and may have all relevant business properties and processes as properties and methods. This abstraction may reduce the complexity of a problem and make it easy to manage.

For example, EquipmentControlEditModel object abstracts all business properties and processes relevant to managing containers or chassis in terminal.

```
public class EquipmentControlEditModel
{
  public InquiryModel Inquiry { get; set; }
  public MultiInquiryModel MultiInquiry { get; set; }
  public string SteamshipCompany { get; set; }
  public EquipmentState State { get; set; }
  public string InventoryStatus { get; set; }
  public string DamageCondition { get; set; }
  public string Memo { get; set; }
  public string InDate { get; set; }
  public string OutDate { get; set; }
  public string InGatePass { get; set; }
  public string OutGatePass { get; set; }
  public bool HasAction { get; set; }
  public string ActionType { get; set; }
  public string ServiceCodeDescription { get; set; }
  public bool HasPendingAction { get; set; }
  public bool ShowErrorMessage { get; set; }
  public string ErrorMessage { get; set; }
}
```

This modularity makes an object to be maintained independently of other objects. Objects may be independent of each other and may be maintained separately. Modifications may be made in an object without affecting functionalities of other objects

### Security

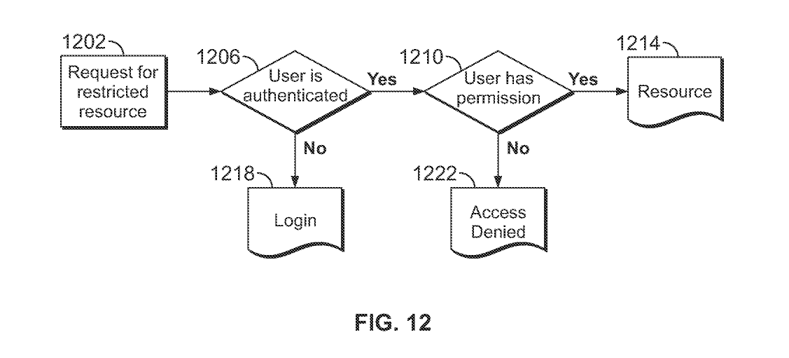

Embodiments of the present TOS Web Portal systems and methods may have one or more of the following security implementations: authentication to authenticate users; authorization to decide which operations the user may execute and which resources the user may access; confidentiality to help ensure protection of sensitive data disclosure; and integrity to protect from changes, user data transmitted between client and server. FIG. 12 is an exemplary flow diagram of an illustrative user authentication and authorization process consistent with one or more aspects of the innovations herein. Referring to the exemplary processing of FIG. 12, a user submits a request for restricted resource 1202, and the system verifies whether the user is authenticated 1206. If not, the user must login 1218. Once the user is authenticated, the system may verify whether the user has permission 1210, and if so, allows access to the resource 1214, or else denies access 1222.

In certain example implementations of the system and methods, authentication may be found in different methods. Examples of these may be, inter alia, Windows Authentication (user signed into windows), Forms Authentication (using a web page to sign in), Passport Authentication (using Microsoft's Passport, also known as Live Id these days, to authenticate) etc.

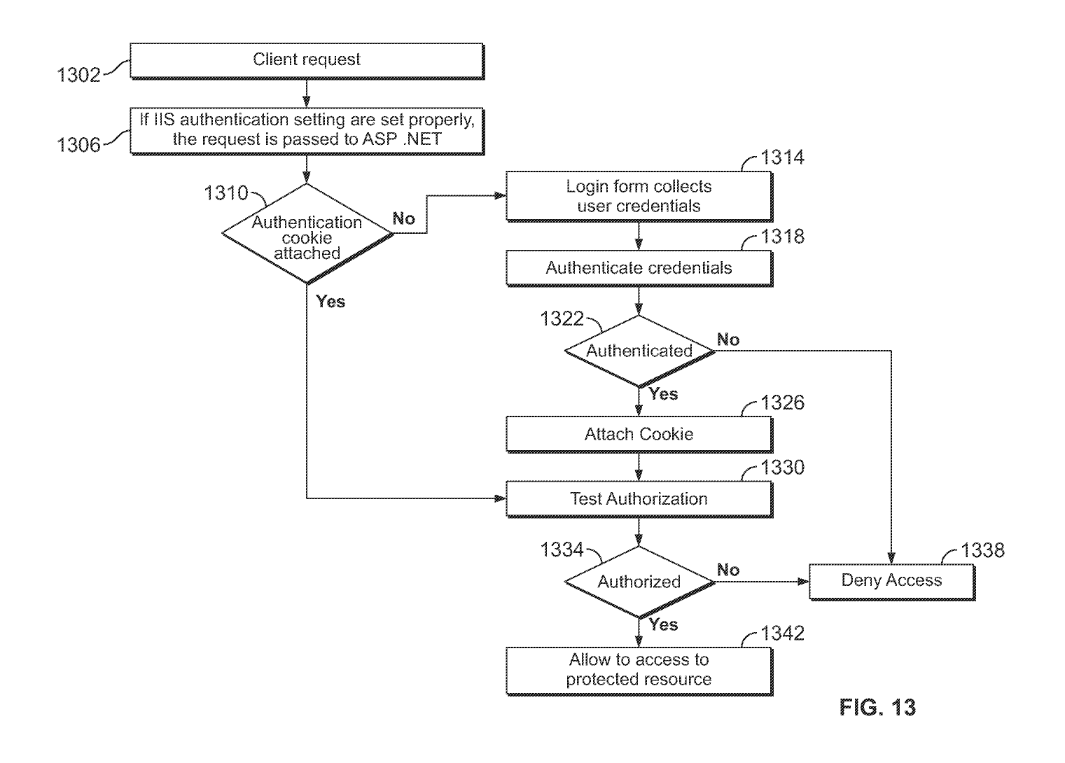

Forms Authentication may allow use from the internet and restrict use to approved customers. Further, Forms authentication can be a token-based system. For example, when users log in, they may receive a token with basic user information. This information may be stored in an encrypted cookie that is attached to the response so it is automatically submitted on each subsequent request. FIG. 13 is an exemplary flow diagram of an illustrative forms authentication and authorization process consistent with one or more aspects of the innovations herein. An example of this authentication process includes the initial client request 1302, which is passed to ASP.NET provided proper IIS Authentication settings 1306. The system verifies whether user has been assigned an authentication cookie 1310, and if no, the login form 1314 collects user credentials and authenticates the credentials 1318. If the credentials pass the authentication process 1322, then the system attaches a cookie 1326 and tests whether the credentials are authorized for access 1330. If the credentials are either not authenticated 1322 or authorized 1334, the system will deny access 1338. If the credentials are both authenticated 1322 and authorized 1334, the system will allow the user to access the protected resource 1342.

Further, system and methods herein may employ an authorization model. For example, implementations may be configured to use a permission-based security model. Such a model may have pre-defined roles such as those that perform similar functions as “Groups” or “Types” of existing systems. In some embodiments, however, implementations may require permissions for each action that needs security validation, such as:
To view or update a page, user needs permission for the action.
To view or update a data/field, user needs permission for the action.
When a user wants to view Import Container list, user should have appropriate permission for the import container list page.
When a user wants to update or save contents in Import Container page, user should have appropriate permission for the import container list page.

According to these implementations, a role may be defined by a set of permissions that are allowed to the owner of the role. Users can have multiple roles and then will have all permissions belong to each role. Such features allow users to have different roles for a steamship company in a site, or have the same role for all steamship companies for the site or one role for all steamship companies and all sites.

Further, implementations may have pre-defined role(s) and custom role(s). Here, for example, pre-defined role examples may include, User Admin, Gate Clerk, High Volume User, Appointment Admin, Super Admin, SSCO User, Terminal User, and possibly others. Custom Role may allow a user to have customized role (a set of permissions). An admin module of the TOS Web Portal systems herein may provide tool(s) to assign permissions to a user that will be persisted as a new role, such as ABCD-Admin, XYZ-Bob, etc. Further, these custom roles can be reused. In still other implementations involving security, ASP.NET security framework can have a standardized user accounts system that supports all common user account tasks, including registering, managing passwords, and setting personal preferences.

According to additional embodiments herein, there may be other functional areas that may be implemented, including one or more of:
Membership, including registering user accounts and accessing a repository of account details and credentials
Roles, including putting users into a set of (possibly overlapping) groups, typically used for authorization
Profiles, allowing users to store arbitrary data on a per-user basis
   It should be noted that ASP.NET provides implementations for each of these three areas, however, some systems may be configured with custom implementation through a system of providers. Here, for example, custom providers may be derived from “built-in” abstract provider classes.

Finally, with respect to some implementations, systems and methods herein involving the present TOS Web Portal features may use SSL (Security Sockets Layer) in all modules.

### TOS-Agnostic Details and Aspects

Implementations herein may involve the layered architecture set forth above. A layer refers to a logical separation, such as a introducing a different assembly in the same process space. Layering provides separation of concerns and better factoring of code, which gives us maintainability and scalability. According to various implementations herein, there may be 4 layers in the present TOS Web Portal systems and methods—Presentation, Service, Business Logic and Data Access layers.

Business logics layer/aspects herein may be represented by a domain model which may be a conceptual model that represents the TOS Web Portal′ business domain. A domain model mingles data and process, has multi-valued attributes and a complex web of associations, and may use inheritance, for example. Further, the data access layer may be the layer that is solely responsible for talking to the data store and persisting and retrieving business objects. The layer may include the create, read, update and delete methods, transaction management, data concurrency, and/or a querying mechanism to enable the business logic layer to retrieve object for any given criteria.

Different Terminal Operating Systems may use different data persisting technologies and may require different method to access persisted data. For example, access to relational databases but from different vendors (Oracle, MS Sql, MySql, etc.) or it an access to the end point of WS*—compliant web services. For the system to be TOS agnostic, the system may switch data access method with minimum impact on business logic layer and presentation layer.

Repository-Pattern.

Repository pattern features and functionality herein may be used to make the application independent of Terminal Operating System (TOS). The repository may separate the logic that retrieves the data and maps it to the entity model from the business logic that acts on the model, for example. The business logic may be agnostic to the type of data that comprises the data source layer. For example, the data source layer can be a database or a Web service.

Further, in some implementations, a backing store for data can be a business service that is exposed by a line-of-business (LOB) application. Services are often expensive to invoke and benefit from caching strategies that are implemented within the repository. In this case, the logic first checks to see if the repository is in the cache. If it is not, the repository instance is created and placed into cache then utilized to retrieve the requested information.

Service Locator Pattern.

Service Locator pattern features and functionality herein may define a component that knows how to retrieve the services an application might need. The caller has no need to specify the concrete type; the caller may indicate an interface or an abstract type. The Service Locator pattern may hide the complexity of component lookup, handle the caching or pooling of instances and, in general, offer common provisioning for component lookup and creation.

A focus in Service Locator Pattern may be to achieve the lowest possible amount of coupling between components. The locator represents a centralized console that an application uses to obtain all the external dependencies it needs.

As such, present implementations may be designed to support multi-terminals with different Terminal Operating Systems. To support multi-terminals in TOS agnostic way, the TOS web interface application may involve processing to look up the repository that provides access to each of distributed terminal databases.

### Repository Initialization

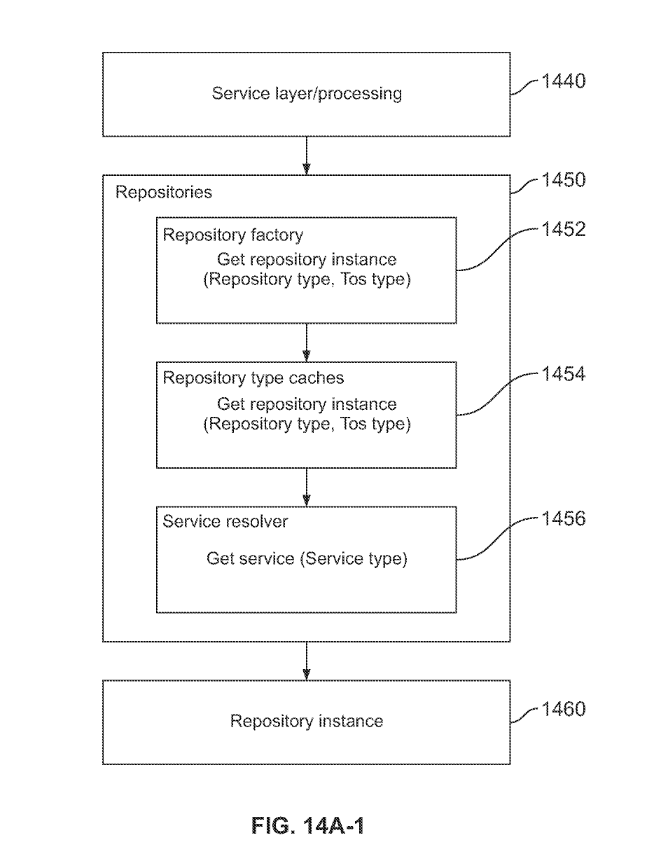

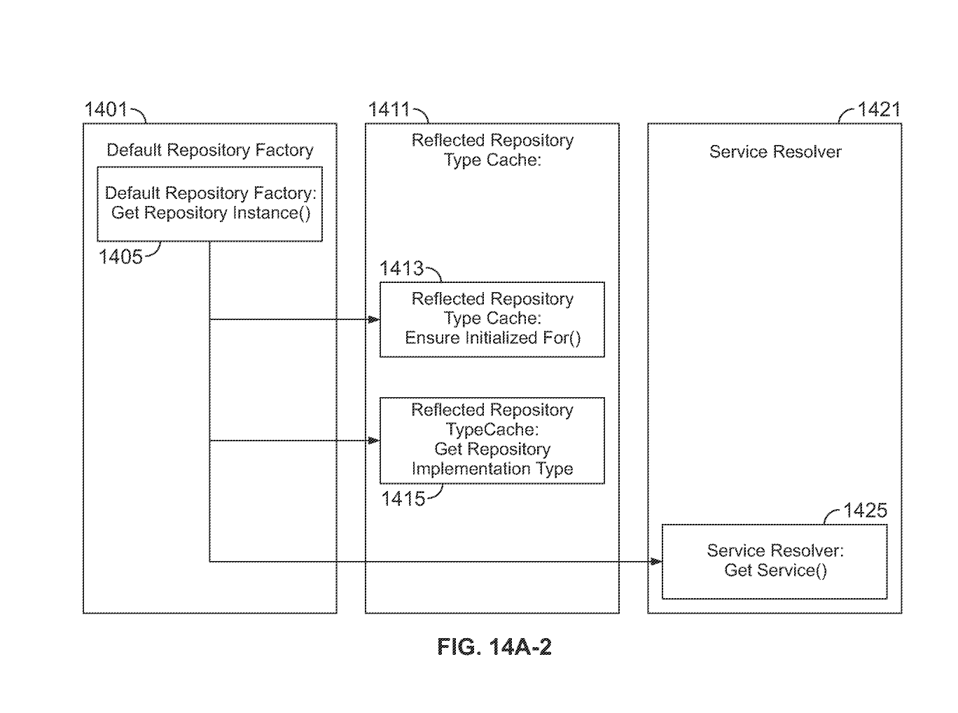

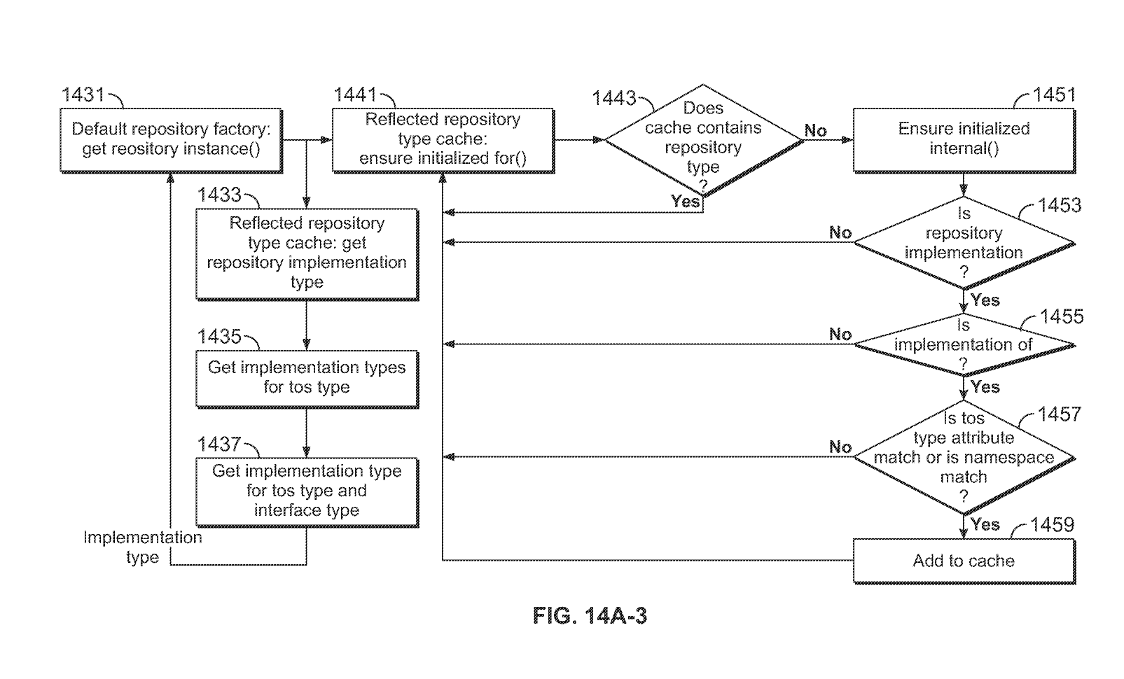

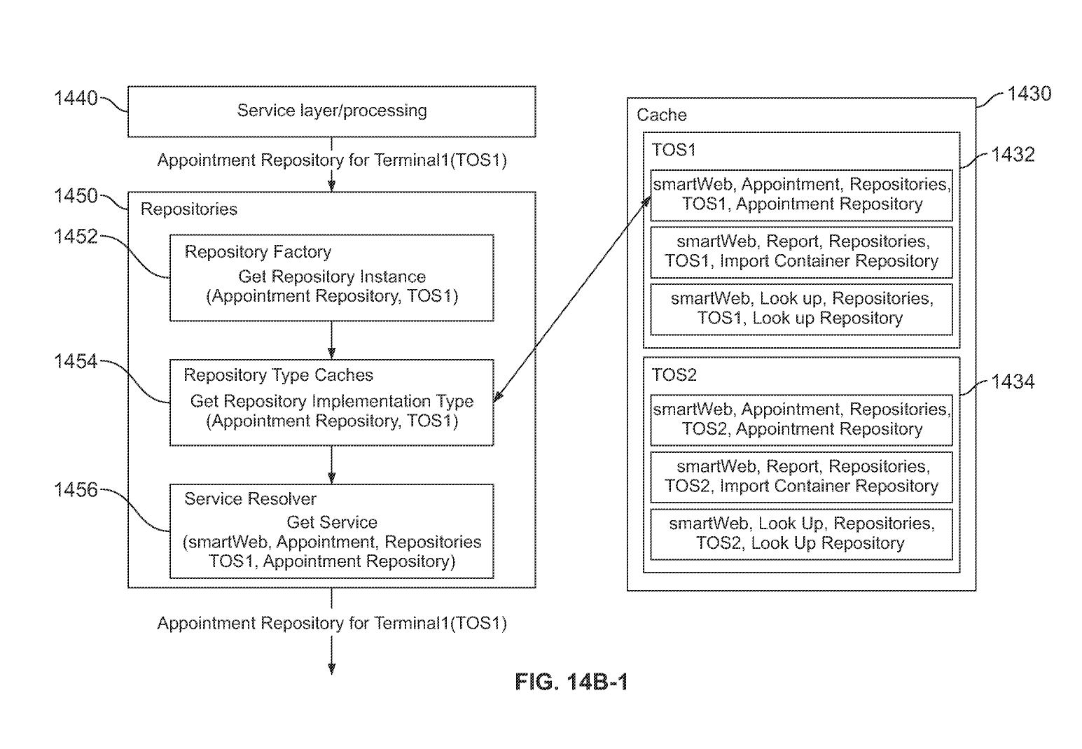

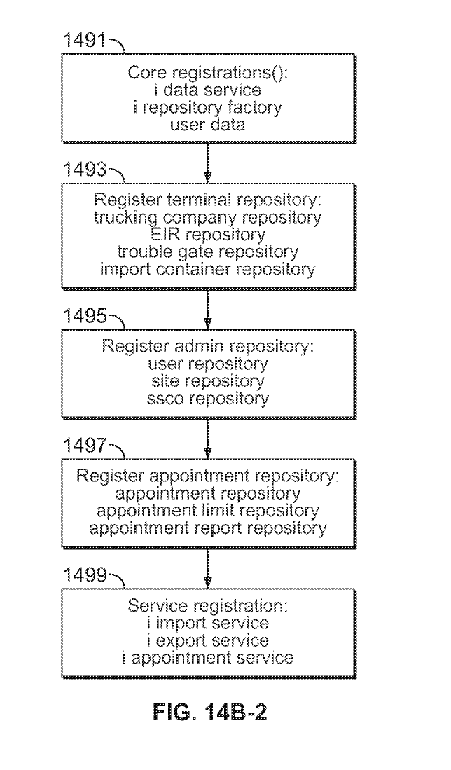

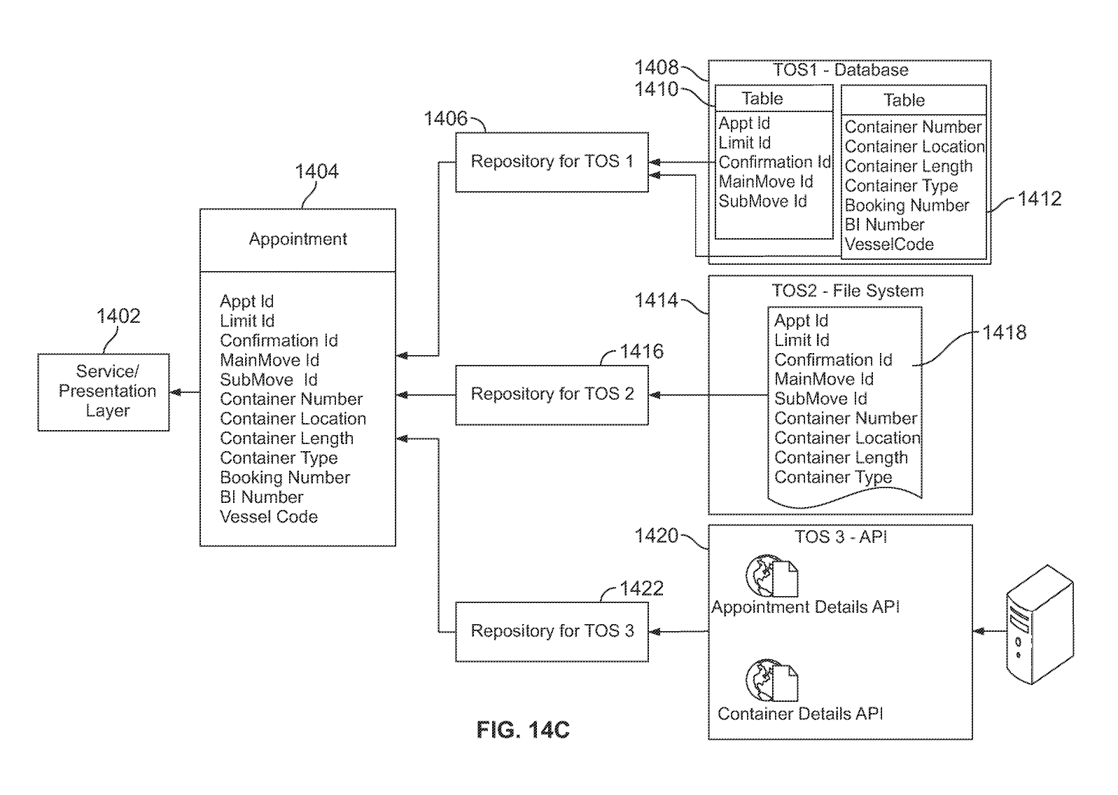

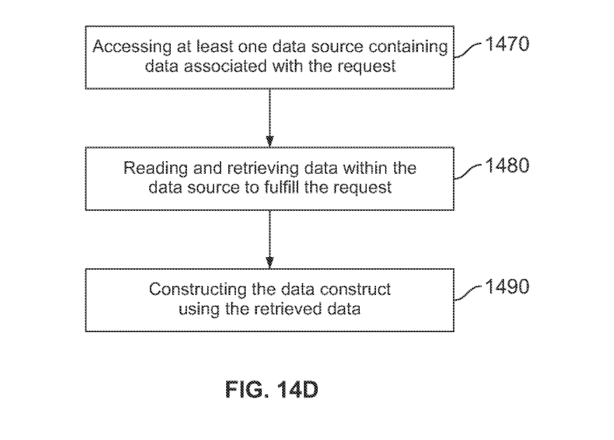

Turning back to overall aspects of the innovations herein, FIGS. 14A and 14B-1 show exemplary flow diagrams involving illustrative repository processing methods consistent with one or more aspects of the innovations herein. FIG. 14B-1 is a specific example illustrating the process outlined in FIG. 14A. Detailed examples of code which may be used by elements of systems performing the described exemplary methods of FIGS. 14A and 14B-1 may be found in Appendix 1, attached hereto.

Turning first to FIG. 14A-1, in 1440 a processing request may be received via a service module/processing layer. For example, this request may be a request to access and/or manipulate data in a TOS or business object. In response, a repository instance may be created and/or retrieved to facilitate processing of the request. In 1450, the request and/or data associated with the request may be transmitted to a repository module/processing layer. In 1452, a repository factory module/processing layer associated with the repository module/processing layer may process information to determine a repository instance that may be appropriate for processing the request. The repository instance may be specific to a TOS type for a TOS to be accessed and/or a repository type associated with the type of request that was received. In 1454, a repository type cache may be accessed by the repository factory to retrieve a previously generated repository implementation type appropriate for the determined repository instance (e.g., based on the repository type and/or TOS type). For example, the system may have received a similar request to perform similar processing on the same TOS type in the past, and may have generated a repository in response and stored the repository in the cache. Default/commonly encountered repositories may also be stored. In some cases, there may be no appropriate repository in the cache, in which case the system may generate one and store it in the cache for future use. A relationship between the cached data and the TOS type may be determined by using a reflection operation, a helper attribute, a convention, and/or in some other way. For example, the reflection operation may be used to discover a TOS type that is configured to implement interfaces configured with an inversion of control container; is contained in a namespace of interest; and/or comprises a TOS type attribute of interest and/or is contained in a sub-namespace named after a TOS type of interest.

In 1456, a service resolver module/processing layer may instantiate the retrieved/generated repository, for example by resolving a service associated with the cached attribute data. In 1460, the repository instance may be delivered. For example, the instance may be provided to the user who made the initial request for interaction.

Further, as set forth in more detail below, a variety of processing and modules may be utilized for different classes, such as GetRepositoryInstance, DefaultRepositoryFactory, TosTypeAttribute, ReportRepository, ServiceAppRegistry, CoreRegistrations, RegisterTerminalRepository, and RegisterAdminRepository.

With respect to exemplary Repository Factory processing, for example, a repository may have single constructor with dependencies defined as constructor parameters. A repository, however, may not be aware about how those components are created—it just may know what contracts implementation it should inject into the constructor. Further, the repository type may be resolved based on supplied TOS type. For this, IRepositoryFactory contract was introduced. Any implementation of this represents the actual component that returns the instance based on some condition.

```
public interface IRepositoryFactory
{
  TRepository GetRepositoryInstance<TRepository>( ) where
  TRepository : class;
}
```

Default one is DefaultRepositoryFactory that conveniently resolves particular repository type using reflection, helper attributes and a set of conventions. It uses the ReflectedRepositoryTypeCache utility class to save the known types until the application shutdown.

```
  public class DefaultRepositoryFactory : IRepositoryFactory
  {
    private static readonly
    ReflectedRepositoryTypeCache _repositoryTypeCache = new
ReflectedRepositoryTypeCache( );
    public DefaultRepositoryFactory(IServiceResolver serviceResolver,
UserData userData)
    {
      ServiceResolver = serviceResolver;
      CurrentUserData = userData;
    }
    protected IServiceResolver ServiceResolver { get; set; }
    public UserData CurrentUserData { get; protected set; }
    public string TosType
    {
      get
      {
        return tosType;
      }
    }
    public object GetRepositoryInstance(Type interfaceType)
    {
      // Ensure the type-cache is initialized for given TOS type
      _repositoryTypeCache.EnsureInitializedFor(TosType);
      // Get implementation type
      var implementationType = _repositoryTypeCache
            .GetRepositoryImplementationType(interfaceType, TosType);
      if (implementationType == null)
        throw new InvalidOperationException(
          ″No implementations of ″ + interfaceType.Name + ″ found for
\″″ + TosType + ″\″″);
      // Resolve instance of obtained type through Service Resolver
      return ServiceResolver.GetService(implementationType);
    }
    public TRepository GetRepositoryInstance<TRepository>( )
    where TRepository : class
    {
      return GetRepositoryInstance(typeof (TRepository)) as TRepository;
    }
  }
```

As shown in FIG. 14A-2, once RepositoryFactory 1401 retrieves implementation type from RepositoryTypeCache 1411 for the interface type and TOS type, the RepositoryFactory 1401 may ask IServiceResolver 1421 to build the instance. The cache 1411 may ensure initialization 1413 and get repository implementation type 1415. The factory 1401 may comprise logic 1405 to define which type to instantiate, but actual creation 1425 may be delegated to IServiceResolver 1421. This allows for flexibility since all the dependencies could be automatically configured.

Exemplary Module and Processing

i. RepositoryTypeCache

DefaultRepositoryFactory may be responsible to resolve the concrete repository type to be instantiated. It does that based on supplied Terminal TOS type, for example. For actual type discovery, it may use the set of conventions and helper attributes.
Internally, it may use reflection to discover types that:
Implement interfaces configured with IoC-container;
Are contained inside the “smartWeb” namespace;
Have the optional TOS-type attribute defined (optional) or (in case of no TOS-type attribute) have been placed in sub-namespace named after TOS-type.
   To use attribute or namespace, the factory tries to see whether there is a TosTypeAttribute defined. If there is no attribute then it tries to figure out the relation to given TOS type by namespace. Namespace-convention is strong convention so the attribute is for special cases only.

```
[AttributeUsage(AttributeTargets.Class, AllowMultiple = false,
Inherited = true)]
public class TosTypeAttribute : Attribute
{
  public TosTypeAttribute(string tosType)
  {
    TosType = tosType;
  }
  public string TosType { get; protected set; }
}
```

As an example, consider two convenience subclasses for TosTypeAttribute: TOS1Attribute and TOS2Attribute. Those are just shortcuts to allow [TOS1] or [TOS2].

```
[AttributeUsage(AttributeTargets.Class, AllowMultiple = false,
Inherited = true)]
public class TOS1Attribute : TosTypeAttribute
{
  public TOS1Attribute( ) : base(″TOS1″) { }
}
[AttributeUsage(AttributeTargets.Class, AllowMultiple = false,
Inherited = true)]
public class TOS2Attribute : TosTypeAttribute
{
  public TOS2Attribute( ) : base(″TOS2″) { }
}
```

Report repository for TOS1 could be either marked with attribute or places into namespace (or both) but just putting into namespace is cleaner:

[TOS1]
public class ReportRepository : IReportRepository { ... }
- or -
namespace smartWeb.Export.Repositories.TOS1
{
public class ReportRepository : IReportRepository { ... }
}

The types when discovered may be stored in a thread-safe dictionary by ReflectedRepositoryTypeCache. This eliminates the need for runtime reflection on every request so performance loss may be prevented. Lazy loading technique is leveraged on per-TOS-type basis in some examples, although other techniques could be used.

```
  internal sealed class ReflectedRepositoryTypeCache
  {
    private volatile Dictionary<string, Dictionary<Type,
Type>> _cache = new Dictionary<string, Dictionary<Type, Type>>( );
    private static readonly object _locker = new object( );
    public IEnumerable<Assembly> Assemblies
    {
      get { return
AppDomain.CurrentDomain.GetAssemblies( ).Where(a =>
a.FullName.StartsWith(″smartWeb″)); }
    }
    public IEnumerable<Type> LoadedTypes
    {
      get { return Assemblies.SelectMany(a => a.GetTypes( )); }
    }
    public Type GetRepositoryImplementationType(Type interfaceType,
    string tosType)
    {
      if (!_cache.ContainsKey(tosType))
        return null;
      Dictionary<Type, Type> typeDict;
      if (!_cache.TryGetValue(tosType, out typeDict) | | typeDict == null)
        return null;
      if (!typeDict.ContainsKey(interfaceType))
        return null;
      Type implementationType;
      if (!typeDict.TryGetValue(interfaceType, out implementationType))
        return null;
      return implementationType;
    }
    public void EnsureInitializedFor(string tosType)
    {
      if (!_cache.ContainsKey(tosType))
      {
        lock (_locker)
        {
          if (!_cache.ContainsKey(tosType))
          {
            EnsureInitializedInternal(tosType);
          }
        }
      }
    }
    public bool IsRepositoryInterface(Type t)
    {
      return t != null
        && t.IsInterface
        && t.IsPublic
        && t.Name.StartsWith(″I″, StringComparison.OrdinalIgnoreCase)
        && t.Name.EndsWith(″Repository″,
        StringComparison.OrdinalIgnoreCase);
    }
    public bool IsRepositoryImplementation(Type t)
    {
      return t != null
        && t.IsClass
        && !t.IsAbstract
        && t.IsPublic
        && t.Name.EndsWith(″Repository″,
        StringComparison.OrdinalIgnoreCase);
    }
    public bool IsImplementationOf(Type interfaceType, Type t)
    {
      return t != null
        && interfaceType != null
        && interfaceType.IsAssignableFrom(t);
    }
    public bool IsTosTypeAttributeMatch(Type t, string tosType)
    {
      var tosTypeAttr = t.GetCustomAttributes(typeof(TosTypeAttribute),
true).FirstOrDefault( ) as TosTypeAttribute;
      return tosTypeAttr != null && tosTypeAttr.TosType.Equals(tosType);
    }
    public bool IsNamespaceMatch(Type t, string tosType)
    {
      return t - != null
        && !string.IsNullOrEmpty(t.Namespace)
        && (t.Namespace.EndsWith(″.″ + tosType,
StringComparison.OrdinalIgnoreCase) | |
          t.Namespace.IndexOf(″.″ + tosType + ″.″) >= 0);
    }
    private void EnsureInitializedInternal(string tosType)
    {
      var interfaceTypes =
      LoadedTypes.Where(IsRepositoryInterface).ToList( );
      var typeDict = new Dictionary<Type, Type>( );
      foreach (var ifc in interfaceTypes)
      {
        var interfaceType = ifc;
        var implementationTypes = LoadedTypes
          .Where(t =>
            IsRepositoryImplementation(t)
            && IsImplementationIf(interfaceType, t)
            && (IsTosTypeAttributeMatch(t, tosType) | |
IsNamespaceMatch(t, tosType))).ToList( );
        if (implementationTypes.Count == 1)
        {
          var implementationType = implementationTypes.First( );
          typeDict.Add(interfaceType, implementationType);
        }
        else if (implementationTypes.Count > 1)
        {
          throw new InvalidOperationException(string.Format(
            ″Ambiguous implementations of {0} found for \″{1}\″: {2}″,
            interfaceType, tosType,
            implementationTypes.Select(s =>
            Environment.NewLine + ″[″ + s +
″]″)));
        }
      }
      if (typeDict.Count > 0)
        _cache.Add(tosType, typeDict);
    }
```

One example of the aforementioned process is illustrated in FIG. 14A-3. Repository factory may get repository instance 1431. The reflected repository type cache may get repository implementation type 1433, get implementation types for TOS type 1435, and get implementation type for TOS type and interface type 1437. The reflected repository type cache may also ensure initialization 1441. If the cache already contains the repository type 1443, the repository instance may be supplied. If the cache does not contain the repository type 1443, it may be built and added to cache 1451-1459. Specifically, in some embodiments, internal initialization may be insured 1451, repository implementation may be checked 1453, implementation may be checked 1455, attribute and/or namespace match may be checked 1457, and, if all checks pass, the repository type may be added to cache 1459 and supplied.

### ServiceResolver

To address the general service resolution issue and obtain the ability to follow the Dependency Inversion Principle, an IServiceResolver contract is introduced.

IServiceResolver may resolve any service for supplied type (be it an interface or concrete type) and any of its specific implementation may be capable of performing “constructor injection” which is the primary technique of Dependency Injection.

```
public interface IServiceResolver
{
  object GetService(Type serviceType);
  IEnumerable<object> GetServices(Type serviceType);
}
```

Note that IServiceResolver doesn't represent some particular infrastructural part and only works at .NET type level. ServiceResolver is very generic and is capable of resolving any kinds of program components.

```
public class ServiceResolver
{
  private static readonly ServiceResolver _instance = new
  ServiceResolver( );
  private IServiceResolver _innerResolver =
  new DefaultServiceResolver( );
  public static IServiceResolver Current
  {
    get { return _instance.InnerResolver; }
  }
  public IServiceResolver InnerResolver
  {
    get { return _innerResolver; }
  }
  public static void SetResolver(IServiceResolver resolver)
  {
    _instance.InnerSetResolver(resolver);
  }
  public void InnerSetResolver(IServiceResolver resolver)
  {
    if (resolver == null)
      throw new ArgumentNullException(″resolver″);
    _innerResolver = resolver;
  {
  private class DefaultServiceResolver : IServiceResolver
  {
    public object GetService(Type serviceType)
    {
      try
      {
        return Activator.CreateInstance(serviceType);
      }
      catch
      {
        return null;
      }
    }
    public IEnumerable<object> GetServices(Type serviceType)
    {
      return Enumerable.Empty<object>( );
    }
  }
}
```

Program components may not contain any initialization code for their dependencies. They may only receive configured instances through their constructors and may never care where those instances came from. This eliminates close coupling altogether. There may be only place in the application where all the components are wired up. It can be treated as the “Application Architecture Hub”. As one example: Get Report Repository for TOS 1 to process GetImportContainer request for a terminal using TOS 1 from User.

In one specific example of FIG. 14B-1, the service module/processing layer may send a request for a appointment repository for a first terminal (Terminal 1) to the repository module/processing layer. As shown, Terminal 1 may use a first TOS type (TOS 1). In 1452, the repository factory module/processing layer may get a repository instance based on the appointment repository type and the TOS 1 type. In 1454, the cache may be searched for the appropriate implementation. In this example, a subset of the cache 1430 contains appointment repository instances for a TOS 1 type TOS 1432 and a TOS 2 type TOS 1434. Because the appointment repository being requested is for TOS 1, the TOS 1 entry 1432 may be selected. In 1456, the service resolver module/processing layer may use data retrieved from the cache to instantiate the repository, and the appropriate appointment repository may be sent to a desired recipient.

### Exemplary Modules/Processing Regarding FIG. 14B-2

The StructureMap library is used as a “backing” technology behind IServiceResolver. This may not introduce any dependency on StructureMap because of IServiceResolver design. Any other implementation of IServiceResolver could be easily supplied without changing a single line of code.

The repository concrete type may be configured in “IoC container registry”. Also, no one except container registry may be aware of configured concrete type for IRepositoryFactory. ServiceAppRegistry class is an “IoC container registry” using StructureMap and used to configure repositories and repository factories.

In some embodiments, such as that shown in the code below and illustrated in FIG. 14B-2, for example, processing may proceed as follows. Core registrations (e.g., data service, repository factory, user data, etc.) may be performed 1491. Terminal repositories (e.g., trucking company, EIR, trouble gate, import container, etc.) may be registered 1493. Admin repositories (e.g., user, site, SSCO, etc.) may be registered 1495. Appointment repositories (e.g., appointment, appointment limit, appointment report, etc.) may be registered 1497. Services (e.g, import, export, appointment, etc.) may be registered 1499.

```
public class ServiceAppRegistry : Registry
{
    public ServiceAppRegistry( )
    {
      // Core infrastructure registrations
      CoreRegistrations( );
      // Repositories
      // Gate
      RegisterTerminalRepository<ITruckingCompanyRepository>( );
      RegisterTerminalRepository<IEIRRepository>( );
      RegisterTerminalRepository<ITroubleGateRepository>( );
      // Admin repositories
      RegisterAdminRepository<ISiteRepository, SiteRepository>( );
      RegisterAdminRepository<ISscoRepository, SscoRepository>( );
      // Services
      For<IExportService>( ).Use<ExportService>( );
      For<IGateService>( ).Use<GateService>( );
      // Gateway service (only interface is known at design time)
      For(typeof(ISuperService)).Use(
        new
GatewayServiceTypeFactory( ).
GetImplementationTypeFor<ISuperService>( ));
    }
    public void CoreRegistrations( )
    {
      // Default database (resolved based on Terminal ID
      passed by requestor user)
      For<OracleDataService>( ).Use(c =>
c.GetInstance<UserDataBasedDataServiceFactory>( ).GetDataService( ));
      // Repository factory (default one resolves instances based on TOS
type for user Terminal)
      For<IRepositoryFactory>( ).Use<DefaultRepositoryFactory>( );
      // Whatever needs the UserData will take it from container
      // For<UserData>( ).Use(( ) =>
      RequestMessageHeader.Current.ToUserData( ));
      For<UserData>( ).Use(( ) => new UserData
      { TerminalId = ″PAOH″ }); // Mockup
(for usage with WCF Test Client)
    }
    public void RegisterTerminalRepository<TInterface>( )
    where TInterface : class
    {
      // Every non-admin repository is created by registered factory.
      // DefaultRepositoryFactory registered above resolves types
      // based on TOS type and uses conventions
      (attributes and namespaces).
      For<TInterface>( ).Use(c =>
c.GetInstance<IRepositoryFactory>( ).
GetRepositoryInstance<TInterface>( ));
    }
    public void RegisterAdminRepository<TInterface, TImplementation>( )
      where TImplementation : TInterface
    {
      // This states that for every interface-class registered here as a
constructor
      // parameter of type OracleDataService we use
      OracleDataService resolved by
      // AdminDataServiceFactory.
      For<TInterface>( ).Use<TImplementation>( )
        .Ctor<OracleDataService>( ).Is(c => { return new
AdminDataServiceFactory( ).GetDataService( ); });
    }
  }
```

FIG. 14C shows an exemplary block diagram involving an illustrative appointment process and TOS agnostic processing consistent with one or more aspects of the innovations herein. FIG. 14C is a specific example illustrating the process outlined in FIG. 14D. Detailed examples of code which may be used by elements of systems performing the described exemplary methods of FIGS. 14C and 14D may be found in Appendix 2, attached hereto.

A TOS 1 database 1408 may be read for appointment data 1410 and corresponding container data 1412 that may be provided in tables in a TOS 1 specific format. The data 1410 and 1412 may be read and transmitted over a network to TOS 1 repository instance component/processing 1406. A similar process may occur for each of TOS 2 repository instance component/processing 1416 and TOS 3 repository instance component/processing 1422. The TOS 2 data source 1414 may be stored in a file system where appointment/container data 1418 are stored in a TOS 2 specific format different from the TOS 1 format and TOS 3 format once they are read and transmitted to the TOS 2 repository instance component/processing 1416. The TOS 3 data source may be an API where appointment detail API and corresponding container detail API data are read and transmitted to the TOS 3 repository instance component/processing in a TOS 3 specific format. In FIG. 14C, each repository instance component/processing corresponds to the appointment business object and one of three TOS types. The appointment business object may have a plurality of associated functions and properties, such as a appointment number, steamship company, vessel, shipper, loading port, discharge port, appointment type, booking lines, export container, reefer info, hazardous cargo info, EDI memo, user memo, and the like. These properties may have a one-to-one correspondence to the data stored in the TOS databases 1412, 1418 and 1420, or may have a one-to-many correspondence.

Each TOS repository instance component/processing 1406, 1416 and 1422 may perform processing to process/transform the data of a TOS specific format retrieved from a corresponding database into the business object format that is a TOS agnostic format. In FIG. 14C, the transformation/mapping process occurs from the TOS specific format to the business object format, but may also be performed from the business object format to the TOS specific format as well. The retrieved data that is converted into the TOS agnostic business object format is transmitted from any of the TOS repository instance component/processing 1406, 1416, 1422 to the business object component/processing 1404. The business object component/processing 1404 performs processing on the business object data according to the user input, for example. The result may be output to the service/presentation layer 1402 for further processing and/or display to a user interface.

FIG. 14D shows an exemplary flow chart involving illustrative repository based TOS agnostic processing consistent with one or more aspects of the innovations herein. The process begins at step 1470 with accessing at least one data source containing data associated with the request. Next, data may be read and retrieved within the data source to fulfill the request at step 1480. Then, the data construct may be constructed at step 1490 using the retrieved data from step 1480.

### Processing User Request in TOS Agnostic

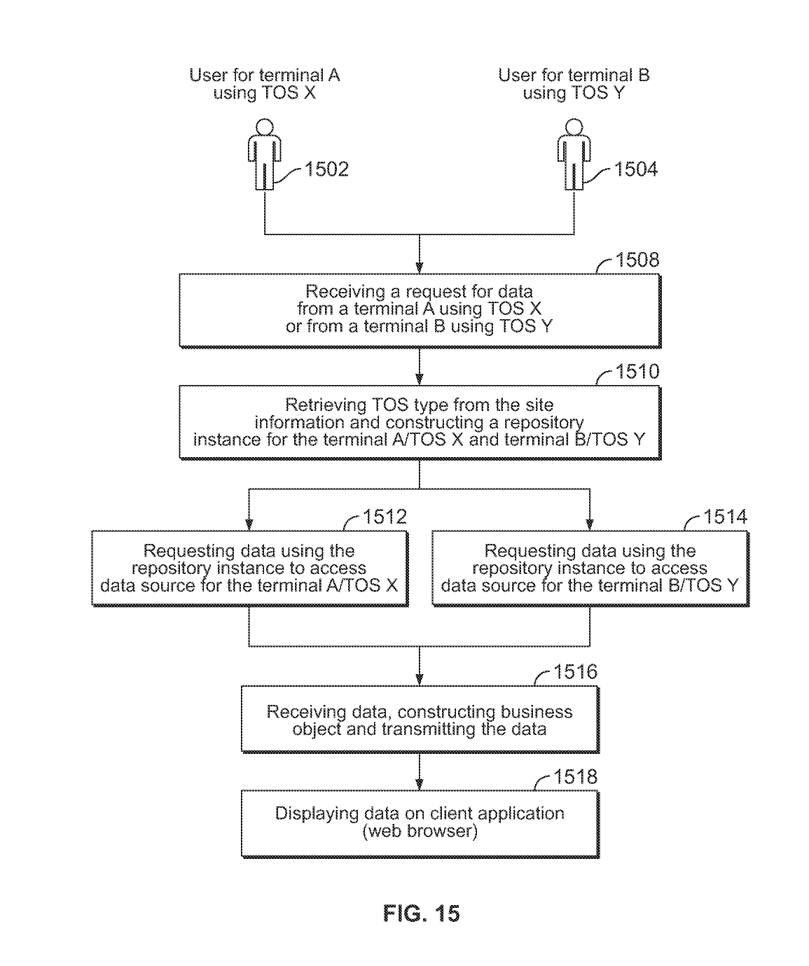

FIG. 15 shows an exemplary flow of processing performed via an illustrative TOS agnostic system and associated processing consistent with one or more aspects of the innovations herein. The inventive systems and methods are not limited to a user of a specific Terminal Operating System and terminal. Instead, the TOS agnostic system allows a plurality of users to access a plurality of terminals operating under any of a plurality of Terminal Operating Systems. Referring to FIG. 15, users 1502 and 1504 represent different users accessing a plurality of terminal sites operating under different Terminal Operating Systems. For example, user 1502 desiring access to a Terminal A site that implements a TOS X while user 1504 desires access to a Terminal B that implements a TOS Y, where the TOS X and TOS Y are incompatible with each other. In particular, each Terminal Operating System operates based on a proprietary language and/or data format. The same information stored by one TOS database may be described so as to be unrecognizable and unusable to a different TOS database.

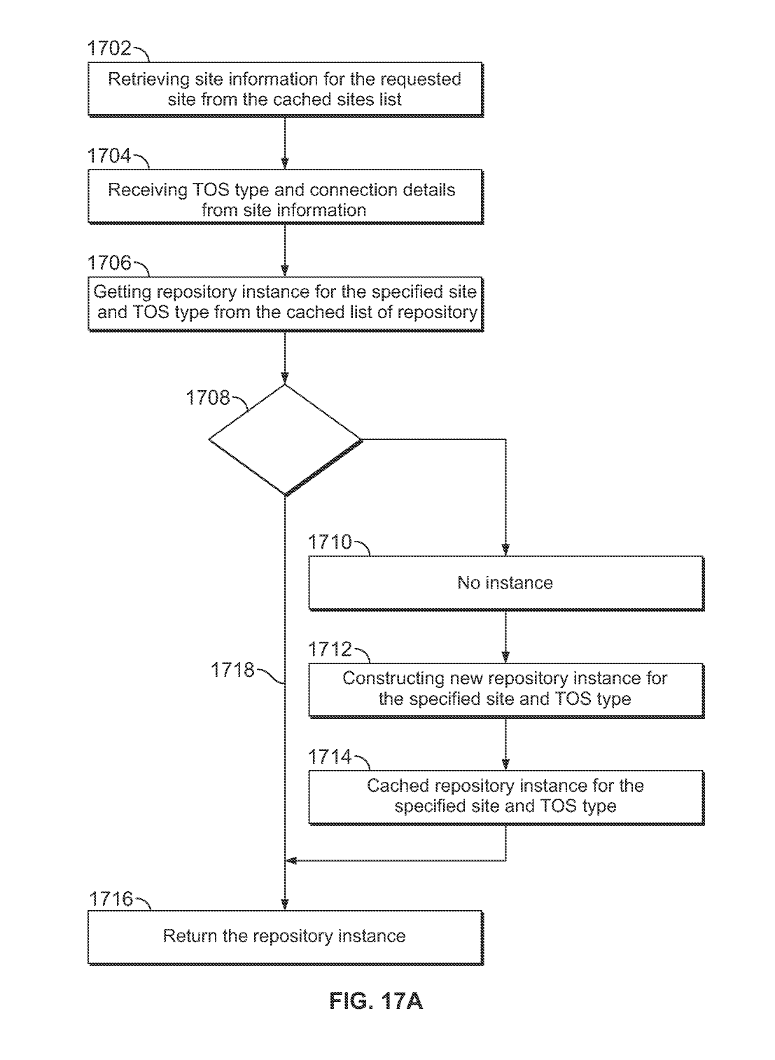

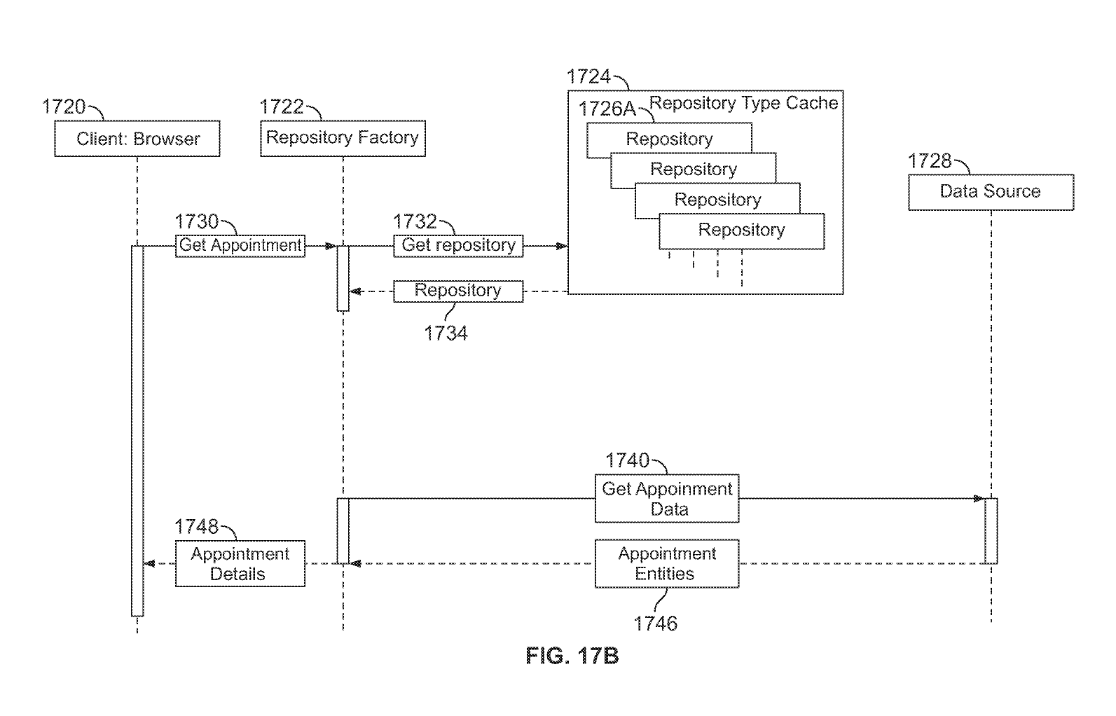

Conventionally, a user who wishes to access data of terminal sites using different Terminal Operating Systems may need to access an interface specific to the Terminal Operating System of that terminal site. However, consistent with aspects of the present innovations, requests for data are processed regardless of the Terminal Operating System used such that each user 1502, 1504 is able to access any desired terminal site. At step 1508, a request for data may be received for any or both Terminal A and Terminal B by the TOS agnostic system. For example, a user interface provides a list of terminals for a user to select. At step 1510, a TOS type may be determined based on the request. The system may determine correspondence between a selected terminal and the TOS associated with the terminal. Based on the determined TOS type, a repository instance may be constructed for the Terminal requesting data. The construction of the repository instance is discussed in greater detail below in FIG. 17A-17B. Next, one of steps 1512 and 1514 may be executed based on the Terminal making the data request. Step 1512 requests data using the repository instance created to access data source for the Terminal A using the Terminal Operating System X. Likewise, step 1514 requests data using the repository instance created to access data source for the Terminal B using the Terminal Operating System Y. At step 1516, data may be received by the repository instance, whereby the data is then processed to construct business object data. The retrieved data from a TOS database may be converted into a common data format in order to provide a common business object data format. The business object data may be transmitted to the user making the data request. At step 1518, the system may display the business object data to the user via a client application such as a web browser or other user interface. In this manner, a user may be able to retrieve data from any Terminal operating any Terminal Operating System from a TOS agnostic system.

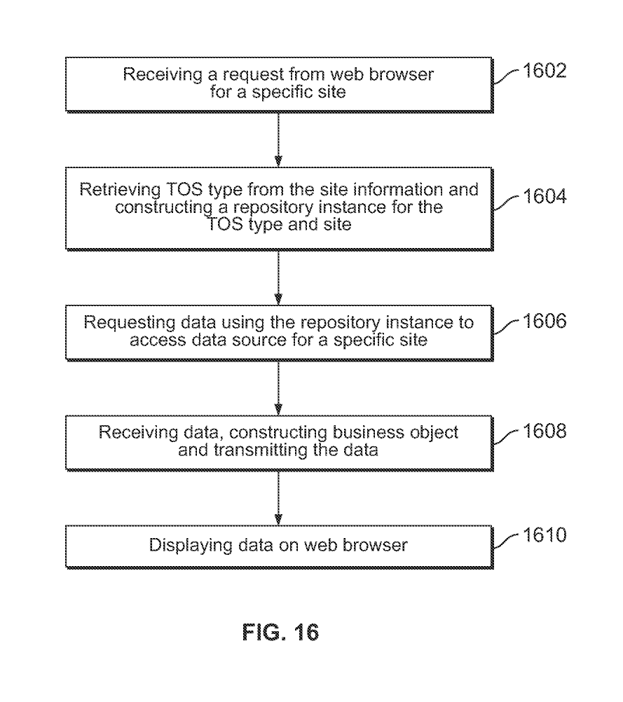

FIG. 16 shows an exemplary work flow diagram of illustrative TOS agnostic processing consistent with one or more aspects of the innovations herein. At step 1602, a request may be received from a user interface such as a web browser for a specific terminal site among a plurality of terminal sites. At step 1604, a TOS type may be determined from the terminal site information. Based on the determined TOS type, a repository instance may be constructed within the TOS agnostic system specific to the TOS type and terminal site. At step 1606, the TOS agnostic system may request data from the terminal site to store in the repository instance. Next, the requested data may be received at step 1608 and is processed by the TOS agnostic system to create a set of business objects. The business objects may be transmitted to the user interface and are displayed at step 1610.

### Repository Locator

FIG. 17A shows an exemplary flow diagram of illustrative TOS agnostic repository locator processing consistent with one or more aspects of the innovations herein. At step 1702, terminal site information may be retrieved for a requested terminal site based on a cached list of terminal sites. At step 1704, based on the retrieved terminal site, a Terminal Operating System type corresponding to the terminal site may be determined and connection information is retrieved from terminal site information. Next, step 1706 attempts to obtain a repository instance for the specified terminal site and corresponding TOS type from a cached list of repository instances. At the decision step 1708, if it is determined that the TOS agnostic system has previously constructed a repository instance for the requested terminal and TOS type, then the cached repository instance may be returned at step 1716. However, if it is determined that no repository instance exists for the specified terminal and TOS type, then a new repository instance may be constructed for the specified terminal and TOS type. Once created, the repository instance may be cached at step 1714 and returned to the user at step 1716.

FIG. 17B shows an exemplary sequence diagram involving an illustrative appointment process and TOS agnostic processing consistent with one or more aspects of the innovations herein. A user 1720 operates a client/browser to input a request 1730 for TOS data, which in this case refers to appointment data request 1730. A user can use various mobile devices to access the browser. The repository factory 1722 may receive this request and may attempt to locate a stored repository 1724 from among a plurality of repository instances 1726 that corresponds to the appointment request. If a match is found, then the corresponding appointment repository may be returned to the repository factory 1722 at step 1734, and the requested appointment details 1748 from the located repository 1726A are returned to the browser on either mobile devices or desktops 1720 and output to a user.

However, if no repository instance is located that corresponds to the appointment request 1730, then a create repository function 1736 may be called to generate a appointment repository 1738. Once created, the repository locator 1722 may call a get appointment data 1740 function to the repository 1738 to retrieve the requested appointment data from the data source 1728. The repository 1738 then may call a get appointment data 1742 function to the data source 1728 to obtain the requested appointment information. In response, the data source 1728 may return appointment entities 1744 in a format of the data source to the repository 1738. The repository 1738 then may perform processing on the appointment entities 1744 to map/convert/transform them into appointment business objects 1746 in a data source agnostic format.

The appointment objects 1746 are then transmitted from the repository 1738 to the repository locator 1722 which may process the appointment objects 1746 into appointment details 1748. The repository locator 1722 then may transmit the appointment details 1748 to the browser 1720 in response to the appointment request 1730. In this system, the browser needs not be compatible with the operating system or data format of the data source 1728 in order to request and receive information from the data source 1728 since the appointment entities 1744 are processed into appointment objects 1746 that are data source agnostic.

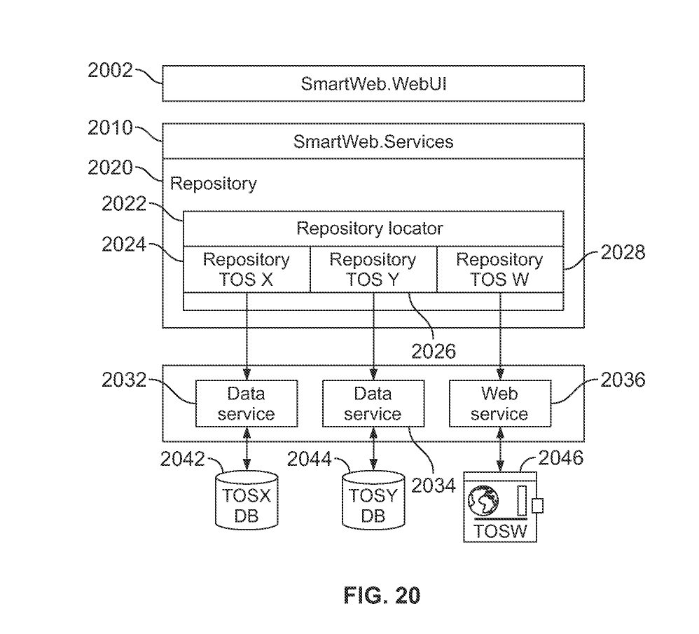

FIG. 20 is a block diagram depicting an illustrative repository locator hierarchy/structure for an exemplary TOS agnostic system consistent with one or more aspects of the innovations herein. A web interface 2002 may display the retrieved database data to the requesting user. The services layer 2010 may process and store the retrieved data via a repository 2020. The cached repositories may retrieve data through the use of respective data services 2032, 2034 and web service 2036. For example, the data service 2032 interfaces with the TOS1 DB for storage into repository 2024. The web service 2036 may similarly retrieve requested data from a web source 2046 for caching in repository 2028.

### Layer Architecture of TOS Agnostic System

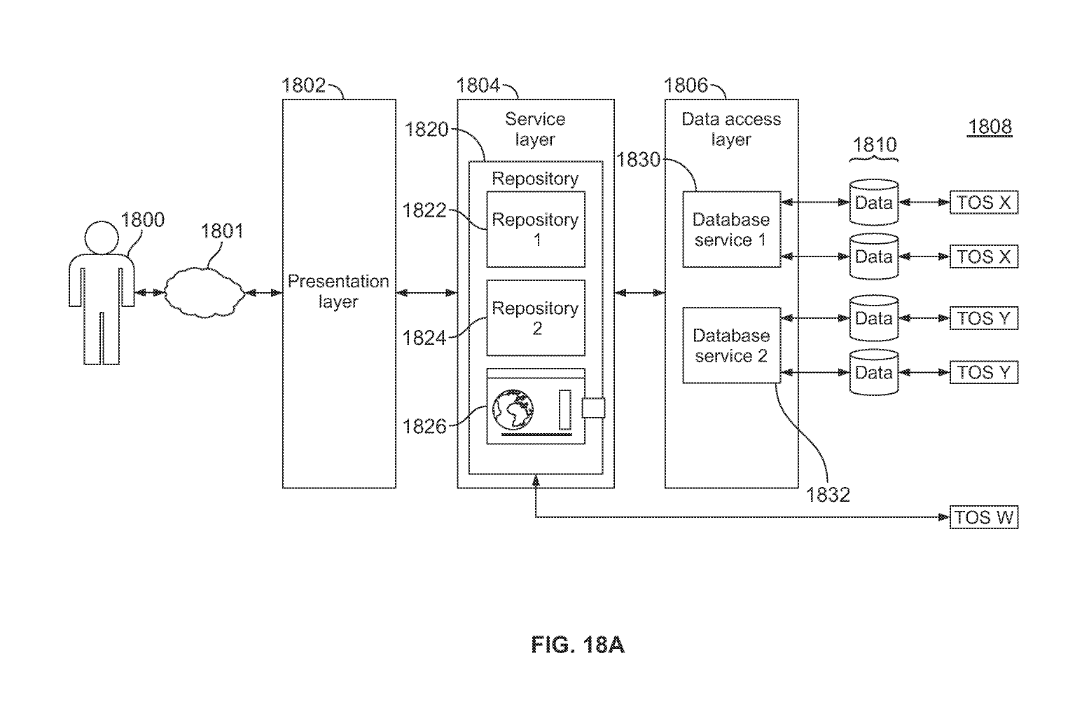

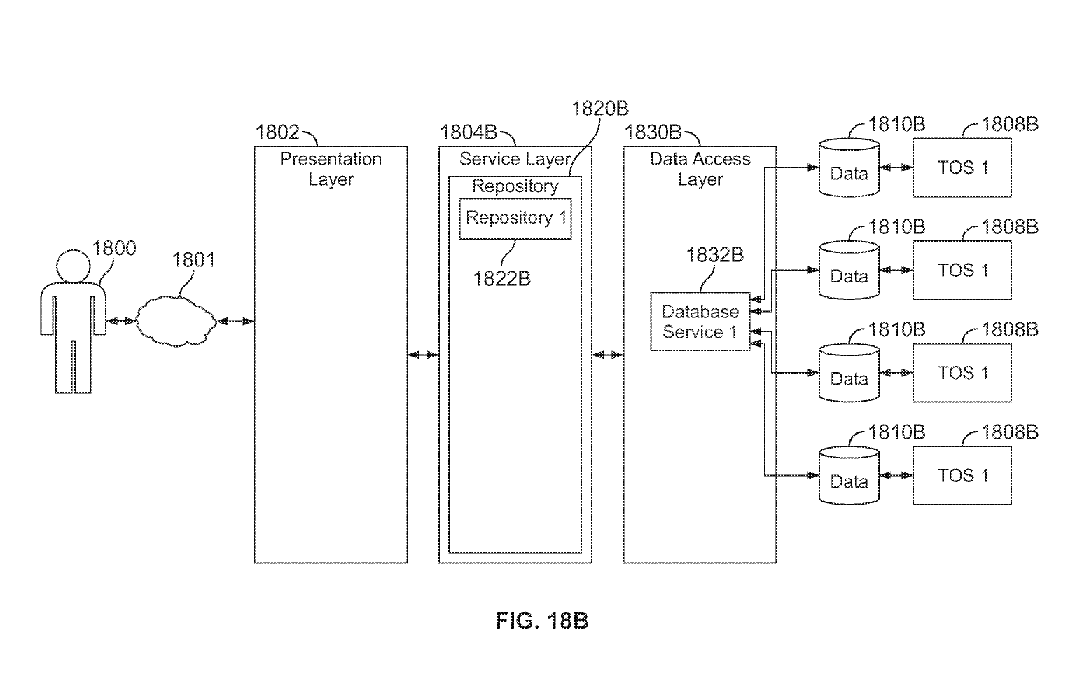

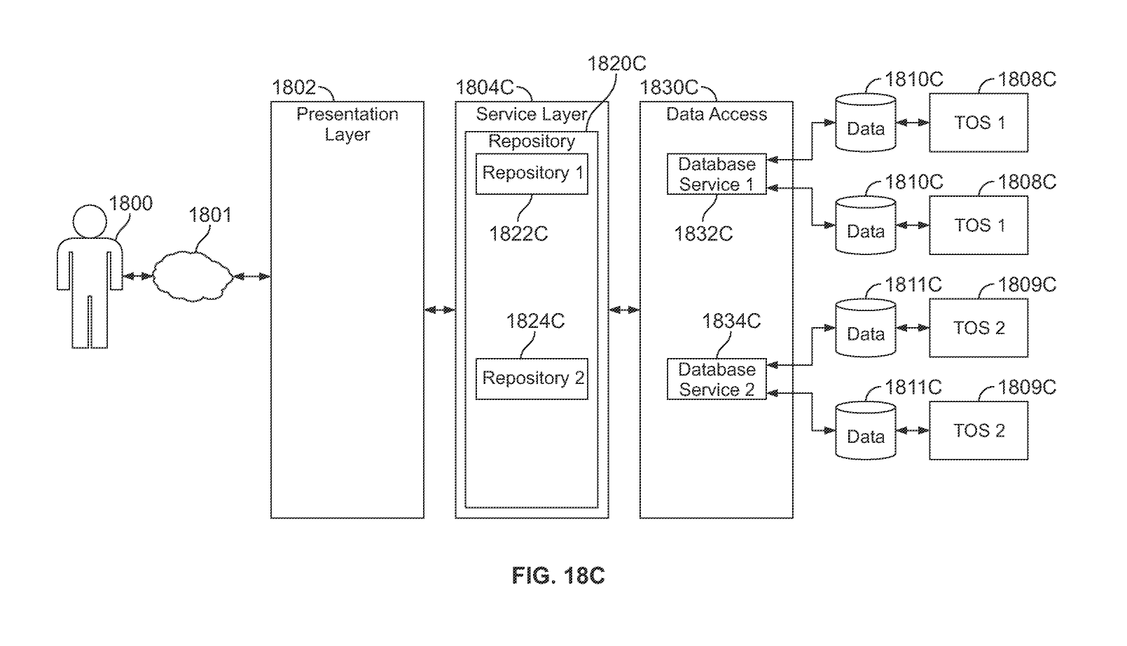

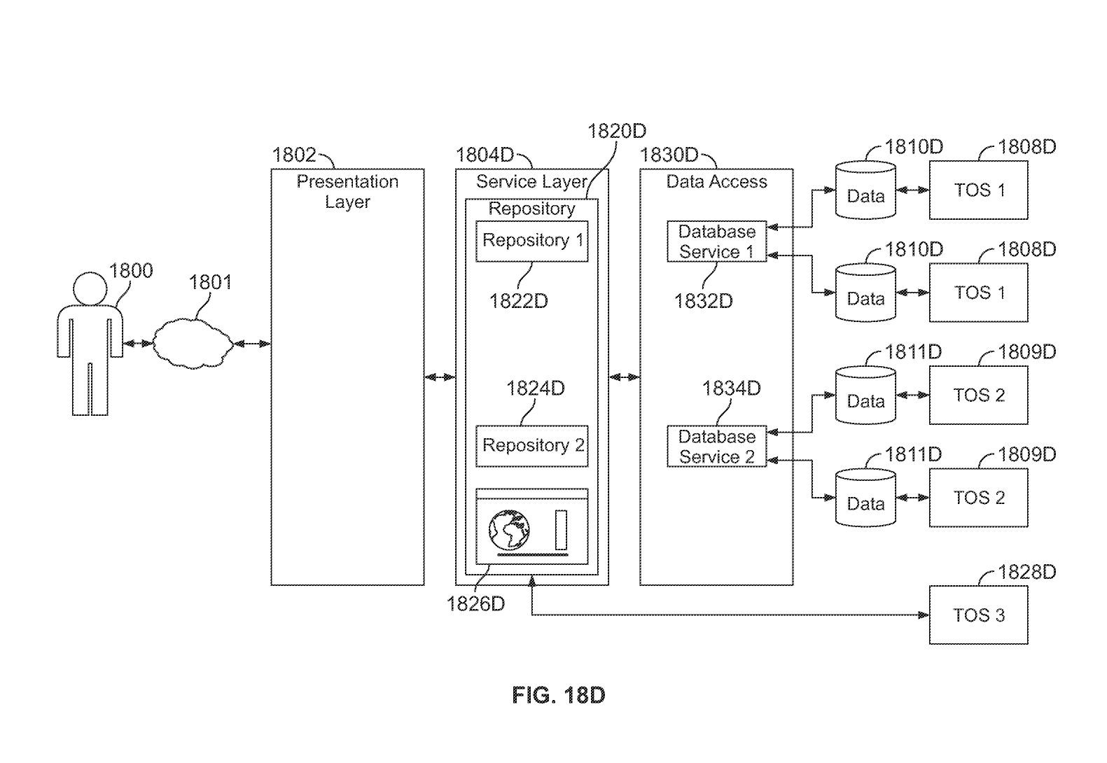

FIG. 18A is a block diagram depicting one illustrative layer architecture for an exemplary TOS agnostic system consistent with one or more aspects of the innovations herein. In this example, user 1800 operates a computing device that connects to a network 1801 to view a presentation layer 1802. The presentation layer 1802 receives data from a service layer 1804 that stores and processes terminal data from a plurality of TOS types. The service layer 1804 includes a repository 1820 including a plurality of repository instances 1822, 1824, 1826, etc. The repository 1826 is a Web Service that is provided data from a TOS W. The repository instances may be connected to a data access layer 1806 that are connected to a plurality of data sources 1810 operating under different Terminal Operating Systems 1808. The data access layer 1806 obtains the requested terminal data from any of a plurality of data sources 1810 via corresponding database services 1830, 1832. A database service may be provided for each TOS type such that each data source corresponding to TOS X is accessible by database service 1830. Similarly, each data source corresponding to TOS Y is accessible by database service 1832. However, a data source 1810 and data access layer 1806 is not necessary for TOS W. The TOS W provides data to the Web Service 1826.

In some embodiments, the TOS agnostic system performs repository processing including instantiating a first repository instance for a first TOS type. For example, first data is requested using the first repository instance and a first database service to access a data source for a specific site. A first business object may be constructed using the first data and the first business object is presented to a user as a first TOS-agnostic output. A second repository instance may be instantiated for a second TOS type. Second data is requested using the second repository instance and a second database service to access a data source for a specific site. A second business object may be constructed using the second data and the second business object is presented to a user as second TOS-agnostic output. A third repository instance may instantiated as a web service that accesses third data from a third TOS type directly. A third business object may be constructed using the third data and the third business object is presented to a user as third TOS-agnostic output.

FIG. 18B is a block diagram depicting one illustrative layer architecture for an exemplary TOS agnostic system consistent with one or more aspects of the innovations herein. In this example, a user 1800 operates a computing device that connects to a network 1801 to view a presentation layer 1802. The presentation layer 1802 receives data from a service layer 1804B that stores and processes terminal data from a TOS using a relation database. The service layer 1804B includes a repository 1820B including at least one repository instance 1822B. The repository instances may be connected to a data access layer 1830B including a plurality of data sources 1810B operating under a Terminal Operating System 1808B. The data access layer 1830B obtains the requested terminal data from any of a plurality of data sources 1810B via corresponding database services 1832B. A database service 1832B is provided for the TOS 1808B such that each data source 1810B corresponding to TOS 1808B is accessible by database service 1832B.

In some embodiments, the TOS agnostic system performs repository processing including instantiating a repository instance for a TOS type. Data may be requested using the repository instance and a database service to access a plurality of data sources for a specific site. A first business object may be constructed using the data and the first business object is presented to a user as a TOS-agnostic output.

FIG. 18C is a block diagram depicting one illustrative layer architecture for an exemplary TOS agnostic system consistent with one or more aspects of the innovations herein. In this example, a user 1800 operates a computing device that connects to a network 1801 to view a presentation layer 1802. The presentation layer 1802 receives data from a service layer 1804C that stores and processes terminal data from a plurality of TOS types using different relational databases. Examples of non-limiting relational databases include Oracle, MS SQL, MySql, etc. The service layer 1804C includes a repository 1820C including a plurality of repository instances 1822C, 1824C, etc. The repository instances may be connected to a respective plurality of data sources 1810C, 1811C operating under respective Terminal Operating Systems 1808C, 1809C via data access layer 1830C. The data access layer 1830C obtains the requested terminal data from any of a plurality of data source 1810C, 1811C via corresponding database services 1832C, 1834C. A database service is provided for each TOS type such that each data source corresponding to TOS 1 is accessible by database service 1832C. Similarly, each data source corresponding to TOS 2 is accessible by database service 1834C.

In some embodiments, the TOS agnostic system performs repository processing including instantiating a first repository instance for a first TOS type. For example, data is requested using the first repository instance and a first database service to access at least one data source for a specific site. A first business object may be constructed using the first data and the first business object is presented to a user as a first TOS-agnostic output. A second repository instance may be instantiated for a second TOS type. Second data is requested using the second repository instance and a second database service to access the at least one data source for the specific site. A second business object may be constructed using the second data and the second business object is presented to a user as second TOS-agnostic output.

FIG. 18D is a block diagram depicting one illustrative layer architecture for an exemplary TOS agnostic system consistent with one or more aspects of the innovations herein. In this example, a user 1800 operates a computing device that connects to a network 1801 to view a presentation layer. The presentation layer 1802 receives data from a service layer 1804D that stores and processes terminal data from a plurality of TOS types including a TOS 1828D providing data using a Web Service 1826D. The service layer 1804D includes a repository 1820D including a plurality of repository instances 1822D, 1824D, 1826D, etc. The repository instances may be connected to plurality of data sources 1810D, 1811D operating under respective Terminal Operating Systems 1808D, 1809D via data access layer 1830D. The repository instance 1826D is a Web Service that is provided data from a TOS 1828D. The data access layer 1830D obtains the requested terminal data from any of a plurality of data sources 1810D, 1811D via corresponding database services 1832D, 1834D. A database service is provided for TOS types 1808D, 1809D such that each data source corresponding to TOS 1808D is accessible by database service 1832D. Similarly, each data source corresponding to TOS 1809D is accessible by database service 1834D.

In some embodiments, the TOS agnostic system performs repository processing including instantiating a first repository instance for a first TOS type. For example, data is requested using the first repository instance and a first database service to access at least one data source for a specific site. A first business object may be constructed using the first data and the first business object is presented to a user as a first TOS-agnostic output. A second repository instance may be instantiated for a second TOS type. Second data is requested using the second repository instance and a second database service to access at least one data source for a specific site. A second business object may be constructed using the second data and the second business object is presented to a user as second TOS-agnostic output. A third repository instance may instantiated as a web service that accesses third data from a third TOS type directly. A third business object may be constructed using the third data and the third business object is presented to a user as third TOS-agnostic output.

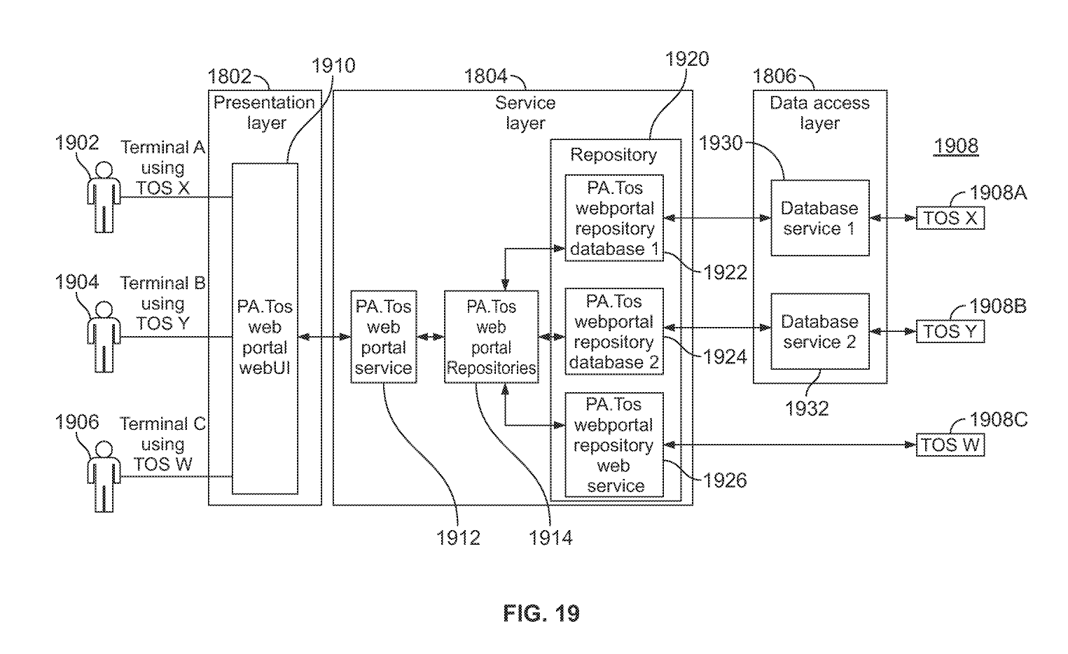

FIG. 19 is a block diagram depicts an illustrative layer architecture and associated processing modules for an exemplary TOS agnostic system consistent with one or more aspects of the innovations herein. In FIG. 19, each user 1902, 1904 and 1906 inputs a request to the presentation layer 1802 to access data from different terminal using different Terminal Operating Systems. Description of elements already described are omitted for brevity.

PA.Tos.smartWeb.WebUI at step 1910 represents a server component that may be built based on MS ASP.NET MVC framework. This component may be designed based on a Model-View-Controller (MVC) design pattern and may be responsible to receive and process user requests and construct and send responses to users. Next, PA.Tos.smartWeb.Service 1912 may be a service component that receives user requests from the Controller in PA.Tos.smartWeb.WebUI component. The service component may call methods in repositories to process user requests. The service component may retrieve data from repository, send data to repository to update data source, process business logic, and construct responses and return responses to Controller in PA.Tos.smartWeb.WebUI component. PA.Tos.smartWeb.Repositories 1914 may be a server component that implements Repository Locator which instantiates Repository instance for a terminal and TOS type depending on the user request.

PA.Tos.smartWeb.Repository.Database2 1924 may be a Repository instance for a specific database of a TOS. The Repository instance may know a type of the database, how to communicate with the database, where is the database, etc. Repository instance may construct business entities from data specific to TOS type or convert any information in business entities to data be used in TOS specific database.

PA.Tos.smartWeb.Repository.WebService 1926 may be a Repository instance used to retrieve or send data to TOS data source using Web Service. The Repository instance may know a type of web service, service contract, data contract, operation contract, how to communicate, where is the service access, etc. Repository instance may construct business entities from data specific to TOS type or convert any information in business entities to data be used in TOS specific data source.

### TOS Agnostic Processing

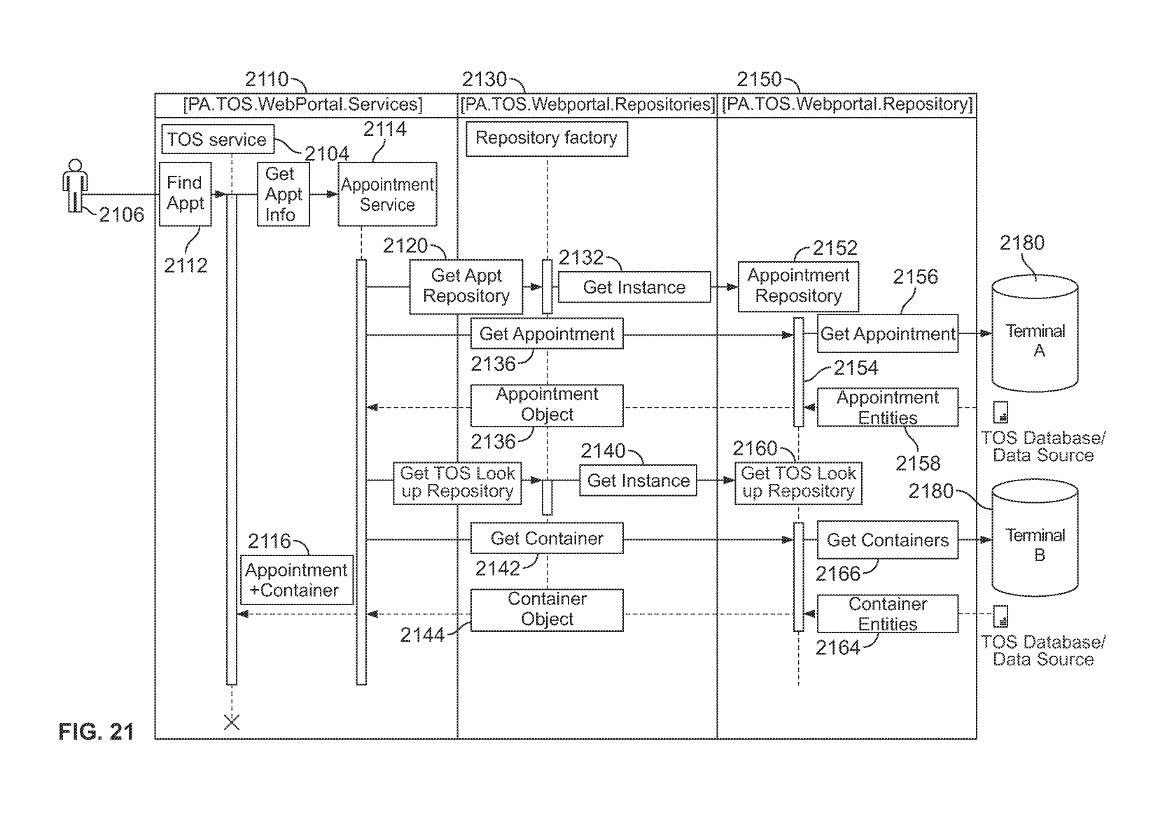

FIG. 21 shows an exemplary sequence diagram involving an illustrative searching an appointment process and TOS agnostic processing consistent with one or more aspects of the innovations herein. Referring to FIG. 21, illustrative processing may begin at step where a user logs into a Terminal A via a web-based user interface and inputs a request for the appointment information of a container for Terminal A. For example, a user may request information for a container number CNTR123456. Next, the TOS Agnostic service receives and processes the user request for the appointment information of a container. The service calls a GetApptInfo method in appointment service. The appointment service implements methods related to appointment business processes. The GetApptInfo method is processed by appointment repository. The appointment service first requests an appointment repository instance from the repository factory using the GetApptRepository method. The repository factory is a repository locator that returns the repository instance for Terminal A. The repository factory requests an appointment repository for Terminal A using the GetInstance method. The appointment repository retrieves and stores the appointment information from an appointment database for Terminal A.

Next, the GetAppointment method is defined in the appointment service to call the GetAppointment method of the appointment repository to request the appointment information corresponding to container number CNTR123456 of Terminal A. GetAppointment method accesses the appointment database and obtains the requested appointment information as appointment entities. The appointment entities are then stored in the appointment repository as appointment objects. For instance, the appointment entities retrieved from the Appointment database as raw data that are converted/translated into an appointment business object. The appointment objects 2136 are then returned to the appointment service.

Further, GetContainer is an internal method call to retrieve container information related to the requested appointment. Similar to the GetApptRepository method, the appointment service executes a GetTosLookUpRepository method to the repository factory to obtain container information corresponding to the appointment information requested by the user. GetInstance method requests a TosLookUp repository instance for the Terminal A. The GetContainer method implemented by the appointment service requests the container data related to the appointment information from the Tos lookup repository. The tos lookup repository retrieves data related to the container corresponding to the container number from the Terminal A database using the GetContainer method. In response, the Terminal A database transmits the requested data as container entities. The appointment entities and container entities are provided in the format of the Terminal A operating system incompatible with the format of other Terminal Operating Systems. Therefore, the tos lookup repository converts/translates the raw container data of the Terminal A into a container object to be added to the container repository. Once the appointment object and corresponding container object are returned to the appointment service, then the appointment and container objects collection are returned to the TOS Agnostic service. The TOS Agnostic service processes the business object data and displays appointment and container objects to the user via a web-based user interface including mobile devices and personal computers, as shown in more detail in connection with FIGS. 46A-46S.

### Incorporated TOS-Agnostic Code

With regard to certain features and functionality herein, the TOS-Agnostic computer code contained in the compact disks submitted in application Ser. No. 13/987,447, filed Jul. 24, 2013, is hereby incorporated herein by reference if/as needed with regard to sub (dependent) TOS-Agnostic features circumscribed therein.

### Additional Services/Service Layer Aspects

In addition to the basic architectural features set forth above, the service layer may serve as a baseline for integration for/between various illustrative components that may be associated with the TOS interfaces/Terminal Operating Systems herein, e.g., other web applications and Terminal Operating Systems like M21, with respect to which various implementations herein may communicate. Here, for example, the present disclosure and Appendices herein shows how various functionality and information is passed and processed between web applications and a TOS (e.g., M21) via or throughout the service layer. For example, computer program code associated with M21 helping illustrate such features is contained in the “TOS Data Access Library” of the attached compact disc.

With regard to Equipment Interchange Report (EIR) features, generating EIR may be a data and business logic-intensive process. Many data are collected from one or more TOS databases, such as an M21 database, and archived database(s). Those data are manipulated in various process and applied business logic to be presented in printed format. Further, gate-activity modules in disparate systems or web applications may implement such processes and maintain them separately. In some implementations, ReportService functionality may be utilized to provide with all data for EIR to be used for presentation but hide details of business logic and data access processes. This improves the maintainability and extensibility of the application.

Here, it is specifically reiterated that the features described above and below should also be understood in connection with the associated computer code appendices and Appendices 1-4 submitted herewith. Certain features and functionality shown and described at one level of detail herein are provided in greater detail via such appendices. Further, many of the systems and processes described above, as well as other features and functions, may be employed with, supported by, and/or interact with various user interfaces. In one aspect, the systems and methods provided herein include multiple interfaces, e.g., accessible via internet connection and/or other network connection. In some embodiments, an interface combines the functionalities of a summary report and status update, which allows a user to access, review and update statuses of various elements in the shipping process.

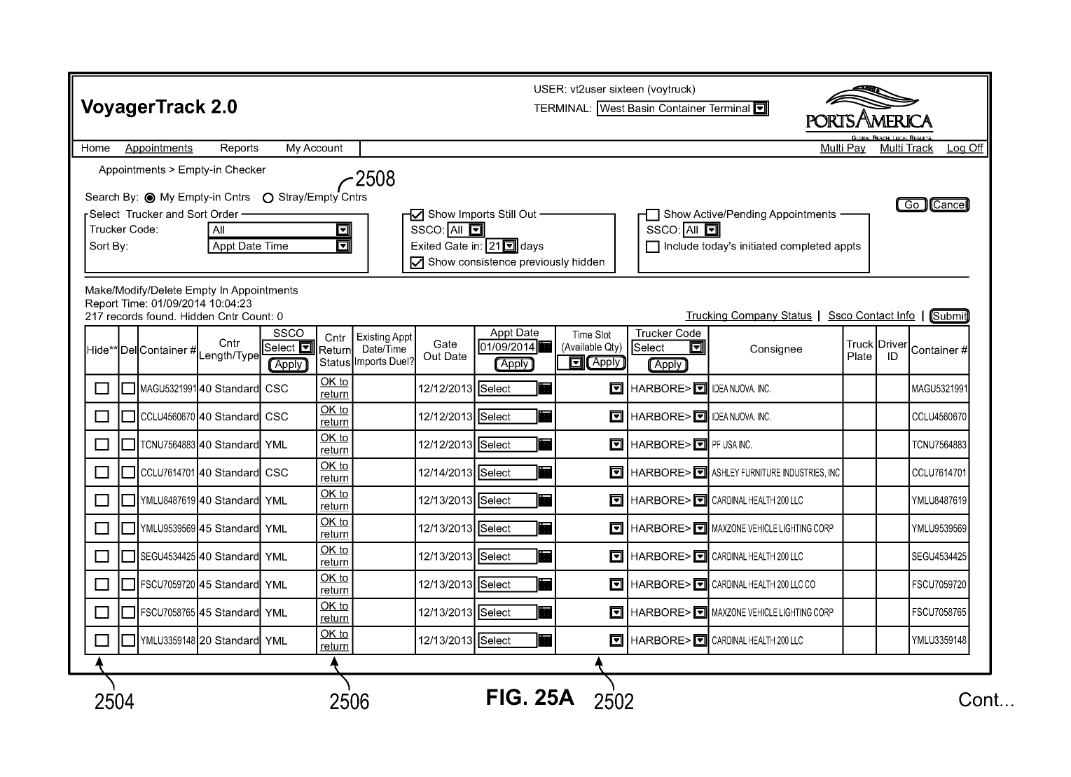

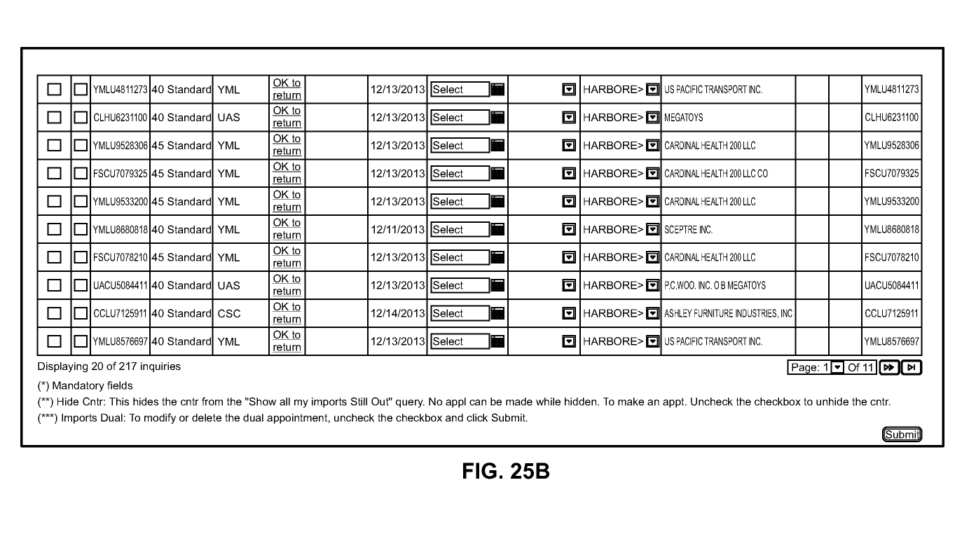

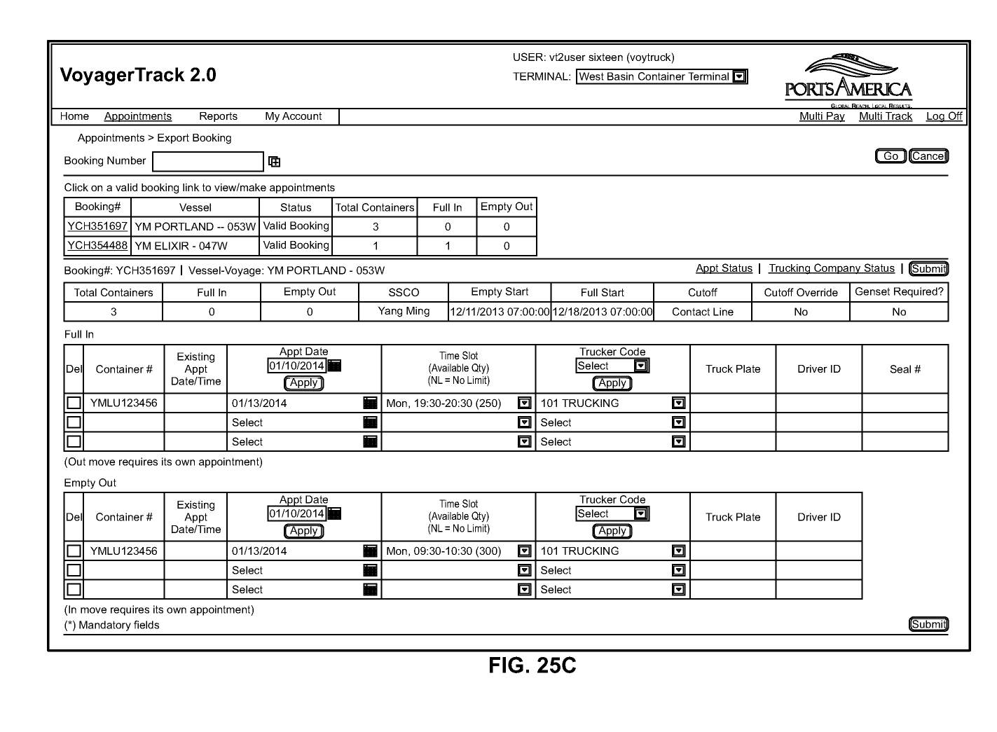

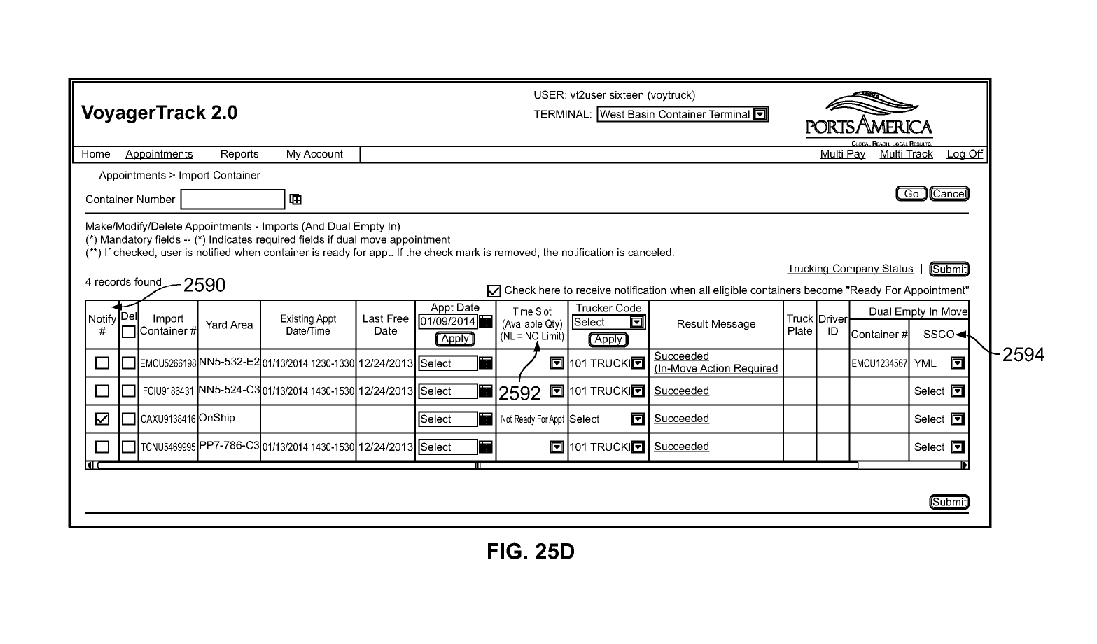

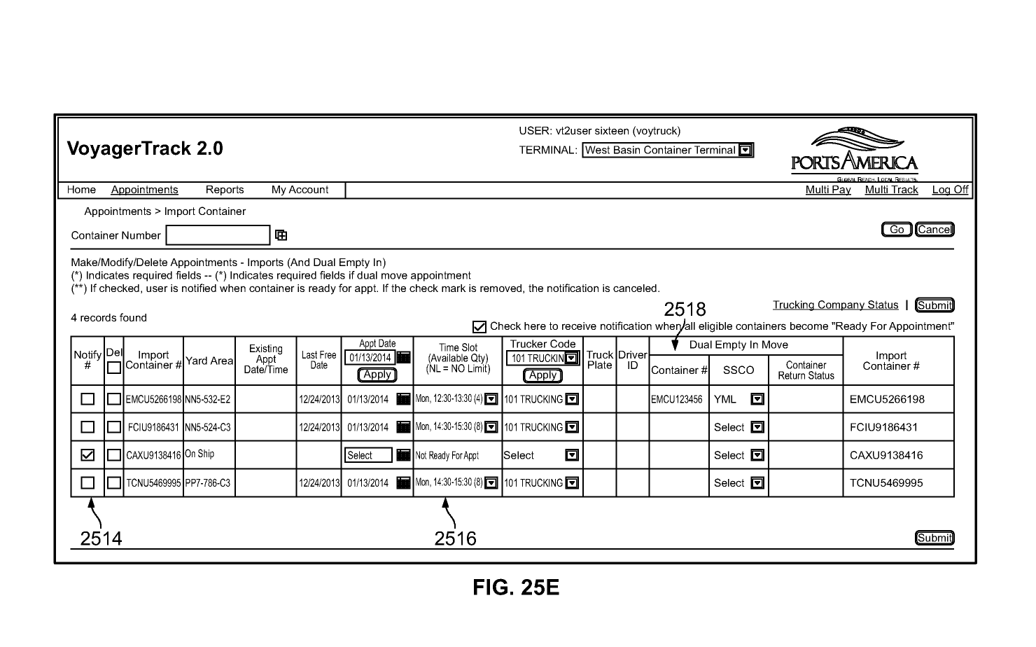

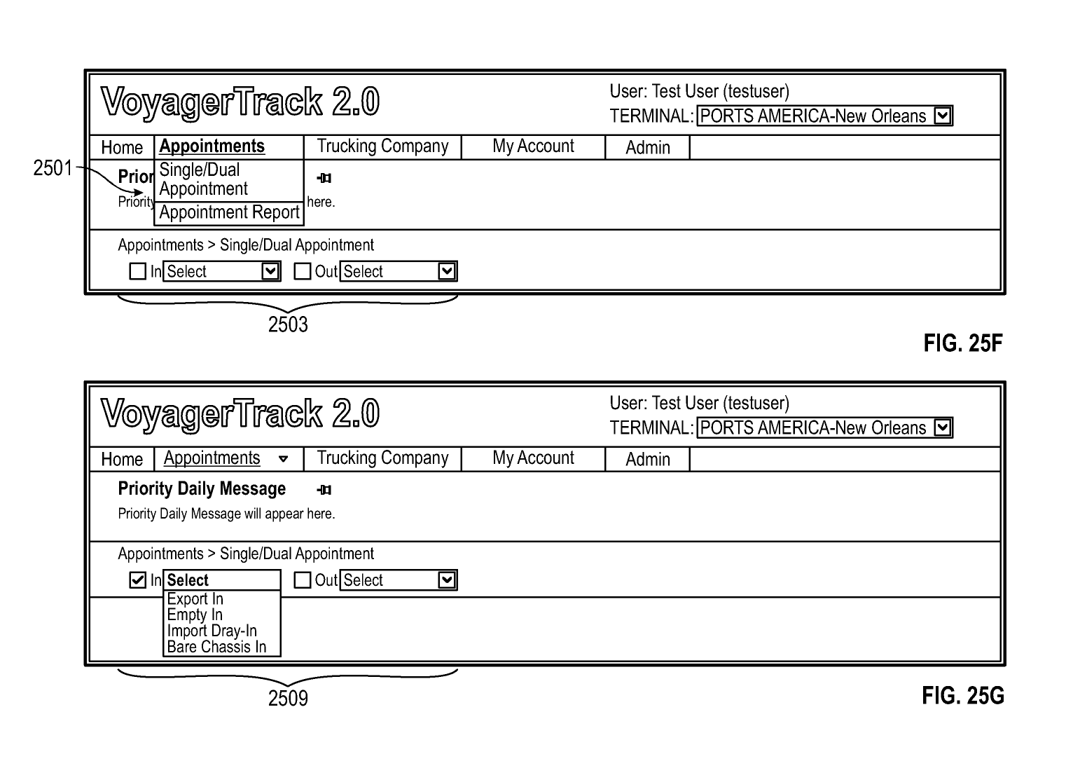

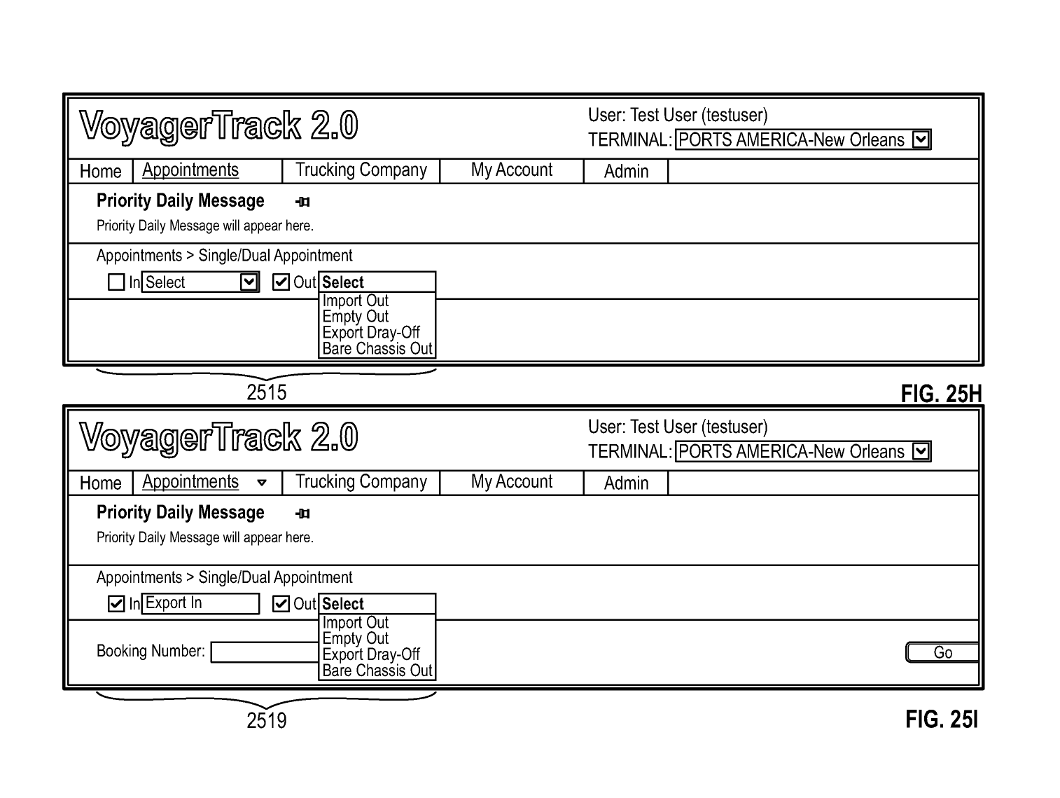

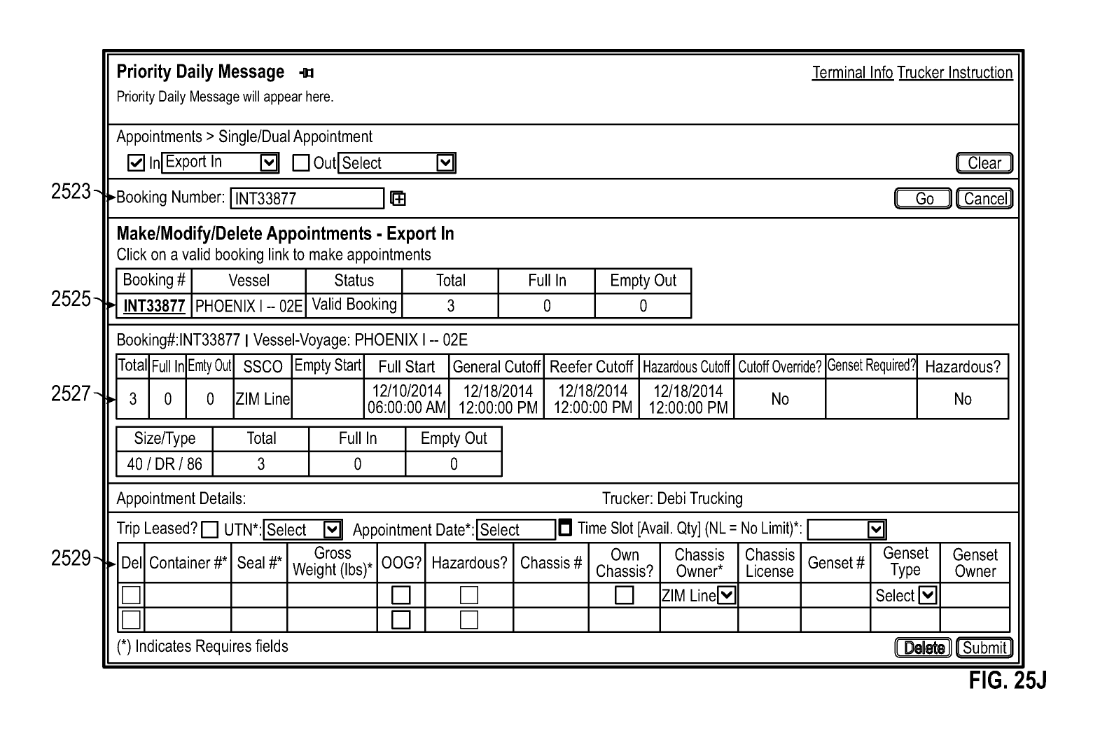

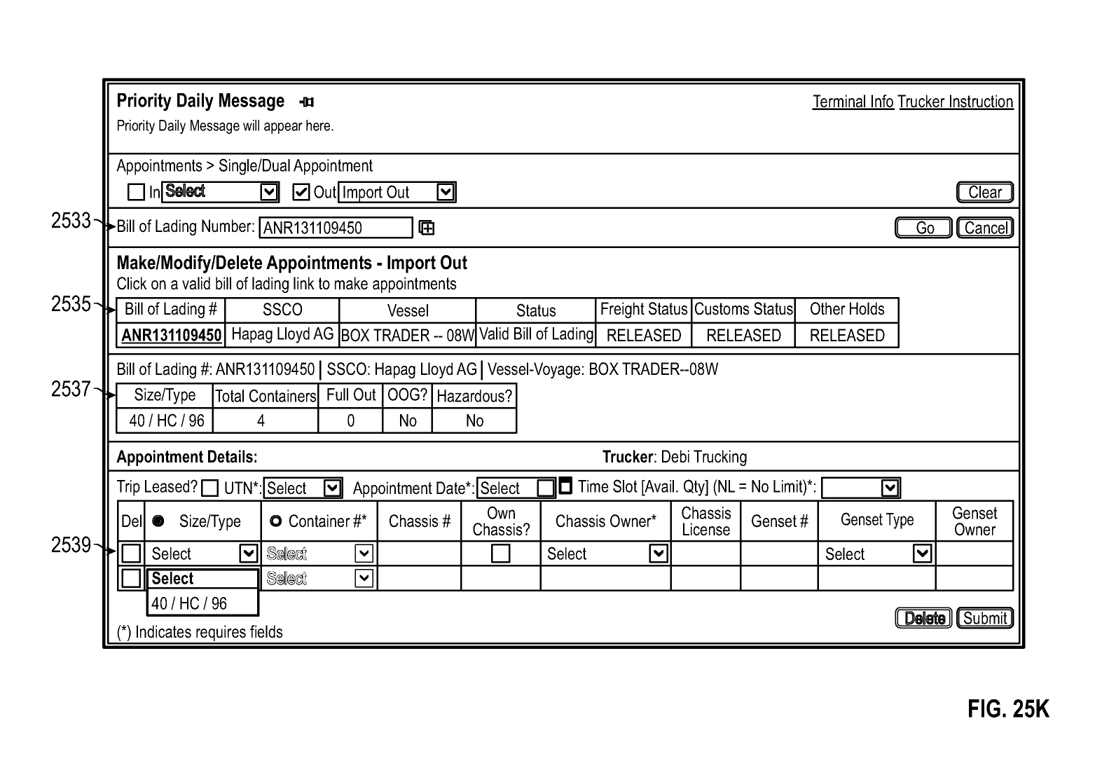

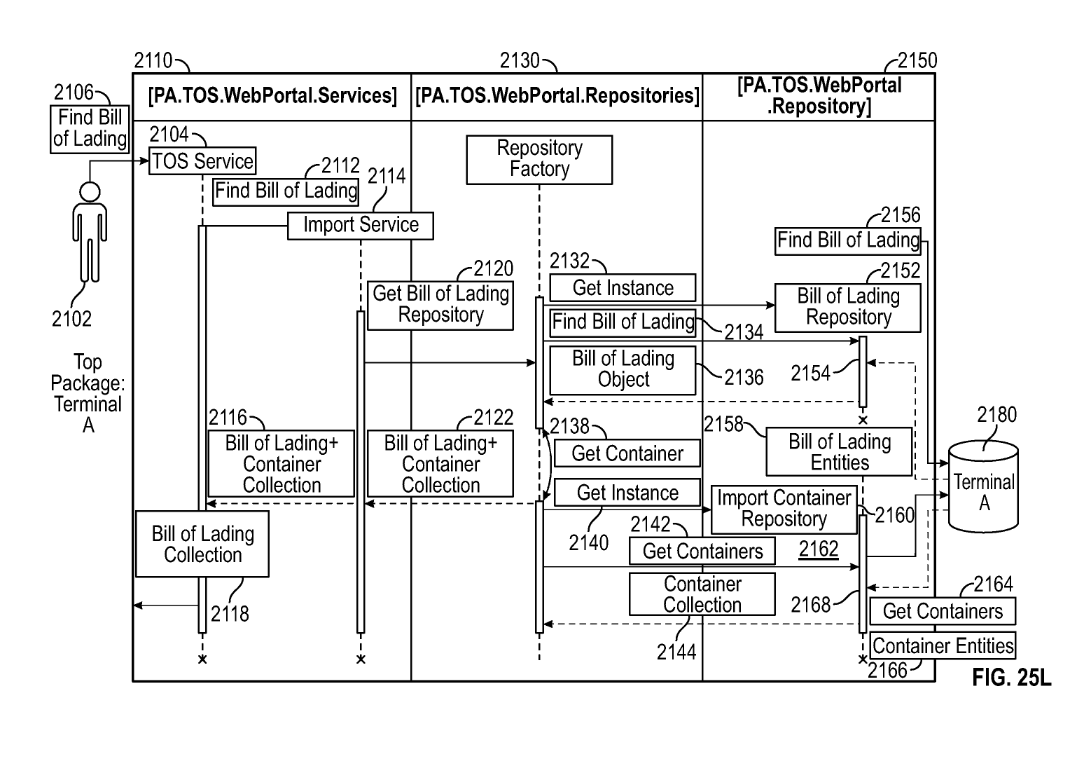

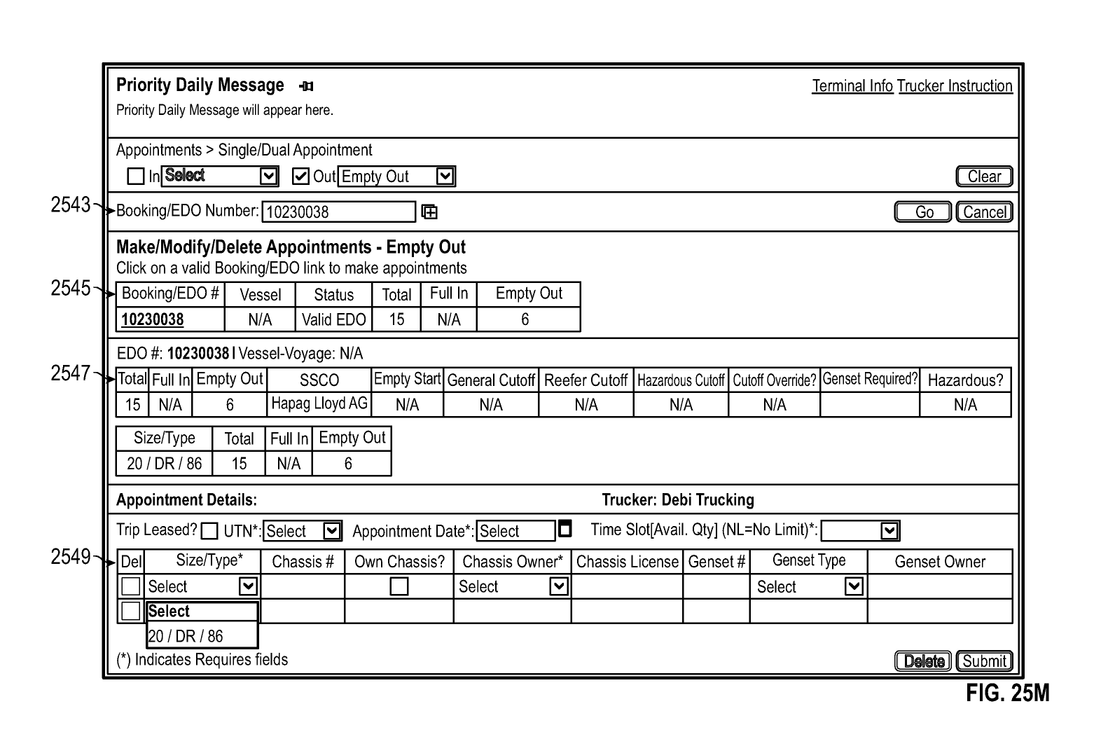

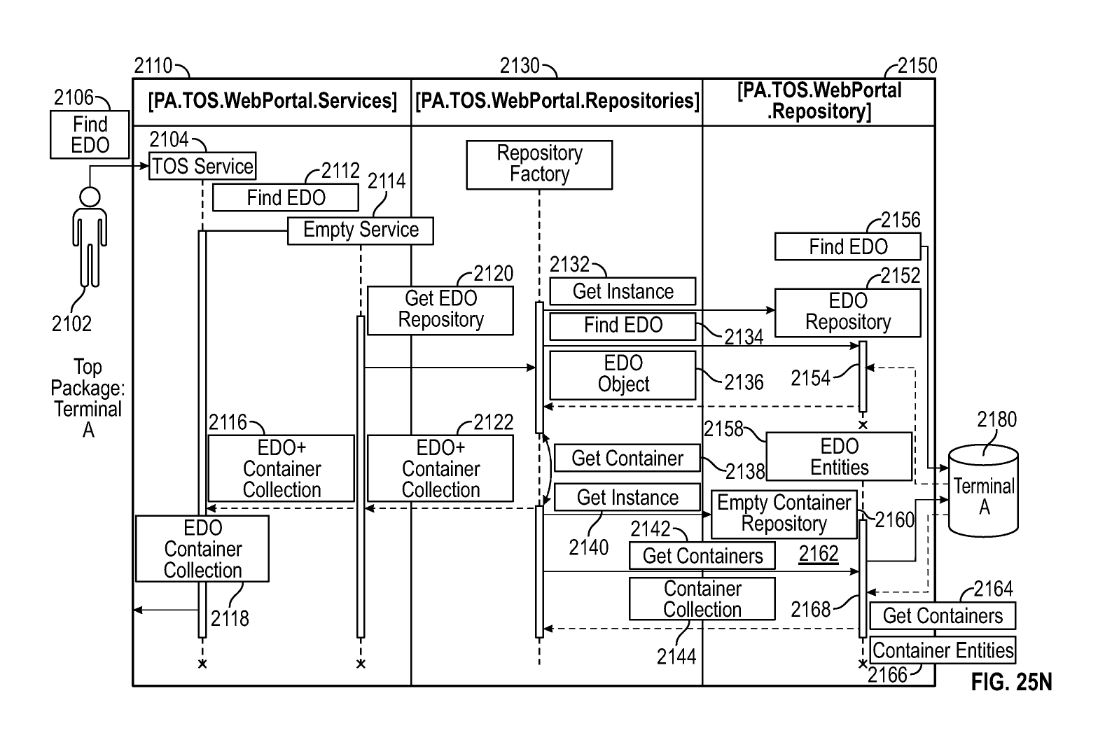

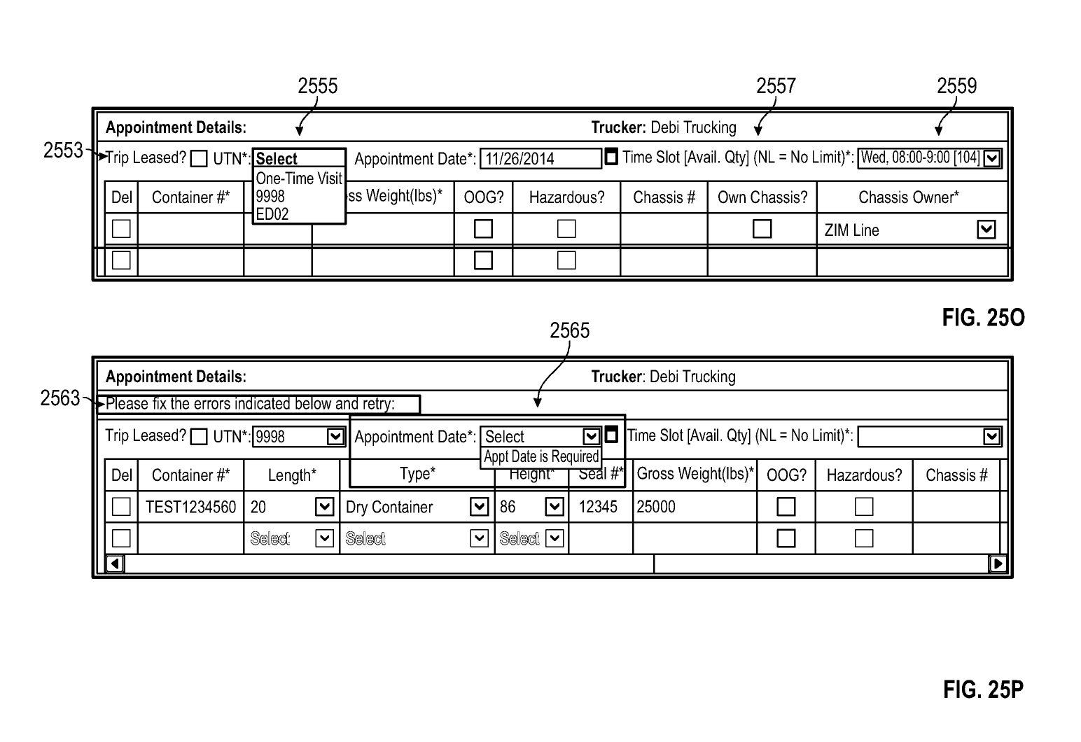

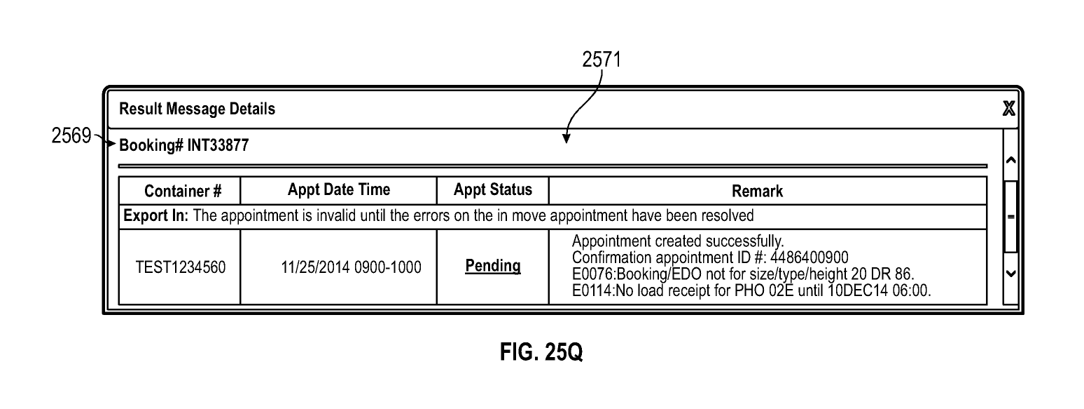

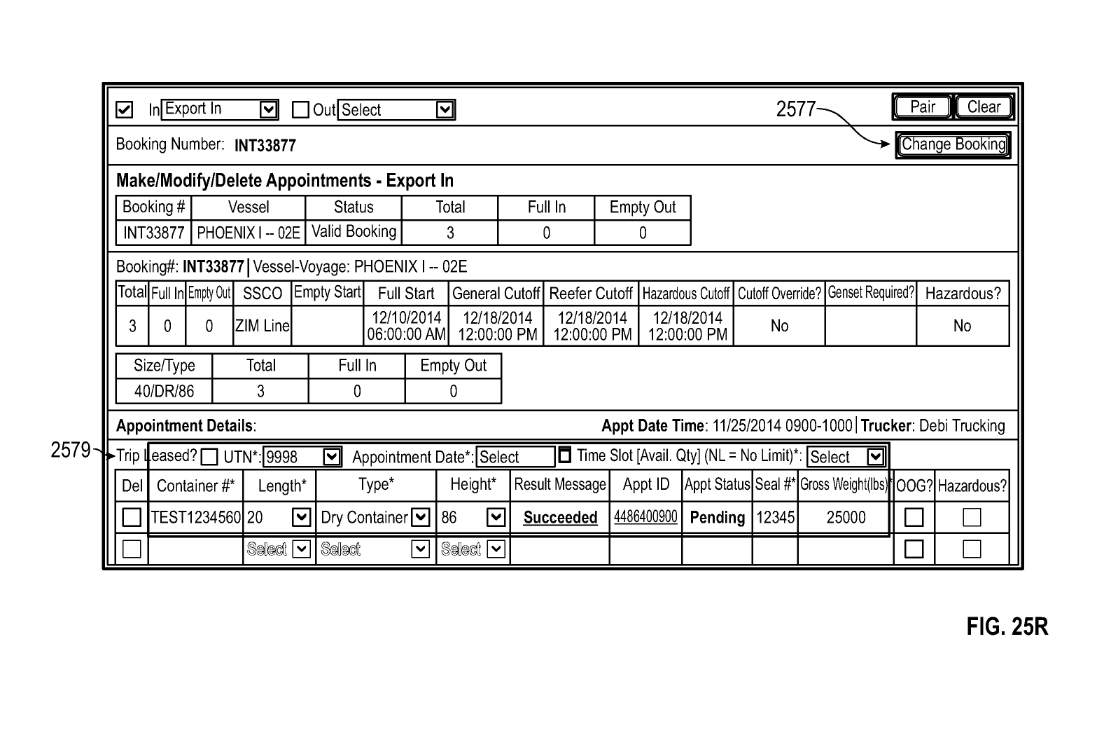

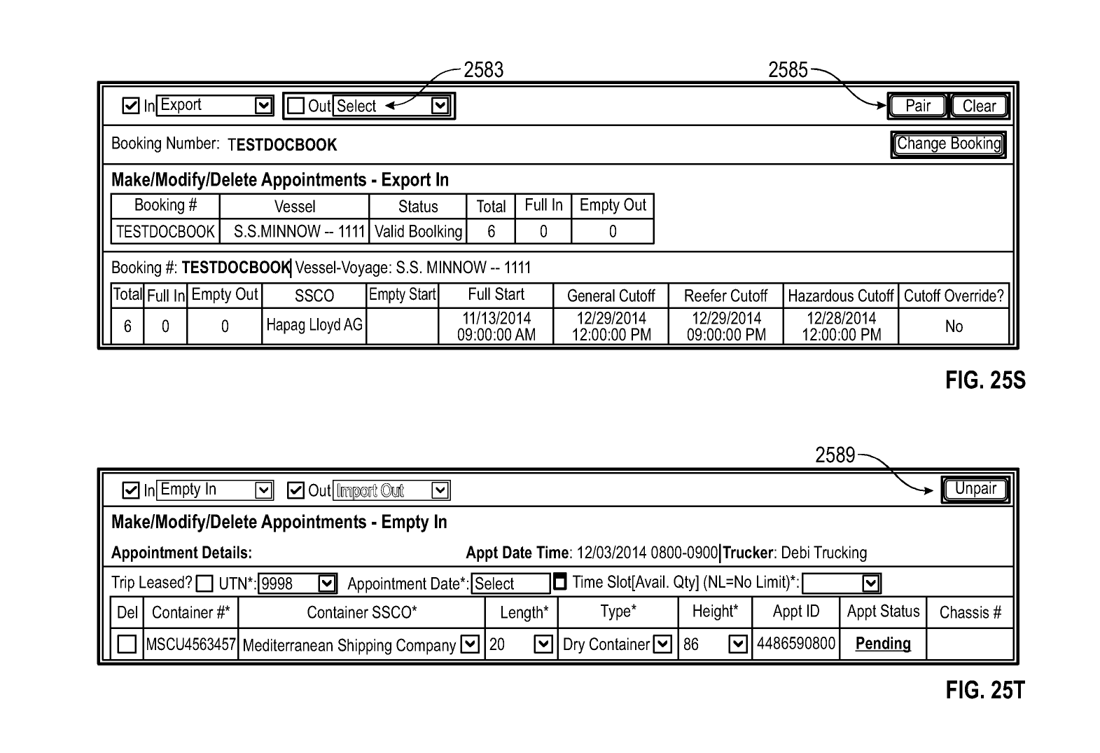

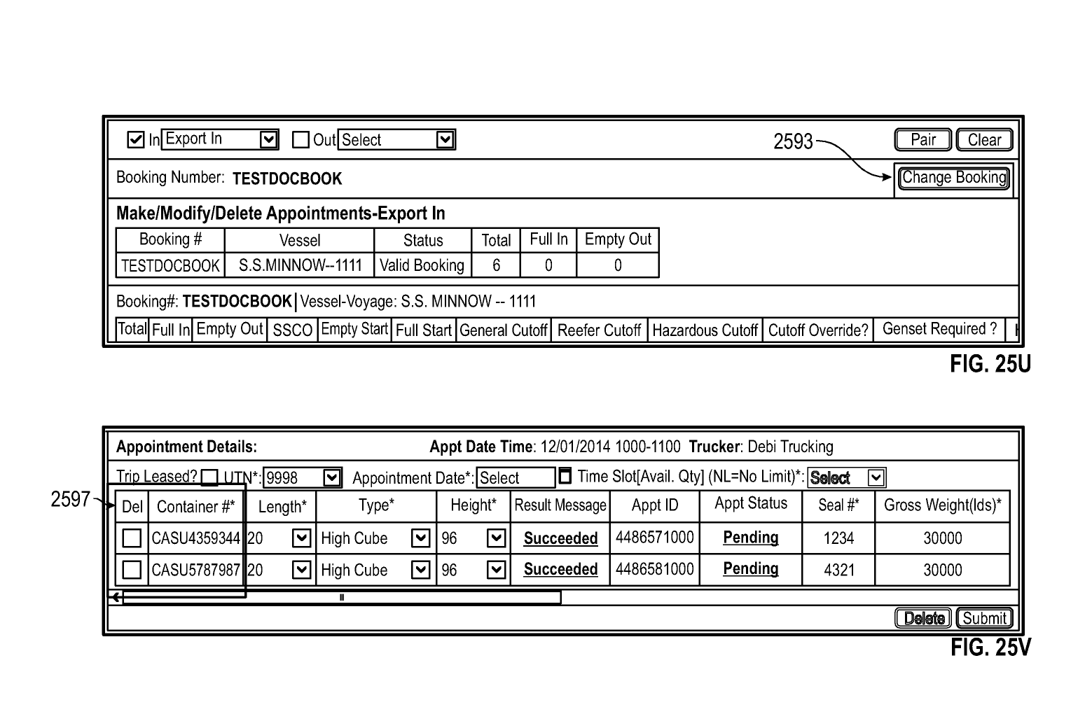

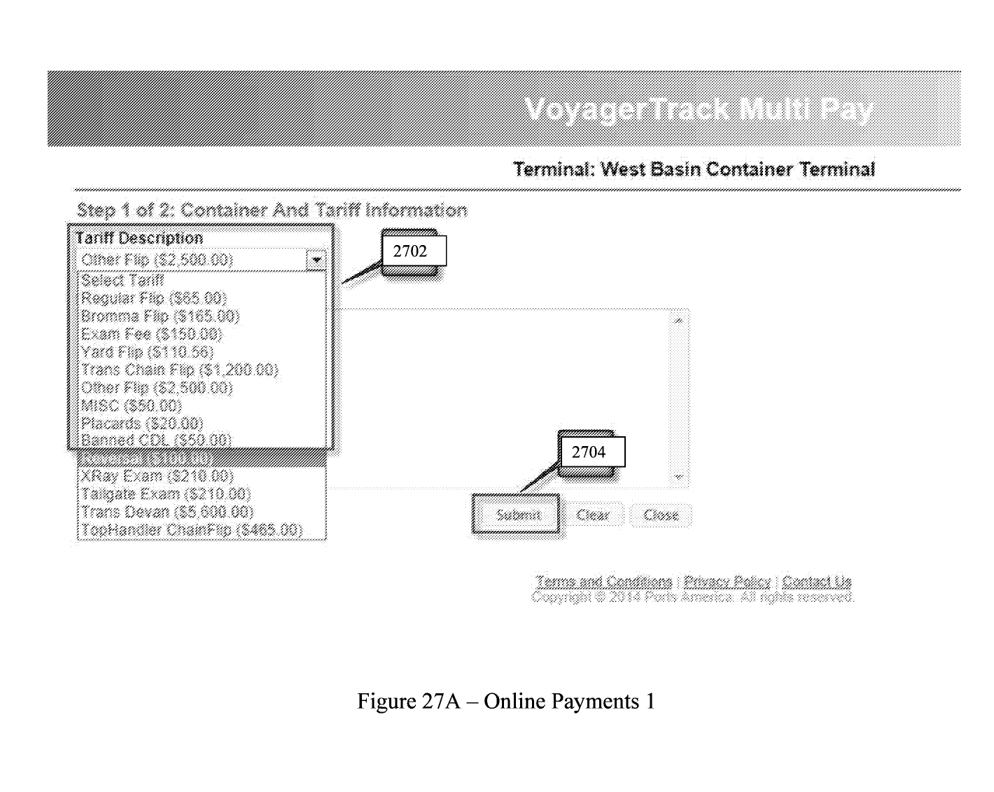

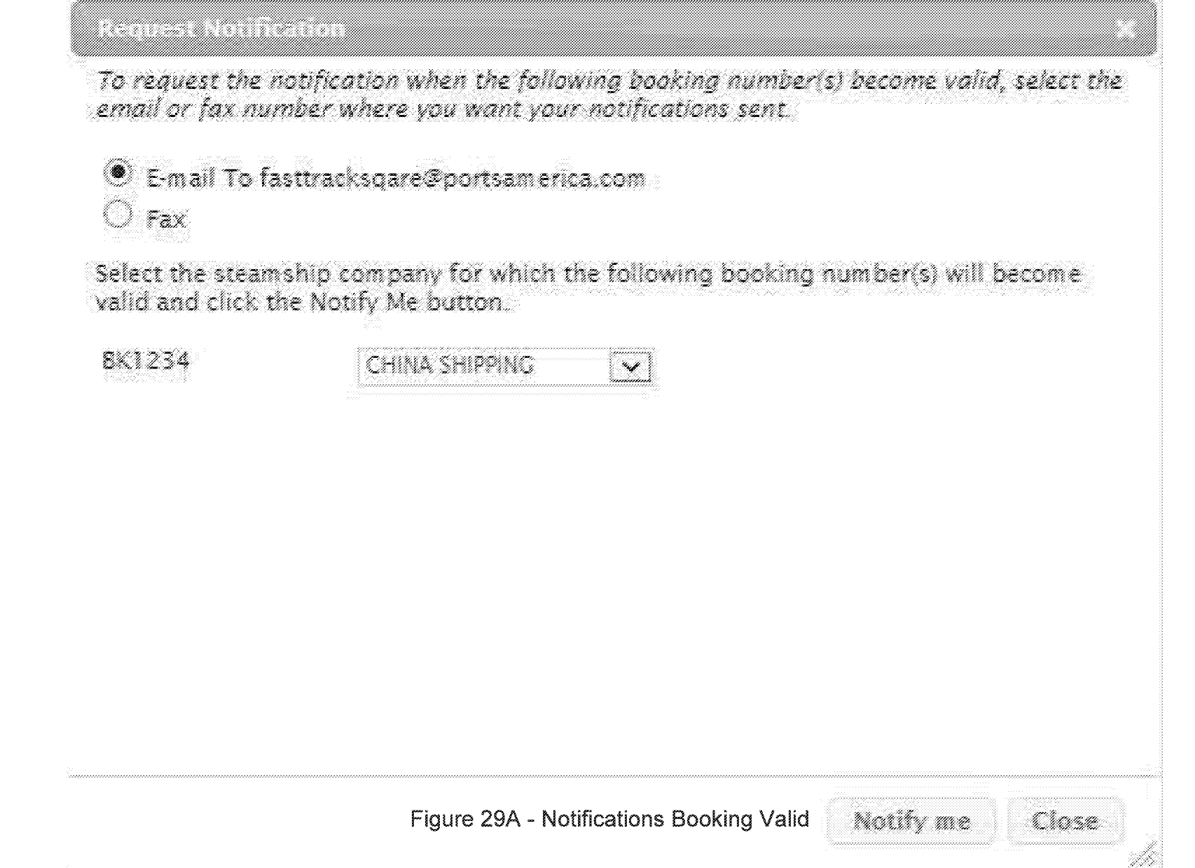

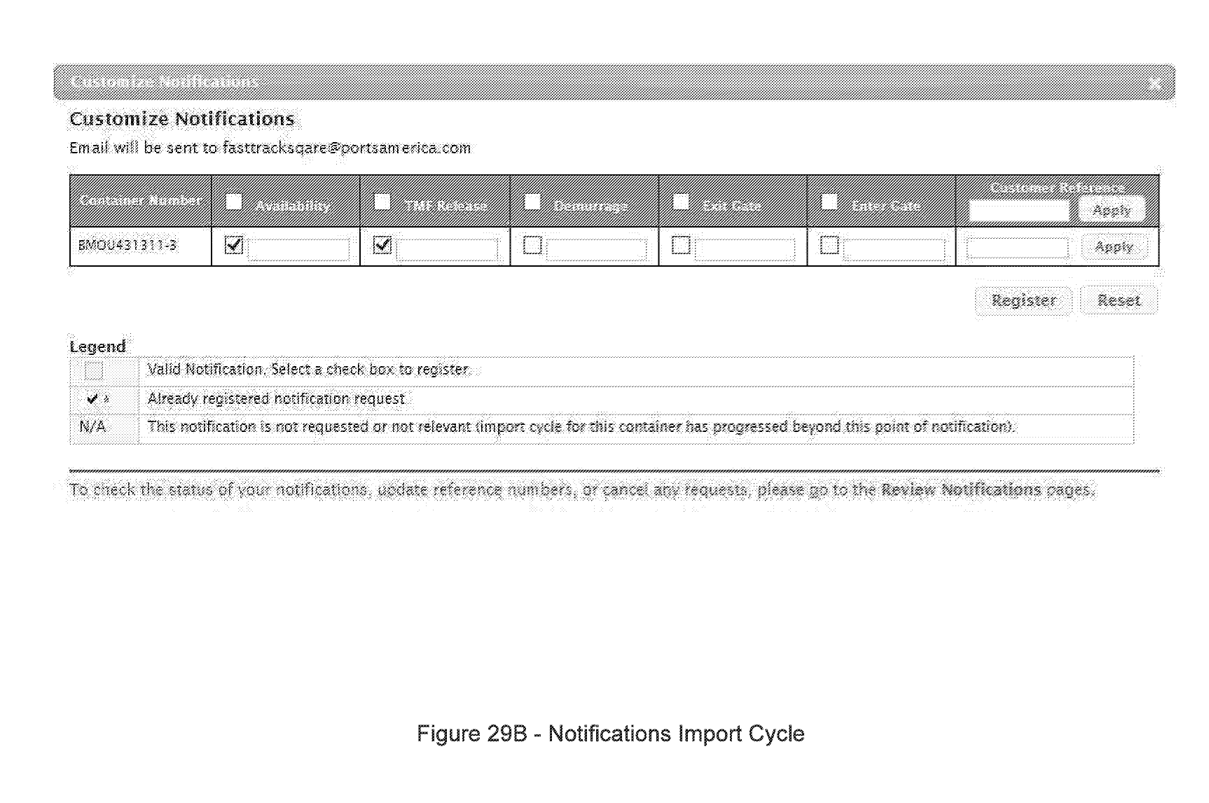

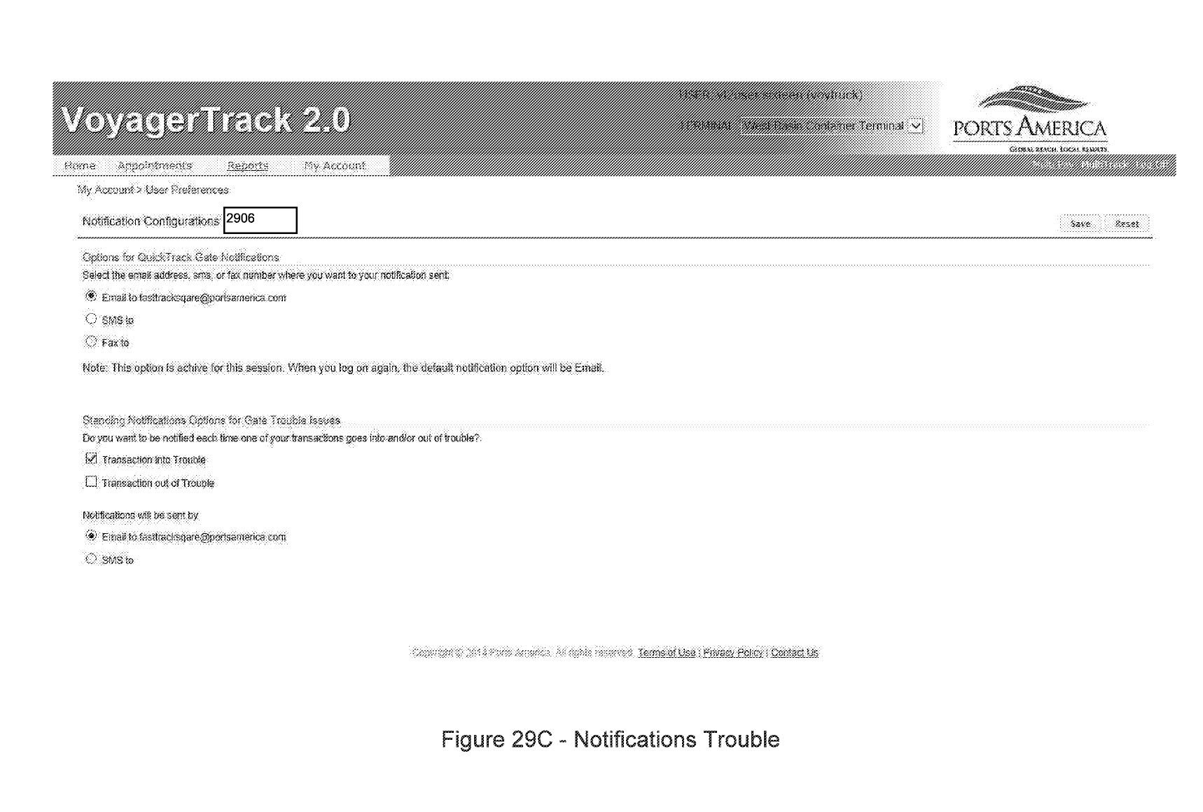

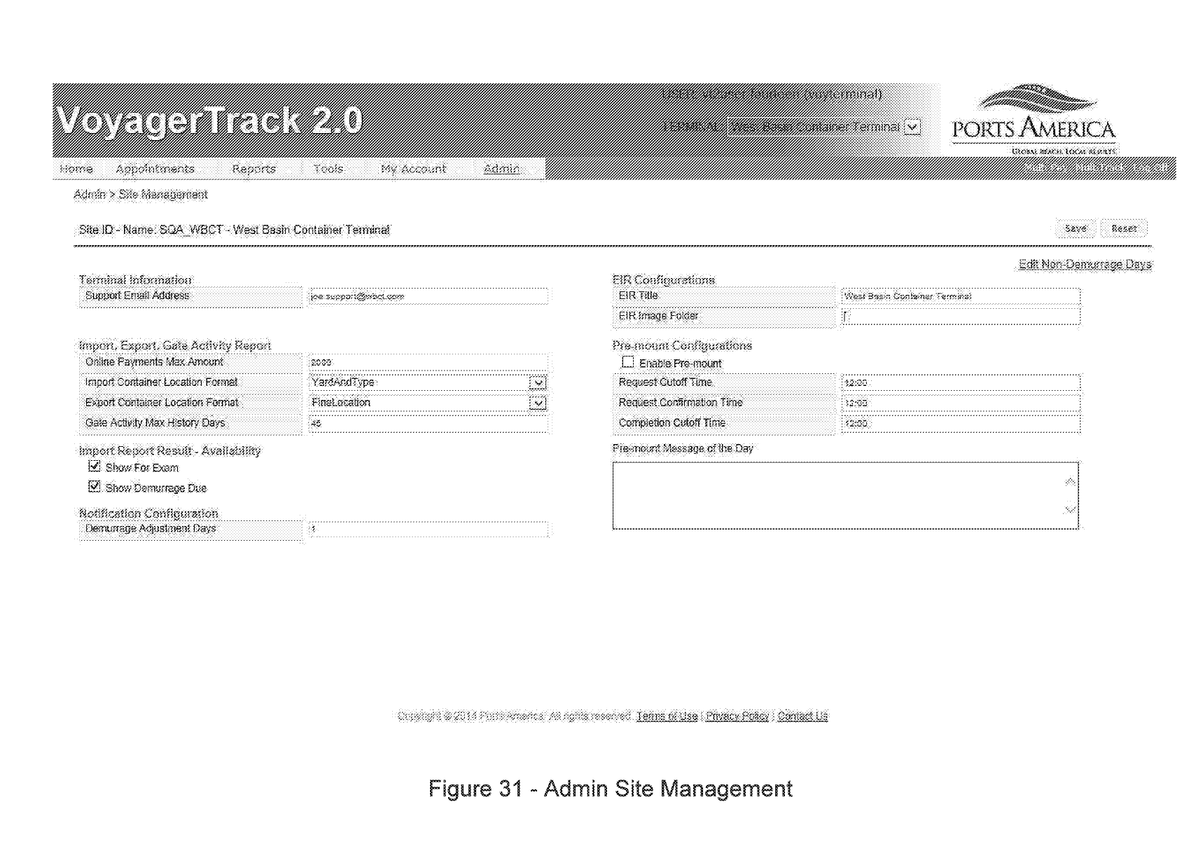

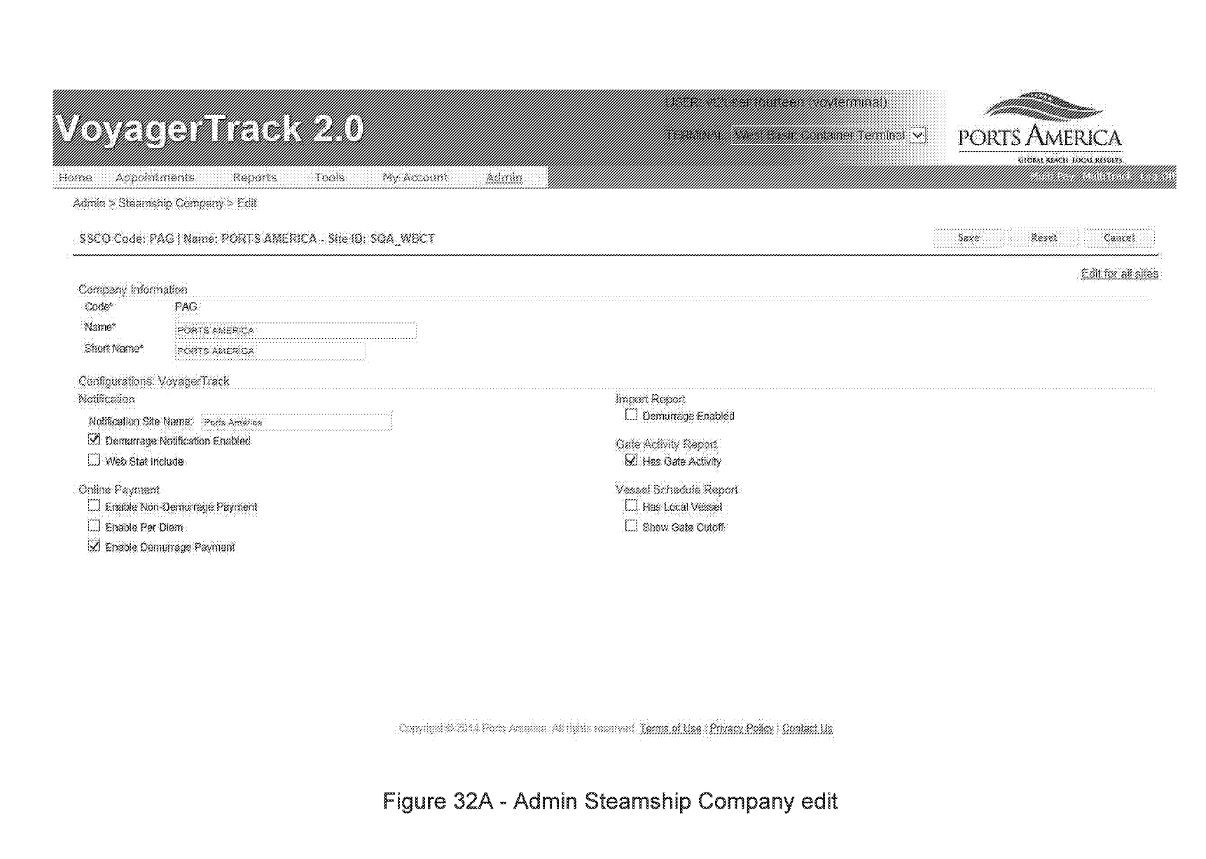

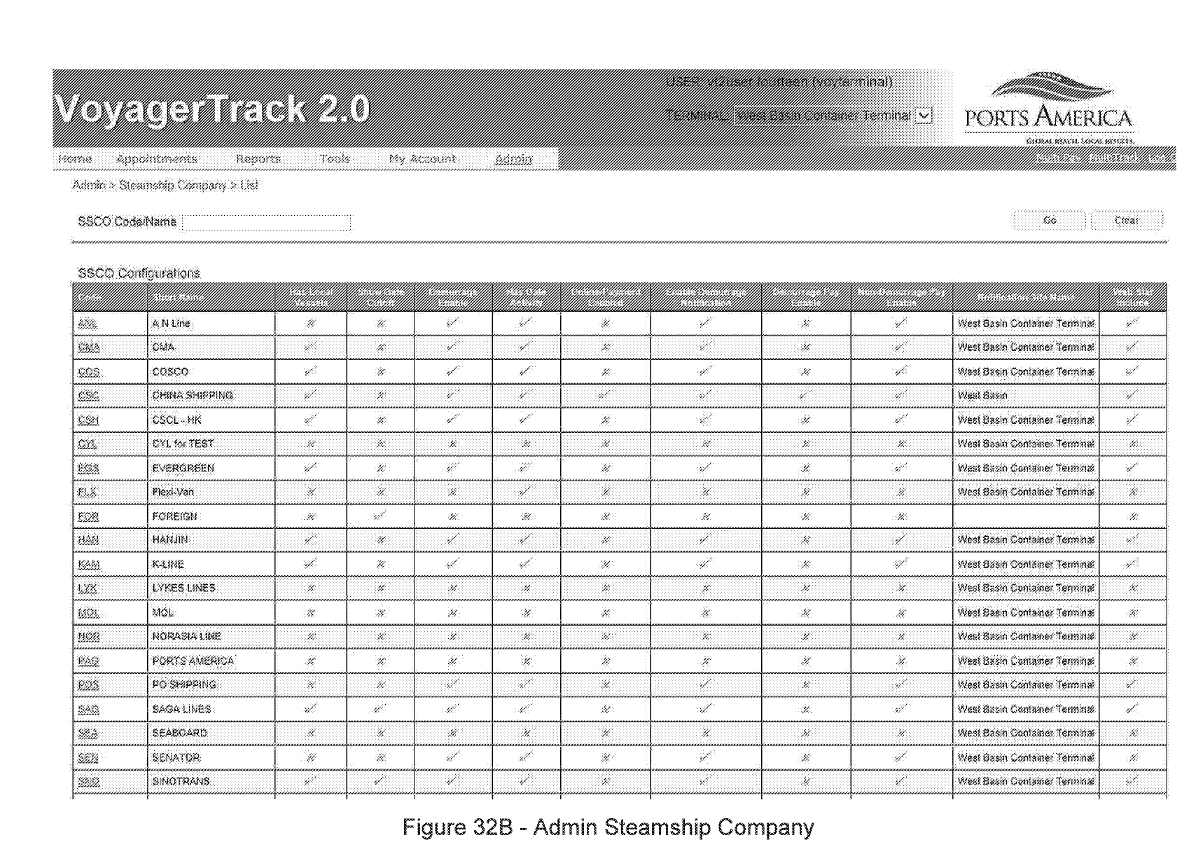

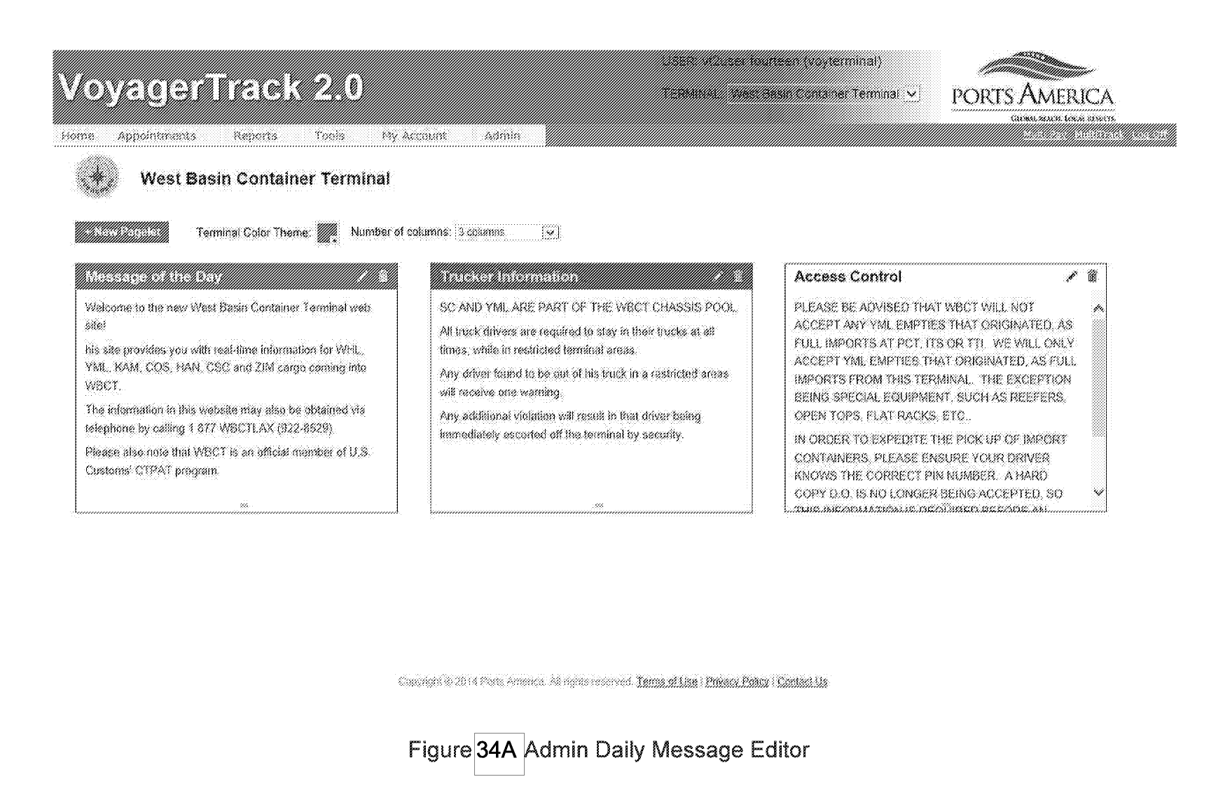

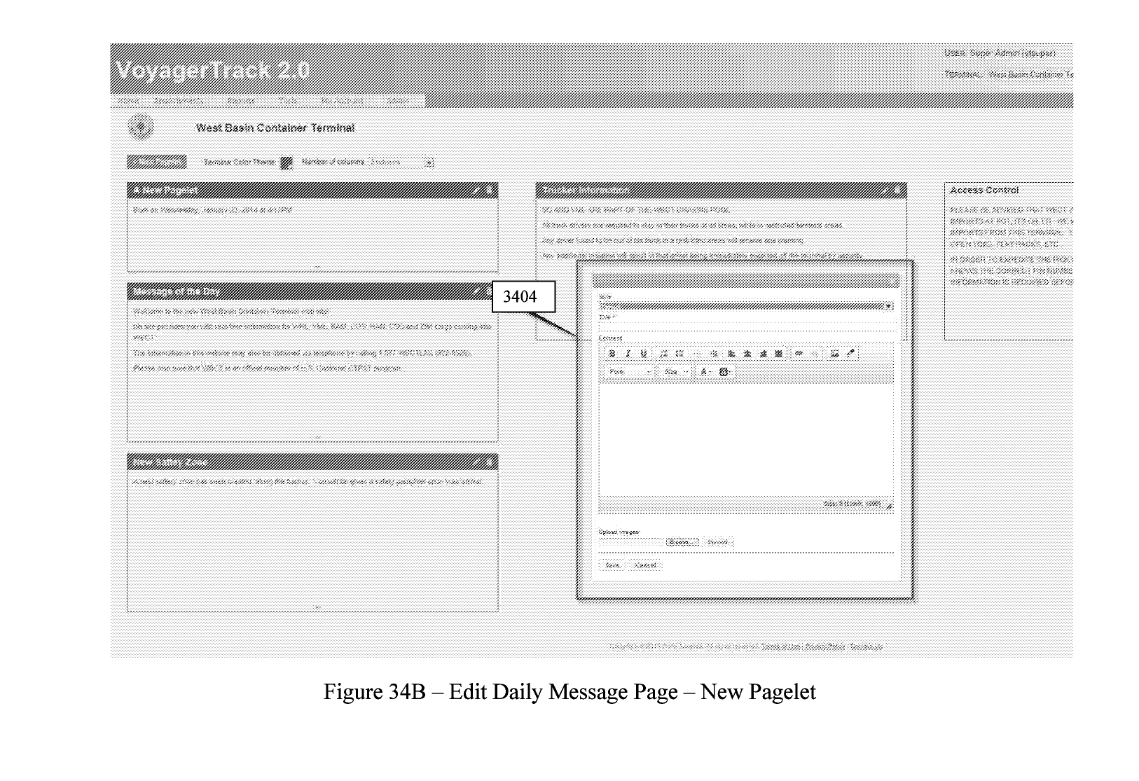

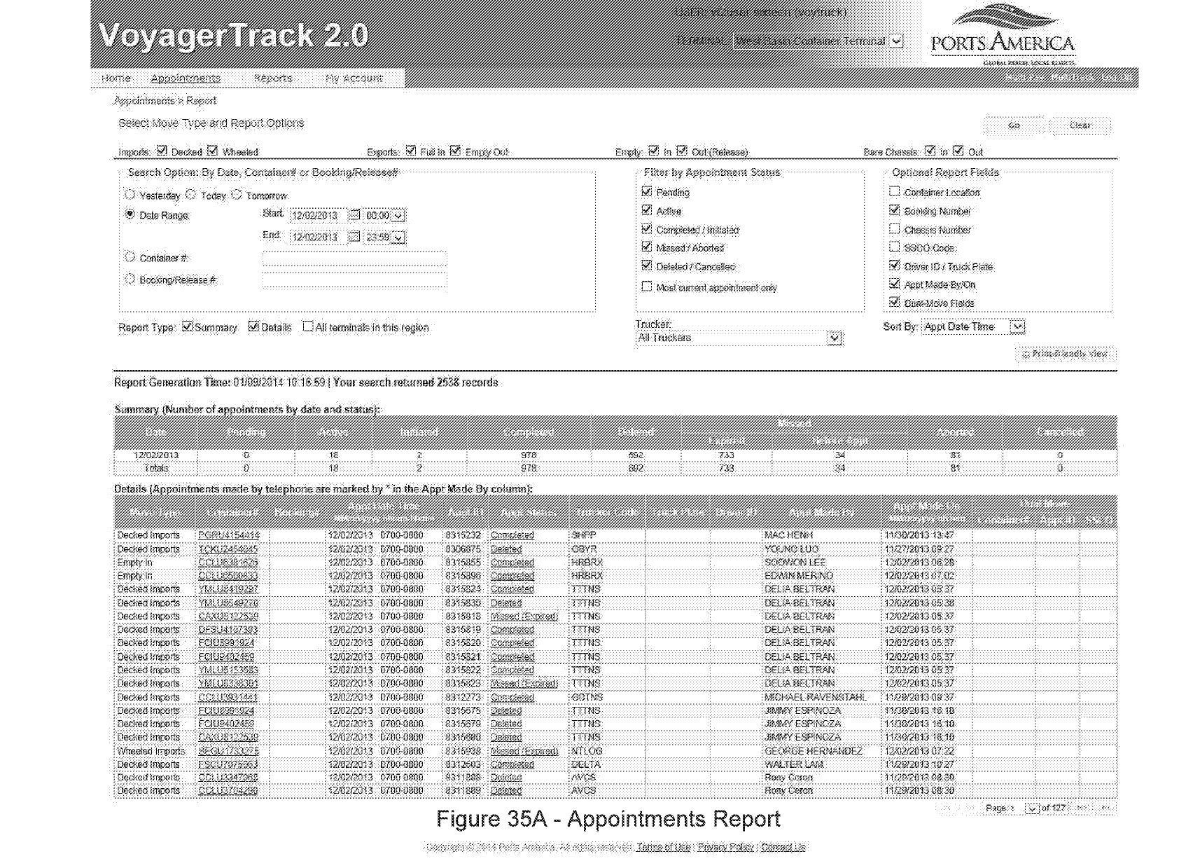

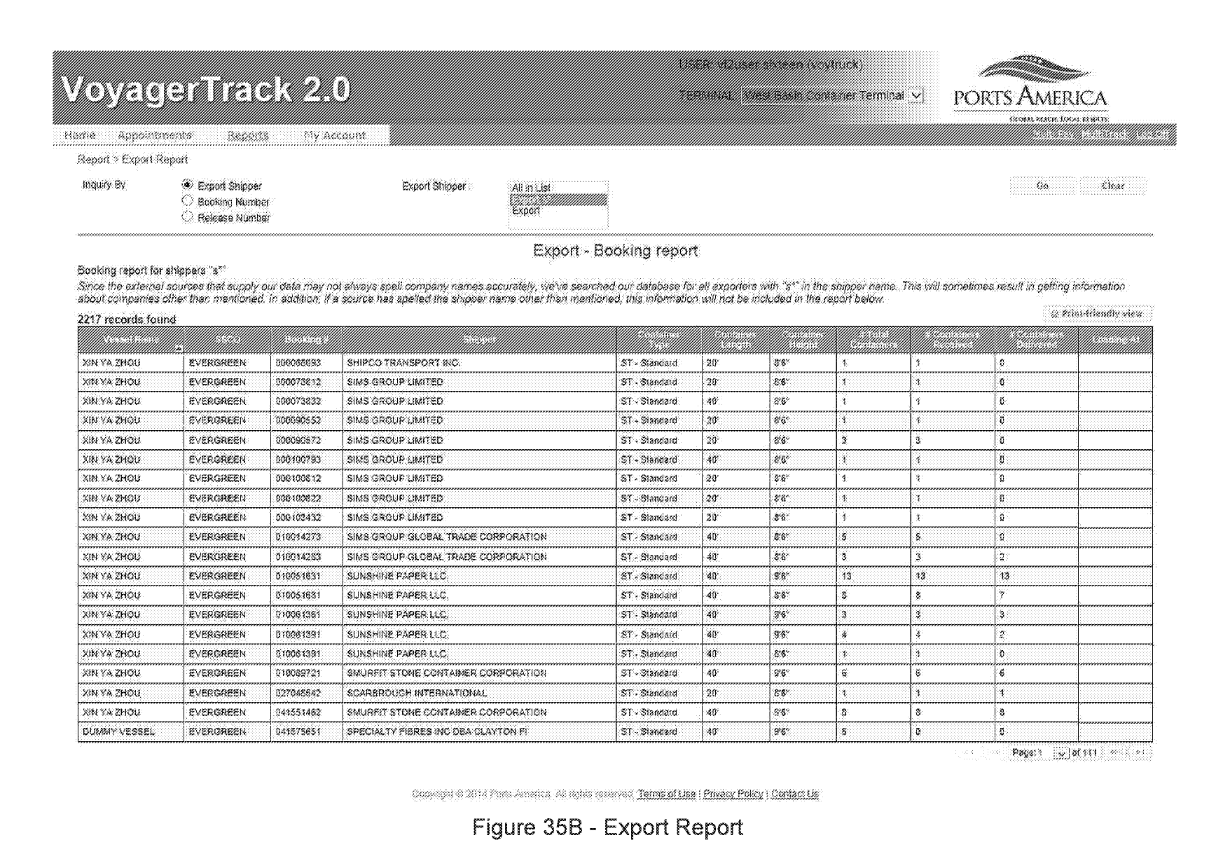

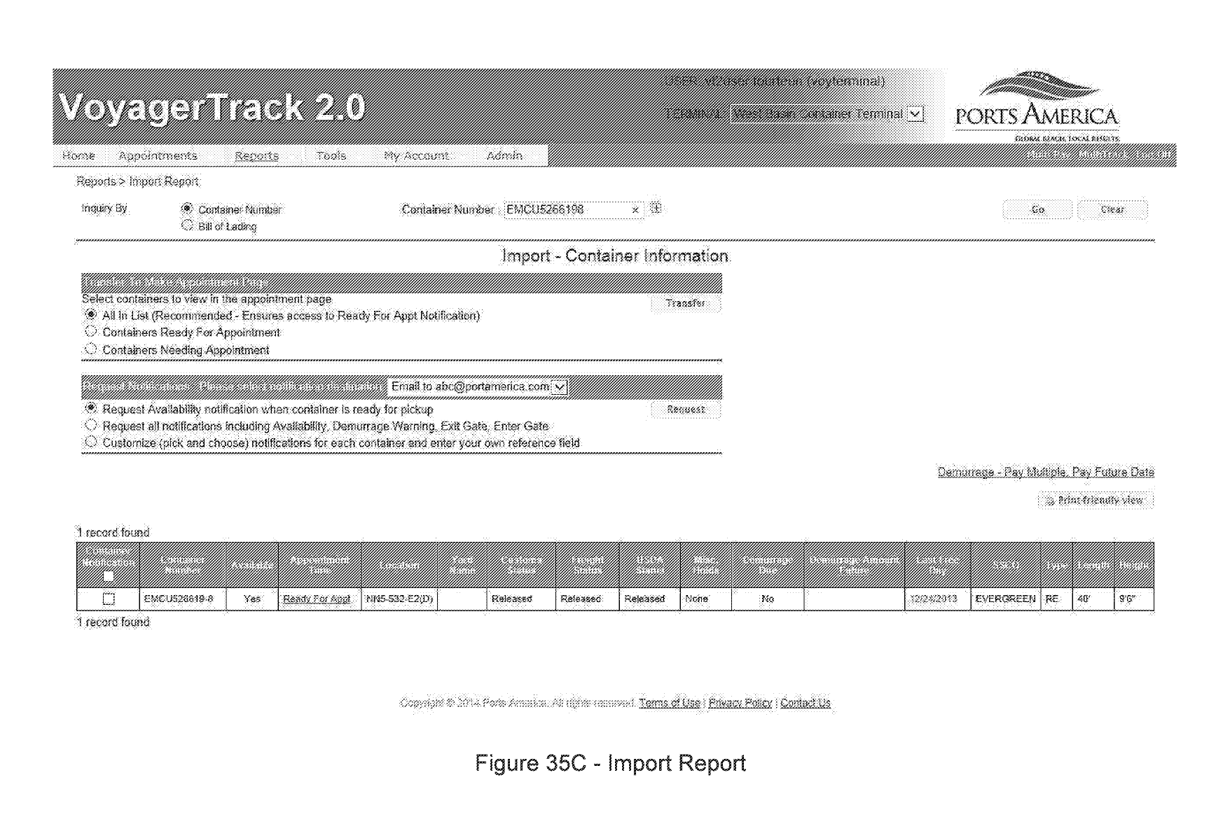

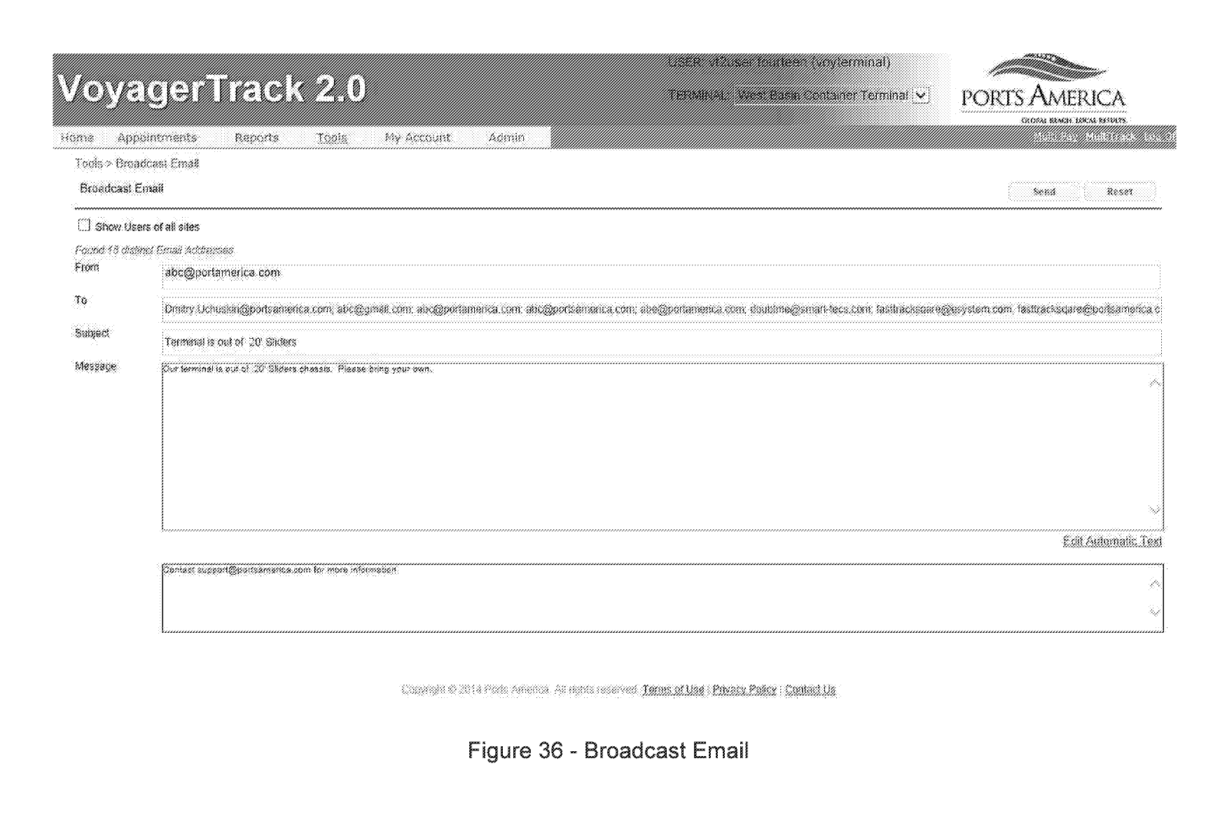

Any information that can be reviewed and updated includes but is not limited to information relating to: Appointments (see, e.g., FIGS. 25A-B); Online payment (see, e.g., FIGS. 27A-B); Notifications (see, e.g., FIGS. 29A-C); Administration (see, e.g., FIGS. 31, 32A-B); Reports (see, e.g., FIGS. 35A-C); Tools (see, e.g., FIGS. 36, 34A-B); among other things.

It should be noted that any reference to a menu or drop down menu can include any number of data entry fields, and is not limited to drop down menus. Free text boxes can be used, auto populated text entry boxes, radio button selection, or any number of menu selection options can be used. Various specific illustrations herein are for exemplary purposes only.

The systems and methods herein also allow for various interfacing with other applications such as VRU/IVR (Voice Response Unit/Interactive Voice Response) and the VoyagerTrack system. However, any network-based device can be used to access the system.

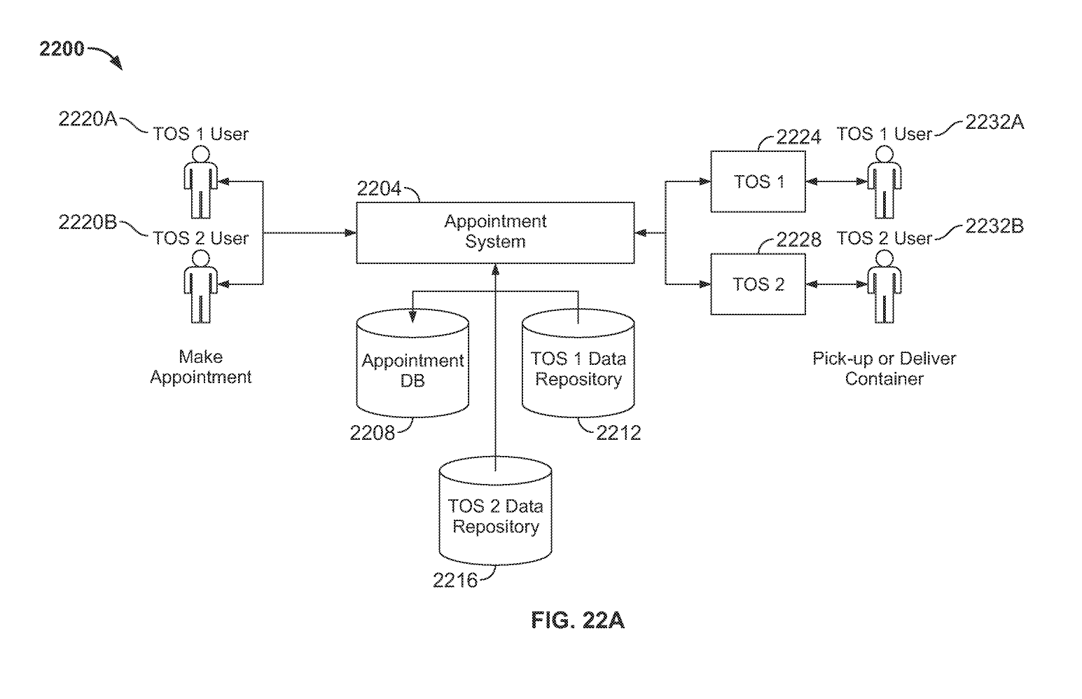

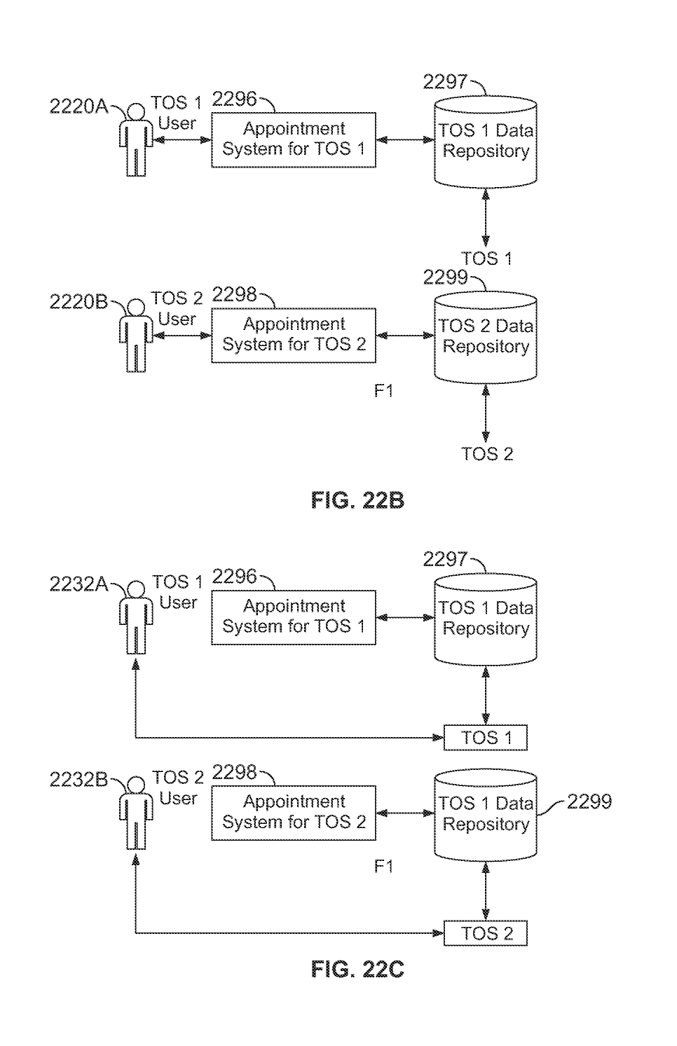

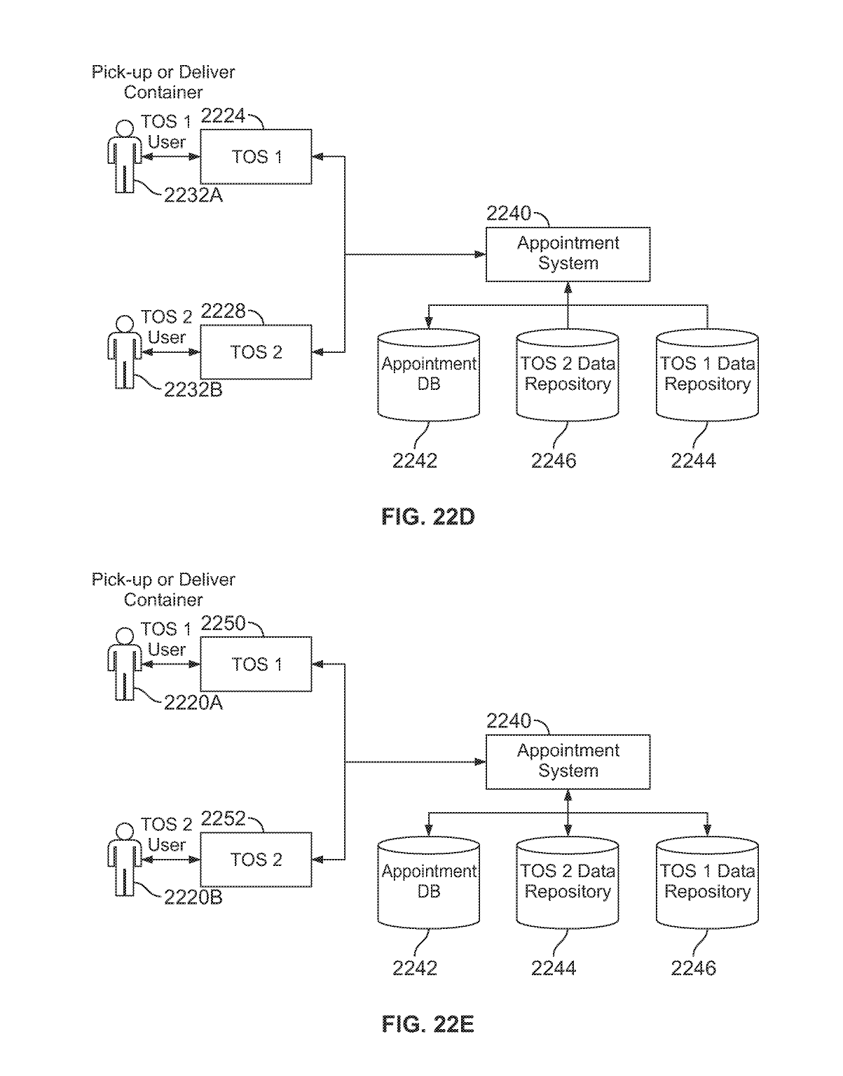

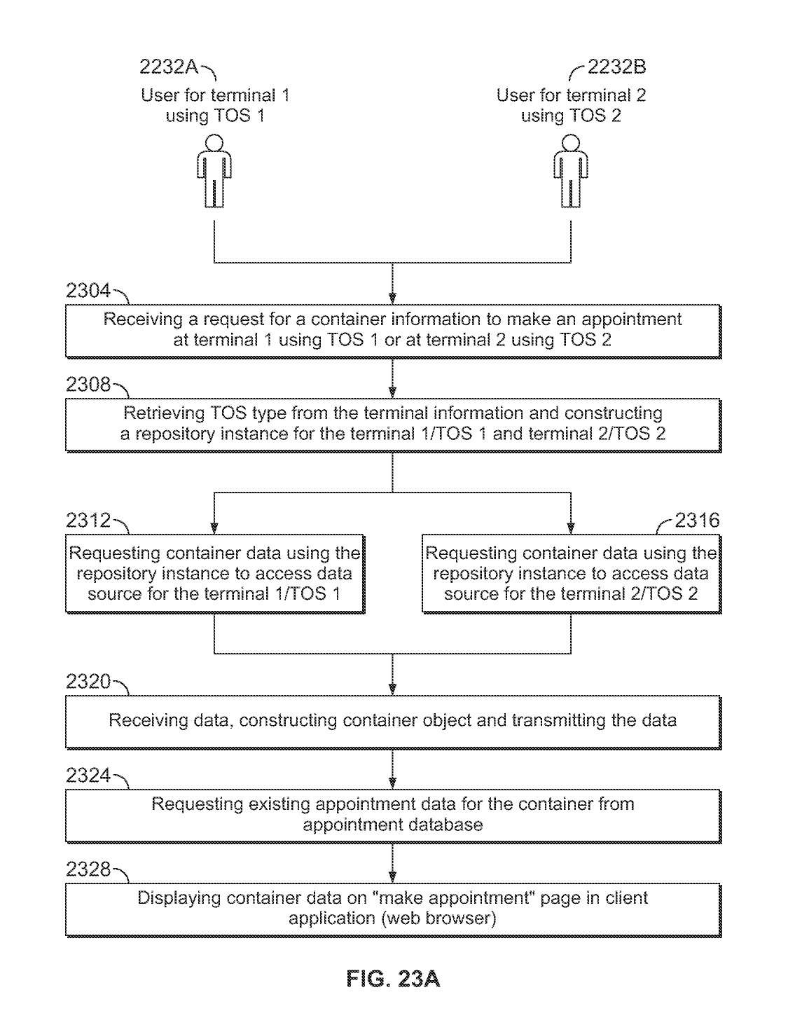

FIG. 22A is a block diagram illustrating an exemplary environment 2200 including an appointment system 2204, which in some implementations may be TOS-Agnostic, a network 2200 and other aspects consistent with one or more aspects of the innovations herein. Each specific TOS may have its own appointment system, and different appointment systems may not be natively compatible with one another or with other TOS database schema. The appointment system 2204 of FIG. 22 may be built on top of TOS agnostic architecture so that it can interact with various TOS, for example TOS 1 2224 and TOS 2 2228. The appointment system 2204 may allow users (e.g., trucking companies, etc.) to make, view, edit, search, and/or cancel appointments in multiple TOS environments through one access point.

The appointment system 2204 may include and/or involve one or more computers and may have its own appointment database 2208. The appointment system 2204 may maintain appointment data in the appointment database 2208. The appointment system 2204 may also be in communication with one or more TOS data repositories. In the example of FIG. 22, the appointment system 2204 is connected to a TOS 1 data repository 2212 and a TOS 2 data repository 2216. Each of these repositories 2212, 2216 may be an internal repository for its respective TOS 2224, 2228. The appointment system 2204 may access these repositories 2212, 2216 to retrieve data (e.g., to evaluate status in making an appointment), but may store appointment data in its own database 2208 rather than in the repositories 2212, 2216.

The appointment system 2204 may make it possible for users to use one appointment system 2204 for different terminals using different TOS 2224, 2228 in the same geographic area. Moreover, users may view and manage multiple terminals in the one appointment system 2204. For example, FIG. 22 shows a TOS 1 user 2220A (e.g., a user of a TOS 1 terminal) and a TOS 2 user 2220B (e.g., a user of a TOS 2 terminal) making appointments with the appointment system 2204. Either user may make, view, change, delete, search, etc. appointments for either TOS 1 or TOS 2, regardless of which TOS their terminal uses. As a result, pick-ups or deliveries by TOS 1 users 2232A or TOS 2 users 2232B may have been scheduled by either TOS 1 users 2220A or TOS 2 users 2220B via the appointment system 2204 without having to access a specific TOS 2224, 2228.

FIG. 22A is a block diagram illustrating an exemplary environment 2200 including an appointment system 2204, which in some implementations may be TOS-Agnostic, a network 2200 and other aspects consistent with one or more aspects of the innovations herein. Each specific TOS may have its own appointment system, and different appointment systems may not be natively compatible with one another or with other TOS database schema. The appointment system 2204 of FIG. 22A may be built on top of TOS agnostic architecture so that it can interact with various TOSs, for example TOS 1 2224 and TOS 2 2228. The appointment system 2204 may allow users (e.g., trucking companies, etc.) to make, view, edit, search, and/or cancel appointments in multiple TOS environments through one access point. TOS Users 2220A and 2220B access the system through the appointment system 2204 to make appointments. The appointment system 2204 may include an appointment database 2208 and TOS data repositories 2212, 2216. TOS users 2232A and 2232B may interact with TOS 2224, 2228 for pick-up and delivery of containers.

FIG. 22B is a block diagram illustrating a conventional appointment system. The appointment system in FIG. 22B is tightly bound to TOS. When Users 2220A, 2220B (e.g., trucking company) make an appointment, the users access to the appointment systems 2296, 2298 that works with the specific TOS 2297, 2299. Furthermore, conventional appointment systems 2296, 2298 shares a database used by the TOS. Appointment systems working with one TOS cannot be used another TOS using a different database schema.

FIG. 22C is a block diagram illustrating another conventional appointment system. To pick up or deliver a container, the User 2232A, 2221B (e.g., trucker) should access the TOS specific to the database and retrieve data created by appointment system 2296, 2298.

FIG. 22D is a block diagram illustrating an exemplary environment including an appointment system 2240, which in some implementations is built on the top of TOS agnostic architecture and uses an appointment database 2242 to persist appointment data. The appointment system 2240 accesses the TOS database 2244, 2246 just to retrieve data (without update of the TOS databases) to evaluate status to make an appointment.

FIG. 22E is a block diagram illustrating an exemplary environment including an appointment system 2240 according to some implementations. To pick up or deliver a container, a user 2220A, 2220B accesses the TOS 2250, 2252 connected to the Appointment system 2240 and communicates with each other. The Appointment system 2240 functions as a centralized hub for the TOS 2250, 2252, TOS DB 2244, 2246 and Appointment DB 2242, and controls and completes the gate process. According to some embodiments, Users 2220A, 2220B (e.g, trucking company) use one Appointment system 2240 for two different terminals 2250, 2252 using different TOSs in the same geographic area, for example. Moreover, users can view and manage multiple terminals in the system.

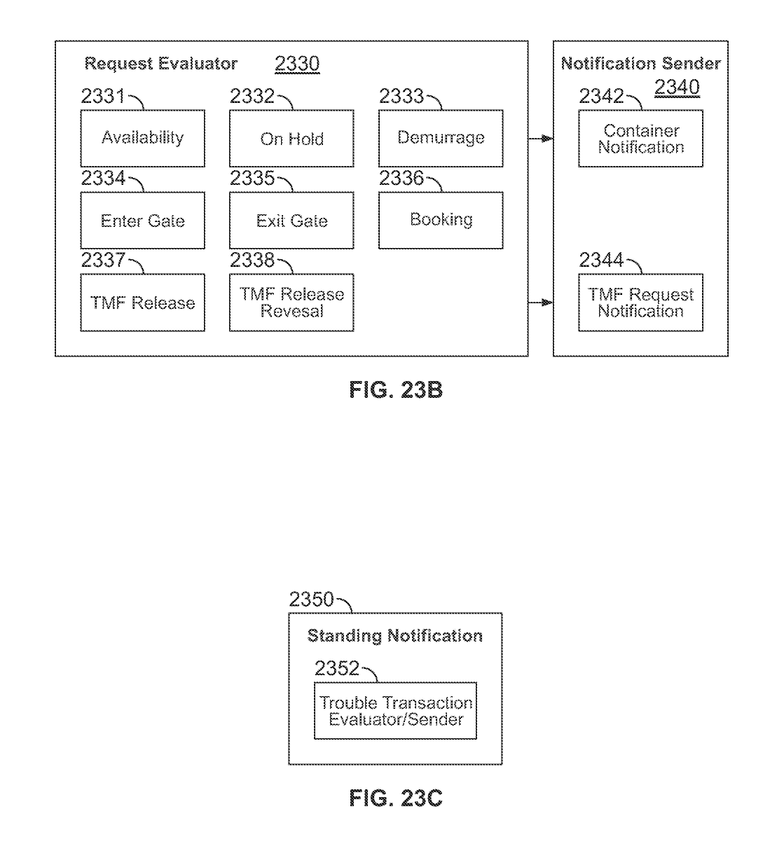

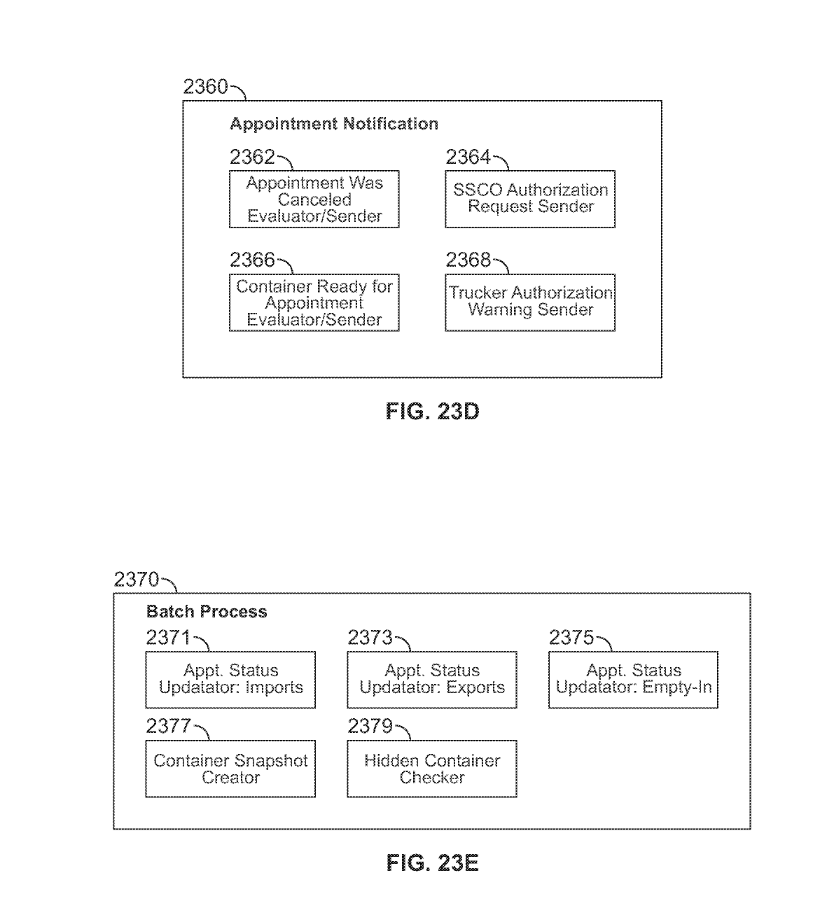

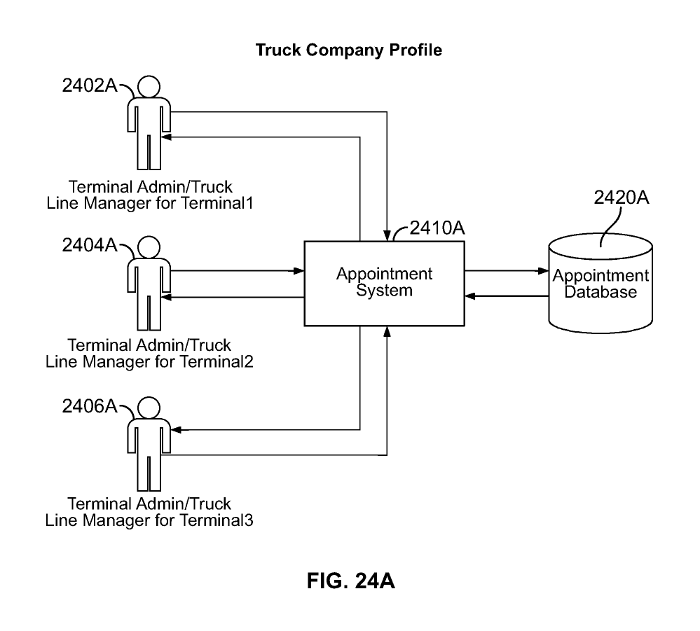

FIG. 23A is a diagram illustrating exemplary appointment processing consistent with one or more aspects of the innovations herein. A user of a terminal (terminal 1) of TOS 1 2232A and/or a user of a terminal (terminal 2) of TOS 2 2232B may begin this processing by requesting an appointment. The appointment system 2204 may receive a request for container information to make an appointment at terminal 1 using TOS 1 or at terminal 2 using TOS 2 2304. The appointment system 2204 may retrieve TOS type (i.e., TOS 1 or TOS 2) from the terminal information and construct a repository instance for the terminal and TOS type 2308. Depending on TOS type, the appointment system 2204 may request container data using the repository instance to access data source for the terminal 1/TOS 1 2312 or request container data using the repository instance to access data source for the terminal 2/TOS 2 2316. Once data has been accessed, the appointment system 2204 may receive the data, construct a container object for the appointment, and transmit the data 2320. The appointment system 2204 may also request existing appointment data from the appointment database 2208 for the container 2324. The appointment system 2204 may cause container data to be displayed on a client (i.e., terminal 1 or terminal 2) application such as a web browser 2328.

Notification Agent

Notification Agent may be an application for evaluating notification requests and performing other background processing tasks. It may run in the background of the other processes described herein and may evaluates the following notification requests based on scheduled jobs, for example: Availability Request, On Hold Request, Enter Gate Request, Exit Gate Request, Booking Valid Requests, Container Ready for Appointment Request, Demurrage Notification Request, or a combination thereof.

After evaluation of each request to determine whether the request is satisfied by looking in the various database tables, the Notification Agent may set the Request Status value, which may be used to send a notification to a user. A Customer Service Manager in the Notification Agent may group together all notifications of a single user and send the notifications by emails, Faxes, or text messages, for example.

FIG. 23B is an exemplary block diagram of request evaluator and notification sender functionality consistent with one or more aspects of the innovations herein. A request evaluator 2330 transmits data to a notification sender 2340. The request evaluator 2330 may include functionality including availability 2331, on hold 2332, demurrage 2333, enter gate 2334, exit gate 2335, booking 2336, TMF release 2337, and TMF release reversal 2338. The notification sender 2340 may include functionality including container notification 2342 and TMF request notification 2344.

### Container Request Notification:

As shown in FIG. 23C, the following may be the various sub-modules in a container request notification example. A request evaluator 2330 may comprise an availability request evaluator 2331 (checks for container becoming available), OnHold request evaluator 2332 (checks for container going on hold) enter gate 2334 (checks for container entering the gate), exit gate 2335 (checks for container exiting the gate), demurrage 2333 (checks for container going to demurrage warning condition), TMF release 2337 (checks for container being TMF released), TMF release reversal 2338 (checks for container's TMF release reversal (back on TMF hold)), and/or booking 2336 (checks for booking becoming valid). A notification sender 2340 may comprise a container notification sender 2342 (sends the notification request email/fax to the user) and/or TMF request notification sender 2344 (sends the TMF related notification request email/fax to the user).

The Request Evaluators 2330 may check the status of a container as per the Notification Request stored in database. If the current conditions of the container match the request conditions, the request will have been considered as Satisfied or Completed. For example, for the Availability case, the Request may be satisfied when the container becomes Available. The request may become Invalid if the current condition is such that the condition requested cannot be achieved. In the Availability case, for example, if the container is found to be Inland before it is detected as Available, then the corresponding request becomes Invalid. After Evaluation, the requests may be updated with the changed status. If there are any errors during evaluation of a request, is the request may be marked as such and re-evaluated during the next cycle.

The TMF Release requests may be created implicitly when the user registers for Availability requests or specifically in the “Register All” or in the “Customize Requests” pages in the UI. The TMF Release evaluator may check in the TOS tables for release status and update the request as satisfied. The TMF status may become Released or go back to a TMF Hold status, for example.

The evaluators inherit from the base class, which may contain processing logic common to all the evaluators. This common logic may call methods in the subclasses for specific logic.

The Container Notification Senders may group all the notifications of a user in a single email, Fax, or text message and send the message. If any error occurs during the sending of the message, an attempt may be made to send the message in the next cycle. The request may be marked as Sent after successful sending.

The TMF Notification sender may combine the TMF Release and Reversal Emails in a single message and send it.

The timer interval evaluation period and some settings may be read from the configuration file.

### Standing Notifications (Trouble Transactions)

FIG. 23D is an exemplary block diagram of standing notification functionality consistent with one or more aspects of the innovations herein. The standing notification 2350 may include a trouble transaction evaluator/sender 2352.

FIG. 23D shows an example standing notification module 2350. Standing Notifications may be notifications for which the user does not explicitly make a request. A setting may be made in the user preferences and the system may determine whether the conditions related to that setting has occurred. For example, Trouble Transaction settings may be present. Users may request notifications whenever a gate transaction goes Into or Out Of Trouble. All such notifications of a user may be grouped together and sent by a trouble transaction evaluator/sender module 2352 as soon as the conditions are detected. The users and the transactions may be connected through the Users' truckers. When a transaction goes into (or out of) trouble, all users having the trucker in their associated list may be sent notifications if they have registered.

The timer interval evaluation period may be read from the config file. The settings may be stored as part of UserPreferences stored in the ADMIN database in the USER_SITE_CONFIG table.

Trouble Notification may send details of Trouble Info to all users who have registered for Trouble notifications. The notification may be sent based on users whose truckers are associated with the trouble transactions. Container Notifications may be sent on a per request basis as requested by user, though they may be grouped at sending time.

### Appointment Notifications

FIG. 23E is an exemplary block diagram of appointment notification functionality consistent with one or more aspects of the innovations herein. Appointment notification 2360 may include an appointment cancellation evaluator/sender 2362, SSCO authorization request sender 2364, container ready for appointment evaluator/sender 2366, and trucker authorization warning sender 2368.

FIG. 23E shows an example appointment notification module 2360. The following example notifications may be related to Appointments.

### Container Ready for Appointment Notification 2366—Per Request

### (CUSTOMER_REQUEST)

This notification may be sent by a container ready for appointment evaluator/sender module 2366 when a container becomes ready for making an appointment. Due to various import container related reasons a container may not be ready for making appointments. In such a case the user may request that a notification be sent when the container becomes ready. All notifications of a user may be grouped together in a single message. This notification may apply to Import Appointments only in some embodiments.

### Appointment was Cancelled Notification 2362—Default (not Configurable)

This notification may be sent by an appointment canceled evaluator/sender module 2362 when an appointment gets cancelled due to limits being cancelled or modified in Set Limits. In Set Limits, if the Appointment Admin deletes slots which have appointments made, then these appointments may be marked as being cancelled. This evaluator may check all such appointments and send messages to users whose appointments got cancelled. All notifications of a user may be grouped together in a single email. All types of appointments could get cancelled.

### SSCO Authorization Request Notification 2364—Default (not Configurable)

When the user makes an Empty In Appointment for a container that has a status of “Requires Authorization”, the status of the appointment will be “Pending”. In this case a message may be sent by an SCCO authorization request sender module 2364 to the SSCO requesting Return Authorization for the container. The SSCO may authorize the container return by performing operations that update the TOS table xxxxx. This message may be sent only if the SSCO has allowed the sending of the email for this purpose in some embodiments.

### Trucker Authorization Warning Notification 2368—Default (not Configurable)

This notification may be sent by a trucker authorization warning sender module 2368 to the user who made the appointment. When it is detected that the SSCO has not authorized the return of the Empty container and the appointment is less than 2 hours away, this notification may be generated and sent. The timer interval evaluation period and some settings may be read from the config file. Some other settings related to these notifications are stored in the database.

### Batch Processes

FIG. 23E is an exemplary block diagram of batch process functionality consistent with one or more aspects of the innovations herein. Batch process 2370 may include an import appointment status updater 2371, export appointment status updater 2373, empty-in appointment status updater 2375, container snapshot creator 2377, and hidden container checker 2379.

As shown in FIG. 23E, a batch process module 2370 may comprise a variety of modules configured to handle a variety of processes. The appointment status updater—imports module 2371 may update the status of Active/Pending/Initiated Appointments as required to Active or Pending, Completed/Aborted, Missed or Early Pickup. The appointment status updater—exports module 2373 may update the status of Non-Import/Non-EmptyIn Active/Initiated Appointments as required to Completed/Aborted, or Missed. The appointment status updater—empty in module 2375 may update the status of Active/Pending/Initiated EmptyIn Appointments as required to Active or Pending, Early-Missed or Completed/Aborted, or Cancelled or Missed.

TOS may set the appointment status to Initiated for all Appointment types when a transaction starts. The above updater modules may ignore all “Pseduo” appointments, which are those created by TOS. They may process appointments which are created from Web/VRU. The CREATED_FROM field may be used for this purpose.

The container snapshot creator module 2377 may create container statistics related to occupancy, or user having kept the appointments etc. These may be displayed in the Set Limits screens, and the Limits Reports. The data may be updated in the APPT LIMITS table.

The hidden container checker module 2379 may unhideEmpty-In containers which have valid Dual appointments. Users may hide containers in the Empty-In Return Checker page. Only those containers which do not have any appointments may be hidden. An Empty In appointments may have an Import appointment as a dual. This dual appointment may be made in the Imports appointments module. This process may check all the hidden containers for any Imports appointments, and if any hidden containers are found to have an Imports appointments, then they may be marked as Unhidden. These containers may show in the Empty In Checker page when the user does a query that returns the container.

The timer interval evaluation period and some settings may be read from the config file. The various other settings related to these notifications may be stored in the SITE_CONFIG table.

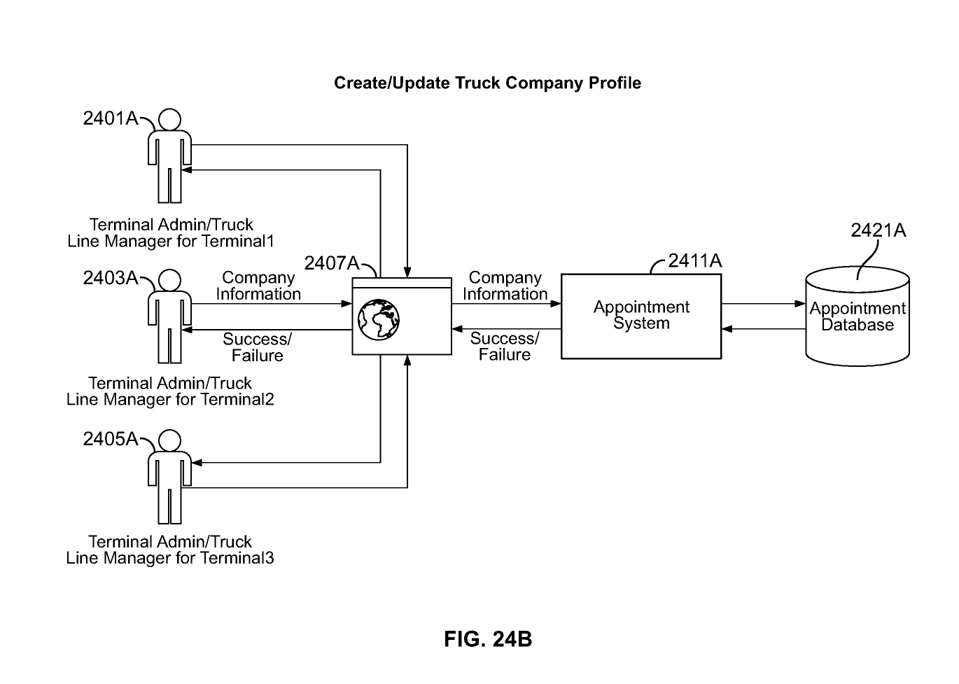

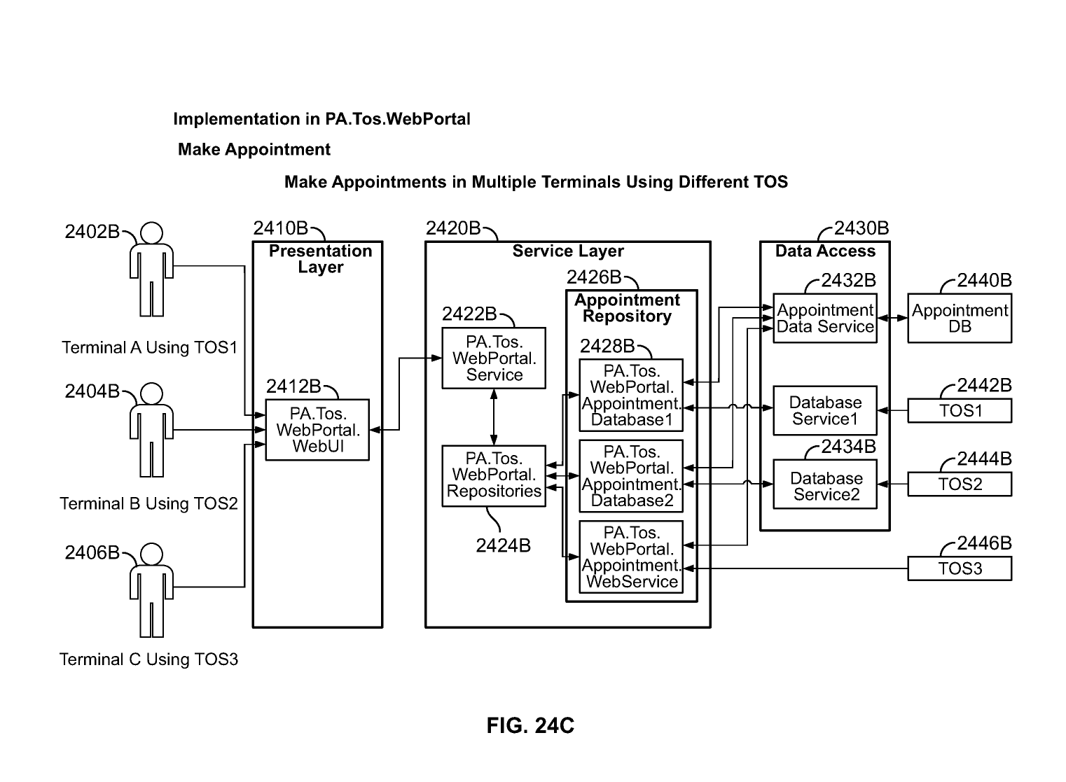

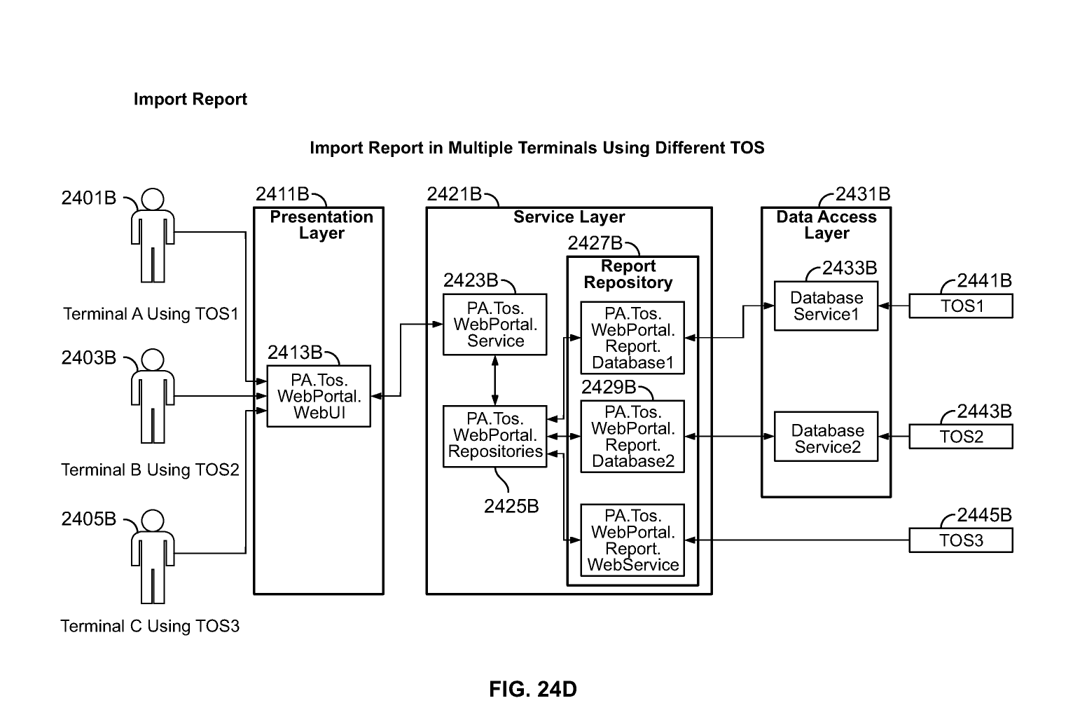

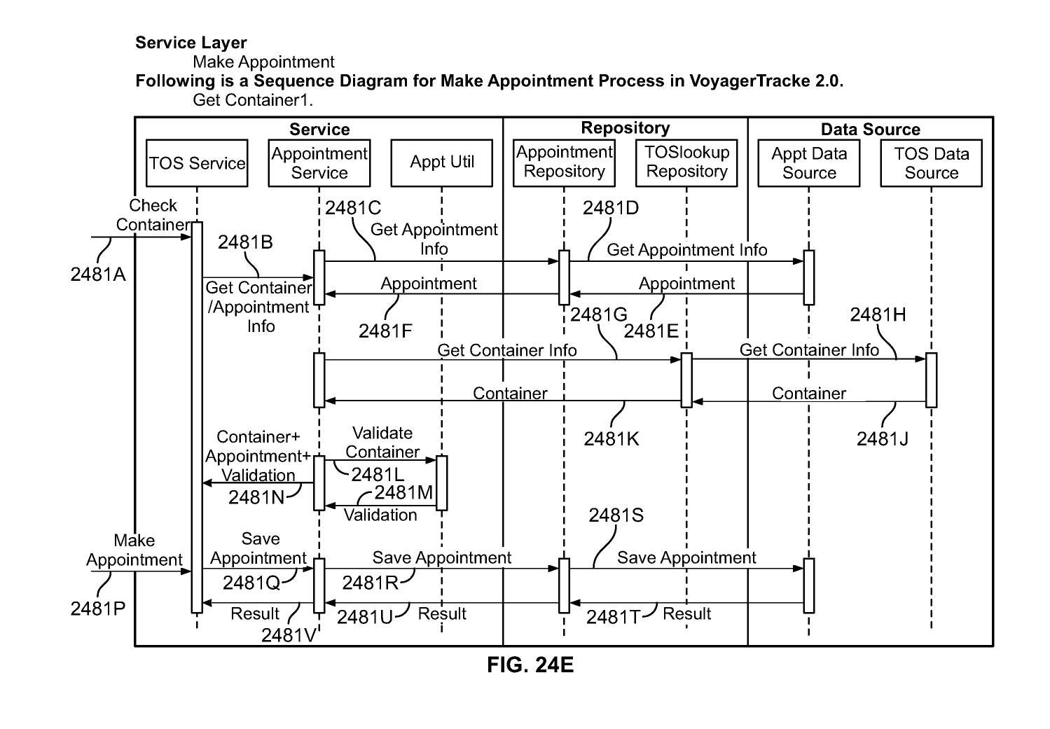

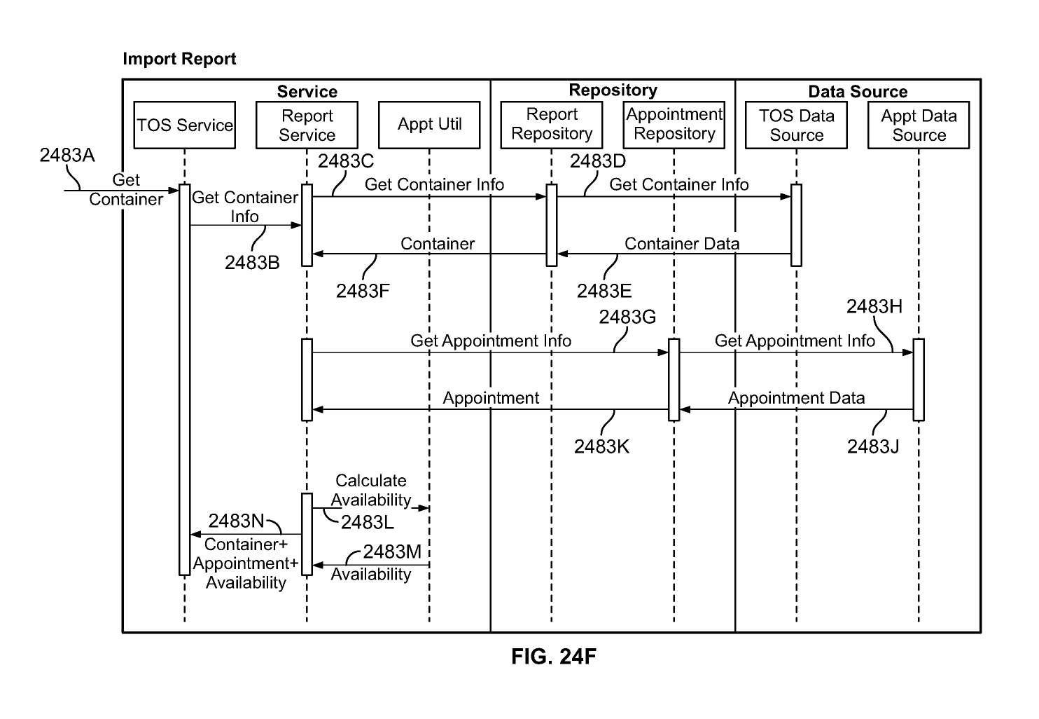

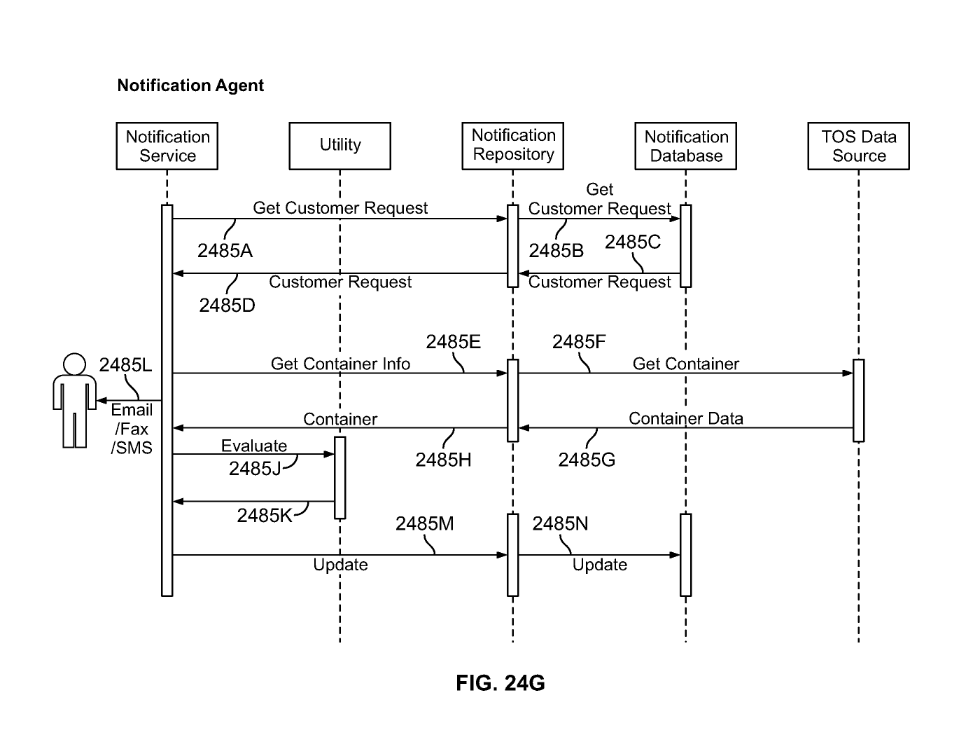

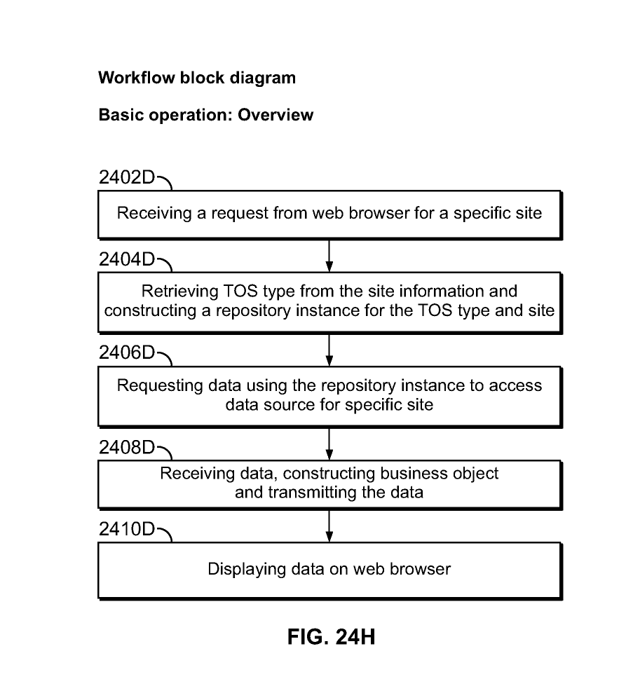

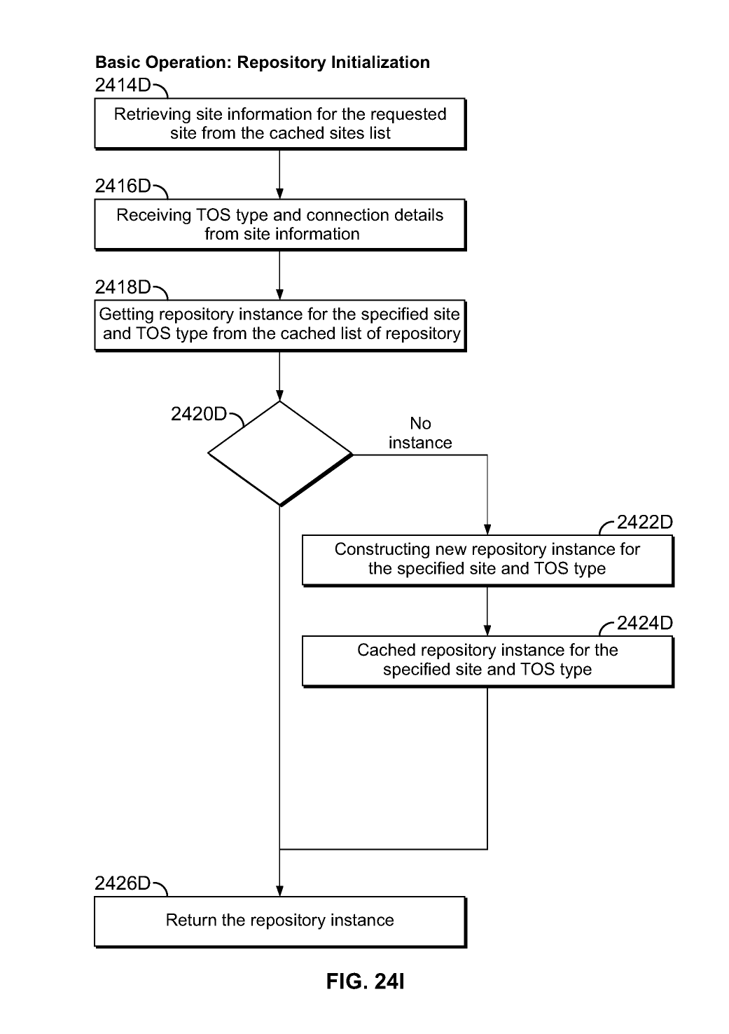

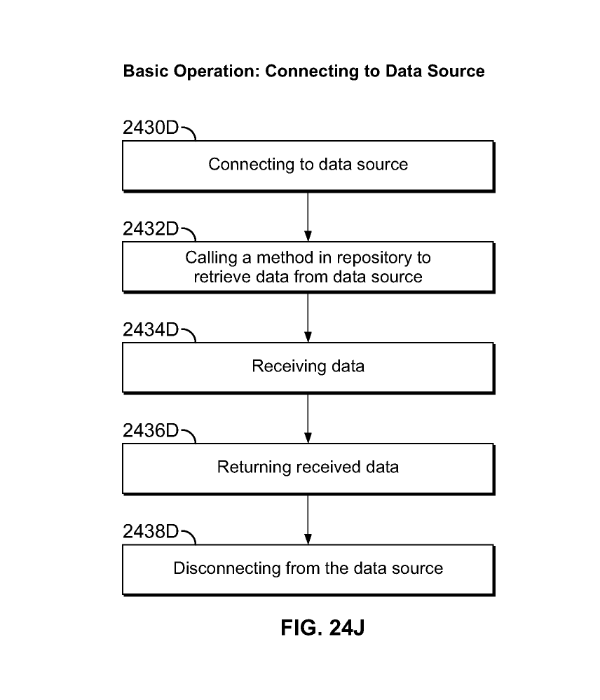

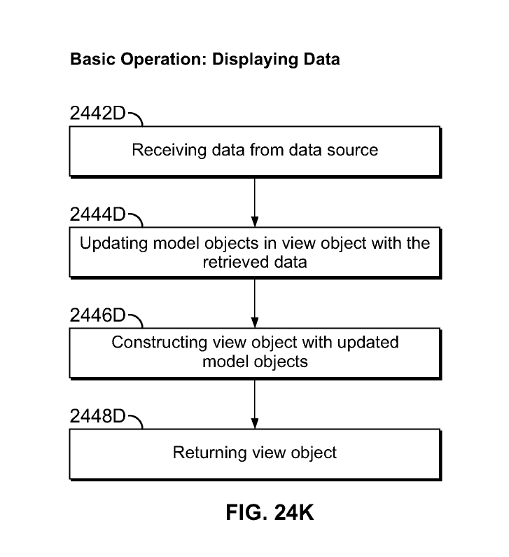

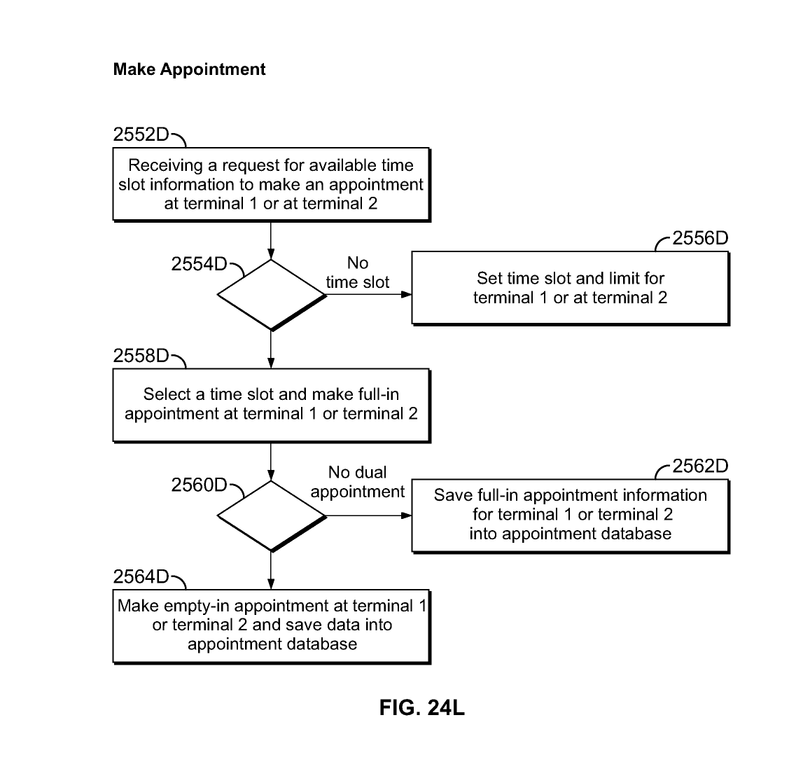

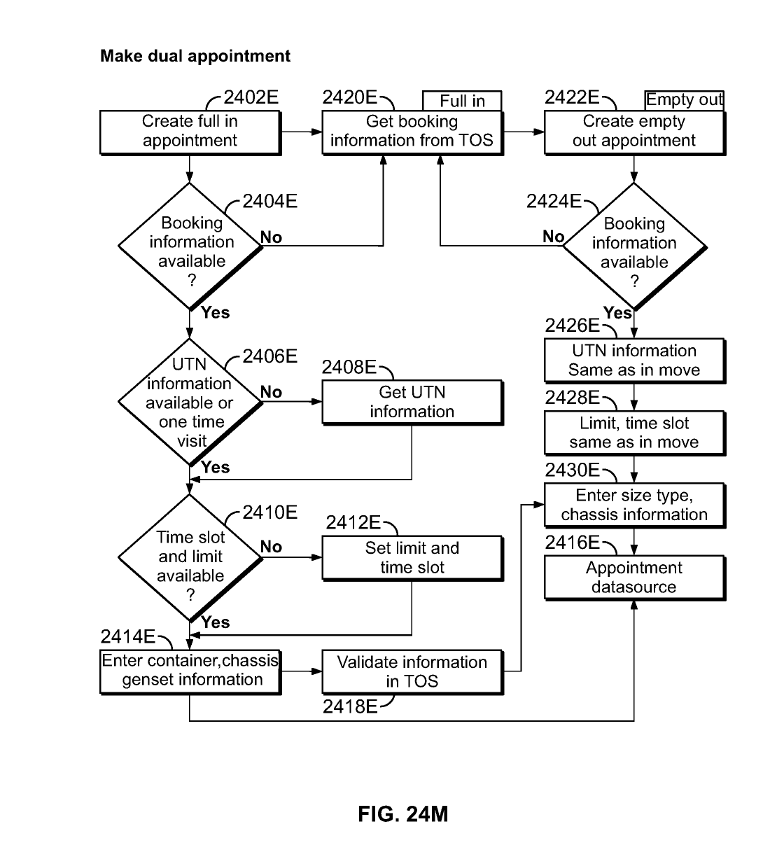

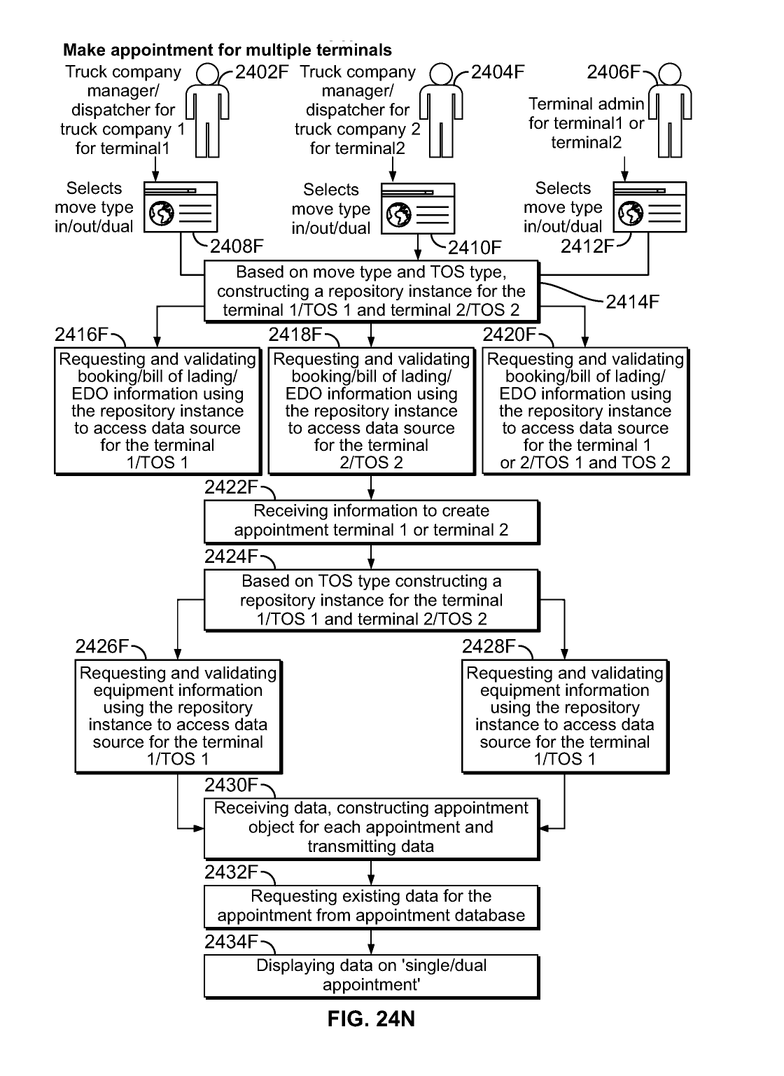

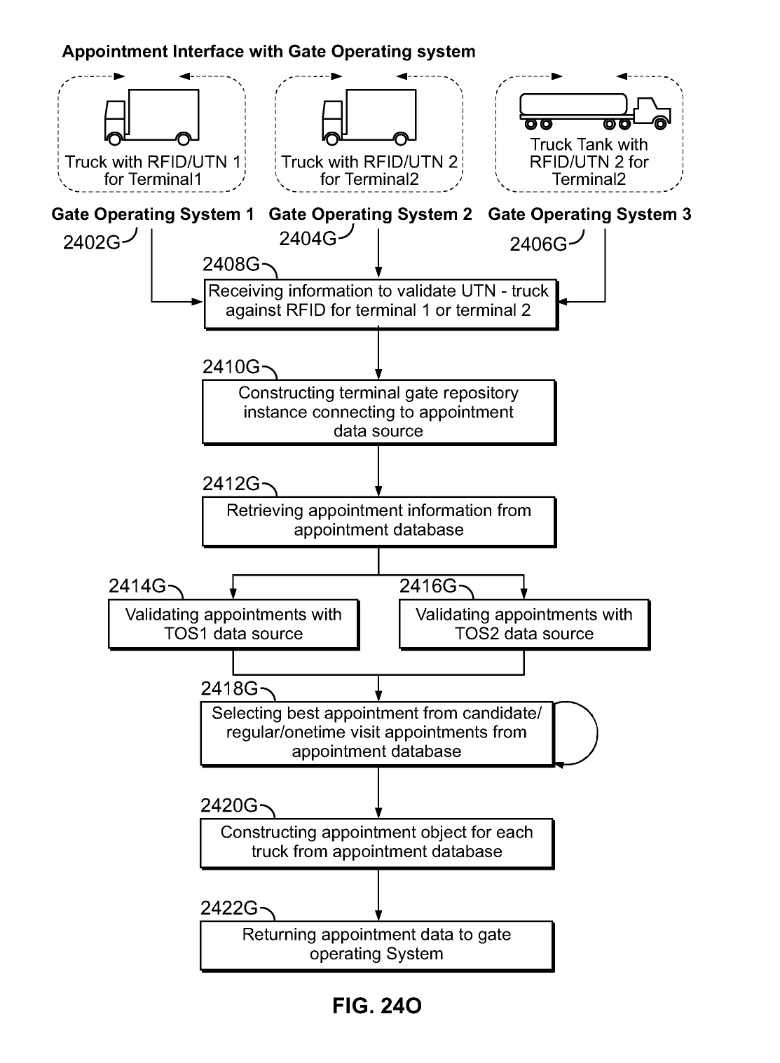

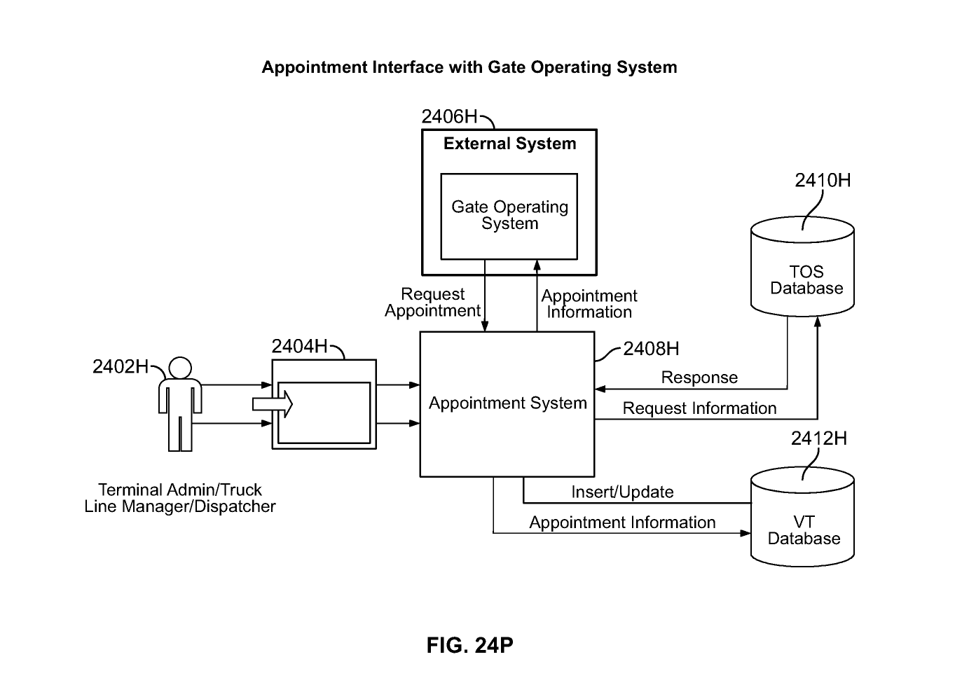

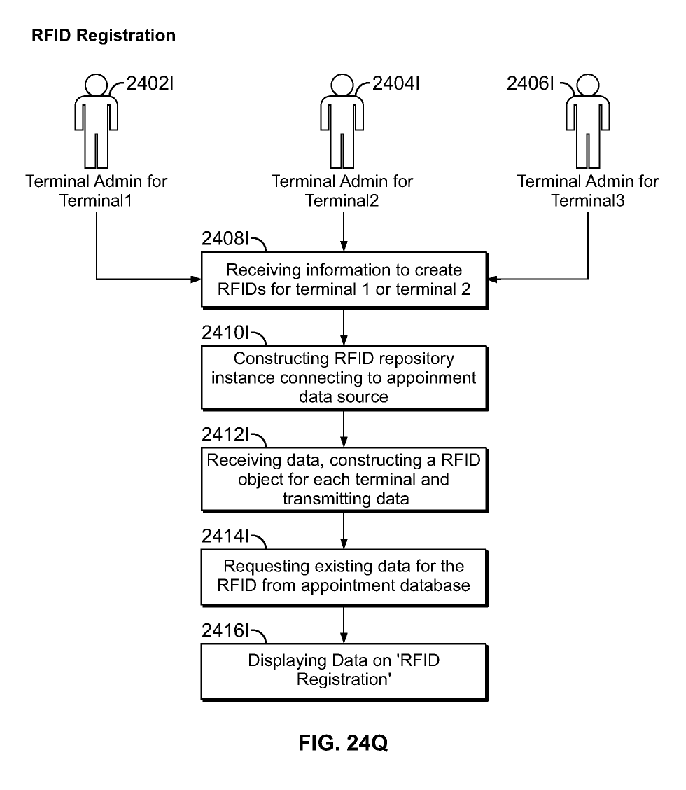

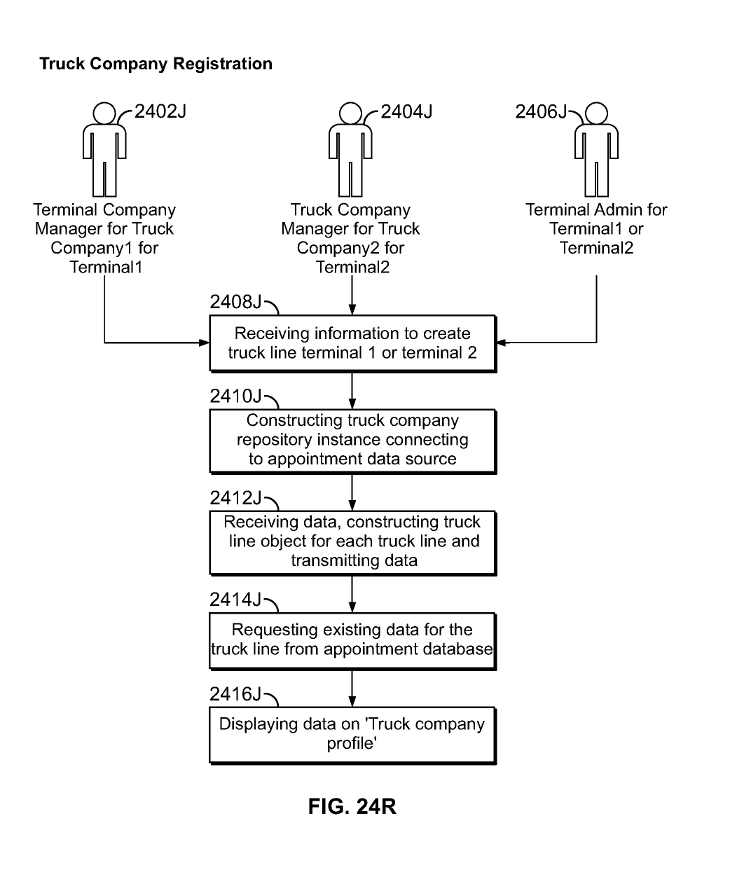

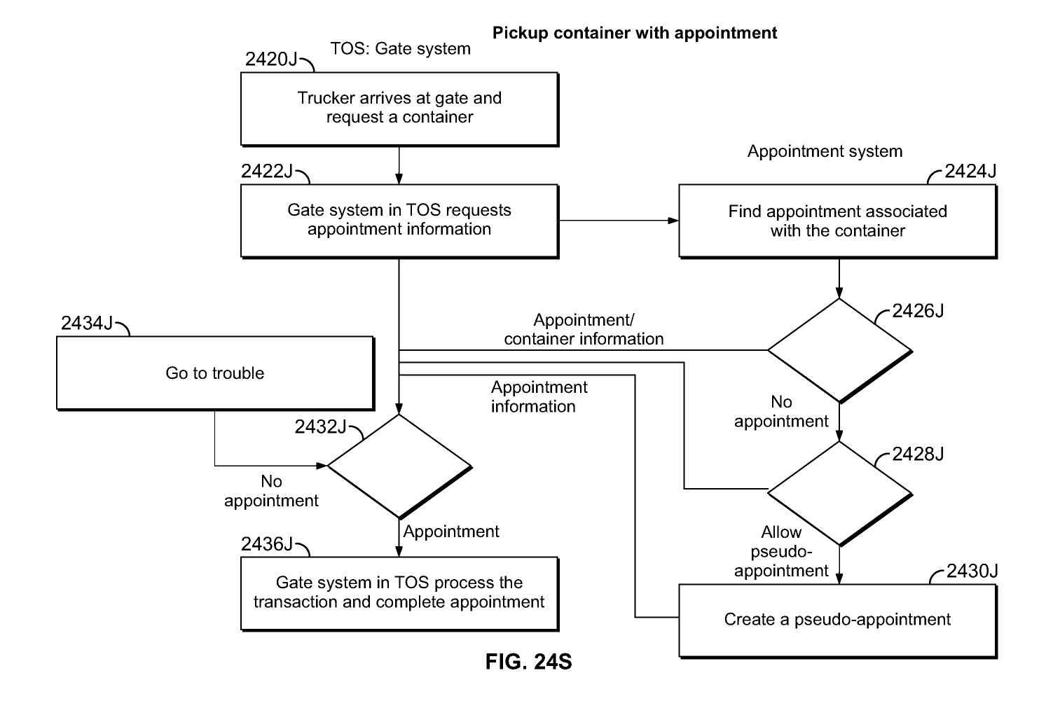

FIGS. 24A-B are block diagrams illustrating truck company profile systems or processes consistent with one or more aspects of the innovations herein. FIG. 24A illustrates one implementation of truckline management, including a company profile, RFID, and UTN. FIG. 24A illustrates a truck company profile where a plurality of users may access the appointment system 2410A and appointment database 2420A. The user 2402A, 2404A, 2406A may be a terminal administrator or truck line manager and allow those different users to each access the appointment system 2410A to create/view/modify/update a truck company profile.

According to implementations herein, a truck company profile is provided for a truck line company authorized to receive and deliver equipment to the terminal. Each truck line company may include a plurality of trucks.

According to some implementations, in order to enter the NOLA terminal, each truck is required to have an RFID tag. This RFID tag is required to support the Call Forward and Gate processes. The RFID tag is registered with the truck company and the management of these tags. Terminal Administrators may create RFID tags in batches and assign a predetermined number of batches to different trucking companies. Truck Company Administrators may manage the RFIDs and assign them to individual trucks. Maintenance of RFID tags is done by a RFID registration page.

According to some implementations, truck companies have a defined list of trucks which are authorized to receive and deliver equipment to the terminal. Each truck has unique truck number that is known as UTN. Each truck line has assigned to it a UTN range. A truck company administrator or terminal administrator may then assign an RFID to UTN. Assignment of RFID and UTN is performed via a truck maintenance screen.

For instance, in FIG. 24B, each of the different users 2401A, 2403A, 2405A access the appointment system 2411A via an interface 2407A, such as a web browser interface. The appointment system 2411A accesses and retrieves data from appointment database 2421A. For example, a user 2403A requests to create/update/modify/view company information via interface 2407A. That request and any associated input is transmitted to the appointment system 2411A, which requests the data and/or provides the input to the appointment database 2421A. The request is then processed and the appointment database returns the appropriate data to the appointment system 2411A. The appointment system 2411A then outputs a success/failure signal along with any appropriate data to display on the interface 2407A. The interface 2407A may display the success/failure confirmation as well as the truck company information.

FIG. 24C is a block diagram depicting one illustrative layer architecture for an exemplary TOS agnostic system for making an appointment consistent with one or more aspects of the innovations herein. Any of a Terminal A user 2402B using TOS1, Terminal B user 2404B using TOS2, and Terminal C user 2406B using TOS3 operates a computing device that connects to a presentation layer 2410B including a Web user interface portal 2412B. The presentation layer 2410B receives data from a service layer 2420B that stores and processes terminal data from a plurality of TOS types including a TOS 2442B, 2444B, 2446B and/or appointment database 2440B. The service layer 2420B includes an appointment repository 2426B including a plurality of repository instances 2428B. The repository instances may connect to an appointment database service 2432B and/or a database service 2434B. The repository instance may also be a web service. The service layer further includes a TOS Web portal service 2422B and TOS Web portal repositories 2424B. The repository instances may be connected to a data access layer 2430B including a plurality of database services 2434B operating under respective Terminal Operating Systems 2442B, 2444B via data access layer 2430B. The repository instance that is a Web Service may be provided from a TOS 2446B. The data access layer 2430D obtains the requested terminal data from any of an appointment database 2440B and TOSs via corresponding database services 2432B, 2434B. The appointment repository 2426B may also retrieve data directly from a TOS 2446B, for example.

In some embodiments, the TOS agnostic system performs repository processing including instantiating a first repository instance for a first TOS type. First data is requested using the first repository instance and a first database service to access at least one data source for a specific site. A first business object may be constructed using the first data and the first business object is presented to a user as a first TOS-agnostic output. A second repository instance may be instantiated for a second TOS type. Second data is requested using the second repository instance and a second database service to access at least one data source for a specific site. A second business object may be constructed using the second data and the second business object is presented to a user as second TOS-agnostic output. A third repository instance may instantiated as a web service that accesses third data from a third TOS type directly. A third business object may be constructed using the third data and the third business object is presented to a user as third TOS-agnostic output. The business objects may include appointments in multiple terminals using different TOSs.

FIG. 24D is a block diagram depicting one illustrative layer architecture for an exemplary TOS agnostic system for importing a report consistent with one or more aspects of the innovations herein. Any of a Terminal A user 2401B using TOS1, Terminal B user 2403B using TOS2, and Terminal C user 2405B using TOS3 operates a computing device that connects to a presentation layer 2411B including a Web user interface portal 2413B. The presentation layer 2411B receives data from a service layer 2421B that stores and processes terminal data from a plurality of TOS types including a TOS 2441B, 2443B, 2445B. The service layer 2421B includes an appointment repository 2426B including a plurality of repository instances 2428B. The repository instances may connect to a database service 2433B. The repository instance may also be a web service. The service layer further includes a TOS Web portal service 2445B and TOS Web portal repositories 2424B. The repository instances may be connected to a data access layer 2431B including a plurality of database services 2433B operating under respective Terminal Operating Systems 2441B, 2443B via data access layer 2431B. The repository instance that is a Web Service may be provided from a TOS 2445B. The data access layer 2431D obtains the requested terminal data from any of a database service 2433B and TOSs. The users may request an import report from multiple terminals using different TOSs using the system of FIG. 24D, for example.

In some embodiments, the TOS agnostic system performs repository processing including instantiating a first repository instance for a first TOS type. First data is requested using the first repository instance and a first database service to access at least one data source for a specific site. A first business object may be constructed using the first data and the first business object is presented to a user as a first TOS-agnostic output. A second repository instance may be instantiated for a second TOS type. Second data is requested using the second repository instance and a second database service to access at least one data source for a specific site. A second business object may be constructed using the second data and the second business object is presented to a user as second TOS-agnostic output. A third repository instance may instantiated as a web service that accesses third data from a third TOS type directly. A third business object may be constructed using the third data and the third business object is presented to a user as third TOS-agnostic output. The business objects may include import reports in multiple terminals using different TOSs.

FIGS. 24E-G present example embodiments of the systems and methods described herein related to truck line company management. For example, a truck line company may employ a fleet of trucks that may be authorized to receive and deliver containers to a terminal. Each truck may have an RFID tag, which may enable tracking of the truck and interaction between the truck and the terminal, for example. Truck companies may have a defined list of trucks which are authorized to receive and deliver equipment to the terminal. Each truck may have a unique truck number that is known as UTN. Each truck line may be assigned a UTN range.

FIG. 24E is a TOS agnostic appointment method consistent with one or more aspects of the innovations herein. This appointment method may be used for managing trucks equipped with RFID tags in a fleet of trucks, for example, or to manage other groups of vehicles. The appointment method in FIG. 24E may be used to generate appointments for trucks to pick up containers, for example. Thus, the example process in FIG. 24E is illustrated as being based on the container to be picked up, although appointments may be made on other bases in other embodiments. A check container command may be input to the TOS service 2481A which may specify a container for which the appointment is to be made. As discussed throughout, this may be any TOS service due to the TOS-agnostic nature of the method. The TOS service may request container and/or appointment information from the appointment service 2481B. The appointment service may request appointment information from the appointment repository 2481C. The appointment repository may retrieve appointment information from the appointment data source 2481D, which may send available appointment slots to the appointment repository 2481E. Available appointment slots in the repository may be reported to the appointment service 2481F. the appointment service may also request container information about the container from the TOS lookup repository 2481G. The TOS lookup repository may retrieve container information from the TOS data source 2481H, which may send the container information to the TOS lookup repository 2481J. The container information may be reported to the appointment service 2481K. The appointment service may request validation of the container by the appointment utility 2481L, and the appointment utility may validate the container in return 2481M. The appointment service may send the container information, appointment information, and validation to the TOS service 2481N. A user may be able to view this information and make the appointment 2481P. The appointment may be saved with the appointment service 2481Q, appointment repository 2481R, and appointment data source 2481S. The save may be reported by the appointment data source 2481T, appointment repository 2481U, and appointment service 2481V.

For example, a method of processing information involving terminal operating systems may comprise some or all of the following actions. Information may be provided for display, to a user, of an interface comprising terminal operating system appointment functionality and an input field to receive a user input, the information comprising first information that includes container information and second information that includes appointment information. Information related to the user input, received via the interface, may be processed to manage the terminal operating system appointment functionality. Processing may be performed to generate an output/result to transmit instructions within the system, to a third party, or a combination thereof; execute the terminal operating system appointment functionality in the system such that an output of a result of the managed terminal operating system appointment functionality is produced; or a combination thereof. The user input may comprise a command to establish a truck container appointment, modify a truck container appointment, search truck container appointments, delete a truck container appointment, view a truck container appointment, or a combination thereof. The truck container appointment may comprise an import appointment, an export booking appointment, an empty in-container appointment, or a combination thereof. The output may comprise an established truck container appointment, a modified truck container appointment, a search result including a truck container appointment, a deletion of a truck container appointment, a display of a truck container appointment, or a combination thereof. The truck container appointment may comprise an import appointment, an export booking appointment, an empty in-container appointment, or a combination thereof. Performing processing to generate an output/result may comprise retrieving container information, appointment information, or a combination thereof from a repository, a data source, or a combination thereof. Performing processing to generate an output/result may comprise validating a container. Performing processing to generate an output/result may comprise saving information related to an appointment in a repository, a data source, or a combination thereof. The output may comprise container information, appointment information, validation information, save confirmation, or a combination thereof.

FIG. 24F is a TOS agnostic reporting method consistent with one or more aspects of the innovations herein. This reporting method may be used for managing trucks equipped with RFID tags in a fleet of trucks, for example, or to manage other groups of vehicles. The reporting method in FIG. 24F may be used to find import reports for containers and/or appointment data for containers scheduled to be picked up by trucks, for example, although other reporting may be possible. A get container command may be input to the TOS service 2483A which may specify a container for which information is desired. As discussed throughout, this may be any TOS service due to the TOS-agnostic nature of the method. The TOS service may request container information from the report service 2483B. The report service may request container information from the report repository 2483C. The report repository may retrieve container information from the TOS data source 2483D, which may send the container information to the report repository 2483E. The report repository may send the container information to the report service 2483F. The report service may also request appointment information related to the container from the appointment repository 2483G. The appointment repository may retrieve appointment information from the appointment data source 2483H, which may send the appointment information to the appointment repository 2483J. The appointment repository may send the appointment information to the report service 2483H. The report service may direct the appointment utility to calculate availability of the data for reporting 2483L. Availability may be returned 2483M, and the report service may send a report which may comprise container, appointment, and/or availability information to the TOS service 2483N.

For example, a method of processing information involving terminal operating systems may comprise some or all of the following actions. Information may be provided for display, to a user, of an interface comprising terminal operating system appointment functionality and an input field to receive a user input, the information comprising first information that includes container information. Information related to the user input, received via the interface, may be processed to manage the terminal operating system appointment functionality. Processing may be performed to generate an output/result to transmit instructions within the system, to a third party, or a combination thereof; execute the terminal operating system appointment functionality in the system such that an output of a result of the managed terminal operating system appointment functionality is produced; or a combination thereof. The user input may comprise a command to establish a truck container import report, modify a truck container import report, search truck container import reports, delete a truck container import report, view a truck container import report, or a combination thereof. The truck container import report may comprise container information, appointment information, availability information, or a combination thereof. The output may comprise an established truck container import report, a modified truck container import report, a search result including a truck container import report, a deletion of a truck container import report, a display of a truck container import report, or a combination thereof. Performing processing to generate an output/result may comprise retrieving container information, appointment information, or a combination thereof from a repository, a data source, or a combination thereof. Performing processing to generate an output/result may comprise calculating an availability. The output may comprise container information, appointment information, availability information, or a combination thereof. FIG. 24G is a TOS agnostic notification method consistent with one or more aspects of the innovations herein. The notification method may provide notifications to users via email, fax, SMS, or other reporting technologies. For example, appointment data, import reporting, etc. may be delivered to users via notification. Notifications may be similar to the notifications discussed in other embodiments herein. The notification service may retrieve a customer request from the notification repository 2485A. The notification repository may retrieve the customer request from the notification database 2485B, which may send the customer request to the notification repository 2485C. The notification repository may send the customer request to the notification service 2485D. The customer request may include information such as contact information for a customer and/or triggers for sending a notification (e.g., notify when an appointment is made or when an appointment is near, etc.). Based on the information in the customer request, the notification service may identify a container for which a notification is requested. The notification service may retrieve container information from the notification repository 2485E. The notification repository may retrieve the container information from the TOS data source 2485F, which may send the container information to the notification repository 2485G. The notification repository may send the container information to the notification service 2485H. The notification service may direct the utility to evaluate the customer request and container information to determine whether a notification is warranted 2485J, and the utility may make the determination and report the determination to the notification service 2485K. For example, if the customer request specifies that a notification is to be sent when an appointment for a container is scheduled, and the container information indicates that the appointment is scheduled, the evaluation may determine that a notification should be sent. Therefore, the notification service may send a notification 2485L and update the data in the notification repository 2485M and/or notification database 2485N to indicate that the notification was sent.

For example, a method of processing information involving terminal operating systems may comprise some or all of the following actions. Information may be provided for display, to a user, of an interface comprising terminal operating system notification functionality and an input field to receive a user input, the information comprising first information that includes notification information related to a truck container. Information related to the user input, received via the interface, may be processed to manage the terminal operating system notification functionality. Processing may be performed to generate an output/result to transmit instructions within the system, to a third party, or a combination thereof; execute the terminal operating system notification functionality in the system such that an output of a result of the managed terminal operating system notification functionality is produced; or a combination thereof.

The user input may comprise a command to register an import availability/hold status, modify an import availability/hold status, search import availability/hold statuses, delete an import availability/hold status, view an import availability/hold status, or a combination thereof. The output may comprise a registered import availability/hold status, a modified import availability/hold status, a search result including an import availability/hold status, a deletion of an import availability/hold status, a display of an import availability/hold status, or a combination thereof.

The user input may comprise a command to register a traffic migration fee release/release reversal notification, modify a traffic migration fee release/release reversal notification, search traffic migration fee releases/release reversal notifications, delete a traffic migration fee release/release reversal notification, view a traffic migration fee release/release reversal notification, or a combination thereof. The output may comprise a registered traffic migration fee release/release reversal notification, a modified traffic migration fee release/release reversal notification, a search result including a traffic migration fee release/release reversal notification, a deletion of a traffic migration fee release/release reversal notification, a display of a traffic migration fee release/release reversal notification, or a combination thereof.

The user input may comprise a command to register a demurrage notification, modify a demurrage notification, search demurrage notifications, delete a demurrage notification, view a demurrage notification, or a combination thereof. The output may comprise a registered demurrage notification, a modified demurrage notification, a search result including a demurrage notification, a deletion of a demurrage notification, a display of a demurrage notification, or a combination thereof.

The user input may comprise a command to register a booking valid notification, modify a booking valid notification, search booking valid notifications, delete a booking valid notification, view a booking valid notification, or a combination thereof. The output may comprise a registered booking valid notification, a modified booking valid notification, a search result including a booking valid notification, a deletion of a booking valid notification, a display of a booking valid notification, or a combination thereof.

The user input may comprise a command to register an exit gate notification, modify an exit gate notification, search exit gate notifications, delete an exit gate notification, view an exit gate notification, or a combination thereof. The output may comprise a registered exit gate notification, a modified exit gate notification, a search result including an exit gate notification, a deletion of an exit gate notification, a display of an exit gate notification, or a combination thereof.

The user input may comprise a command to register an enter gate notification, modify an enter gate notification, search enter gate notifications, delete an enter gate notification, view an enter gate notification, or a combination thereof. The output may comprise a registered enter gate notification, a modified enter gate notification, a search result including an enter gate notification, a deletion of an enter gate notification, a display of an enter gate notification, or a combination thereof.

The user input may comprise a command to register a standing notification, modify a standing notification, search standing notifications, delete a standing notification, view a standing notification, or a combination thereof. The output may comprise a registered standing notification, a modified standing notification, a search result including a standing notification, a deletion of a standing notification, a display of a standing notification, or a combination thereof.

FIG. 24H is an exemplary flow diagram of an illustrative workflow process consistent with one or more aspects of the innovations herein. The basic operation starts with receiving a request from the web browser for a specific site 2402D. A TOS type is retrieved from the site information and a repository instance is constructed 2404D for the TOS type and the site. Data is then requested using the repository instance to access a data source for a specific site 2406D. Data is then received, business objects are constructed and data transmitted 2408D. The data is displayed on a Web Browser 2410D.

FIG. 24I is an exemplary flow diagram of an illustrative workflow process for repository initialization consistent with one or more aspects of the innovations herein. Site information is received for the requested site from a cached sites list 2414D. The TOS type and connection are received from site information 2416D. From the cached list of repository, the repository instance for the specified site and TOS type is retrieved 2418D. A determination 2420D of whether the repository instance is present. If so, the repository instance is returned 2426D. If no repository instance is present, then a new repository instance is constructed for the specified site and TOS type 2422D. The repository instance for the specified site and TOS type is cached 2424D.

FIG. 24J is an exemplary flow diagram of an illustrative workflow process for connecting to a data source consistent with one or more aspects of the innovations herein. A connection to a data source 2430D is made and then a call to a method in repository to retrieve data from data source 2432D. Data is received 2434D and the received data is returned 2436D. The data source is then disconnected 2438D.

FIG. 24K is an exemplary flow diagram of an illustrative workflow process for displaying data consistent with one or more aspects of the innovations herein. Data is received from a data source 2442D. Model objects are updated in view object with the retrieved data 2444D. The view object is constructed with updated model objects 2446D. A view object is returned 2448D.

FIG. 24L is an exemplary flow diagram of an illustrative workflow process for making an appointment consistent with one or more aspects of the innovations herein. A request for an available time slot information is received to make an appointment at a first or second terminal 2552D. A determination 2554D is made of whether a time slot is available. If no time slot is available, a time slot and limit is set for the first or second terminal 2556D. If a time slot is available, then a time slot is selected and a full-in appointment is made at the first or second terminal 2558D. A determination 2560D is made of whether a dual appointment is selected. If no dual appointment is selected, the full-in appointment information is saved for the first or second terminal into the appointment database 2562D. If a dual appointment is available, then an empty-in appointment at the first or second terminal is made 2564D and the data is saved into the appointment database.

FIG. 24M is an exemplary flow diagram of an illustrative workflow process for making a dual appointment consistent with one or more aspects of the innovations herein. In order for a truck line dispatcher to make efficient use of a trucker's time, the dispatcher will schedule appointments for the truckers to deliver and pick up equipment in the same visit to the terminal. Therefore, when scheduling the trucker for an appointment, the dispatcher is able to make an appointment for both an inbound and outbound move for the same truck during the same date and time slot. The user has the ability to pair and unpair appointments. Further, the user can create paired dual move appointments (one inbound and one outbound) for all move type combinations.

In some implementations, a user makes a request to create an appointment repository instance for particular TOS will and appointment data will be modified against data in the TOS. Some of the repository methods for dual appointments may include the following exemplary code:

```
  /// <summary>
    /// Retrieves dual appointment information (list of
<see cref=″ApptInfo″/>) for given main move appointment ids.
    /// </summary>
    /// <param name=″apptIds″>The list of main move
    appointment ids</param>
    /// <returns>The list of <see cref=″ApptInfo″/></returns>
    IEnumerable<ApptInfo> GetDualAppts(IEnumerable<int>
    mainMoveIds);
    /// <summary>
    /// Retrieves main appointments information for dual sub appointment
using given main move id.
    /// </summary>
    /// <param name=″apptIds″>The list of main move
    appointment ids</param>
    /// <returns>The list of <see cref=″ApptInfo″/></returns>
    IEnumerable<ApptInfo> GetMainAppts(int mainMoveId);
bool DissociateDualAppt(ApptInfo appt);
Sample service interface
/// <summary>
    /// Unpairs group appointments.
    /// </summary>
    /// <param name=″mainMoveId″></param>
    /// <returns></returns>
    [OperationContract]
    OperationResult UnpairApptGroup(int mainMoveId);
    [OperationContract]
GroupApptOperationResult PairApptGroups(int mainMoveId,
int subMoveId);
```

As illustrated in FIG. 24M, a full-in appointment 2402E is created. Then, a determination is made whether booking information is available 2404E. If not available, then booking information from a TOS is retrieved 2420E. If available, then a determination is made whether UTN information is available or if the appointment is a one time visit 2406E. If not available, then UTN information is retrieved 2408E. If so, then a determination is made whether the time slot and limit is available 2410E. If not available, then the limit and time slot is set 2412E. If so, then the container, chassis, and Genset information is input. The information is sent to the appointment data source 2416E and the information is validated in the TOS 2418E.

For empty out, an empty out appointment is created 2422E. A determination is then made whether booking information is available 2424E. If not, then booking information from the TOS is retrieved 2420E. If booking information is available, 2424E, then the UTN information is the same as for the In move 2426E. Similarly, the limit and time slot is the same as the In move 2428E. Size, type, and chassis information are then input 2430E. The information is sent to the appointment data source 2416E.

FIG. 24N is an exemplary flow diagram of an illustrative workflow process for making an appointment for multiple terminals consistent with one or more aspects of the innovations herein. According to some implementations, a VoyagerTrack user associated with a trucking company having permission may create and modify appointments for all move type appointments. When appointments are created, then a trucking company user (based on user permissions) will have the ability to make, modify and delete appointments for the defined move types. Truckers for different terminal can make appointments at the same time using the VoyagerTrack system. Based on terminal selection, an appointment repository will connect to different TOS databases and validate information with associated the TOS.

As illustrated in FIG. 24N, each user 2402F, 2404F, 2406F interacts with a respective web interface 2408F, 2410F, 2412F. The user may be a manager or dispatcher for different truck companies for different terminals that selects a move type such as In/Out/Dual. Based on the move type and TOS type, a repository instance is constructed for the terminal 1/TOS1 and terminal 2/TOS 2 2414F. Booking/Bill of Lading/Edo information is requested and validated using the repository instance to access data source for the terminal 1/TOS 1 2416, terminal 2/TOS 2 2418F, and for the terminal 1 or terminal 2/TOS 1 or TOS 2 2420 F. Information to create an appointment for terminal 1 or terminal 2 is received 2422F. Then, based on the TOS type, a repository instance is constructed for the terminal 1/TOS 1 and terminal 2/TOS 2 2424F. Equipment information is requested and validated using the repository instance to access a data source for the terminal 1/TOS 1 2426F. Equipment information is requested and validated using the repository instance to access a data source for the terminal 2/TOS 2 2428F. Data is received and an appointment object is constructed for each appointment 2430F. Existing data for the appointment is requested from the appointment database 2432F. Data on the single/dual appointment is displayed 2434F.

FIG. 24O is an exemplary flow diagram of an illustrative workflow process for an appointment interface with a gate operating system consistent with one or more aspects of the innovations herein. The appointment system may be used by different gate operating systems. These systems can get appointments using an interface developed using WCF (Windows Communications Foundation) services, for example, or some other interface. Each truck 2402G, 2404G, 2406G includes a RFID/UTN for respective terminal within a respective gate operating system. When a truck enters a terminal, based on RFid and OCR readings of the equipment, information to validate the UTN may be received (e.g., truck against RFID for terminal 1 or terminal 2 2408G). An appointment may be verified with a respective terminal data source. For example, a terminal gate repository instance connecting to an appointment data source may be constructed 2412G. Appointments with TOS 1 and TOS 2 data source may be validated 2414G 2416G. The best appointment from the candidate/regular/one-time visit appointments from the appointment database may be selected 2418G. The appointment object for each truck from the appointment database may be constructed 2420G. Appointment data for a gate operating system may be returned 2422G. Information may be passed back to a gate clerk. Based on the available information, the gate clerk may decide to allow the truck into terminal (e.g., if the truck is present for its scheduled appointment). Also, when the truck exits the terminal, the appointment may be updated (e.g., with information about delivered equipment from the yard).

FIG. 24P is an exemplary block diagram of an illustrative workflow process of an appointment interface with a gate operating system consistent with one or more aspects of the innovations herein. Trucking company administrators and dispatchers may create appointments. These appointments are used when trucks arrives at the gate. Gate operating systems can query appointment information to speed up the equipment pickup or equipment drop off process. Some implementations of the invention include service APIs that can be used by Gate operating systems. These APIs will make real time validation with TOS system and return appointment and equipment information to a Gate clerk. Based on this information Gate Clerk will decide to allow truck into terminal. An example of exemplary code is provided below:

```
[ServiceContract]
  public interface ITerminalGateService : ICallForwardService
  {
    [OperationContract]
    /// <summary>
    /// Returns the best appointment based on information provided
    /// </summary>
    SgResponse<IEnumerable<N4ApptInfo>> GetTargetAppointment
(TargetAppointmentRequest request);
    [OperationContract]
    /// <summary>
    /// Returns UTN of the truck based on the RFID
    /// </summary>
    SgResponse GetTruckUTN(GetTruckUTNRequest request);
    [OperationContract]
    /// <summary>
    /// Request is sent to VT when the truck is at the pre-gate
    /// </summary>
    SgResponse AppointmentInitiated
    (AppointmentInitializationRequest request);
    [OperationContract]
    /// <summary>
    /// Request is sent to VT when the Appointment needs to
remove the Initiated Status
    /// when the transaction is cancelled by Navis
    /// </summary>
    SgResponse AppointmentUnInitiated
    (AppointmentInitializationRequest request);
    [OperationContract]
    /// <summary>
    /// Request is sent to VT when smart-tecs process to Un-Initiate &
    Un-pair an
    /// Out-Move appointment from its paired Dual In-Move appointment
    /// </summary>
    SgResponse AppointmentUnInitiatedUnPaired
(AppointmentInitializationRequest request);
    [OperationContract]
    /// <summary>
    /// Request is sent to VT from an out-gate indicating that the truck
    /// has completed the appointment successfully
    /// </summary>
    SgResponse CompleteAppointment
    (CompleteAppointmentRequest request);
    [OperationContract]
    /// <summary>
    /// Request is called during the In and Out gate operations within the
    /// smart-tecs process when a subset of the entire move is
    cancelled in Navis
    /// </summary>
    SgResponse AppointmentDeleted(AppointmentDeleteRequest request);
    [OperationContract]
    /// <summary>
    /// Request is sent to VT to find out terminal operations timings
for a given date
    /// </summary>
    SgResponse<OperationsTimingsResponse>
GetTerminalOperationsTimings(DateTime dateTime);
    [OperationContract]
    /// <summary>
    /// Most likely first call of SG. Determins that truck
    can be called forwad
    /// </summary>
    /// <param name=″request″>Utn, Rfid</param>
    /// <returns>True if can be called forward, otherwise false with
    reason</returns>
    GetTruckStatusResponse GetTruckStatus
    (GetTruckStatusRequest request);
    [OperationContract]
    /// <summary>
    /// Most likely first call of SG. Determins that trucks
    can be called forwad
    /// </summary>
    /// <param name=″request″>Object with list of Utn and Rfid</param>
    /// <returns>Returns list of responses</returns>
    GetTruckStatusesResponse GetTruckStatuses(GetTruckStatusesRequest
    request);
  }
```

In FIG. 24P, a user 2402H such as a terminal administrator, truck line manager or dispatcher interacts with an appointment interface 2404H. The interface 2404H receives and transmits data with appointment system 2408H. The appointment system 2408H provides and receives appointment information from the gate operating system 2406H, which may be an external system. The appointment system requests information and receives responses from a TOS database 2410H. The appointment system provides appointment information and receives an insert/update from a VT database 2412H.

FIG. 24Q is an exemplary flow diagram of an illustrative workflow process for RFID registration consistent with one or more aspects of the innovations herein. In order to enter the terminal, each truck is required to have an RFID tag. This RFID tag is required to support the Call Forward and Gate processes. The RFID tag is registered with the truck company. Terminal Administrators may create RFID tags in the batch and assign them to trucking companies as necessary. Truck Company Administrators may manage RFIDs and assign them to individual trucks. Maintenance of RFID tags is performed using an RFID registration page. Some implementaitons of an interface for an RFID repository is provided below:

```
/// <summary>
  /// Repository for rf tags CRUD operations
  /// </summary>
  public interface IRfidRepository
  {
    /// <summary>
    /// Returns tag number by id
    /// </summary>
    /// <param name=″id″>RFID id</param>
    /// <returns>RFID number</returns>
    string GetTagNumberByID(int id);
    /// <summary>
    /// Adds rf tag
    /// </summary>
    /// <param name=″rfid″></param>
    /// <param name=″scacCode″></param>
    /// <param name=″effectiveDate″></param>
    /// <returns>response data</returns>
    Response<string> AddRfidTags(string rfid, string scacCode, DateTime
effectiveDate);
    /// <summary>
    /// Deletes specified rfid
    /// </summary>
    /// <param name=″rfid″></param>
    /// <returns>response data</returns>
    Response<string> DeleteRfid(string rfid);
    /// <summary>
    /// Updates specified RFID
    /// </summary>
    /// <param name=″rfid″></param>
    /// <returns>response data</returns>
    Response<string> UpdateRfid(Rfid rfid);
    /// <summary>
    /// Find rf tags by specifying prefix, fromNumber, toNumber or/and
by specifying scacCode
    /// </summary>
    /// <param name=″prefix″>prefix for rf tags</param>
    /// <param name=″fromNumber″>starting number for rf tags
    sequence</param>
    /// <param name=″toNumber″>ending number for rf tags
    sequence</param>
    /// <param name=″scacCode″>SCAC code to search for. Not used if
    null</param>
    /// <returns></returns>
    PagedListResponse<Rfid> FindRfidTags(IEnumerable<string> tags,
string prefix, int fromNumber, string scacCode, int page, int pageSize,
      RfidFieldKey sortKey, SortOrder sortOrder, int quantity);
    /// <summary>
    /// Find rf tags that are not assigned to any truck for given
    TruckCompany
    /// </summary>
    /// <param name=″scacCode″>SCAC code of rf tags</param>
    /// <returns>collection of available rf tags</returns>
    IDictionary<string, string> GetAvailableRfTags(string scacCode);
    /// <summary>
    /// Find rf tags that are not assigned to any truck for given
    TruckCompany
    /// </summary>
    /// <param name=″scacCode″>SCAC code of rf tag</param>
    /// <param name=″truckId″>TruckId of rf tag</param>
    /// <returns>collection of available rf tags</returns>
    IDictionary<string, string> GetAvailableRfTagsForTruck(string
scacCode, int truckId);
  }
```

A user 2402I, 2404I and 2406I provide information to create RFIDs for terminal 1 or terminal 2 2408I. The user may be a terminal administrator for any of a plurality of terminals. An RFID repository instance is constructed connecting to appointment data source 2410I. Data is received and an RFID object is constructed for each terminal and data is transmitted 2412I. Existing data for the RFID from the appointment database is requested 2414I. Data on RFID registration is displayed 2416I.

FIG. 24R is an exemplary flow diagram of an illustrative workflow process for truck company registration consistent with one or more aspects of the innovations herein. Truck Company registration is provided for a truck line company which is authorized to receive and deliver equipment to the terminal. Each truck line company includes registered trucks. Some implementations of truck company registration include the exemplary code provided below:

```
public interface ITruckCompanyProfileRepository
  {
    /// <summary>
    /// Checks if passed SCAC code exists
    /// </summary>
    /// <param name=″scac″>SCAC code</param>
    /// <returns>true if exists, otherwise false</returns>
    bool IsScacCodeExist(string scac);
    /// <summary>
    /// Checks if passed trucklineName and scac code exist
    /// </summary>
    /// <param name=″trucklineName″>name of truck line</param>
    /// <param name=″scac″>SCAC code</param>
    /// <returns>true if exists, otherwise false</returns>
    bool IsTrucklineNameExist(string trucklineName, string scac);
    /// <summary>
    /// Checks if passed usDot and scac code exist
    /// </summary>
    /// <param name=″usDot″>usDot</param>
    /// <param name=″scac″>SCAC code</param>
    /// <returns>true if exists, otherwise false</returns>
    bool IsUsDotExist(string usDot, string scac);
    /// <summary>
    /// Adds passed TruckCompanyProfile
    /// </summary>
    /// <param name=″profile″></param>
    /// <returns></returns>
    Response<string> AddTruckCompanyProfile
    (TruckCompanyProfile profile);
    /// <summary>
    /// Updates passed TruckCompanyProfile
    /// </summary>
    /// <param name=″profile″></param>
    /// <returns></returns>
    Response<string> UpdateCompanyProfile(TruckCompanyProfile
    truckCompanyProfile);
    /// <summary>
    /// Deleted passed TruckCompanyProfile
    /// </summary>
    /// <param name=″scacCode″></param>
    /// <returns></returns>
    Response<string> DeleteCompanyProfile(string scacCode);
    /// <summary>
    /// Looks for TruckCompanyProfile corresponding to passed
    search criteria
    /// </summary>
    /// <param name=″request″></param>
    /// <returns>collection of found TruckCompanyProfiles</returns>
    PagedListResponse<TruckCompanyProfile>
FindTruckCompanyProfiles(TruckCompanyProfileSearchRequest request);
    /// <summary>
    /// Checks if passed pattern and scac code exist
    /// </summary>
    /// <param name=″pattern″>UTN pattern</param>
    /// <param name=″scac″>SCAC code</param>
    /// <returns>true if exists, otherwise false</returns>
    bool IsUtnPatternExist(string s, string pattern);
    /// <summary>
    /// Check if truck line is denied.
    /// </summary>
    /// <param name=″trklineCode″>Truck line code (SCAC code)</param>
    /// <returns>True if denied, otherwise false</returns>
    bool IsTrucklineDenied(string trklineCode);
    /// <summary>
    /// Retreives truck company profiles for matching SCAC codes.
    /// </summary>
    /// <param name=″scacCodes″>List of SCAC codes</param>
    /// <returns>List of <see cref=″TruckCompanyProfile″/></returns>
    IList<TruckCompanyProfile>
    FindTruckCompanyProfiles(IList<string> scacCodes);
```

A user 2402J, 2404J and 2406J provides information to create truck line terminal 1 or 2 2408J. The user may be a truck company manager for different truck companies for any of a plurality of terminals. A truck company repository instance is constructed connecting to appointment data source 2410J. Data is received and a truck line object is constructed for each truck line and data is transmitted 2412I Existing data for the truck line from the appointment database is requested 2414J. Data on a truck company profile is displayed 2416J.

FIG. 24S is an exemplary flow diagram of an illustrative workflow process for making a pickup container with an appointment consistent with one or more aspects of the innovations herein. A trucker arrives at a gate and requests a container 2420J. The gate system in the TOS requests appointment information 2422J. A determination is made whether appointment information is available 2432J. If not, an error is determined 2434J. If available, the gate system in the TOS processes the transaction and completes the appointment 2436J. After requesting appointment information 2422J, the appointment associated with the container is determined 2424J by the appointment system. A determination is performed of whether the appointment/container information is available 2426J. If no appointment is found, then a determination is performed of whether the pseudo-appointment is allowed 2428J. If a pseudo-appointment is allowed, then a pseudo-appointment is created 2430J.

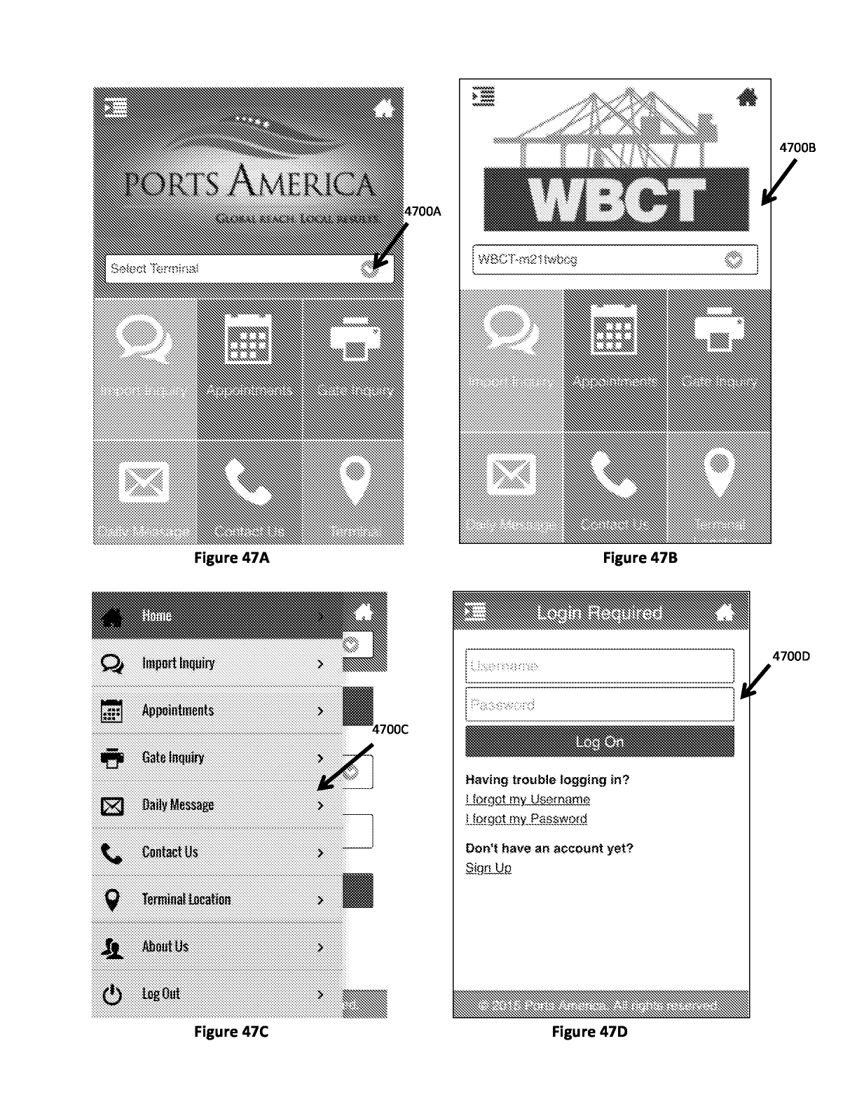

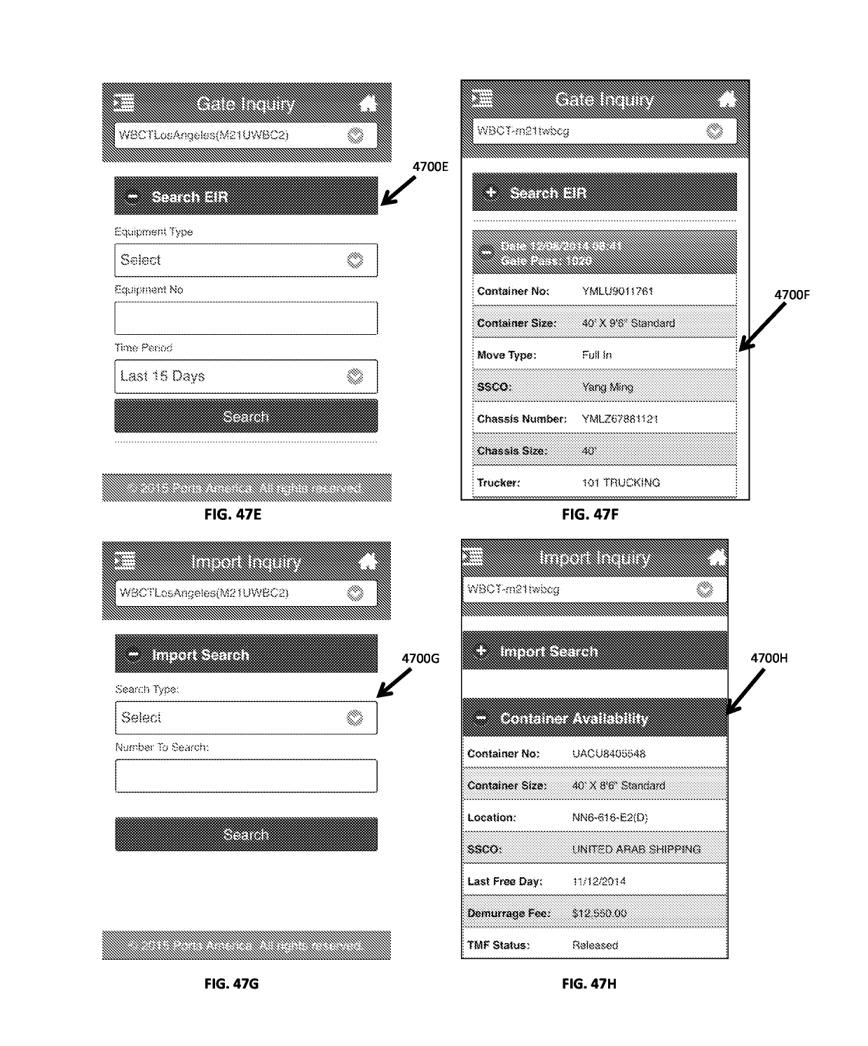

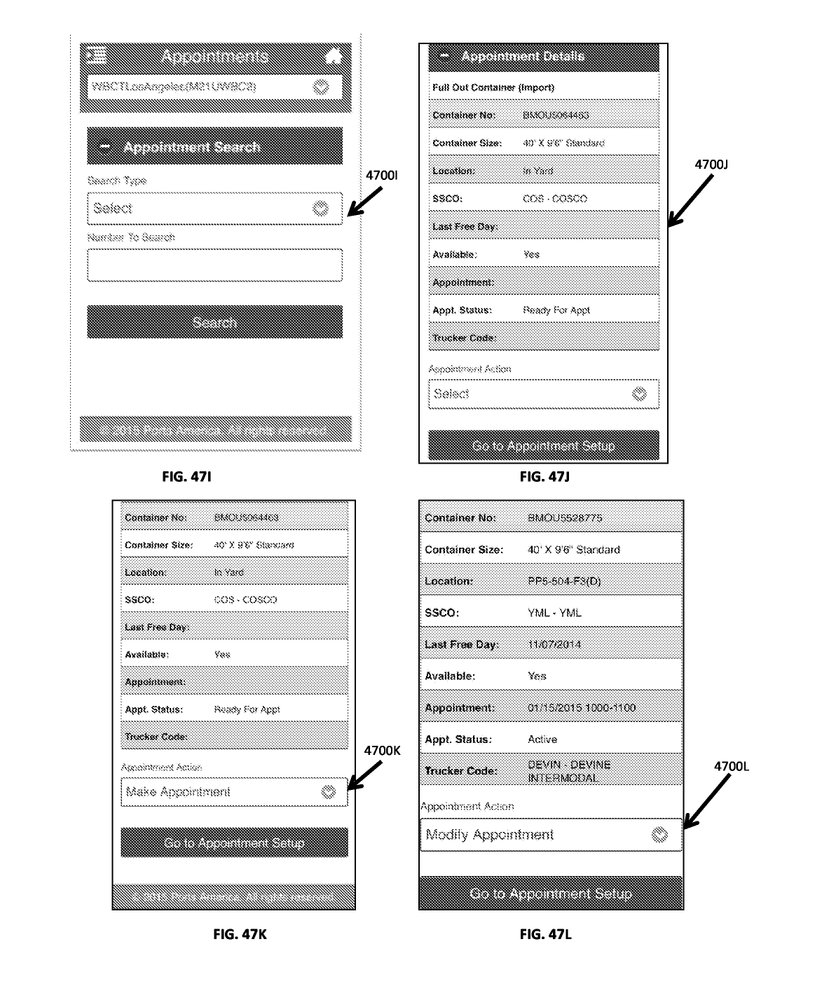

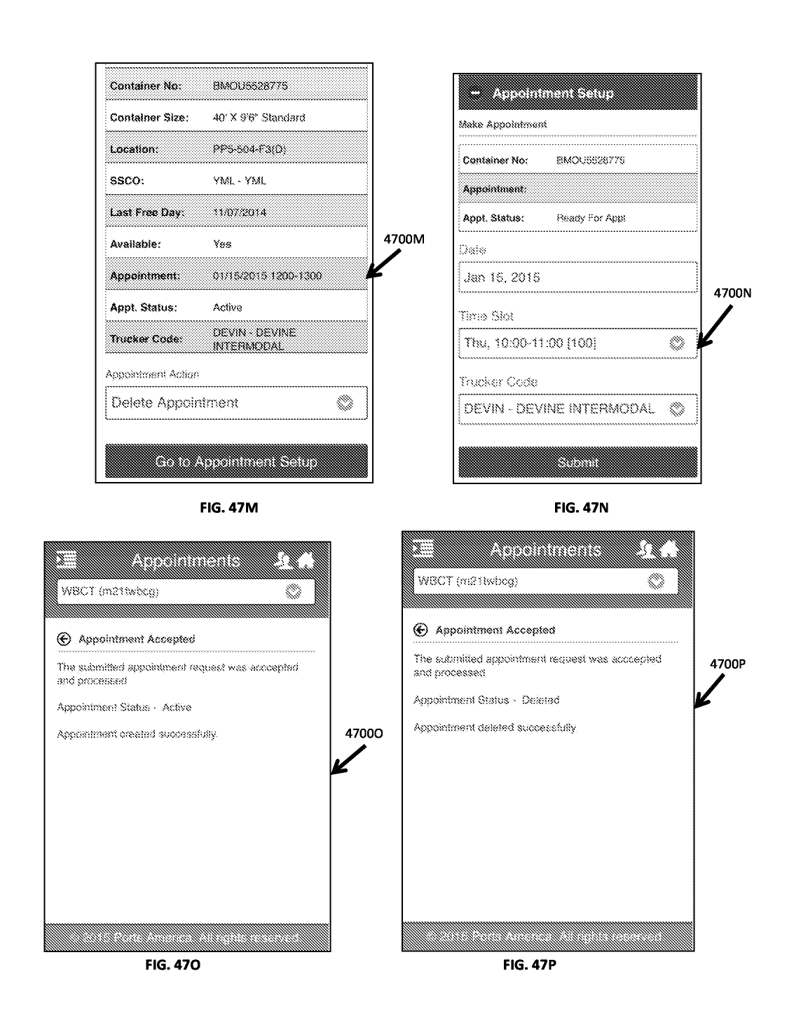

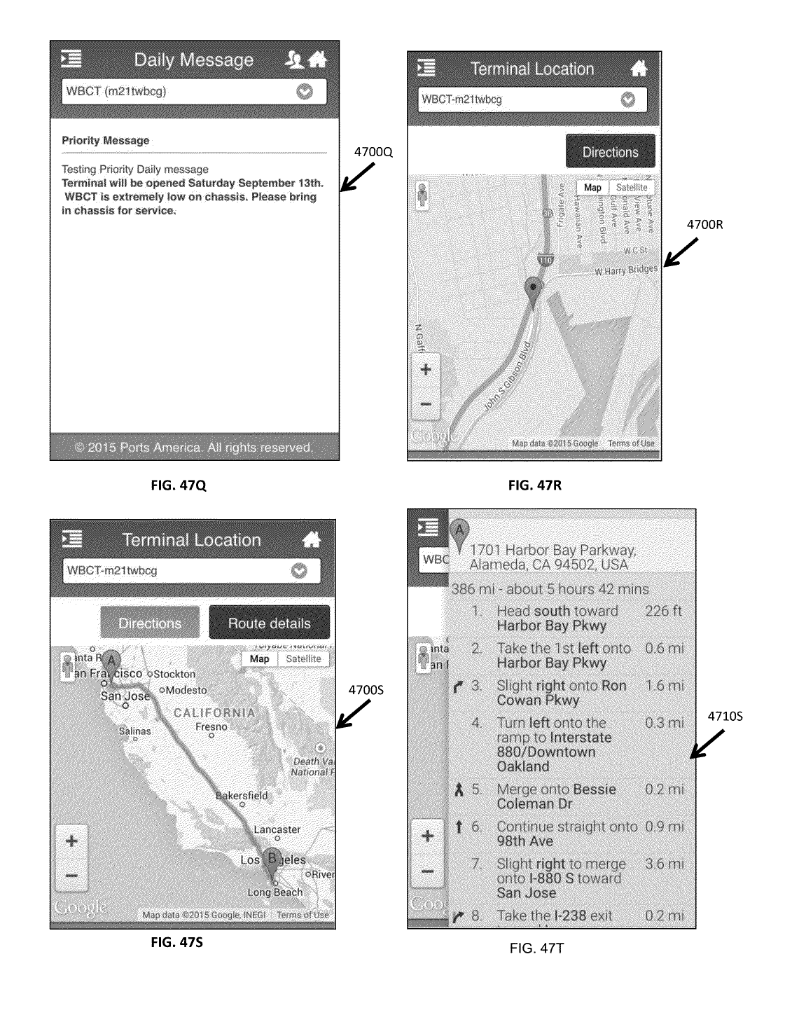

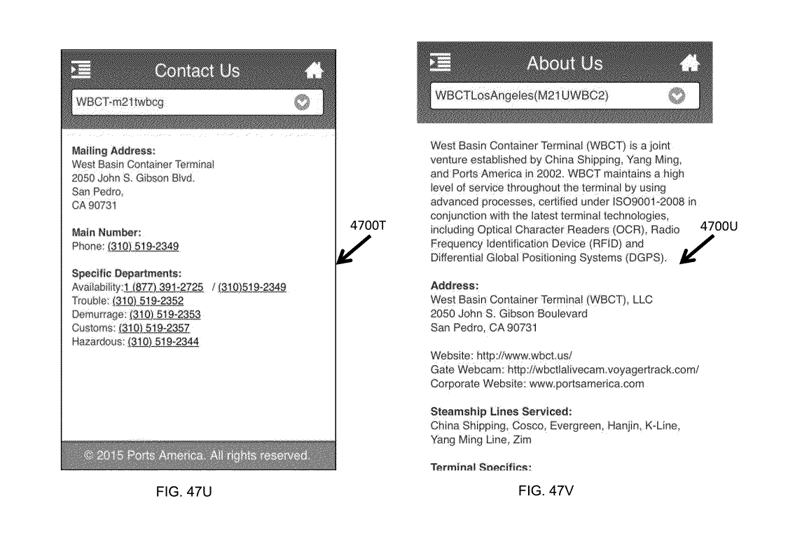

FIG. 25A-25V are diagrams of exemplary appointment user interfaces consistent with one or more aspects of the innovations herein including the ability to manage appointments. Further, various features and associated system/server processing of the present inventions, such as the appointment system functionality set forth herein, may also be implemented via or in connection with a mobile application and associated mobile device interface, wherein an illustrative mobile device interface for such innovations is set forth in FIGS. 47A-47U and the associated written description.

In particular, in FIGS. 25A and 25B, a user can make, modify, delete and view appointment information for Empty In containers, as well as run a specified query that allows user to work on Empty In appointments. Time slot 2502 allows a user to view the quantity of appointments available for a specific time slot and allows a user to select a specific time slot for an empty in container appointment. Hide 2504 allows a user to filter empty containers out of the appointment list view such that the selected containers will not display. The hide filter can be added and removed as desired. Container Return Status 2506 validates the empty return status of an empty in container against the steamship company assignment. Here, implementations herein will transmit/process information with the TOS to determine or verify status or data regarding return and return status of the container, and/or perform various other empty in checker functionality set forth herein. For example, when a steamship company, container equipment information such as size type, etc. have been identified, processing may be performed to provide the correct return status as well as automatically authorize entry of the equipment to the terminal. In some implementations, the Empty In Container return status 2506 includes functionality to reference data from the TOS system to determine the condition of a container. If not acceptable to return, then the TOS returns the reason the container is not acceptable. Further, systems and methods may include or involve TOS-Agnostic processing, features and functionality set forth elsewhere above. Turning back to the figure, Stray/Empty Containers 2508 allows a user to disassociate an appointment for an empty in container that has been defined as a dual move appointment (empty in and full out). This feature allows the empty in container to move without the full out move.

FIG. 25C illustrates an exemplary GUI where a user can make, modify, delete and view appointment information for bookings such as export bookings. Time Slot 2510 allows user to view the quantity of appointments available for a specific time slot and allows a user to select a specific time slot for an export booking appointment. Dual Empty Out Move 2512 allows a user to make two appointments for different move types (e.g., Full In export move and Empty Out) simultaneously. Additional processing of selections and or functionality shown here is set forth in further detail in connection with FIG. 21. As a function of such features, improvements in technical utilization of the system are achieved, including avoiding any additional processing to contact the terminal directly, so as prevent a step previously undertaken, providing innovative validation processing that prevents various unnecessary system action and processing, such as the setting of an invalid appointment where, for example, a truck arrives to deliver cargo when a ship has already departed.

FIG. 25D-25E illustrates an exemplary GUI where a user can make, modify, delete and view import appointment information for import containers. FIG. 25D shows the import container appointment made while FIG. 25E described below illustrates the import container appointment display before final selection. Notify 2590, 2514 allow a user to request container appointment availability notification based on the container status (i.e., ‘Ready For Appt’, ‘Not Ready For Appt’). Time Slot 2592, 2516 allow a user to view the quantity of appointments available for a specific time slot and allows a user to select a specific time slot for an import container appointment. Dual Empty In Move 2594, 2518 allow a user to make two appointments for different move types (Empty In and Full Out import move) simultaneously. By means of the selection of these features, processing is performed via the system to allow a user to receive or otherwise be advised of notification information regarding changes to the status of the appointment. For example, with regarding various import container ‘out’ processing, here, present implementations may automatically perform and/or involve processing associated with bringing or returning the empty containers ‘in’. As a function of such features, improvements in technical utilization of the system are achieved, including implementations to make a dual move appointment by inputting a container and SSCO information further able to define and perform processing associated with an empty in move and/or a dual move. Additionally, further processing and innovations, here, may be provided via features and functionality associated with the BOL routine as set forth in FIG. 25L. For example, various appointment processing may be performed before a container is available.

FIG. 25F illustrates an exemplary GUI for single/dual appointment settings. Select Single/Dual Appointment option 2501 may be selected from an Appointments menu tab to make a new single/dual appointment. A user will have the option to make a single or dual move appointment by selecting specified move types 2503.

FIGS. 25G-25V are diagrams of exemplary Appointment user interfaces consistent with one or more aspects of the innovations herein. FIG. 25G illustrates an exemplary GUI for single/dual appointment settings for a single appointment. A plurality of move types 2509 are available for selection after selecting one or both of an In and Out move. The move type 2509 may be selected from a drop down menu. Thereafter, appointment details may be entered based on the move type 2509 selected. FIG. 25G illustrates a user selection of an In move and the display of a drop down menu for selection of Export In, Empty In, Import Dray-In and Bare Chassis In options.

FIG. 25H illustrates an exemplary GUI for single/dual appointment settings for a single appointment. A plurality of move types 2515 are available for selection after selecting one or both of an In and Out move. The move type 2515 may be selected from a drop down menu. Thereafter, appointment details may be entered based on the move type 2515 selected. FIG. 25H illustrates a user selection of an Out move and the display of a drop down menu for selection of Import Out, Empty Out, Export Dray-Off and Bare Chassis Out options.

FIG. 25I illustrates an exemplary GUI for single/dual appointment settings for a dual appointment. A plurality of move types 2519 are available for selection after selecting one or both of an In and Out move. The move type 2519 may be selected from a drop down menu. Thereafter, appointment details may be entered based on the move type 2519 selected. FIG. 25I illustrates a user selection of an In move and an Out move and the display of a drop down menu for selection of In moves: Export In, Empty In, Import Dray-In and Bare Chassis In and Out moves: Import Out, Empty Out, Export Dray-Off and Bare Chassis Out options, respectively. Export In is selected as the move type 2519 for the In move.

FIG. 25J illustrates an exemplary GUI for single/dual appointment settings for an appointment header booking. Booking inquiries are performed for the move types Export In and Empty Out. To begin certain booking inquiry processing for an Export In or Empty Out appointment, a booking number 2523 is entered. The booking information corresponding to the booking number is presented from the TOS to provide the details regarding the received equipment and cutoff of delivered equipment to the terminal. The information may also include details regarding hazardous cargo. Booking information is displayed in FIG. 25J as Booking status 2525, Booking summary results 2527 and appointment details 2529. Based on the data displayed in FIG. 25, a user may decide how to proceed with the transaction. Additional processing, here, is set forth in further detail in connection with FIG. 21. As a function of such features and functionality, a user is able to search for a single booking inquiry or a plurality of booking inquiries, and is returned status information for all bookings for equipment.

For booking inquiries, an initial validation processing is performed to determine if the status of the booking is valid, booking not found or past booking (where ship/cargo departed). If the status of the booking is not found in the TOS, then a dispatcher (e.g., trucking company) is notified to reach out to the steamship company to determine why the booking information is not present in the TOS. This feature prevents users from contacting the port terminal directly, so as avoid a step previously undertaken. Furthermore, the validation process performed prevents the setting of an invalid appointment where, for example, a truck arrives to deliver cargo when a ship has already departed.

FIG. 25K illustrates an exemplary GUI for single/dual appointment settings for an appointment header bill of lading. Bill of Lading inquiries are performed for an Import Out move type. For an Import Out appointment, a bill of lading number(s) 2533 is entered to perform bill of lading inquiry. The bill of lading information corresponding to the bill of lading number is presented. Bill of lading information is displayed in FIG. 25K as status 2535, summary results 2537 and appointment details 2539.

If a bill of lading is valid, then appointment details 2539 will appear for a user to make an appointment. A bill of lading inquiry will return one of a valid bill of lading, bill of lading not found or all containers delivered on bill. If a valid status is returned, then a user can make an appointment to pick up cargo. A first validation process is performed to provide one of the three statuses discussed above. Then, for a valid status, a second validation process is performed. A user is able to make the appointment, and review freight status, customs status, and other hold information. A hold status may indicate hold or released. If a hold is in place, the user may still make an appointment and returns a pending status, not active/completed status. If a user makes the appointment while under a hold, the system may automatically advance the status/processing once the hold is lifted so as to automatically switch the status from pending to active. Under a pending status, a notification is processed and includes reason for the pending/hold status. Then, when the status switches to active, another notification is generated to a user that indicates the next available steps (e.g., deliver or pickup cargo).

FIG. 25L shows an exemplary sequence diagram involving an illustrative bill of lading (BOL) process and TOS agnostic processing consistent with one or more aspects of the innovations herein. Referring to FIG. 25L, illustrative processing may begin at step 2536 where a user logs into a Terminal A via a web-based user interface and inputs a request for bill of lading information for the Terminal A database. For example, a user may request information for a bill of lading number BK123456. Next, the TOS Agnostic service 2534 receives and processes the user request for the bill of lading information. The service 2534 calls a FindBOL method 2542 in import service 2544. The import service 2544 implements methods related to import business processes. The FindBOL method 2542 is processed by BOL repository 2572. The import service 2544 first requests a BOL repository instance from the repository factory 2554 using the GetBOLRepository method. The repository factory 2554 is a repository locator that returns the repository instance for Terminal A. The repository factory 2554 requests a bill of lading repository for Terminal A using the GetInstance method. The BOL repository 2572 retrieves and stores the bill of lading information for Terminal A from a Terminal A database.

Next, the FindBOL method 2558 is defined in the import service 2544 to call the FindBOL method 2576 of the BOL repository 2572 to request the bill of lading information corresponding to BOL number BK123456 of Terminal A. FindBOL method 2576 accesses the Terminal A database and obtains the requested bill of lading information from the Terminal A database as BOL entities 2578. The BOL entities 2578 are then stored in the BOL repository 2572 as bill of lading objects 2560. For instance, the BOL entities 2578 retrieved from the Terminal A as raw data that are converted/translated into a bill of lading business object 2560. The bill of lading objects 2560 are then returned to the import service 2544.

Further, GetContainer 2562 is an internal method call to retrieve container information related to the requested bill of lading. Similar to the GetBOLRepository method, the import service 2544 executes a GetContainer method 2568 to the repository factory 2554 to obtain container information corresponding to the bill of lading information requested by the user. GetInstance method 2564N requests a container repository 2580 instance for the Terminal A. The GetContainers method 2568 implemented by the import service 2544 requests the container data related to the bill of lading information from the container repository 2580. The container repository 2580 retrieves data related to import containers corresponding to the bill of lading number from the Terminal A database using the GetContainers method 2584. In response, the Terminal A database transmits the requested data as container entities 2586. The BOL entities 2578 and container entities 2586 are provided in the format of the Terminal A operating system incompatible with the format of other Terminal Operating Systems. Therefore, the container repository 2580 converts/translates the raw container data 2586 of the Terminal A into a container object 2570 to be added to the container repository 2580. Once the BOL object 2560 and corresponding container object 2570 are returned to the import service 2544, then the bill of lading and container objects collection 2546 are returned to the TOS Agnostic service 2534. The TOS Agnostic service 2534 processes the business object data 2546 and displays bill of lading and container objects 2548 to the user via a web-based user interface.

FIG. 25M illustrates an exemplary GUI for single/dual appointment settings for an appointment header Equipment Delivery Order (EDO). EDO inquiries are performed for an Empty Out and Bare Chassis Out move type. For appointments for each of these move types, an EDO number(s) 2543 is entered to perform an EDO inquiry. The EDO information corresponding to the EDO number 2543 is presented. EDO information is displayed in FIG. 25M as status 2545, summary results 2547 and appointment details 2549. If a valid EDO is provided, then appointment details 2549 will be displayed. When looking for a booking, the EDO record may also be searched. However, this is different than bill of lading and is more similar to a find booking function for export in.

FIG. 25N shows an exemplary sequence diagram involving an illustrative EDO process and TOS agnostic processing consistent with one or more aspects of the innovations herein.

FIG. 25N shows an exemplary sequence diagram involving an illustrative EDO process and TOS agnostic processing consistent with one or more aspects of the innovations herein. Referring to FIG. 25N, illustrative processing may begin at step 2536N where a user logs into a Terminal A via a web-based user interface and inputs a request for EDO information for the Terminal A database. For example, a user may request information for a EDO number BK123456. Next, the TOS Agnostic service 2534N receives and processes the user request for the EDO information. The service 2534N calls a FindEDO method 2542N in empty service 2544N. The empty service 2554N implements methods related to empty business processes. The FindEDO method 2542N is processed by EDO repository 2572N. The empty service 2544N first requests a EDO repository instance from the repository factory 2554N using the GetEDORepository method. The repository factory 2554N is a repository locator that returns the repository instance for Terminal A. The repository factory 2554N requests a EDO repository for Terminal A using the GetInstance method. The EDO repository 2572N retrieves and stores the EDO information for Terminal A from a Terminal A database.

Next, the FindEDO method 2558N is defined in the empty service 2544N to call the FindEDO method 2576N of the EDO repository 2572N to request the EDO information corresponding to EDO number BK123456 of Terminal A. FindEDO method 2576N accesses the Terminal A database and obtains the requested EDO information from the Terminal A database as EDO entities 2578N. The EDO entities 2578N are then stored in the EDO repository 2572N as EDO objects 2560N. For instance, the EDO entities 2578N retrieved from the Terminal A as raw data that are converted/translated into a EDO business object 2560N. The EDO objects 2560N are then returned to the empty service 2544N.

Further, GetContainer 2562N is an internal method call to retrieve container information related to the requested EDO. Similar to the GetEDORepository method, the empty service 2544N executes a GetContainer method 2568N to the repository factory 2554N to obtain container information corresponding to the EDO information requested by the user. GetInstance method 2564N requests a container repository 2580N instance for the Terminal A. The GetContainers method 2568N implemented by the empty service 2544N requests the container data related to the EDO information from the container repository 2580N. The container repository 2580N retrieves data related to empty containers corresponding to the EDO number from the Terminal A database using the GetContainers method 2584N. In response, the Terminal A database transmits the requested data as container entities 2586N. The EDO entities 2578N and container entities 2586N are provided in the format of the Terminal A operating system incompatible with the format of other Terminal Operating Systems. Therefore, the container repository 2580N converts/translates the raw container data 2586N of the Terminal A into a container object 2570N to be added to the container repository 2580N. Once the EDO object 2560 and corresponding container object 2570N are returned to the empty service 2544N, then the EDO and container objects collection 2546N are returned to the TOS Agnostic service 2534N. The TOS Agnostic service 2534N processes the business object data 2546N and displays EDO and container objects 2548N to the user via a web-based user interface.

FIG. 25O illustrates an exemplary GUI for single/dual appointment settings for appointment details. Appointment details include UTN types including trip leased 2553, one-time visitor 2555 and registered UTN 2555. A trip leased option refers to, for example, a sharing agreement of trucks, which requires further input that may be validated by the system. A one-time visitor provides an option for a user who hasn't registered equipment to come into the terminal for a one-off reason. A time slot 2557 allows a user to view the quantity of appointments available for a specific time slot and allows the user to select a specific time slot for an appointment as well as a candidate appointment 2559. A candidate appointment is an option to not commit to an appointment time. There is a commitment to delivery or pickup, but not of a time. The reservation may be set without a specific time.

FIG. 25P illustrates an exemplary GUI for single/dual appointment settings for submitting an appointment for validation. After entering appointment details for a specified move, appointment information details and TOS validation are submitted. If VT appointment validation 2563 displays errors 2565 based on appointment details information, then the system will remain on the appointment page until errors are corrected and resubmitted.

FIG. 25Q illustrates an exemplary GUI for single/dual appointment settings for a secondary validation process. A booking may issue with errors that must be resolved. The issues may be fixed by VoyagerTrack or by contacting the entities involved. A Result Message Details page 2569 will be returned with final TOS validation and includes remarks 2571. Once all fields entered and submitted by the user, an initial validation process is performed. Validation is performed from an initial inquiry, through intermediate pieces, to validate and determine/provide final appointment to be performed. Validation associated with all fields is performed to confirm/validate information and status with various TOSes or other databases to provide the final, validated appointment.

FIG. 25R illustrates an exemplary GUI for single/dual appointment settings for a modifying appointment details 2579. After successfully submitting an appointment, the user can modify appointment by buttons 2577 to pair single or unpair dual move appointments, clear the appointment page and make new appointments, change Booking, Bill of Lading or EDO, and modify/delete appointment details and resubmit for validation. In this manner, a user is provided GUI functionality to modify an appointment, such as by pairing a single appointment to create a dual entry appointment, unpairing a dual move to create single appointment, clearing, changing Booking/BOL/EDO. Validation is performed on all appointment details.

FIG. 25S illustrates an exemplary GUI for single/dual appointment settings for a pairing appointments. Existing single move appointments 2583 can be paired from Modify Appointment page see by selecting pair button 2585 to pair existing single move appointment with another existing single move appointment. A search for existing appointments can be performed by date range, UTN or appointment ID. From any existing single In move appointment, only the user can add a new single Out move 2583 appointment to thereby create a dual move appointment.

FIG. 25T illustrates an exemplary GUI for single/dual appointment settings for unpairing appointments. A dual move appointment can be unpaired from a Modify Appointment page by selecting an unpair button 2589 to unpair existing dual move appointment, resulting in two single move appointments. When dual move appointment is unpaired, the UTN and Appointment Date/Time from the original dual appointment will apply to both appointments.

FIG. 25U illustrates an exemplary GUI for single/dual appointment settings for changing a Booking/Bill of Lading/EDO. Appointment booking/bill of lading/EDO can be changed for active and pending appointments in the following manner. For an existing appointment for an export in, empty out, import out or bare chassis out select change booking/bill of lading/EDO button 2593. The system will prompt the user to enter booking/bill of lading/EDO number and if valid, the user can apply the change. In some implementations, functions illustrated in FIG. 25U utilize processes associated with FIG. 25L (Find Bill of Lading) and FIG. 25N (Find EDO).

FIG. 25V illustrates an exemplary GUI for single/dual appointment settings for deleting appointment details. After successfully submitting appointment user can delete specific equipment appointments using a delete option 2597, for instance. A delete action may result in unpairing action, such that if an appointment associated with a dual move is deleted, the system will automatically trigger an unpairing action.

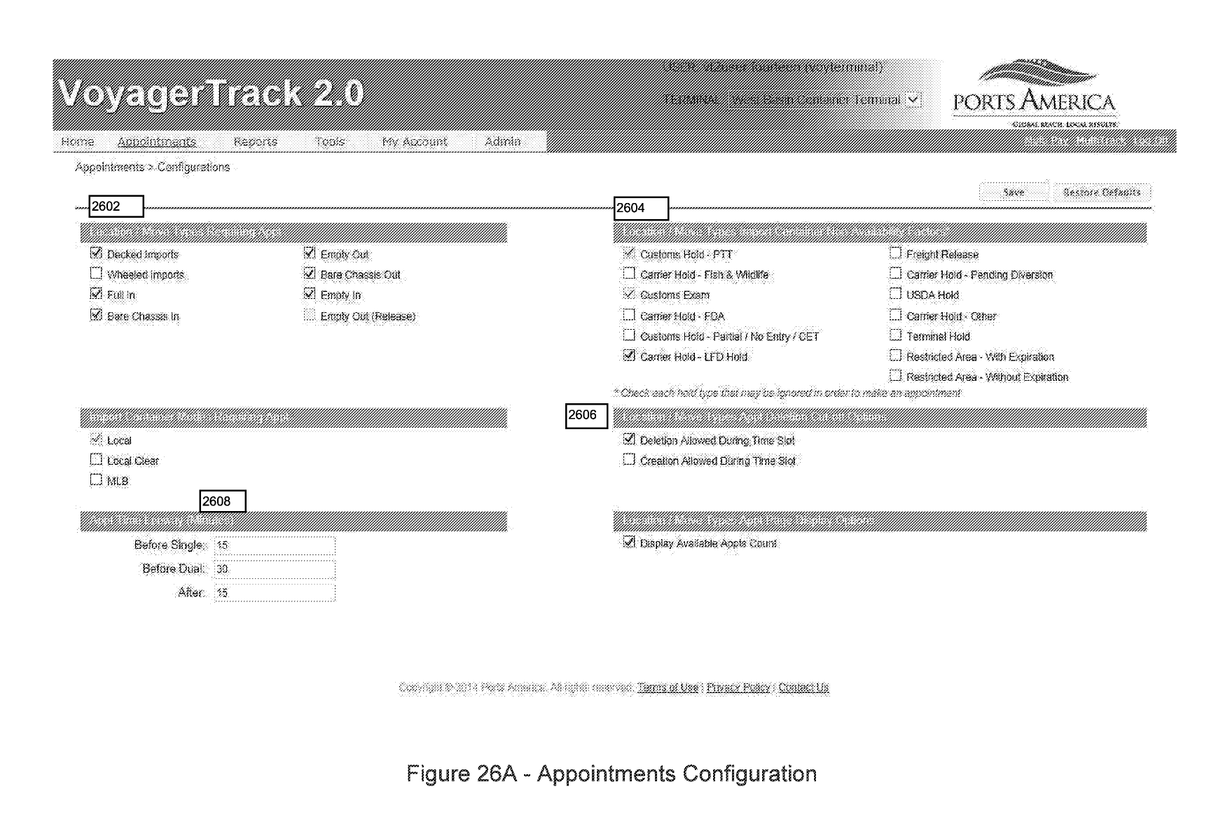

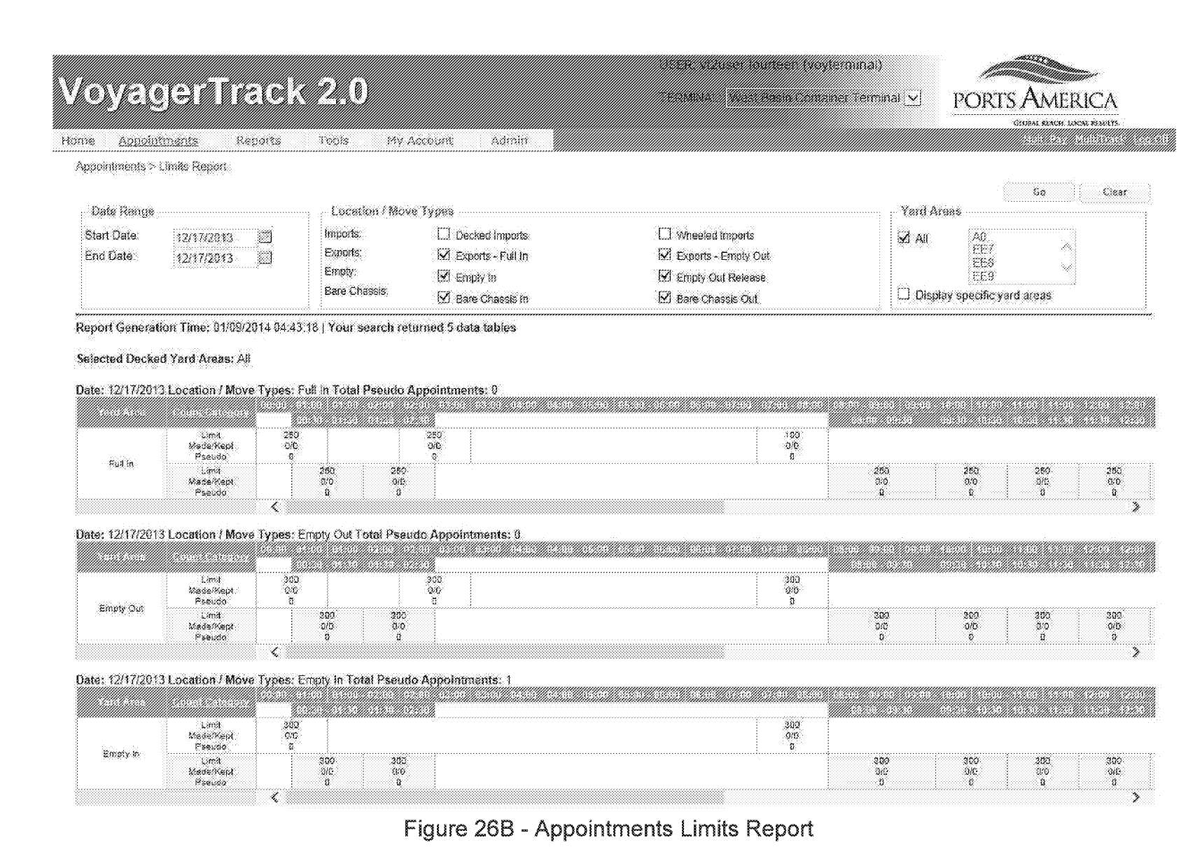

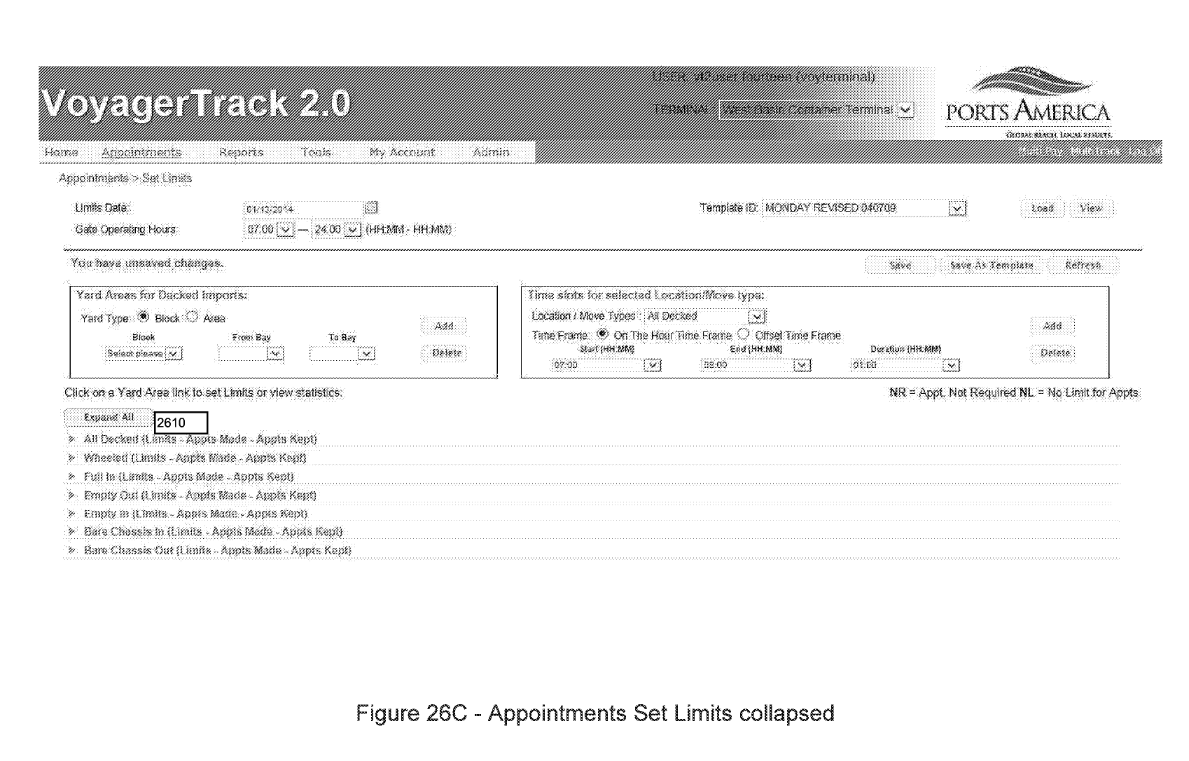

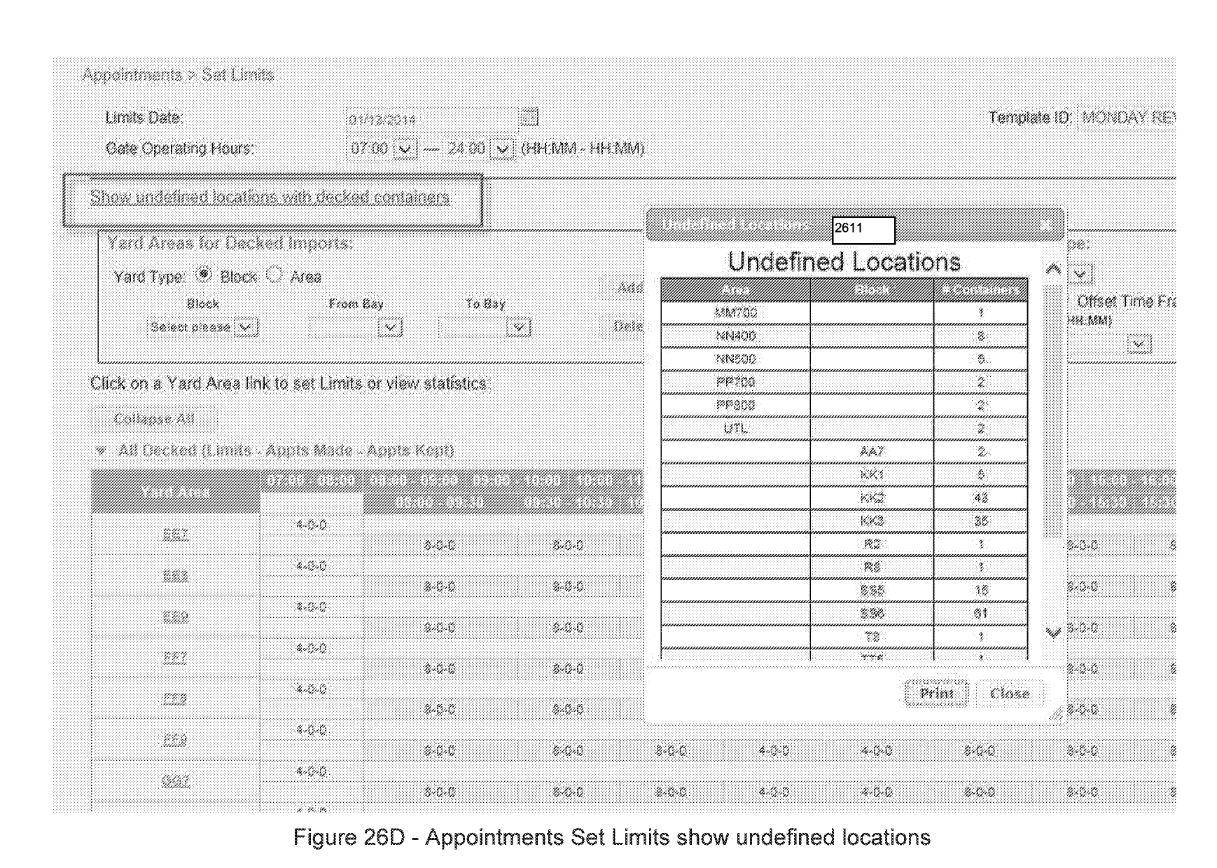

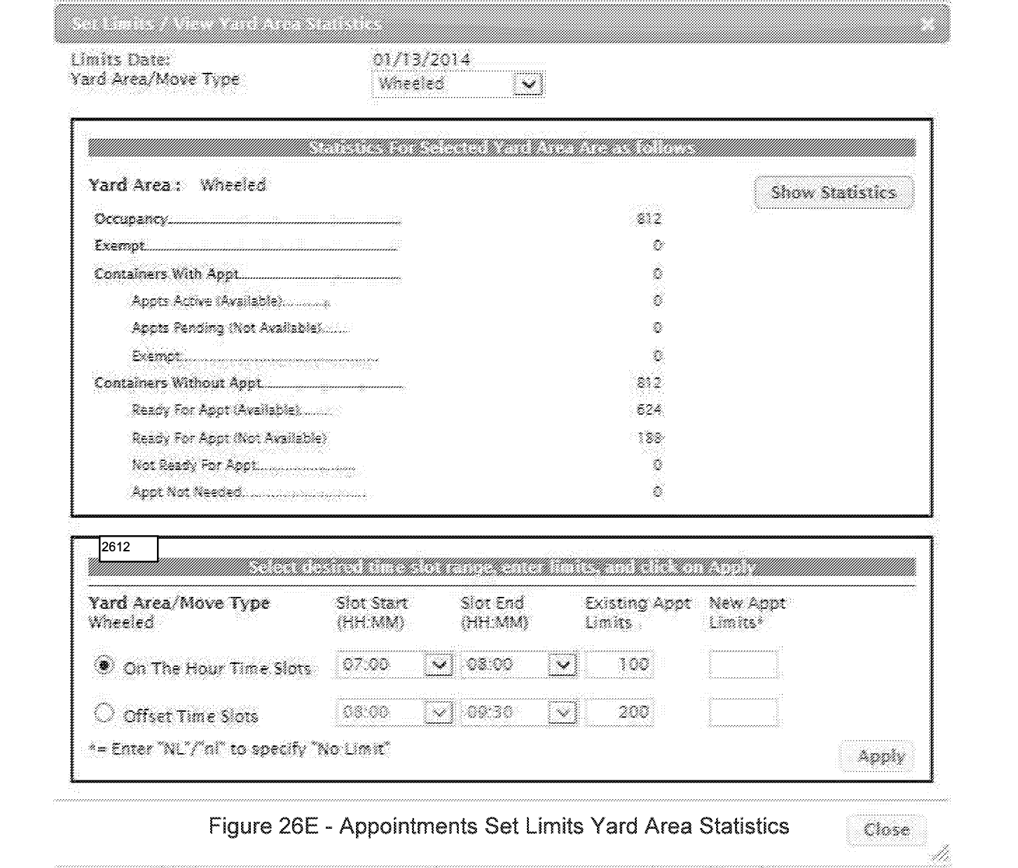

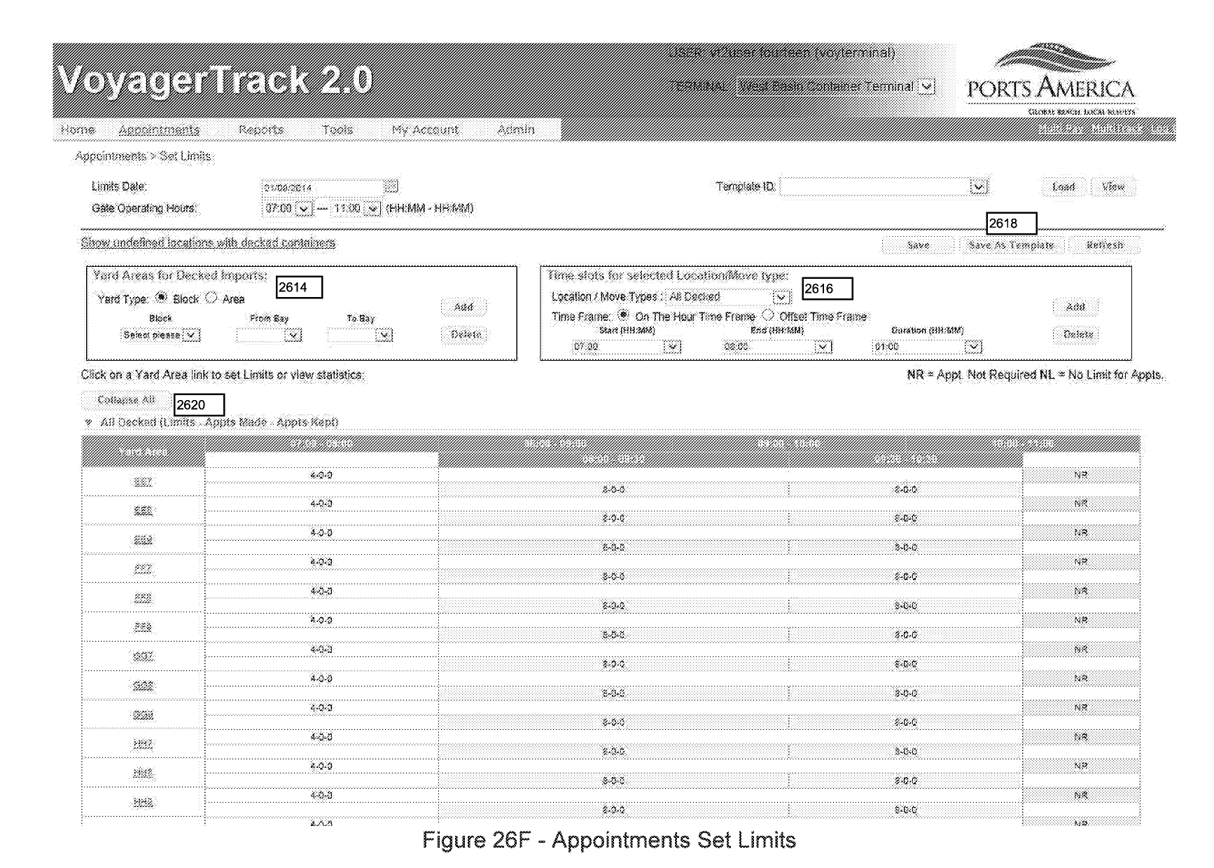

FIGS. 26A-41 below set forth various features and functionality of an appointment system, shown by way of illustration in a traditional desktop display. Further, various features and associated system/server processing of these inventions, such as the appointment system functionality set forth herein, may also be implemented via or in connection with a mobile application and associated mobile device interface, wherein an illustrative mobile device interface for such innovations is set forth in FIGS. 47A-47V and the associated written description.

In FIG. 26A, an administrator can set the configuration for the Premier Appointment System (PAS) for the current terminals and set various configuration values. Location/Move Types Requiring Appointments 2602 allows a user to configure the requirement to have an appointment for all move types as well as specific import container modes. Appointment limit 2602 is provided where all equipment moves are defined by specific move types for making appointments. For example, each move type may be associated with a different limit requirement. Location/Move Types Import Container Non-Availability Factors 2604 allows a user to configure to exclude specific import container availability factors requiring an appointment. In implementations here, for example, various appointment functionality (e.g., regarding status, notifications, etc., set forth elsewhere herein) may be performed even when the particular action may be on hold to otherwise prevent such processing. Location/Move Types Import Container Appointment Deletion Cut-Off Options 2606 allows a user to configure options that allow trucking company users to either delete or create appointments within the given time slot which provides user with fluidity to change appointments at any time. Appointment Time Leeway 2608 allows a user to configure and define appointment time leeway that allows truckers to arrive within a defined margin before and/or after their scheduled appointment time. As a result of these features and functionality, systems and methods herein may be configured to automatically plan and position containers for outbound operations such as delivery as well as coordinate space and other terminal requirements for inbound containers and operations.

FIG. 26B illustrates an exemplary GUI of an Appointment Limit Report where the limits report displays the time slots and appointment statistics for the selected date range, location/move type and yard area(s). FIG. 26C illustrates an exemplary GUI where an administrator can set limits including setting gate operating hours, time slots and appointment limits for the current terminal for a selected date. Templates of settings can be saved and applied. Appointment statistics of yard areas can be viewed and appointments may be cancelled. Set Limits Collapsed View 2610 allows a user to collapse and expand the view for all move types. FIGS. 26B-26C are manifestations of how the terminal may be automatically managed and configured as a function of appointment limits, information regarding vessel loading, vessel discharging, yard activities, by move types. As a function of such features, improvements in technical utilization of the system are achieved, including planning and positioning of cargo in the container yard delivered by vessel, rail and/or truck, and limit setting to control truck flow volume/traffic. The terminal may set limits as a function of move types, vessel status, container capacity, etc.

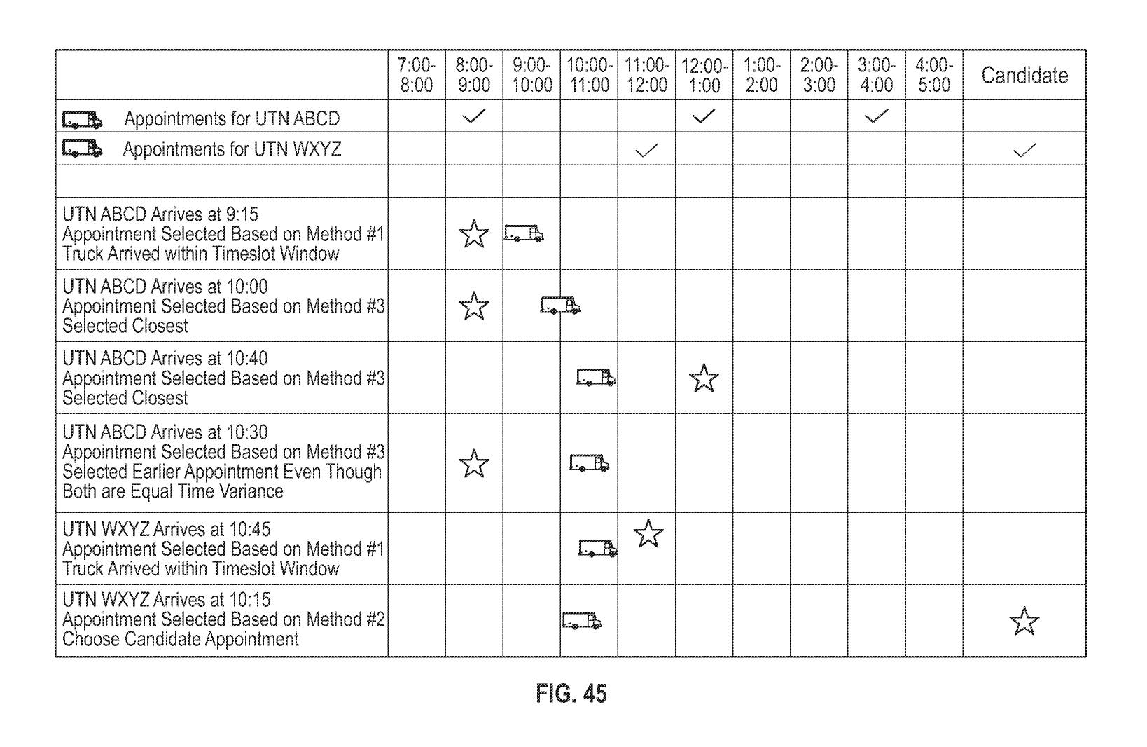

FIG. 26D illustrates an exemplary GUI wherein, with respect to administrator appointment set limits functionality, an illustrative Set Limits Undefined Location 2611 interface or functionality is shown. With regard to this feature, from the Appointments Set Limits page, systems and methods herein provide a view of undefined yard locations by area or block that do not have appointment limits set. A user such as an administrator may utilize the GUI to determine areas of a yard that haven't set limits yet by providing, for example, the number of containers in a predetermined area, so as to control traffic flow. Additional processing of selections and or functionality shown here is set forth in further detail in connection with FIG. 45.

FIG. 26E illustrates an exemplary GUI where an administrator can view a limit report display of the time slots and appointment statistics of a selected date range, location/move type and yard area(s). Set Limits View Yard Area Statistics 2612 allows a user to view statistics from specified yard areas and update the appointment limits for a specific yard area and time slots. Also, the user, such as an administrator, is able to define new appointment limits.

The pop-up windows and associated features shown in FIGS. 26D-26E provide an administrator with a graphical summary of container and/or limit information, which may be utilized to enable improved management of the container yard.

FIG. 26F illustrates an exemplary GUI where an administrator can set limits as set described herein. Yard Areas for Decked Imports 2614 allows user to define specific import decked yard areas by block or area yard types. Time Slots for Selected Location/Move Type 2616 allows a user to define specific time slots for all container and chassis move types. Template 2618 allows a user to create and save custom templates for applying predefined appointment limits. Set Limits collapsed View 2620 allows a user to collapse and expand the view for all move types. More generally, FIG. 26F provides a statistical report where a user sets limits and allows limit templates to be determined. The flow of equipment in/out and traffic in/out is managed to automatically reduce bottlenecks at the gate, in the yard, to reduce and/or eliminate inefficiencies. As a function of the limits that an administrator may set via such GUI, systems and methods herein may be configured for administrator control and associated automatic management of gate(s) and/or yard(s) to, e.g., prevent bottlenecks or other logistical issues or problems.

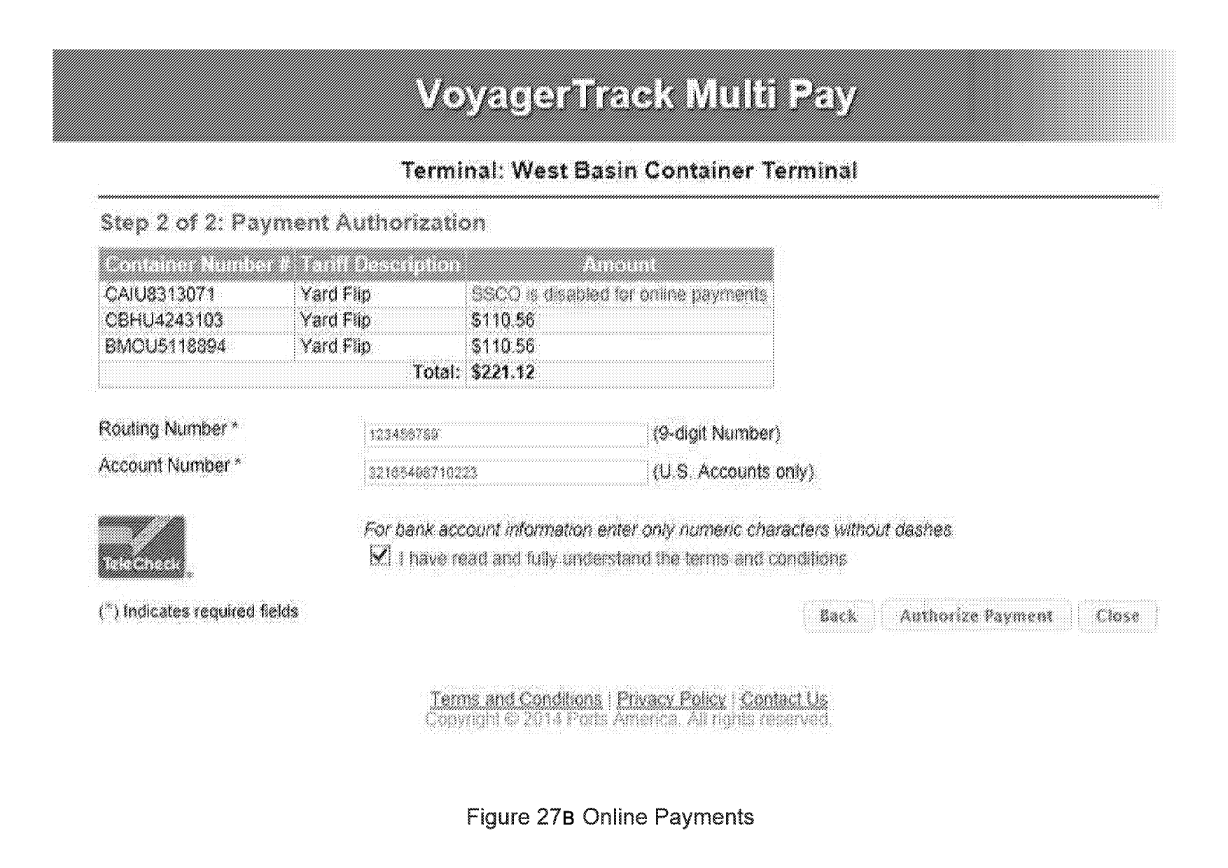

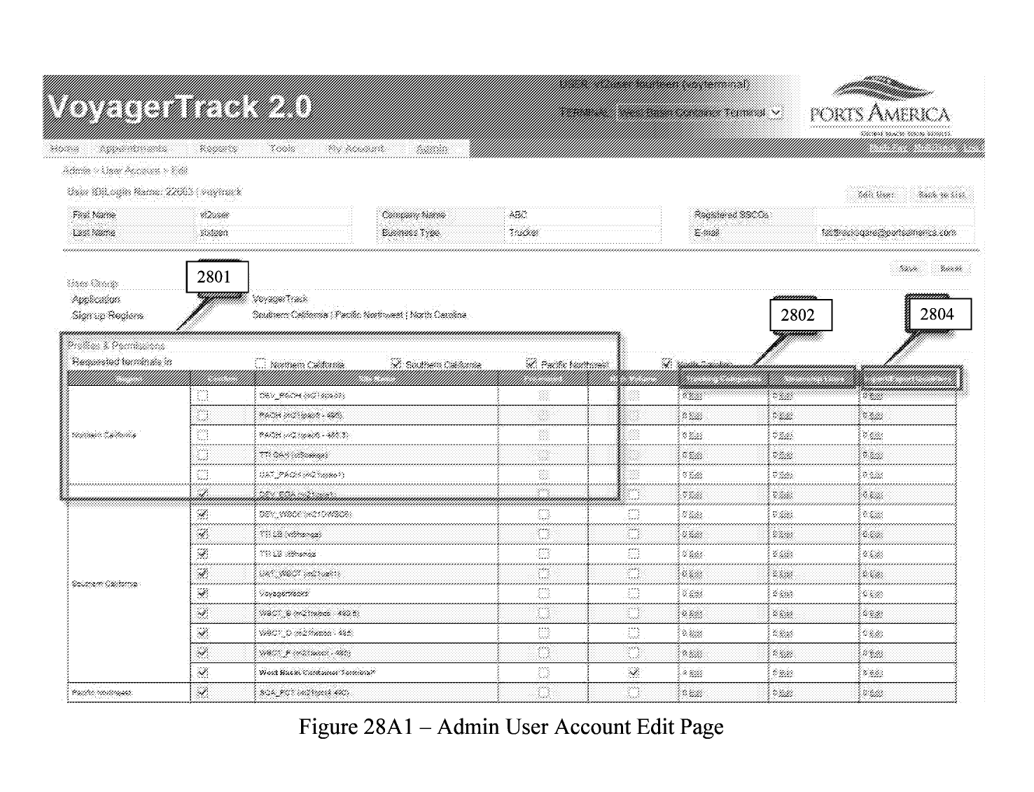

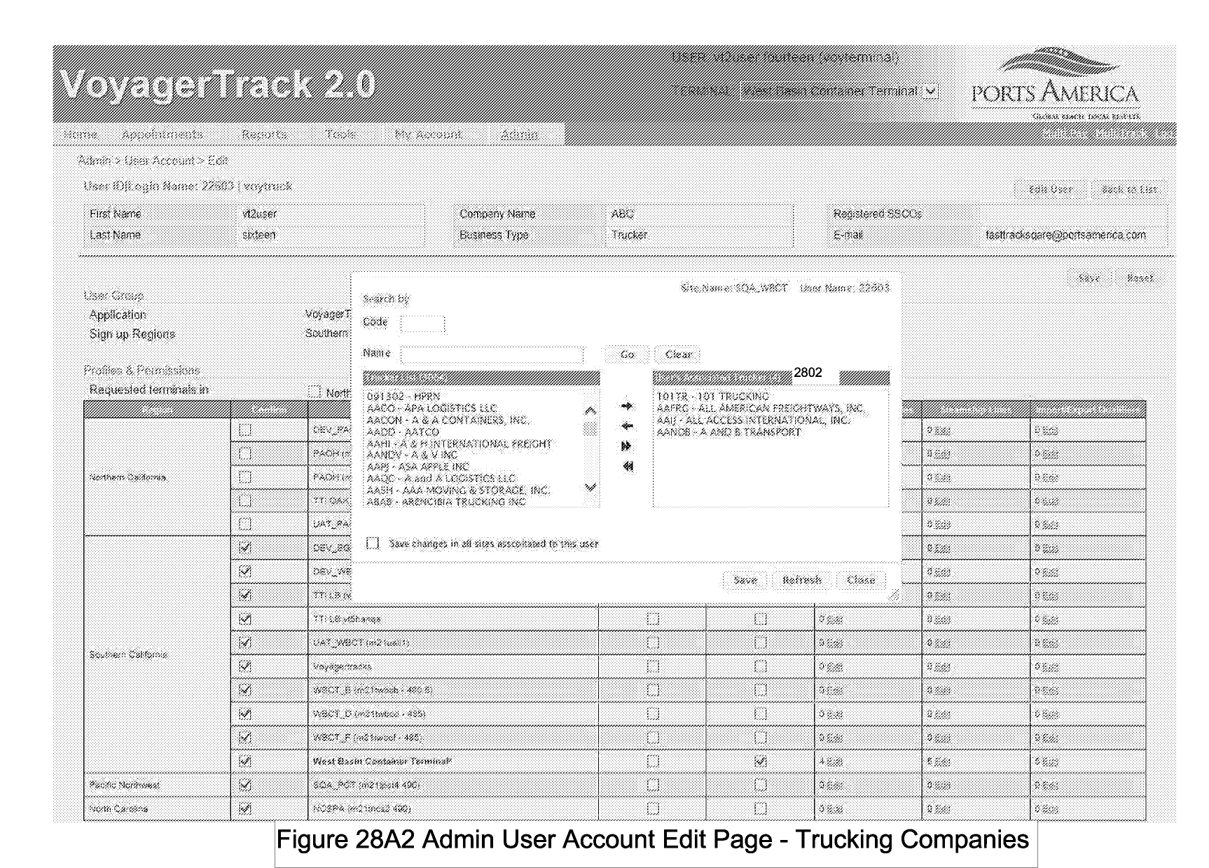

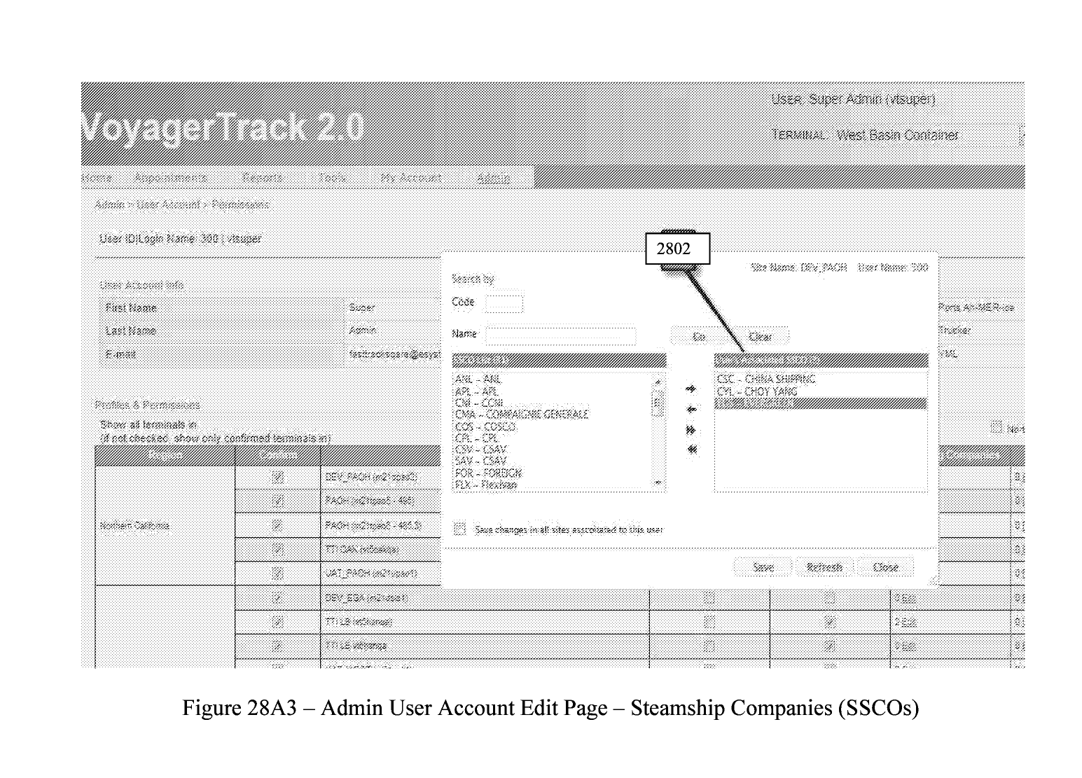

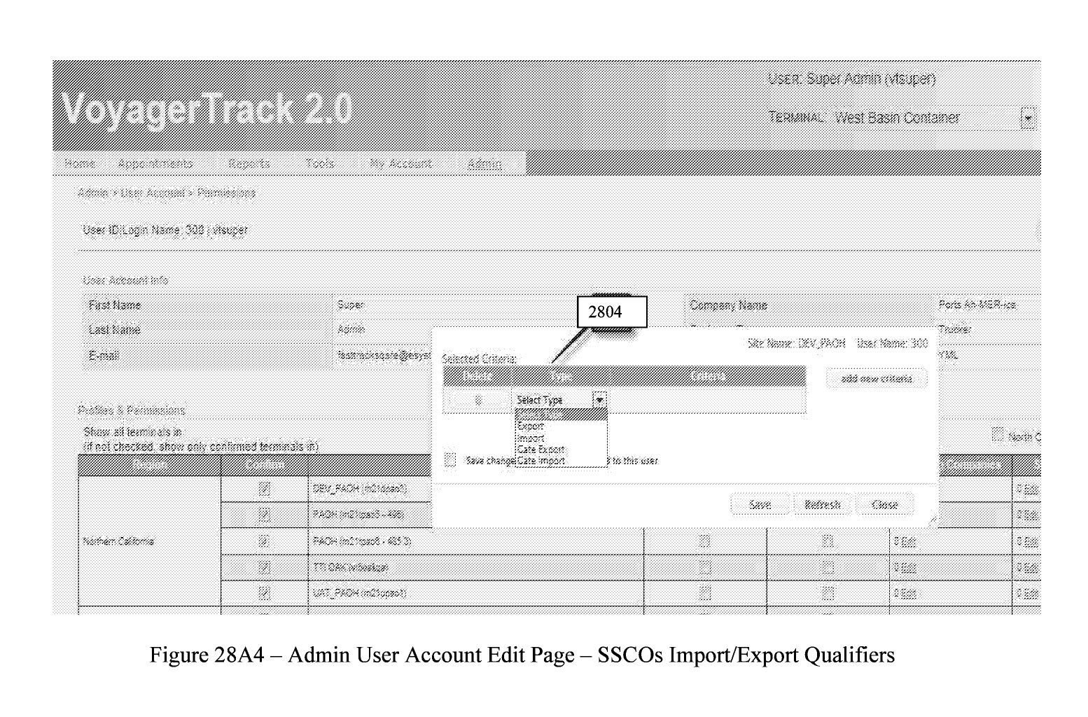

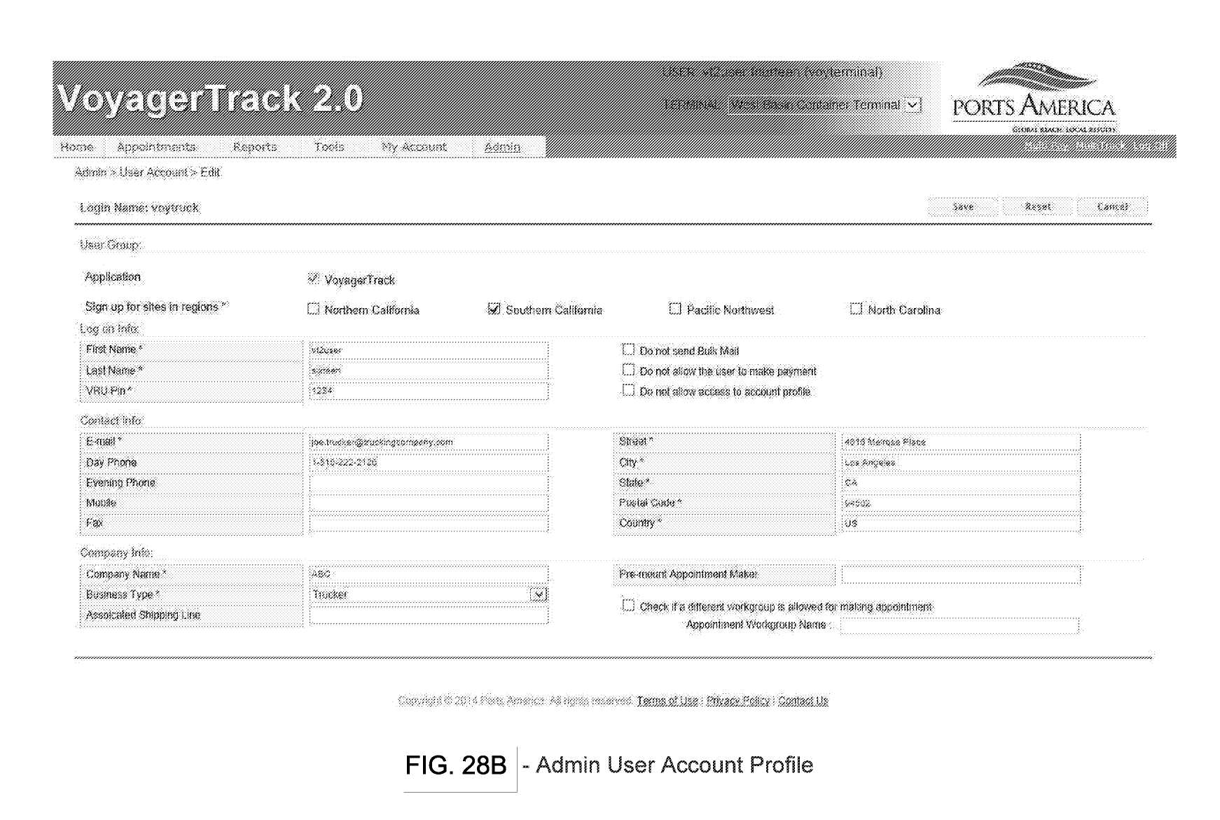

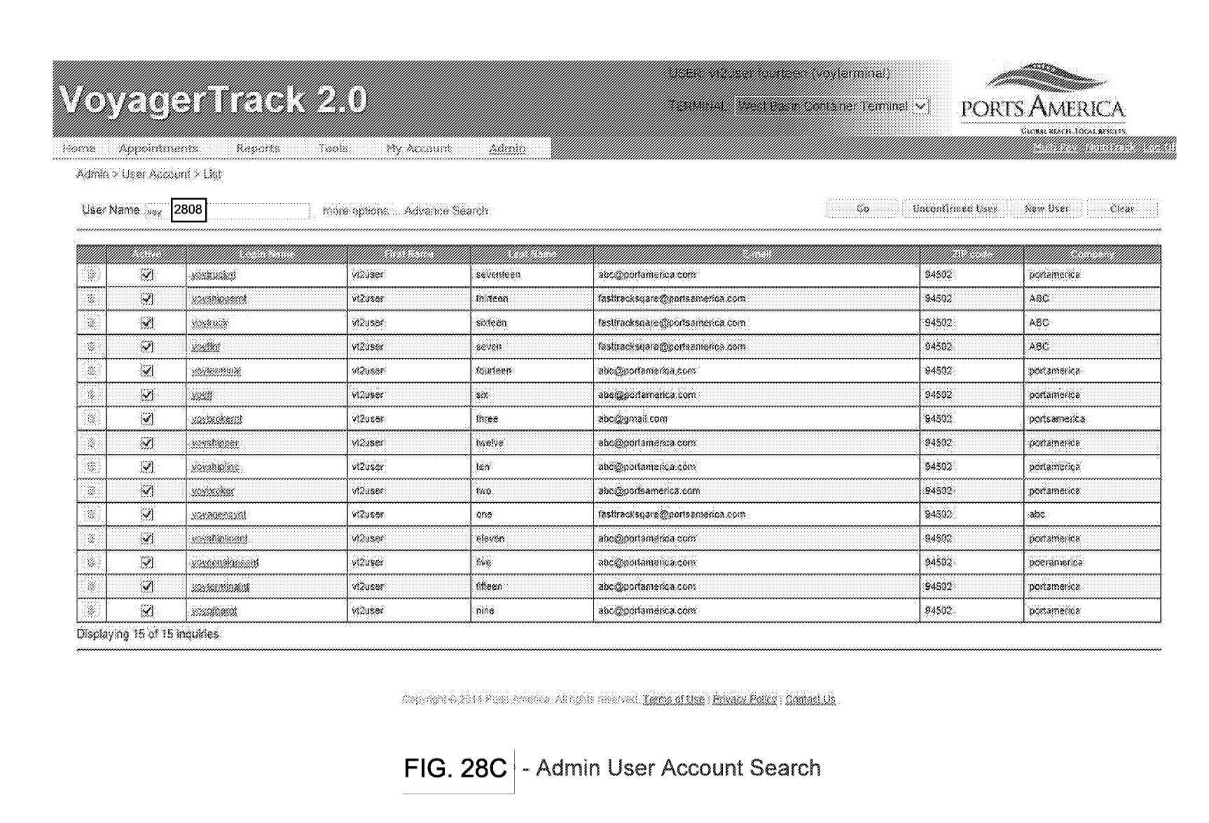

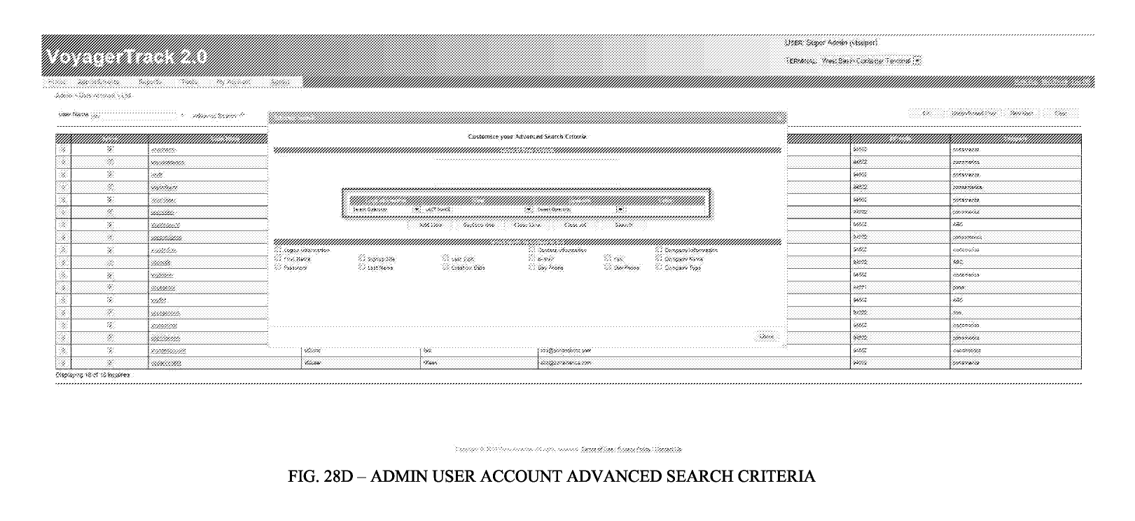

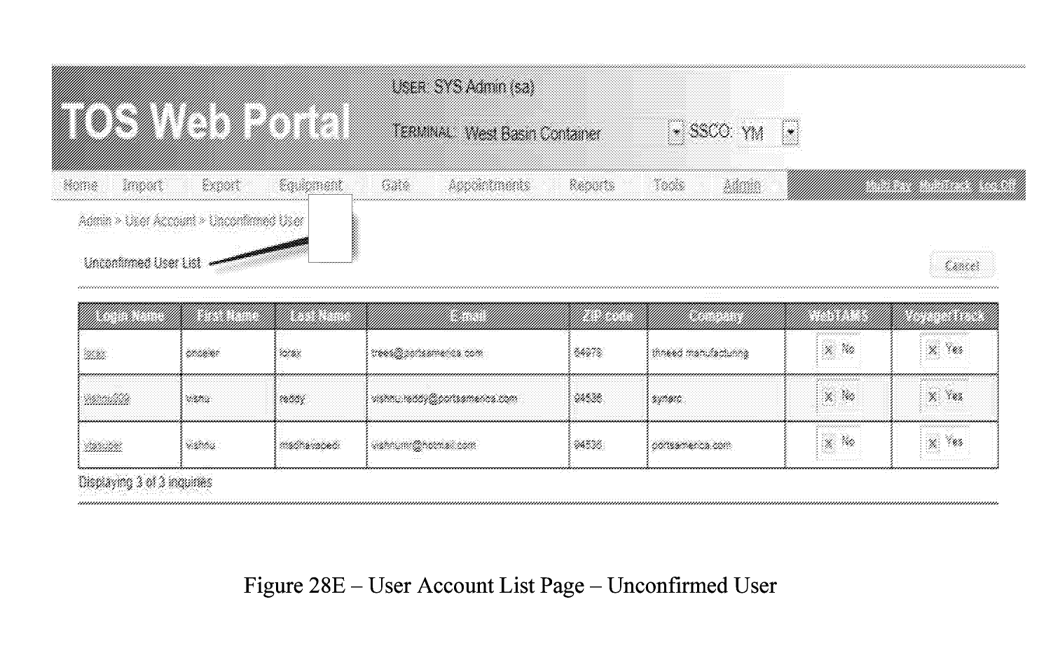

FIGS. 27A-B illustrate exemplary GUI sequence where a user makes online payments including non-demurrage payment (Multi Pay payment). Referring to FIG. 27A, Tariff Information 2702 features and processing may be provided; for example, when the user selects the Multi Pay link, the system provides functionality to allow the user to select predefined terminal charges for non-demurrage tariffs that are applied to multiple containers or driver license when defined. Further, the various terminal charges features and functionality are fully configurable by an administrative user. Tariff information 2702 may include a table provided and controlled by an administrator. Moreover, Edit Check processing may be provided; for example, from the Multi Pay page when the user submits 2704 container and tariff information, the system performs a validation using container edit check rules against the TOS to determine inventory status. Referring to FIG. 27B, Payment Authorization 2706 allows a user to review payments being made for a container(s) and provides input of bank account information. Here, for example, a selection to authorize payment may prompt the system to communicate with a vendor API which validates bank account information and returns an approval status. Further, according to various implementations, the payment processing of FIGS. 27A-27B to automatically process tariff information, communicate with such third party entities (e.g., a vendor API which validates bank account information, accept payments), prior in time to the terminal event to eliminate or reduce delays and save the need to prevent additional processing and thus eliminate any associated waste of resources, time, etc. Thus, the payment process is automatically handled and streamlined in contrast to conventional systems where payment issues are handled between dispatcher and a truck at the gate, leading to burdensome delays. FIGS. 28A1-28A4 illustrate exemplary GUIs where an administrator may edit a user profile of one user. Referring to FIG. 28A1, from the Admin User Account Edit page for Profiles and Permissions, systems and methods herein provide Admin Association 2801 features, GUI options, and functionality that allow the admin user to associate a confirmed user account with multiple terminal sites allowing the user to access these sites by using the same account log in. The latest user profile email may also be sent to the user. Referring to FIGS. 28A1-28A3, additional User Association 2802 features allow the administrator to associate a confirmed user account with trucking companies or steamship lines to provide access related system functions for the defined user type. Referring to FIGS. 28A1 and 28A4, from the Admin User Account Edit page for Profiles and Permissions, systems and methods herein may provide Qualifier/Criteria 2804 features and functionality that allow the admin user to associate a confirmed user account with various criteria such as report qualifiers that reflect defined report criteria.

FIG. 28B illustrates an exemplary GUI where an administrator may edit a user account profile of one user. Bulk Mail 2804 as shown in the Administrator User Account Edit page for Edit User allows the administrator to restrict the user from receiving Broadcast Emails from VoyagerTrack. Pre-mount Appointment Maker 2806 as allows the administrator user to define the user with permissions to make appointments for containers that the user requires the terminal to pre-mount prior to pick up. The functionality provided herein may be used to provide a means for an administrator user to obtain a subscription for notification based on desired criteria, such as a booking status number, or any other information category.

FIGS. 28C-28D illustrate exemplary GUIs of searching/results pages showing user account profile information based on an administrator entered user search query. FIG. 28D illustrates an exemplary GUI where an administrator may utilize certain advanced searching tools and criteria. User Account Search 2808 as shown in the User Account List page allows an administrator to perform a detailed search for user account information based on specific criteria (i.e., login name, first name, last name, email, company name, etc. . . . ). or a combination of criteria.

FIG. 28E illustrates an exemplary GUI of an unconfirmed user results page, showing a list of unconfirmed user account information. Here, for example, from the User Account List page, the system allows an administrator/user to perform a search for unconfirmed user account information. Further, once the admin user accesses the user account information they have the ability to confirm the user. As a function of the administration information updated and features performed in FIGS. 28A-28E, various processing at the terminal may be performed automatically to avoid expenditure of time and unnecessary communications between the computer systems.

FIGS. 29A-29C illustrate example interfaces through which a user may register for notifications from the system. FIG. 29A illustrates an exemplary GUI for booking numbers that are not valid, a user may register for an event notification 2902 once the booking becomes valid. The user can register or unregister to receive the event notifications via email, fax, and/or SMS message, for example.

FIG. 29B illustrates an exemplary GUI where a user may register for customized event notifications 2904, for example for import availability, TMF, Demurrage, Exit Gate, and/or Enter Gate statuses. The user can register or unregister to receive the event notifications via email, fax, and/or SMS message, for example. Another exemplary GUI allows a user to register their account to receive a standing trouble status notification for all equipment move types that have trouble issues occurring at the gate. This may be done from the My Account User Preferences page, for example. The system may allow the user to register or unregister to receive the standing event notifications via email, fax, and/or SMS message, for example.

Various Notification Configurations 2906 features, GUI options and functionality may be provided. Referring to FIG. 29C, among other things, various Trouble Status Standing Notifications aspects may be provided. Here, for example, from the My Account User Preferences page, systems and methods herein allow users to register their accounts to receive a standing trouble status notification for all equipment move types that have trouble issue that occurs at the gate. Further, in some implementations, users may register or unregister to receive the standing event notifications via email, fax and/or SMS message.

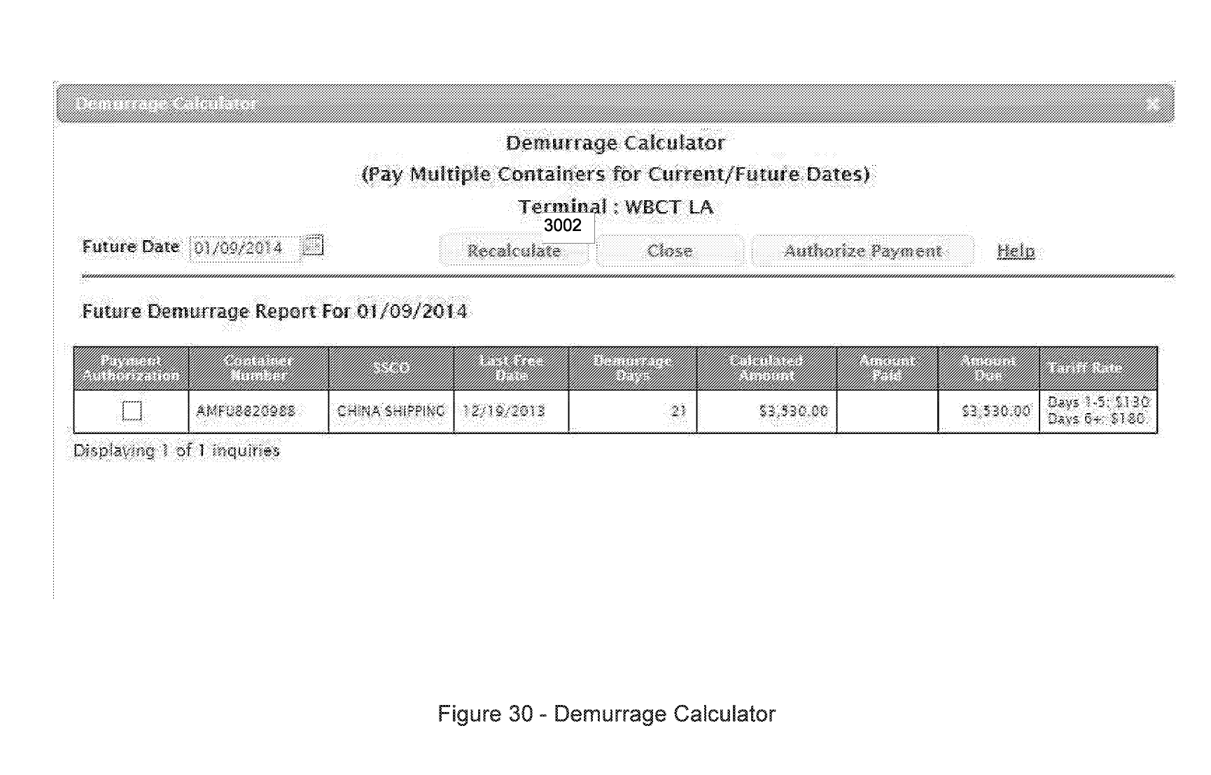

FIG. 30 illustrates an example of a demurrage calculator which the system may provide. From the Demurrage Calculator page a user may calculate 3002 current or future demurrage due for an import container based on the defined last free day and tariff rates, for example. The system may allow users to calculate demurrage for single or multiple containers in one inquiry. The system may allow users to specify future dates of interest and view reports generated by the demurrage calculator. Thus, the payment process is streamlined allowing a user to automatically view an amount owed for demurrage and/or other fees, in contrast to conventional systems where payment issues are handled between dispatcher and a truck at the gate, leading to burdensome delays. FIG. 31 is an example admin interface which may provide site management functionality to a user. From the Admin Site Management page an admin user may select one or more specific terminal sites for configuration. The admin user may configure the specific terminal site with customized configurations for terminal communication, equipment activity reports, demurrage notifications, Equipment Interchange Report (EIR), and/or Pre-mount, for example. Management of terminal site configuration is provided in an automatic manner and saves time and allows an administrator to establish different configuration levels as necessary.

FIGS. 32A-32B illustrate an example admin interface which may provide steamship company management functionality to a user. The SSCO Configuration page allows the terminal admin to view and update the SSCOs at the site. FIG. 32A illustrates a steamship company edit page, and FIG. 32B illustrates a steamship company list page. From the admin steamship company list page, the system may allow the admin user to select steamship companies for editing. From the edit page, the system may allow the admin user to enable or disable specific functionality by steamship company. Functions 3202 related to notifications, online payment (demurrage and non-demurrage), import report, gate activity, and/or vessel schedule, for example, may be edited.

As a function of the administrator features and functionality performed via FIGS. 31-32B, systems and methods herein may be configured to automatically streamline configuration of SSCO interface functionality for each SSCO. In this manner, configuration of functionality including permissions, payments, demurrage, notifications, reports, gate activity, schedules, etc. is improved for administrators, resulting in improved management by an administrator and ease of use for the SSCO.

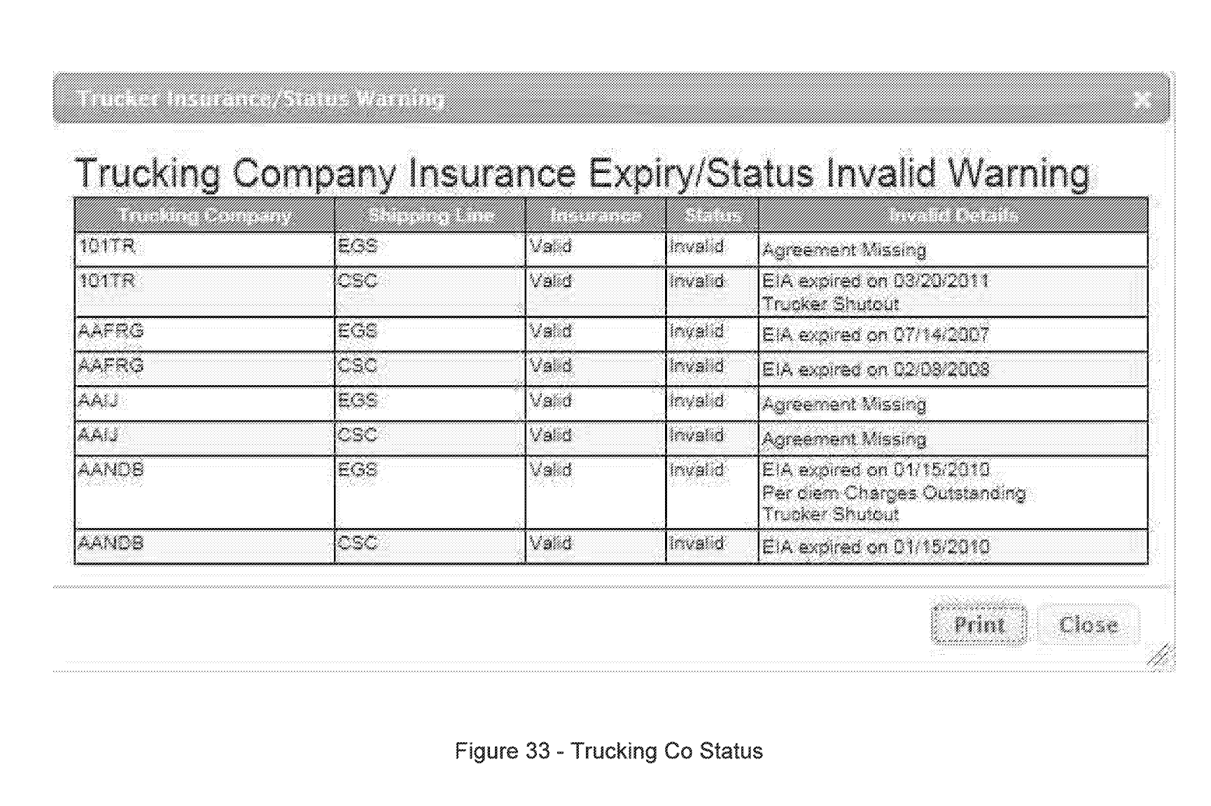

FIG. 33 illustrates an exemplary GUI of Trucking Company Status management functionality to a user. When the Appointment pages (Import Container, Export Booking, Empty In Checker, etc.) are loaded the system validates the trucking company status for each trucking company associated with the user account by steamship company. If a trucking company has an invalid status the warning message 3302 is displayed with the details. In the example, the trucking companies in the list each have an invalid status and an explanation of why the status is invalid. In various implementations, the Trucking Company Insurance Expiry/Status Invalid Warning popup window is displayed every time the Import Appointment page is loaded, when the user's associated trucking company/companies have insurance issues or warnings with the SSCOs of the displayed containers. A pop-up window is provided, for example, to inform the user that the trucking company insurance is expired or that trucking company has been shut-out. This allows a user to be notified automatically to avoid any delays and/or issues during gate processing. Although a return status of truck company insurance is provided, an expired status does not prevent the user from making an appointment.

FIGS. 34A-B illustrate exemplary GUIs of administrator daily message management functionality to a user. Referring to FIG. 34A, from the Edit Daily Message page, the system provides a GUI interface 3402 that allows admin user to define new layout based on configurations available. Further, in some implementations, message(s) can be highlighted to indicate warning status and user can post new messages or modify existing messages. The Daily Message Editor page allows users to edit and save the Priority Message of the Day and Message of the Day. Referring to FIG. 34B, an illustrative New Pagelet 3404 pop-up and functionality are shown in which the user/administrator can edit the message of the day. In some implementations, FIG. 34A-B serves as a splash page to provide a communication status of a terminal/apparatus.

FIGS. 35A-35C are diagrams of an exemplary Reports user interface consistent with one or more aspects of the innovations herein. FIG. 35A illustrates an exemplary GUI of administrator report management functionality to a user. The returned administrator report may display active appointments and history information. In particular, the report provides real-time information on a truck status. Based on the report, a user may be able to determine a cause of a delay or can assign other trucks to pick-up a container, for example. In other implementations, a user and/or administrator may be advised of missed appointments, and of other information related to the container. The reports generated by FIGS. 35A-C may be particularly useful to users, administrators, trucking companies and dispatchers, for example.

FIG. 35B illustrates an exemplary GUI of export report management functionality to a user. FIG. 35C illustrates an exemplary GUI of import report management functionality to a user including online payment and demurrage payment. The Import Report displays the container information of the selected consignee(s) from the list of the associated import qualifiers of the user. The Booking Report displays the booking summary information of the shipper(s) from the list of the associated export qualifiers of the user. The Appointment report displays the appointments for the selected location/move type, search option (by date, date/time range, container number, or booking/release number), appointment status, optional report fields, trucking company/companies, and report type (summary or detail). The sort order of the detail report can be specified. When an import container has a demurrage amount due, the system allows the administrative user to configure the display of a payment link 3502 which allows users to make demurrage payment for a specific container. When an import container has a demurrage amount due the system allows the administrative user to configure the display of a payment link 3504 which allows users to make demurrage payment for single or multiple containers in one transaction as well as make payments for a future date.

FIG. 36 is a diagram of an exemplary broadcast email user interface consistent with one or more aspects of the innovations herein. The Broadcast Email page allows the terminal admin to send an email to all users of the site. Referring to FIG. 36, an exemplary GUI is shown, again as viewed in conjunction with the Appendices, wherein an administrator may broadcast crucial information by sending an email to all applications users for the terminal.

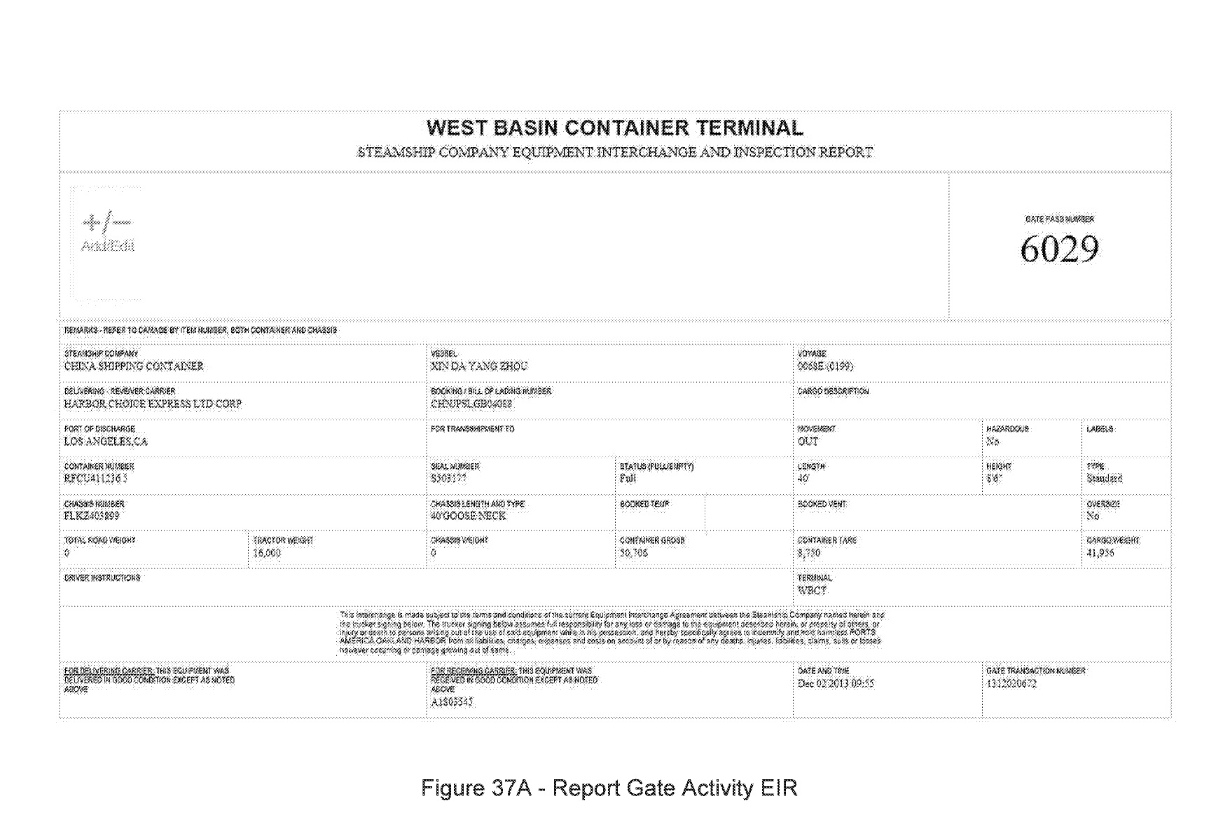

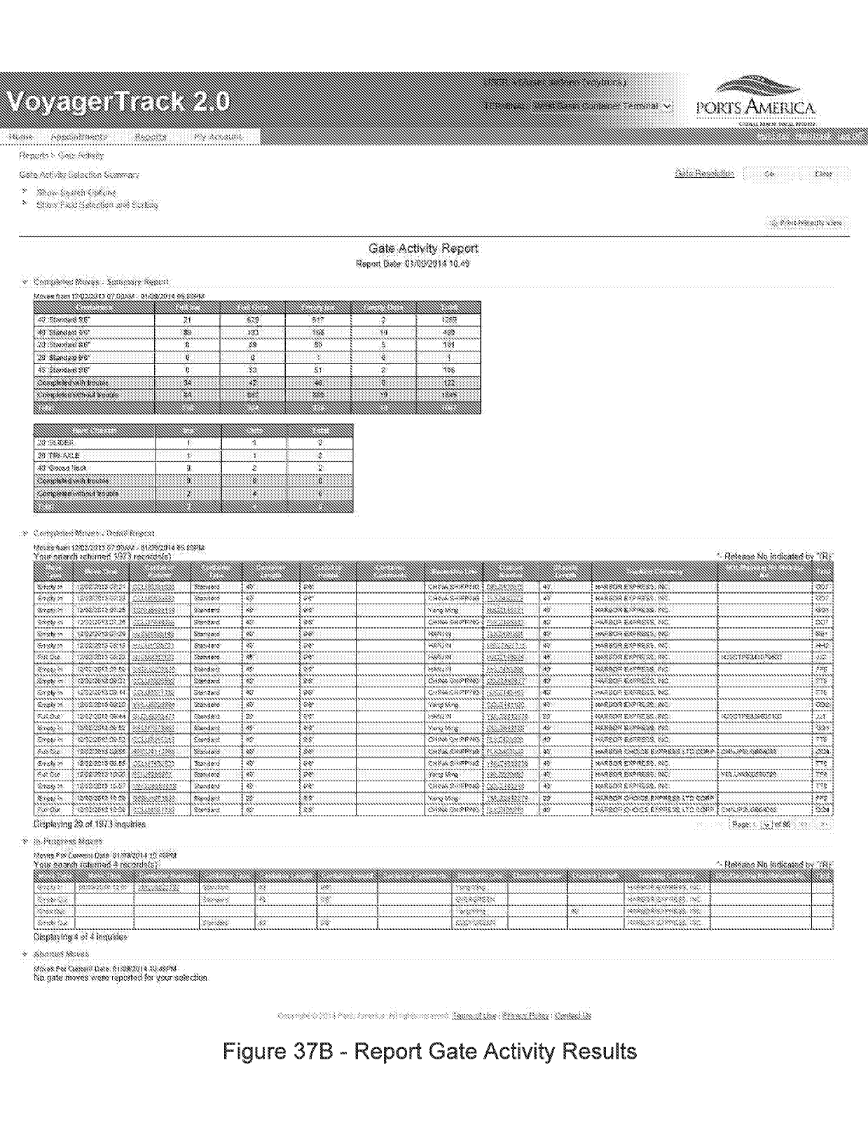

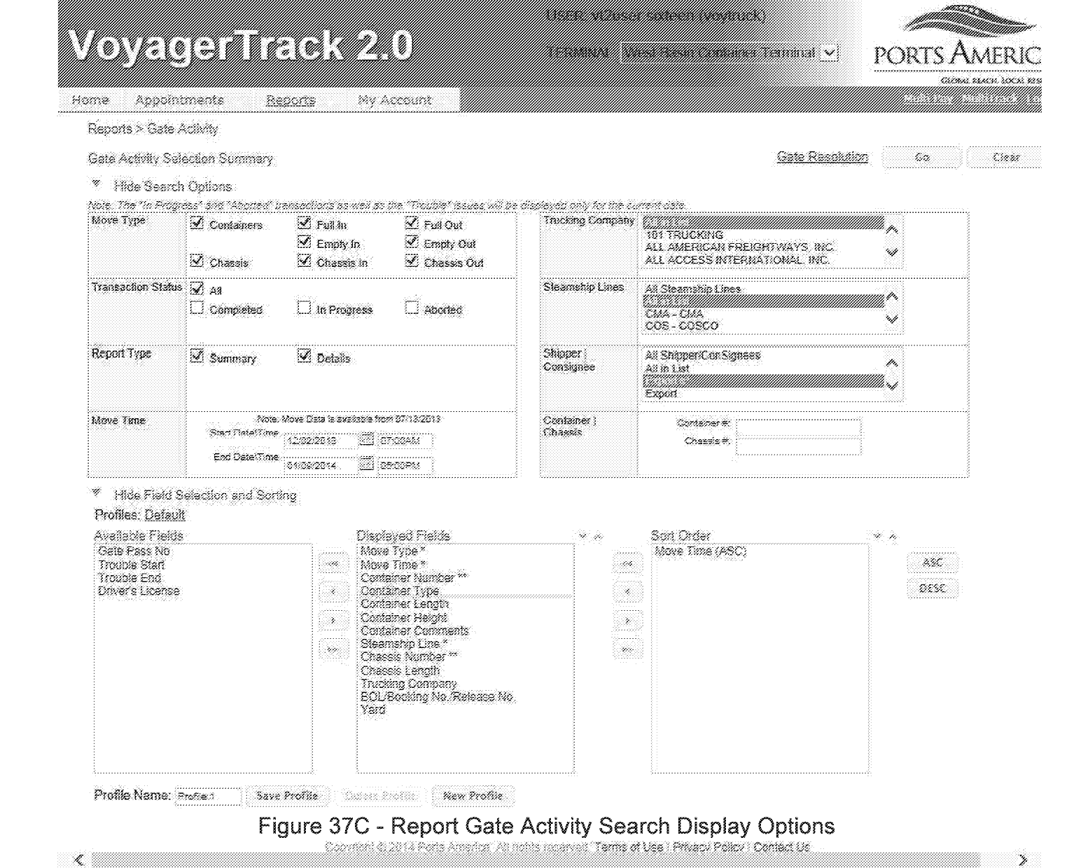

FIGS. 37A-37C are diagrams of an exemplary EIR (Equipment Interchange and inspection Report) user interface consistent with one or more aspects of the innovations herein. FIG. 37A illustrates an exemplary GUI of Report Gate Activity management functionality to a user. The Gate Activity Report displays the gate activity information for a combination of criteria: transaction status (Completed, In Progress, Aborted, All), trucking company, steamship line, shipper/consignee, container and chassis move types, move times, specific container or chassis, displayed fields, sorting order of the displayed fields, report type (summary, detail, or both). A Gate activity report is generated when a truck leaves the terminal facility and may serve as an official record for a container such as a proof of delivery. FIG. 37B illustrates an exemplary GUI of Report Gate Activity Results management functionality to a user. A summary may be provided that includes all moves, empty in/empty out, activity timestamp, status, in-progress, etc. FIG. 37C illustrates an exemplary GUI of Report Gate Activity Search Display management functionality to a user. Values may be set to configure the activity report.

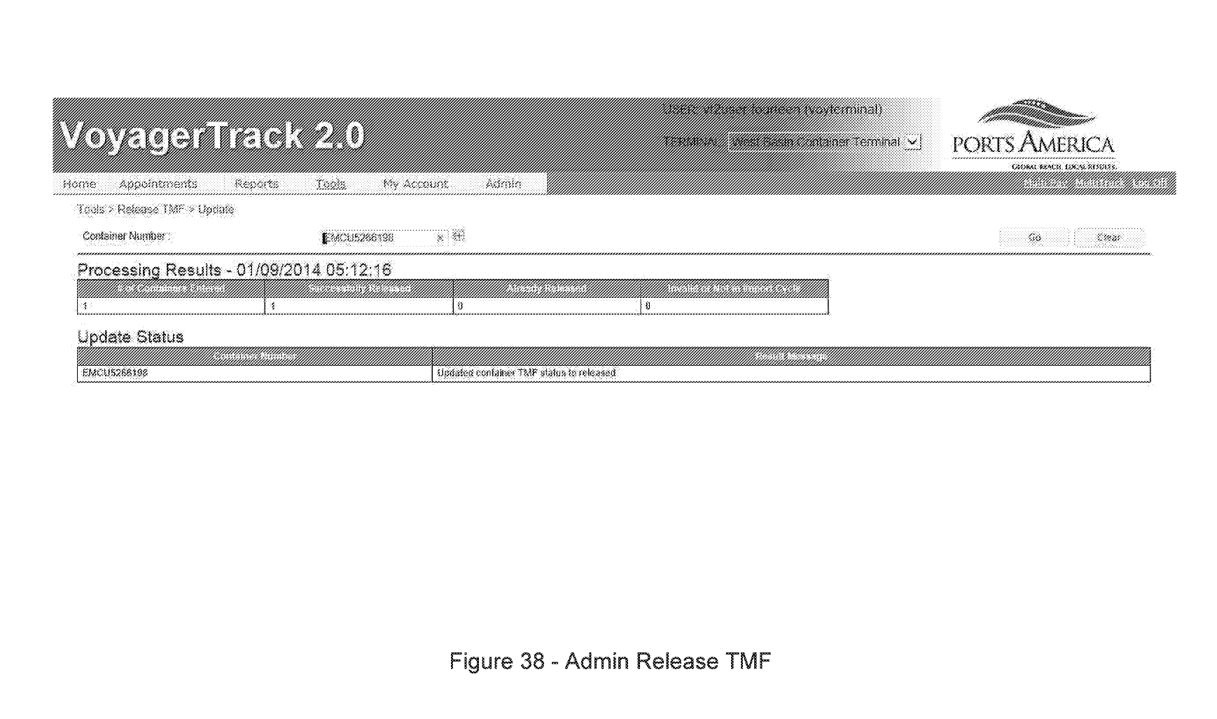

FIG. 38 is a diagram of an exemplary Release user interface consistent with one or more aspects of the innovations herein. TMF (Traffic Mitigation Fee) Release and TMF Release Reversal notifications apply to the import cycle and especially apply, for example, to PierPASS terminals. As background, containers have TMF status of Hold or Released. Here, then, all users can register for email or fax TMF Release notification for containers with TMF Hold status. A terminal administrator function allows certain containers to make exceptions for certain fees such as the TMF. Referring to FIG. 38, an exemplary GUI is illustrated where an administrator may Release a container from various hold situations or events, such as payment of the Traffic Mitigation Fee assessed by the ports of LA and Long Beach for containers picked-up during peak traffic hours.

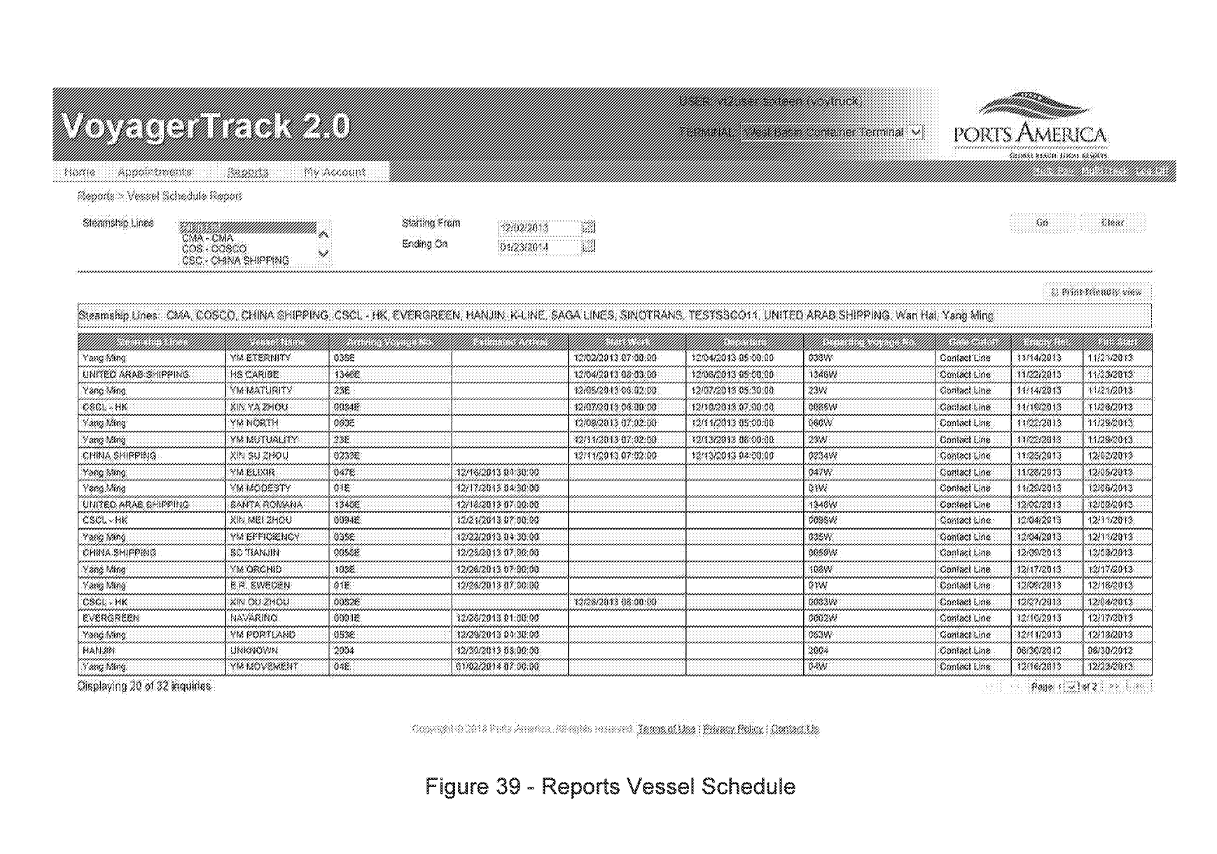

FIG. 39 is a diagram of an exemplary Reports Vessel Schedule user interface consistent with one or more aspects of the innovations herein. The Vessel Schedule page allows users to select shipping lines and a timeframe to view the schedule of the ships. Referring to FIG. 39, an exemplary GUI is illustrated where a user may query and obtain information pertaining to vessel arrival, departure and work schedules. A Report Vessel Schedule may be provided to determine when a ship arrives, cargo availability, empty release, and full start, wherein the empty release indicates where will empty be released to pick up and the full start indicates when start receiving/pick up import full containers.

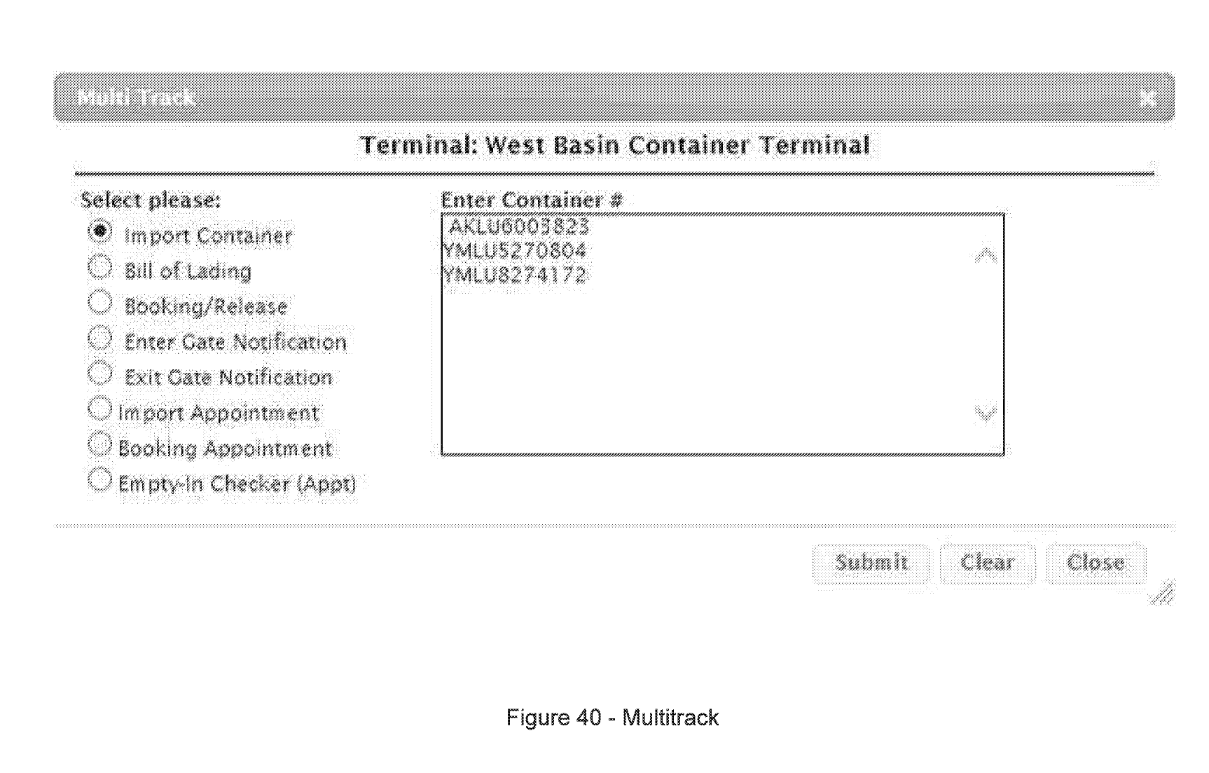

FIG. 40 is a diagram of an exemplary MuliTrack user interface consistent with one or more aspects of the innovations herein. MultiTrack query features and functionality here allow users to run a query on multiple containers, bills of lading (BOL), or bookings, and provide various innovative processing, UIs and results as a function thereof. Referring to FIG. 40, an exemplary GUI is illustrated where a user may have innovative features and options as well as quick access to run queries on multiple data objects such as containers, bills of lading, bookings, releases, notifications and appointments.

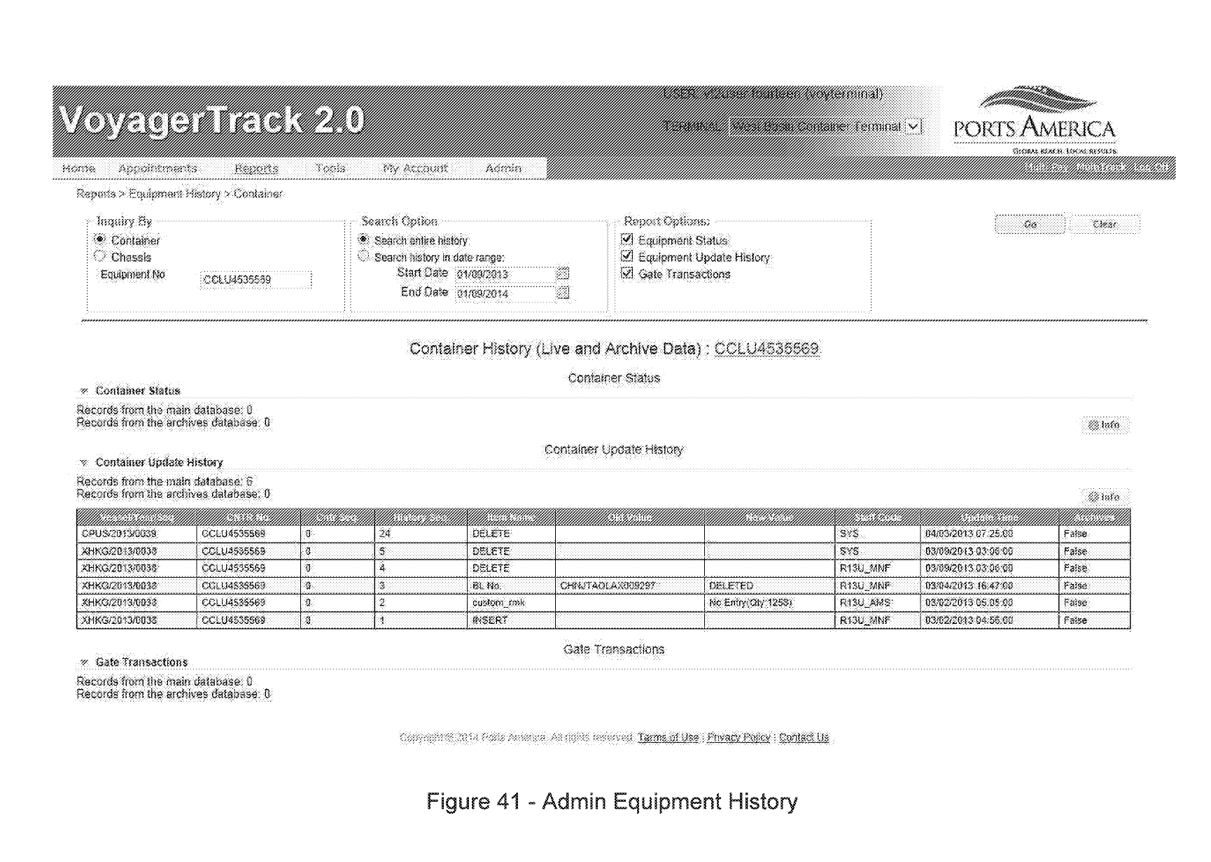

FIG. 41 is a diagram of an exemplary Equipment History user interface consistent with one or more aspects of the innovations herein. The Equipment History page allows the terminal admin to search history records for Equipment. Referring to FIG. 41, an exemplary GUI is illustrated where an administrator may access information pertaining to equipment (containers and chasses). Among other things, implementations herein include processing and may include further processing associated with current container status, history of status changes and gate transactions. The equipment history report is provided to provide a sequence of events associated with a container and provides status to a user to save time and enable proper planning and execution of container logistics.

In some implementations, the integration of the VoyagerTrack (VT) appointment system with the Terminal Operating System (TOS), Terminal Truck Queuing System and the Gate System facilitates the streamlining of truck traffic through the terminal by providing dispatchers/truck drivers with pre-arrival advice of their planned move and verification of a justified purpose for arriving at the terminal. Which is validated against the terminal operating system, allowing errors or missing information to be corrected before the truck is dispatched to the terminal. In addition, the integrated data can streamline gate operations by providing auto-gate capabilities. For example, by recognizing through Optical Character Recognition (OCR) and Weigh-In-Motion (WIM) this equipment data may be utilized to match the appointment equipment with the equipment arriving at the gate pedestals.

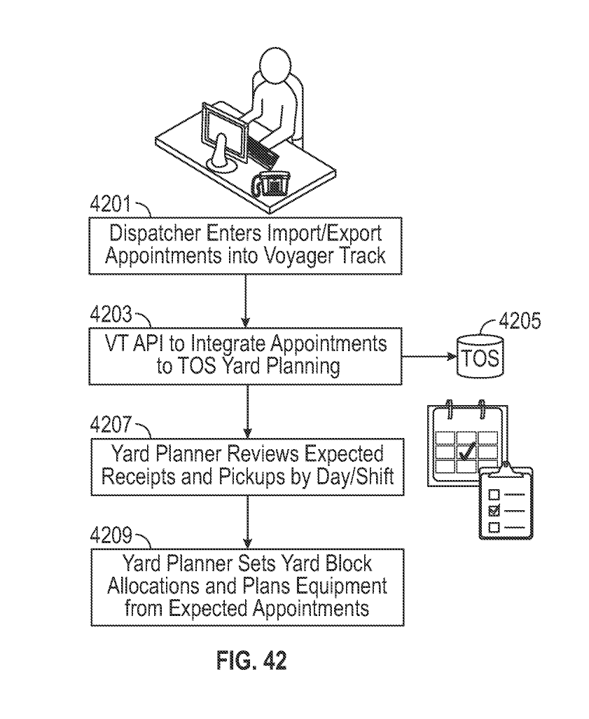

FIG. 42 illustrates an exemplary block diagram for pre-advice of containers consistent with one or more aspects of the innovations herein. A dispatcher enters import/export appointments into the appointment system. The appointment system API integrates the appointments to a TOS Yard planning 4203 via TOS 4205. The yard planner sets yard block allocations and plans equipment requirements based on the expected container move types and times from the appointments 4209.

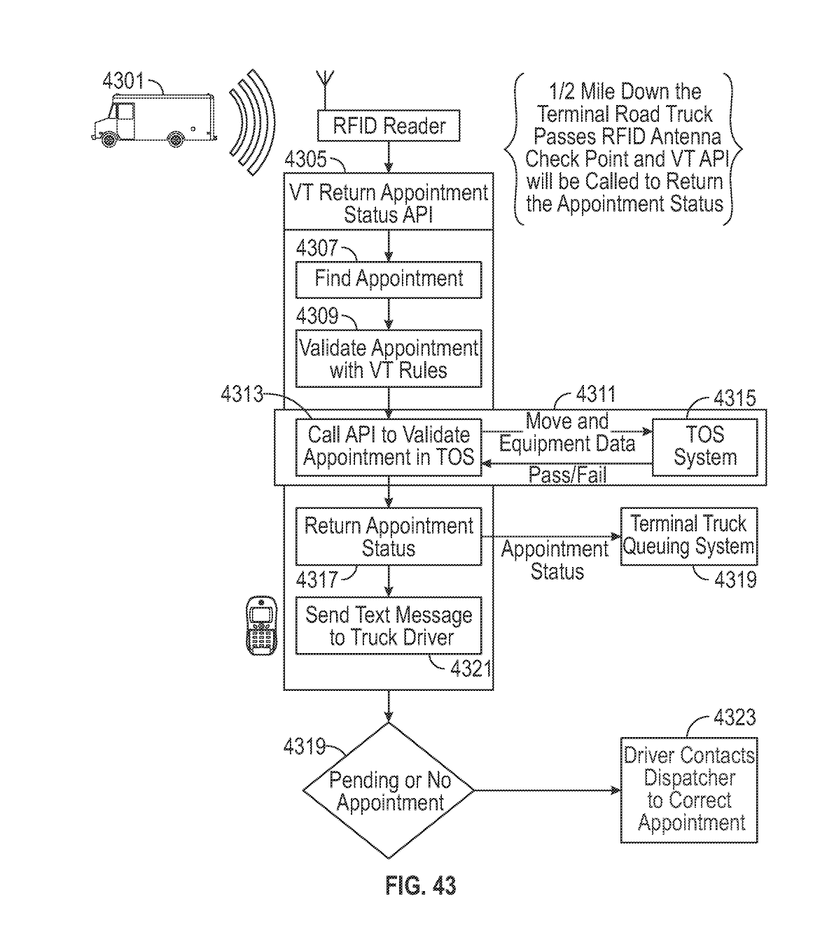

FIG. 43 illustrates an exemplary block diagram for truck arrival at a terminal consistent with one or more aspects of the innovations herein. When a truck 4301 passes an RFID antenna checkpoint, an appointment system API 4305 may be called to return the appointment status. The appointment is found 4307 and then validated both within the appointment system rules 4309 and the TOS 4315 via the TOS validation API 4311. The Terminal Operating System (TOS) verifies the requested appointment meets all the equipment, booking, equipment delivery order (EDO), bills of lading (BOL), and container status validations. This validation against the TOS allows errors or missing information to be corrected before the truck is dispatched into the terminal. The appointment status is returned 4317 and provided to the Terminal Truck Queuing System 4319. A determination of whether there is a pending appointment or no appointment is made 4319. The result is transmitted to a truck driver 4321 via the notification agent.

In some implementations, a VT Return Appointment Status API is provided to determine if the truck arriving at the terminal has a valid appointment and thereby has a justified purpose for arriving at the terminal. Upon the arrival of a truck to the terminal truckway, an API request will be issued to the appointment system for the current appointment status. The appointment system will receive RFID (Radio Frequency Identification) tag number and the arrival time of the truck. Utilizing this information, the appointment system will locate the best appointment matching the RFID and timeslot and return to the Terminal Truck Queuing System the status of the matching appointment. Additionally, the appointment system will send a notification to the truck driver via text and/or email message informing the trucker of the appointment status. The appointment status results include at least one of the following 4321: active appointment results in a Call Forward notification instructing the driver to proceed to the In Gate or the receipt of either a Pending Appointment or No Appointment notification 4319 in which the driver must contact dispatch for assistance. Once the dispatcher corrects the appointment 4323 the updated appointment status will be available for the driver either via a wall mount display or receipt of an updated notification via a text/email message 4321.

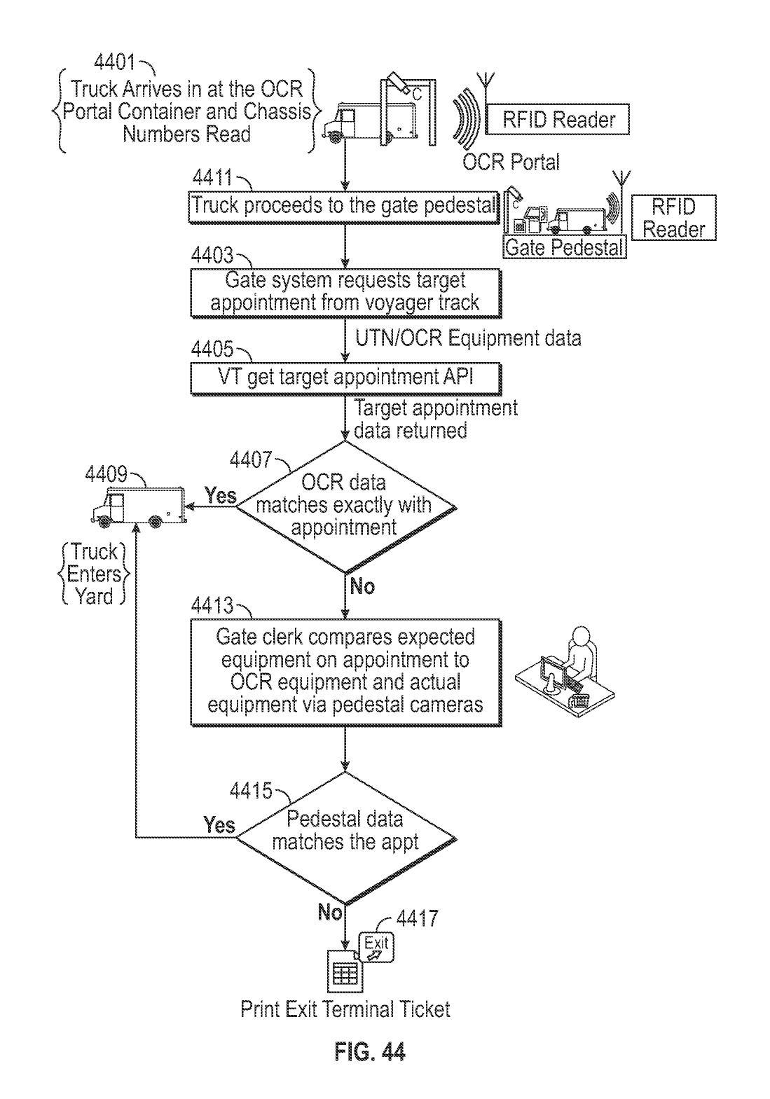

FIG. 44 illustrates an exemplary block diagram for OCR portal and in gate pedestal consistent with one or more aspects of the innovations herein. A truck arrives at an OCR Portal, and the container and chassis numbers are read 4401. The Gate system requests the Target Appointment from the appointment system 4403. RFID Truck data and OCR equipment is transmitted to the VT Get Target Appointment API 4405. The API returns target appointment data as outlined in FIG. 46.

At the In gate pedestal the appointment equipment is matched 4415 with the previously captured OCR equipment data or equipment data manually entered by the gate clerk via pedestal cameras 4413. If the equipment data from the appointment does not match the receiving equipment then the truck is requested to exit the terminal 4417 otherwise the truck may proceed into the yard 4409.

FIG. 46 in some implementations, a Get Target Appointment API is provided to find the best or target appointment match utilizing all the available information from the terminal truck queue system and portals (UTN/RFID Tag number, OCR Equipment numbers). This routine returns the target appointment ID, move types, status and its equipment defined as part of the planned inbound and/or outbound move. This information may be utilized by the gate operations to verify that the expected appointment equipment matches the actual equipment (Container and/or Chassis number and Equipment Size/Type) arriving at the In-Gate pedestal or exiting the Out-Gate pedestal. This information streamlines gate operations by ensuring pre-arrival equipment is at a good status prior to entry into the terminal and facilitates the ability to automate gate operations when expected and actual equipment data matches.

In order to find the target appointment, a series of Matching Methods may be performed until a good target appointment match result is found. Once a good result is found, then no other Matching Methods need to be executed. These Matching Methods are listed in the order in which the routine will attempt to find the best target appointment. (i.e., start with Method 1, if appointment not found then continue to Method 2, 3, and 4 as needed). The only time the matching will return a result of No Appointment Found is if every method below fails to return a result. A set of exemplary, though non-limiting matching methods are described below.

According to a first, illustrative matching process, a UTN has an initiated appointment or In Yard Holding Area (IYHA) Single Out appointment. The first method may include plurality of parameters including Arrival Date/Time, RFID/UTN (Unique Truck Number), Location, Initiated Indicator, First Container, Second Container, Chassis Number, and Chassis LPN (License Plate Number), wherein Arrival Date/Time corresponds to utilizing the Truck Arrival Date matching only appointments with the same date, RFID/UTN corresponds to utilizing UTN or RFID numbers to find the UTN from the Truck Profile if provided (may be required), location corresponds to the current location of the Truck at the time the Get Target Appointment request, Initiated Indicator corresponds to yes, First Container corresponds to First Container not used, Second Container corresponds to second container not used, Chassis Number corresponds to not used, and Chassis LPN (License Plate Number) corresponds to not used.

The first matching process may include two parts including a Single Out and Initiated Appointments. For the first part 4611, the Single Out appointment is checked wherein only if location is IYHA, then best timeslot or candidate active or pending Single Out Move that match the same Date and UTN specified in the parameters are returned. This method is utilized to assign a pick-up move to a UTN if they are already on terminal and their previous pick up move was canceled. Once a truck is in the terminal yard their appointment is initiated. The second part of these method 4612 queries for ALL initiated appointments matching the date and UTN specified. If no Initiated Appointment is found, then continue to the second and third matching method until an Initiated Appointment is found. These additional steps are required for One-Time Visit trucks that do not have UTNs).

The following scenarios illustrate possible situations relevant to the first matching method. For instance, as a truck enters the OutGate pedestal, the gate system will query the appointment system for all its initiated appointments for status processing to either Complete or Cancel based on TOS Transaction status. If a driver is directed to IYHA due to a trouble ticket then this method will return its Initiated appointments for trouble processing within the gate system and TOS system. For an assignment of a new Single Out Appointment where a dual move at the in-gate where in-move is active and out-move is pending and must be canceled by the clerk at the Pre-Gate pedestal via the TOS. The gate system will send the appointment system the outbound appointments for cancellation in which appointment system will unpair and un-initiate the out-move appointment(s). The driver is instructed to go to IYHA to pick up his new out-move instruction. From the IYHA, if the UTN is requesting a new appointment then the dispatcher must have created the appointment as either a Slotted or Candidate Single Out appointment assigned to the same UTN for the first matching method to find it. In the unlikely event that there are multiple Single Out appointments for the same date and same UTN, then the timeslot logic will determine the best appointment.

According to a second, illustrative matching process, Container Equipment is provided by the Gate System. The second method may include plurality of parameters including Arrival Date/Time, RFID/UTN, Location, Initiated Indicator, First Container, Second Container, Chassis Number, and Chassis LPN (License Plate Number), wherein Arrival Date/Time corresponds to utilizing the Truck Arrival Date matching only appointments with the same date, RFID/UTN corresponds to utilizing UTN or RFID numbers to find the UTN from the Truck Profile if provided (optional), location corresponds to the current location of the Truck at the time the Get Target Appointment request, wherein if Initiated Indicator corresponds to yes, then Initiated Appointments are included, and if no, then Initiated Appointments are excluded, First Container corresponds to First Container required, Second Container corresponds to second container optional and use if available, Chassis Number corresponds to not used, and Chassis LPN (License Plate Number) corresponds to not used.

The second matching process is executed only if the gate system sends a good OCR read or gate clerk entered Container number. The container number is the most important equipment match so once an appointment is found matching with the same container, then that result is returned and the matching process stops. If the UTN specified then it MUST match the appointment to qualify as a target appointment. In the unlikely event that multiple appointments for the same container are found, then the timeslot logic should narrow it down to the closest appointment for that UTN.

If the Initiated Indicator is yes 4621 for All Initiated Candidate and Slotted appointments, then utilizes the date, and other available equipment data, such as the RFID/UTN and Container number search appointment system for initiated appointments that match the equipment data specified. If the UTN specified then it MUST match the appointment to qualify as a target appointment. On the other hand, if the Initiated Indicator is no 4622 then search appointment system for Active/Pending (Single In, Dual In), if the UTN is specified then it must match the appointment to qualify as a target appointment. As for a tie breaker, if more than one appointment is found with the same container number specified or if 2-20's through the OCR matches with two different target appointments (i.e., one container matched one appointment and the other container number matches another), then the Timeslot logic will be utilized to further reduce the result set. For the final Tie-Breaker, the earliest Appointment ID is used assuming that the primary equipment appointment for a multi-equipment appointment would be entered first.

The following scenarios illustrate possible situations relevant to the second matching method. For InGate, as a truck enters the In Gate Pedestal the gate system will query the appointment system for all target appointments that are active and pending for In Gate Processing utilizing all equipment data available (either via OCR data or entered by clerk). Here, the Initiated Indicator is no. For IYHA Trouble, if a one-time visit driver (i.e., Truck has no UTN number but has a Container number) is directed to IYHA due to a trouble ticket where TOS transaction is in Yard. Here, the Initiated Indicator is yes. This method will query for Initiated appointments utilizing the clerk entered Container Information searching the appointment system. For IYHA OOG (Out of Gauge) InGate, the OOG cargo that cannot be processed via the In Gate Portals, the cargo is directed to IYHA for InGate Processing utilizing equipment data manually entered by the clerk. Here, the Initiated Indicator is no.

According to a third, illustrative matching process, Chassis Equipment is provided by Gate System. The third method may include plurality of parameters including Arrival Date/Time, RFID/UTN, Location, Initiated Indicator, First Container, Second Container, Chassis Number, and Chassis LPN (License Plate Number), wherein Arrival Date/Time corresponds to utilizing the Truck Arrival Date matching only appointments with the same date, RFID/UTN corresponds to utilizing UTN or RFID numbers to find the UTN from the Truck Profile if provided (optional), location corresponds to the current location of the Truck at the time the Get Target Appointment request, wherein if Initiated Indicator corresponds to yes, then only Initiated Appointments are included, and if no, then Initiated Appointments are excluded, wherein First Container and Second Container are optional and not used, Chassis Number is utilized if available, and Chassis LPN (License Plate Number) is utilized if available.

In some implementations, the third matching method may include the following steps. If the Initiated Indicator is yes for All Initiated Candidate and Slotted appointments, then utilizing the Date, and other available equipment data, RFID/UTN and Chassis number search the appointment system for initiated appointments that match the equipment data specified 4631. If UTN is specified it must be utilized in the matching. If No appointments are found, utilize the Chassis number, then attempt to find an Initiated target appointment with the Chassis LPN if Owned Chassis Flag is yes 4632. If Owned Chassis Flag is no, then do not use the LPN in matching. If the Initiated Indicator is no 4633, then utilize the date and other available equipment data such that the RFID/UTN and Chassis number to search the appointment system for only Active or Pending Primary Candidate & Slotted Appointments. If UTN is specified it must be utilized in the matching. If the Owned Chassis Flag is no 4634, then utilize Single In and Dual In Moves only (No Out Moves). If the Owned Chassis Flag is Yes and no Container data was provided by the gate system, then utilize Single In, Dual In, and Single Out Moves. If the Owned Chassis Flag is Yes and Container data was provided by the gate system, then utilize Single In and Dual In (no Out Moves).

If No appointments are found utilizing the Chassis number, attempt to find an Active or Pending Primary Candidate & Slotted Appointment for Single In, Single Out, or Dual In target appointment with the Chassis LPN if Owned Chassis Flag is yes and Container data was not provided by the Gate System 4635. If the Owned Chassis Flag is Yes and Container data was provided by the gate system, then utilize Single In and Dual In (no Out Moves). If the Owned Chassis Flag is No, do not use LPN matching. As for a tie breaker, if more than one appointment is found with the same Chassis/LPN specified, then the Timeslot logic will be utilized to further reduce the result set. For the final tie-breaker, use the earliest Appointment ID assuming primary equipment appointment for a multi-equipment appointment would be entered first. If no match results then continue to a forth matching method.

This method is executed only if the above Container match did not return a result and the gate system sends a good OCR read or gate clerk entered Chassis/LPN data. When multiple appointment(s) are found matching with the same chassis/LPN then the timeslot logic should narrow it down to the closest appointment.

The following scenarios illustrate possible situations relevant to the third matching method. For instance, as a truck enters the InGate pedestal, the gate system will query appointment system for all its target active and pending appointments for the InGate Processing utilizing all equipment data available (either via OCR or clerk entered). Here, the initiated indicator is no.

As a one-time visit truck (i.e., Truck has no UTN number) enters the OutGate pedestal the gate system will send the Chassis equipment information (either via OCR data or entered by clerk) to query the appointment system for all its Initiated appointments for status processing to either Complete or Cancelled based on TOS Truck Transaction status. Here, the Initiated Indicator is yes.

If a one-time visit driver (i.e., Truck has no UTN number) is directed to IYHA due to a trouble ticket, then this method will query for its Initiated appointments utilizing the clerk entered Chassis Information for trouble processing within the gate system and TOS system. Here, the Initiated Indicator is yes.

According to a fourth, illustrative matching process, the RFID/UTN and no other Equipment data is provided by the Gate System. Only the UTN and date/time is utilized in the Bobtail Method 4640. The fourth matching method may be executed when all previous methods 1-3 have failed to return an appointment result.

The fourth process may include plurality of parameters including Arrival Date/Time, RFID/UTN, Location, Initiated Indicator, First Container, Second Container, Chassis Number, and Chassis LPN (License Plate Number), wherein Arrival Date/Time corresponds to utilizing the Truck Arrival Date matching only appointments with the same date, RFID/UTN corresponds to utilizing UTN or RFID numbers to find the UTN from the Truck Profile if provided (may be required), location corresponds to the current location of the Truck at the time the Get Target Appointment request, Initiated Indicator corresponds to no. First Container, Second Container, Chassis Number, and Chassis LPN (License Plate Number) are not used and should be blank.

The fourth matching process may include the following steps. Utilizing the RFID/UTN number and Arrival Date and Time search only Active and Pending Single Out Bobtail appointments will be searched within the appointment system. As for a tie breaker, if more than one appointment is found with the same UTN Bobtail specified, then the Timeslot logic will be utilized to further reduce the result set. For the final tie-breaker, use the earliest Appointment ID assuming primary equipment appointment for a multi-equipment appointment would be entered first. If no match results then continue to a forth matching method.

The following scenarios illustrate possible situations relevant to the fourth matching method. For instance, for call forwarding, as a truck enters terminal and all that is known by gate system is the RFID/UTN. Here, the Initiated Indicator is no. For InGate, Bob Tail In where all that is known is the RFID/UTN. Here, the Initiated Indicator is no.

According to a fifth, illustrative matching process, the RFID/UTN is provided by Gate System but no other Equipment data is required to be utilized in this matching algorithm. Only the UTN and date/time is required in the Timeslot Logic Method 4650. The fifth matching method may be executed when all previous methods 1-4 have failed to return an appointment result.

The fifth process may include plurality of parameters including Arrival Date/Time, RFID/UTN, Location, Initiated Indicator, First Container, Second Container, Chassis Number, and Chassis LPN (License Plate Number), wherein Arrival Date/Time corresponds to utilizing the Truck Arrival Date matching only appointments with the same date, RFID/UTN corresponds to utilizing UTN or RFID numbers to find the UTN from the Truck Profile if provided (may be required), location corresponds to the current location of the Truck at the time the Get Target Appointment request, Initiated Indicator corresponds to no. First Container, Second Container, Chassis Number, and Chassis LPN (License Plate Number) are optionally not used

The fifth matching process may include the following steps. Including the RFID/UTN number and Arrival Date and Time search only Active and Pending Primary Move Candidate and Slotted appointments including Single In, Single Out, Dual In Moves utilizing the Timeslot Logic described elsewhere below. If more than one appointment is found with the Timeslot logic, then the final Tie-Breaker will be the earliest Appointment ID, assuming that the primary equipment appointment for a multi-equipment appointment would be entered first by the dispatcher. If no appointments are returned after utilizing this last method, then return a message of No Appointment Found to the gate system. This method is executed only if the above methods found no match or no equipment data is available such as in the initial Call Forward process when only a UTN and date-time is known.

In some implementations, timeslot matching may be performed in order or precedence with the first matching method being first and if not successful, then moving onto methods 2, 3, 4, etc.

FIG. 45 illustrates an exemplary chart of timeslot scenarios consistent with one or more aspects of the innovations herein. First step is to see if an appointment exists for the UTN within the exact timeslot. If no appointment found, the next step is to check for a UTN appointment arrival within a Timeslot Window. The Timeslot Window is defined by an arrival time greater than or equal to Timeslot Begin time −30 minutes (parameterized value is leeway (30) in set limits) or an arrival time less than or equal to Timeslot End Time +30 minutes (parameterized value leeway (30) in set limits). The third step is to check for a Candidate Appointment is checked to determine if there is a candidate appointment for UTN and Date. Next step is to check for closest timeslot either earlier or later to the UTN arrival time. An Earlier Timeslot Variance is calculated by subtracting Earlier Appointment's Timeslot End time from an Arrival Time. If there is no earlier appointment for the day, then set Earlier Timeslot Variance to 1440. A Later Timeslot Variance is calculated by subtracting an Arrival Time from a Later Appointment's Timeslot Begin time. If there is no later appointment for the day, then set Later Timeslot Variance to 1440. From the calculations above (Early Timeslot Variance and Later Timeslot Variance), determine which appointment is closer to the UTN arrival time by choosing the appointment whose timeslot variance value is the lesser of the two timeslot variances. If they are equal take the earlier appointment.

The following scenarios illustrate possible situations relevant to the fifth matching method. Any UTNs where no appointments where returned in the previous processes, 1-4.

FIGS. 47A-47V are diagrams of exemplary appointment system mobile application user interfaces including a landing page (FIG. 47A), terminal landing page (FIG. 47B), menu (FIG. 47C), login (FIG. 47D), gate inquiry (FIGS. 47E-47F), import inquiry (FIGS. 47G-47H), appointment (FIGS. 47I-47P), daily message (FIG. 47Q), terminal location (FIGS. 47R-47T), contact (FIG. 47U), about (FIG. 47V), consistent with one or more aspects of the innovations herein. Additional features and functionality associated with the innovations below are set forth in Appendix 5, which is incorporated herein by reference in entirety.

The VoyagerTrack appointment system mobile application is a mobile webpage integrated into an appointment system and/or a Terminal Operating System (TOS) and/or other related systems providing users with the ability to retrieve information easily via any mobile browser, such as a smart phone or tablet device.

The mobile application may provide system users with the capability to create/update/delete appointments from a mobile device from almost anywhere, at any time and prior to actual arrival to the terminal. The application may also provide basic terminal information/rules/advisory, terminal location/directions, equipment availability and inventory summary, EIR viewing, and container inventory screen.

The mobile application processing through the TOS via the appointment system may assist in reducing congestion at the gate and streamlining gate transactions by decreasing gate trouble occurrences.

In various implementations as described herein, the various GUIs provided by the mobile interfaces are transmitted and processed by one or more servers, computing devices and/or computer-readable media that may be TOS agnostic systems. The actions performed by the system is provided to a mobile interface or any computing interface.

In some implementations of the invention, a system includes one or more servers, computing devices and/or computer-readable media processing instructions executable by one or more processors for managing an appointment system and/or terminal operating system. The instructions including instructions for processing information for display on the mobile device from an appointment system for a terminal operating system, the information including first information that includes mobile-input appointment information. A mobile interface is provided for receiving user input associated with appointment functionality. One or more processing devices process information related to the user input, received via the mobile interface, to manage the appointment functionality, the processor performing processing to generate an output and/or a result associated with: processing and/or transmitting instructions within the appointment system, to a computing device external to the appointment system, or a combination thereof; executing the appointment functionality via the appointment system such that an output of a result of the managed appointment functionality and/or the processed information is produced; and/or processing, transmitting and/or executing a combination of features involving the output and/or result.

Further, in certain implementations, the innovations herein may include or involve terminal operating system (TOS) agnostic processing. The user input may include a command to establish an import container appointment, modify an import container appointment, search import container appointments, delete an import container appointment, view an import container appointment, or a combination thereof. The output may include an established import container appointment, a modified import container appointment, a search result including an import container appointment, a deletion of an import container appointment, a display of an import container appointment, or a combination thereof. The appointment functionality may include landing page functionality, terminal landing page functionality, menu functionality, login page functionality, gate inquiry functionality, import inquiry functionality, appointment inquiry functionality, appointment details functionality, appointment modification functionality, appointment deletion functionality, appointment setup functionality, appointment status functionality, message functionality, location functionality, direction functionality, contact functionality, general information functionality, or a combination hereof. The generated output and/or result provides reduced operational costs from improved gate efficiency, accelerated throughput, better equipment utilization, or a combination thereof.

FIG. 47A illustrates an exemplary mobile application landing page GUI, consistent with one or more aspects of the innovations herein. The mobile landing page may be linked to a mobile Web URL associated with an active terminal site defined in the appointment system, for example. From this landing page, a user is able to enter/search/select 4700A a specific terminal. Once input, the GUI will redirect user and display that specific terminal's mobile web page, as illustrated in FIG. 47B.

FIG. 47B illustrates an exemplary mobile application terminal landing page GUI, consistent with one or more aspects of the innovations herein. The GUI of FIG. 47B illustrates an individual mobile Web URL page 4700B for a specific terminal. The terminal web page may represent a web page of a combination of terminals, depending on a user's login access rights. Other available options from landing pages is, a user may choose a specific feature tile prompting user to identify a terminal, displaying data relevant to terminal. Data will be retrieved from appointment system.

FIG. 47C illustrates an exemplary mobile application menu GUI, consistent with one or more aspects of the innovations herein. Side menu 4700C provides users another means to open a mobile webpage sub-application. In addition to interactive feature links, there will be an additional link providing users with information not listed on the main feature page, such as about us, logout, etc.

FIG. 47D illustrates an exemplary mobile application login GUI, consistent with one or more aspects of the innovations herein. Access to certain features will require a user login. When the login page 4700D appears, users will be required to input a Username and Password. Once input, the username and password may validate against appointment system login security data. Following system validation of login, user may access all mobile application secure features via appointment system.

FIGS. 47E-47F are diagrams of exemplary mobile application gate inquiry GUI, consistent with one or more aspects of the innovations herein. The Gate Inquiry functionality as illustrated in FIG. 47G, will provide users with the ability to search for EIRs for containers or chassis. As this is a security feature, a user will be required to first login, before searching 4700E for EIRs associated with terminal EIR data the user has access to. GUI 4700F illustrated in FIG. 47F shows the results of the EIR search and may include data associated with container number, container size, move type, SSCO, etc. derived from an appointment system gate activity page.

FIGS. 47G-47H are diagrams of exemplary mobile application import inquiry GUI, consistent with one or more aspects of the innovations herein. Users may use the Import Inquiry search 4700G to check on the availability status of import containers by inputting relevant search information. GUI 4700H illustrated in FIG. 47H shows the results of the import search and may include data associated with a container number, container size, location, SSCO, etc. derived from appointment system import report page.

FIGS. 47I-47P are diagrams of exemplary mobile application appointment GUI, consistent with one or more aspects of the innovations herein. FIG. 47I is an exemplary appointment inquiry page where a user may input search parameters and/or select an appointment move type, at 4700I, such as from a drop down menu, which may include options such as empty in container, full out container (import), empty out container, full in container (export), booking number, release number, bare chassis in, bare chassis out, import dray in, export dray off, bill of lading, etc. As this may involve secure features and functionality, a user will be required to first login, before searching 4700I for equipment appointment to determine appointment status and then make, modify or delete appointment associated with appointment system data the user has access to. FIG. 47J is an exemplary appointment detail page 4700J showing appointment details including container details and availability derived from appointment system import report page. Appointment actions and setup may also be selected allowing user to make, modify or delete an appointment for final appointment validation. FIG. 47K is an exemplary make appointment page including an appointment action 4700K where a user may select to make an appointment. FIG. 47L is an exemplary modify appointment page including an appointment action 4700L where a user may select to modify an appointment. FIG. 47M is an exemplary delete appointment including an appointment action 4700M where a user may select to delete an appointment. FIG. 47N is an exemplary appointment setup page including an appointment action 4700N where a user may setup appointment details including time slot, trucker code, date, etc. To submit appointment for final appointment validation for make, modify or delete appointment action may be displayed showing appointment details 4700N that have been made, modified or deleted. FIG. 47O is an exemplary appointment results page including an appointment status 4700O confirming the make appointment action. FIG. 47P is an exemplary appointment results page including an appointment status 4700P confirming the delete appointment action.

FIG. 47Q illustrates an exemplary mobile application message GUI, consistent with one or more aspects of the innovations herein. Daily message announcements 4700Q may be taken directly from appointment system Daily Message page. The contents will vary depending on the requirements of each terminal may include messages associated with Priority Message of the Day, Message of the Day and Trucker Information.

FIGS. 47R-47T are diagrams of exemplary mobile application terminal location GUI, consistent with one or more aspects of the innovations herein. A terminal location may be displayed on a map 4700R. For instance, a link to a third party map 4700R may be provided and allows a user to request route directions from their location to the terminal. Map 4700S illustrated in FIG. 47S further includes illustrated directions. The GUI may also display written directions 4710S as shown in FIG. 47T.

FIG. 47U illustrates an exemplary mobile application contact GUI, consistent with one or more aspects of the innovations herein. The contact page may include contact information 4700T such as a mailing address and relevant telephone numbers.

FIG. 47V illustrates an exemplary mobile application about GUI, consistent with one or more aspects of the innovations herein. The About Us page may include general information 4700U regarding a terminal or any number of terminals.

The innovations herein may be implemented via one or more components, systems, servers, appliances, other subcomponents, or distributed between such elements. When implemented as a system, such system may comprise, inter alia, components such as software modules, general-purpose CPU, RAM, etc. found in general-purpose computers, and/or FPGAs and/or ASICs found in more specialized computing devices. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and other media. Computer readable media herein, however, does not encompass/include transitory media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules or other data constituting the functionality herein, embodied in non-transitory format. Further, communication media may include wired media such as a wired network or direct-wired connection, embodied tangibly. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission. Also, the modules can be implemented as hardware logic circuitry implementing the functions encompassed by the innovations herein. Finally, the modules can be implemented using special purpose instructions (SIMD instructions), field programmable logic arrays or mixtures of those or other suitable elements which provide the desired level performance and cost.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though computer readable media herein does not encompass/include transitory media.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the inventions have been specifically described herein, it will be apparent to those skilled in the art to which the inventions pertains that variations and modifications of the various implementations shown and described herein may be made without departing from the spirit and scope of the inventions. Accordingly, it is intended that the inventions be limited only to the extent required by the applicable rules of law.

1. A computer-implemented method for processing information involving an appointment system for a terminal operating system, the method comprising:
providing information for display, to a user, of an interface comprising appointment functionality and an input field to receive a user input, the information comprising first information that includes appointment information;
processing information related to the user input, received via the interface, to manage the appointment functionality; and
performing processing to generate an output and/or a result associated with:
processing and/or transmitting instructions within the appointment system, to a computing device external to the appointment system, or a combination thereof;
executing the appointment functionality via the appointment system such that an output of a result of the managed appointment functionality and/or the processed information is produced; and/or
processing, transmitting and/or executing a combination of features involving the output and/or result.

2. The method of claim 1, wherein the user input comprises a command to establish an import container appointment, modify an import container appointment, search import container appointments, delete an import container appointment, view an import container appointment, or a combination thereof.

3. The method of claim 1, wherein the output comprises an established import container appointment, a modified import container appointment, a search result including an import container appointment, a deletion of an import container appointment, a display of an import container appointment, or a combination thereof.

4. The method of claim 1, wherein the user input comprises a command to establish an export booking appointment, modify an export booking appointment, search export booking appointments, delete ex an export booking appointment, view an export booking appointment, or a combination thereof.

5. The method of claim 1, wherein the output comprises an established export booking appointment, a modified export booking appointment, a search result including an export booking appointment, a deletion of an export booking appointment, a display of an export booking appointment, or a combination thereof.

6. The method of claim 1, wherein the user input comprises a command to establish an empty-in container appointment, modify an empty-in container appointment, search empty-in container appointments, delete an empty-in container appointment, view an empty-in container appointment, or a combination thereof.

7. The method of claim 1, wherein the output comprises an established empty-in container appointment, a modified empty-in container appointment, a search result including an empty-in container appointment, a deletion of an empty-in container appointment, a display of an empty-in container appointment, or a combination thereof.

8. The method of claim 1, wherein the user input comprises a command to establish an appointment report, modify an appointment report, search appointment reports, delete an appointment report, view an appointment report, or a combination thereof.

9. The method of claim 1, wherein the output comprises an established appointment report, a modified appointment report, a search result including an appointment report, a deletion of an appointment report, a display of an appointment report, or a combination thereof.

10. The method of claim 1, wherein the user input comprises a command to establish an appointment limit setting, modify an appointment limit setting, search appointment limit settings, delete an appointment limit setting, view an appointment limit setting, or a combination thereof.

11. The method of claim 1, wherein the output comprises an established appointment limit setting, a modified appointment limit setting, a search result including an appointment limit setting, a deletion of an appointment limit setting, a display of an appointment limit setting, or a combination thereof.

12. The method of claim 10, wherein the appointment limit setting includes a gate operating time, a time slot, an appointment limit for a terminal, or a combination thereof.

13. The method of claim 10, further comprising generating and storing a template of the appointment limit setting.

14. The method of claim 1, further comprising displaying appointment statistics.

15. The method of claim 1, wherein the user input comprises a command to establish an appointment limit report, modify an appointment limit report, search appointment limit reports, delete an appointment limit report, view an appointment limit report, or a combination thereof.

16. The method of claim 1, wherein the output comprises an established appointment limit report, a modified appointment limit report, a search result including an appointment limit report, a deletion of an appointment limit report, a display of an appointment limit report, or a combination thereof.

17. The method of claim 1, wherein the user input comprises a command to establish an appointment configuration for a terminal, modify an appointment configuration for a terminal, search appointment configurations for a terminal, delete an appointment configuration for a terminal, view an appointment configuration for a terminal, or a combination thereof.

18. The method of claim 1, wherein the output comprises an established appointment configuration for a terminal, a modified appointment configuration for a terminal, a search result including an appointment configuration for a terminal, a deletion of an appointment configuration for a terminal, a display of an appointment configuration for a terminal, or a combination thereof.

19. The method of claim 1, wherein the generated output and/or result provides reduced operational costs from improved gate efficiency, accelerated throughput, better equipment utilization, or a combination thereof.

20. A computer-implemented method for processing information involving a payment system for a terminal operating system, the method comprising:
providing information for display, to a user, of an interface comprising payment functionality and an input field to receive a user input, the information comprising first information that includes online payment information;
processing information related to the input, received via the interface, to manage the payment functionality; and
performing processing to generate an output and/or a result associated with:
processing and/or transmitting instructions within the payment system, to a computing device external to the payment system, or a combination thereof;
executing the payment functionality via the payment system such that an output of a result of the managed payment functionality and/or the processed information is produced; and/or
processing, transmitting and/or executing a combination of features involving the output and/or result.

21.-285. (canceled)
